(19) United States
(12) Patent Application Publication
(10) Pub. No.: US 2026/0348180 A1
(43) Pub. Date: Nov. 5, 2026

(54) HYBRID FILTER VALVE AND CHEMICAL CLEANING ASSEMBLY AND METHOD

(71) Applicant: Pentair Water Pool and Spa, Inc., Golden Valley, MN (US)

(72) Inventors: Azur Dzindo, Raleigh, NC (US); Thomas Johnson Ray Safon, Holly Springs, NC (US); Caleb Ray, Apex, NC (US); Anas Alhajeh, Clayton, NC (US); Alexander Smith, Fuquay-Varina, NC (US); Donnie Fore, Sanford, NC (US); Eric Pinnell, Holly Springs, NC (US); Kenneth Koch, Apex, NC (US); Dana Stephanie Royer Adams, Holly Springs, NC (US); Sean McEwan, Chapel Hill, NC (US); Pashupati Dhakal, Garner, NC (US); Patrick Keene, Golden Valley, MN (US); Montie Roland, Sanford, NC (US); Rebekah Ann Hedblom, Apex, NC (US); Keith Lewis, New Hill, NC (US); Grace Marek, Raleigh, NC (US); Alexander Ryan Garcia, Raleigh, NC (US); Mauricio Valencia, New Hill, NC (US); David Durrette, Wake Forest, NC (US); Keena Holley, Knightdale, NC (US); Jared Allen, Apex, NC (US); Jeffrey A. Wilson, Raleigh, NC (US); Samuel Friedel, Raleigh, NC (US); Jeffrey Young, Cary, NC (US)

(21) Appl. No.: 19/667,218

(22) Filed: May 4, 2026

Related U.S. Application Data
(60) Provisional application No. 63/799,169, filed on May 2, 2025.
(60) Provisional application No. 63/993,032, filed on Feb. 27, 2026.

(51) Int. Cl. E04H 4/12; C02F 1/00; C02F 103/42

(52) U.S. Cl. CPC E04H 4/1218; C02F 1/001; C02F 1/008; E04H 4/1245; C02F 2103/42; C02F 2209/02; C02F 2209/40; C02F 2303/16

(57) ABSTRACT

The present disclosure includes a filtration system having a pump in fluid communication with a pool or a spa and a hybrid filter assembly including: one or more membrane filters, a prefilter in fluid communication with the one or more membrane filters, a valve, and a controller. The valve includes a first port in fluid communication with the one or more membrane filters, a second port in fluid communication with the prefilter, a third port in fluid communication with the pump, a fourth port in fluid communication with the pool or the spa, and a fifth port in fluid communication with a waste system. The hybrid filter assembly also includes a chemical cleaning system with a container designed to retain a chemical cleaning agent, where the container is in fluid communication with the hybrid filter assembly. The controller is in communication with the valve to perform several functions described herein.

### CROSS REFERENCE TO RELATED APPLICATIONS

This application claims the benefit of and priority to U.S. Provisional Patent Application No. 63/799,169, filed May 2, 2025, entitled “HYBRID FILTER VALVE AND CHEMICAL CLEANING ASSEMBLY AND METHOD,” and to U.S. Provisional Patent Application No. 63/993,032, filed Feb. 27, 2026, entitled “HYBRID FILTER VALVE AND CHEMICAL CLEANING ASSEMBLY AND METHOD,” the entire contents of which are incorporated herein by reference.

### TECHNICAL FIELD

This disclosure generally relates to filters. More particularly, the disclosure relates to a hybrid two-stage filter for an aquatic application.

### BACKGROUND

Filtration systems are an important aspect of maintaining water clarity and quality in aquatic systems. Contaminants containing bacteria or pathogens may be introduced into bodies of water by environmental sources. Other contaminants or debris may be introduced by swimmers and bathers, such as sweat, bodily oils or secretions, suntan lotion, urine, and other substances. In addition to contributing to high turbidity, contaminants can also react with disinfectant chemicals to produce chloramines and other disinfection by-products, which can contribute to adverse health effects. Thus, in pool and spa systems, to clean the water, the water is typically passed through a filtration system. Filtration systems are used to remove pollutants and contaminants to reduce turbidity and to promote the visual clarity of the water. Filtration systems are one mechanism used to help ensure healthy conditions in swimming pools, hot tubs, spas, plunge pools, and other recreational water venues or aquatic applications.

Traditional pool and spa filtration technologies include diatomaceous earth filters, pressure-fed sand filters, gravity sand filters, and cartridge filters. However, these filtration technologies have inherent shortcomings, including the inability to capture small, suspended solids, bacteria, and viruses without the use of filter aids or secondary sanitization devices. Conversely, high-efficiency filter media technology capable of capturing submicron particles and microorganisms may not be able to process larger suspended solids without becoming clogged. Thus, high-efficiency filter media such as Reverse Osmosis (RO), hollow fiber membrane, or SiC (Silicon Carbide) ceramic technology is traditionally employed through the use of one or more prefilter(s) to capture larger particles.

Traditional filter systems can be cleaned through backwash operations, where the flow of water is reversed through the system to loosen and remove trapped particulates. However, when traditional and high-efficiency filters are used together in the same system, it is difficult to clean the filters to maintain their performance over time. For example, the backwash operations used for traditional filter systems may not effectively clean both the traditional and high-efficiency filter. Furthermore, backwashing may not remove all the contaminants collected by the filter, especially contaminants like organics, viruses, and bacteria. Additionally, systems that use both traditional and high-efficiency filters may be too large to fit on existing pool pads and may require the construction of a new and/or larger pad to allow for installation in an existing pool system.

Therefore, there is a need in the art for a filtration system that can effectively filter out both large and small contaminants without the filtration system becoming clogged. Additionally, there is a need for a filtration system that includes systems and methods for effectively cleaning the hybrid filter components to remove particulates, contaminants, and debris of various sizes. Furthermore, there is a need for a filtration system that includes both traditional and high-efficiency filters and has a reduced footprint.

### SUMMARY

In a first aspect of the present disclosure, the techniques described herein relate to a filtration system including: a pump in fluid communication with a pool or a spa and a hybrid filter assembly including: one or more membrane filters, a prefilter in fluid communication with the one or more membrane filters, and a valve. The valve includes a first port in fluid communication with the one or more membrane filters, a second port in fluid communication with the prefilter, a third port in fluid communication with the pump, a fourth port in fluid communication with the pool or the spa, and a fifth port in fluid communication with a waste system. The valve is designed to receive pressurized water provided from the pump. The hybrid filter assembly also includes a chemical cleaning system with a container designed to retain a chemical cleaning agent, where the container is in fluid communication with the hybrid filter assembly. The hybrid filter assembly also includes a controller in communication with the valve and the chemical cleaning system that is designed to actuate the valve to a filtration configuration, where the valve couples the third port to the second port and the first port to the fourth port, direct the chemical cleaning system to dose the one or more membrane filters with the chemical cleaning agent, and actuate the valve to a backwash configuration, where the valve couples the third port to the first port and the second port to the fifth port.

In a second aspect of the present disclosure, according to the first aspect or any other aspect, the controller is further designed to determine an operational efficiency of the filtration system at predetermined time intervals.

In a third aspect of the present disclosure, according to the second aspect or any other aspect, the controller is further designed to determine if a first permeability value determined at a first time period associated with the predetermined interval of time is below a first threshold permeability value.

In a fourth aspect of the present disclosure, according to the first aspect or any other aspect, the controller is further designed to retain the chemical cleaning agent within an interior of the one or more membrane filters for at least about 1 hour before actuating the valve to the backwash configuration.

In a fifth aspect of the present disclosure, according to the first aspect or any other aspect, the controller is further designed to actuate the valve to a rinse configuration, wherein the valve couples the third port to the second port and the first port to the fifth port.

In a sixth aspect of the present disclosure, according to the first aspect or any other aspect, the controller is further designed to determine a first permeability value of the one or more membrane filters at a first time period, determine a second permeability value of the one or more membrane filters at a second time period, actuate the valve to the backwash configuration if the first permeability value is less than a first permeability threshold value, and direct the chemical cleaning system to dose the one or more membrane filters with the chemical cleaning agent. The controller will dose the one or more membrane filters with the chemical cleaning agent if the second permeability value is less than a second permeability threshold value and the second time period is after the first time period.

In a seventh aspect of the present disclosure, according to the first aspect or any other aspect, the controller is further configured to determine if a permeability value of the one or more membrane filters is less than about 350.

In an eighth aspect of the present disclosure, according to the first aspect or any other aspect, the controller is further configured to actuate the valve to a bypass configuration, wherein the valve couples the third port to the fourth port.

In a ninth aspect of the present disclosure, the techniques described herein relate to a filtration system. The filtration system may include a pump in fluid communication with a pool or a spa; a hybrid filter assembly in fluid communication with the pump. The hybrid filter assembly may include a first membrane filter; a prefilter arranged upstream of and fluidly coupled to the first membrane filter when the hybrid filter assembly operates in a filtration mode; and a valve. The valve may include a first port coupled to the first membrane filter, a second port coupled to the prefilter, a third port coupled to the pump and configured to receive pressurized water, a fourth port coupled to the pool or the spa, and a fifth port coupled to a waste system. The filtration system may further include a chemical cleaning system in fluid communication with the hybrid filter assembly and including a chemical cleaning agent; and a controller in communication with the valve and the chemical cleaning system. The controller may be configured to actuate the valve in a filtration configuration. The valve couples the third port to the second port and the first port to the fourth port; monitor a permeability value of the first membrane filter within the filtration configuration; actuate the valve in a bypass configuration in response to the permeability value falling below a minimum permeability threshold value. The valve couples the third port to the fourth port. The controller may further direct the chemical cleaning system to dose the first membrane filter with the chemical cleaning agent and actuate the valve in a backwash configuration, wherein the valve couples the third port to the first port and the second port to the fifth port.

In a tenth aspect of the present disclosure according to the ninth aspect or any other aspect, the controller is further configured to: actuate the valve in a rinse configuration, wherein the valve couples the third port to the second port and the first port to the fifth port; request the pump to operate at a requested flow rate; and maintain the valve in the rinse configuration until a predetermined rinse volume has been processed.

In an eleventh aspect of the present disclosure according to the ninth aspect or any other aspect, the controller is further configured to maintain the chemical cleaning agent within an interior of the one or more membrane filters for at least about one hour before actuating the valve to the backwash configuration.

In a twelfth aspect of the present disclosure according to the ninth aspect or any other aspect, the chemical cleaning agent includes chlorine.

In a thirteenth aspect of the present disclosure according to the ninth aspect or any other aspect, the controller is further configured to receive a pool temperature value, determine that the pool temperature value is below a temperature threshold value, and decrease a permeability threshold value.

In a fourteenth aspect of the present disclosure according to the ninth aspect or any other aspect, the controller is further configured to: receive a pool temperature value, determine that the pool temperature value is below a temperature threshold value, and increase a dose value.

In a fifteenth aspect of the present disclosure according to the ninth aspect or any other aspect, the controller is further configured to: receive a pool temperature value, determine that the pool temperature value is below a first temperature threshold value, decrease a permeability threshold value, determine that the pool temperature value is below a second temperature threshold value, and increase a dose value.

In a sixteenth aspect of the present disclosure, the techniques described herein relate to a filtration system. The filtration system includes a pump in fluid communication with a pool or a spa and a hybrid filter assembly in fluid communication with the pump. The hybrid filter assembly includes a membrane module, a prefilter arranged upstream of and fluidly coupled to the membrane module when the hybrid filter assembly operates in a filtration mode, and an electrically-actuatable valve. The electrically-actuatable valve may include a first port coupled to the membrane module, a second port coupled to the prefilter, a third port coupled to the pump and configured to receive pressurized water, a fourth port coupled to the pool or the spa, and a fifth port coupled to a waste system. The filtration system may further include an air relief valve in fluid communication with the hybrid filter assembly, an air relief water sensor positioned at an air relief valve outlet and configured to detect a water presence, a chemical cleaning system in fluid communication with the hybrid filter assembly and including a chemical cleaning agent, a controller in communication with the electrically-actuatable valve, the air relief valve, the air relief water sensor, and the chemical cleaning system. The controller may be configured to actuate the electrically-actuatable valve in a filtration configuration, wherein the electrically-actuatable valve couples the third port to the second port and the first port to the fourth port; determine that the hybrid filter assembly requires a backwash cycle; actuate the electrically-actuatable valve in a bypass configuration, wherein the electrically-actuatable valve couples the third port to the fourth port; request the pump to operate at a requested flow rate; open the air relief valve; receive an indication from the air relief water sensor indicating water is present at the air relief outlet; and close the air relief valve in response to receiving the indication; direct the chemical cleaning system to dose the membrane module with the chemical cleaning agent; and actuate the electrically-actuatable valve in a backwash configuration, wherein the electrically-actuatable valve couples the third port to the first port and the second port to the fifth port.

In a seventeenth aspect of the present disclosure according to the sixteenth aspect or any other aspect, the controller is further configured to maintain the chemical cleaning agent within an interior of the membrane module for at least about 1 hour based on a dose value before actuating the electrically-actuated valve to the backwash configuration.

In an eighteenth aspect of the present disclosure according to the seventeenth aspect or any other aspect, the controller is further configured to: receive a pool temperature value; determine that the pool temperature value is below a temperature threshold value; and increase the dose value.

In a nineteenth aspect of the present disclosure according to the sixteenth aspect or any other aspect, to determine that the hybrid filter assembly requires a backwash cycle, the controller is further configured to determine that a permeability value is below a minimum permeability threshold value.

In a twentieth aspect of the present disclosure according to the nineteenth aspect or any other aspect, the controller is further configured to: receive a pool temperature value; determine that the pool temperature value is below a temperature threshold value; and decrease the minimum permeability threshold value.

These and other aspects and advantages of the present disclosure will become apparent to those skilled in the art after considering the following detailed description in connection with the accompanying drawings.

### BRIEF DESCRIPTION OF THE DRAWINGS

FIG. 1 is a schematic diagram depicting a swimming pool and one or more components associated with a pool pad;

FIG. 2 is a front isometric view of a hybrid filter assembly;

FIG. 3 is a left side view of the hybrid filter assembly of FIG. 2;

FIG. 4 is a front isometric view of the hybrid filter assembly of FIG. 2 having a housing removed;

FIG. 5 is a front isometric view of the hybrid filter assembly of FIG. 2 having the housing and a frame removed;

FIG. 6 is a front side elevational view of the hybrid filter assembly of FIG. 5;

FIG. 7 is a left side elevational view of the hybrid filter assembly of FIG. 5;

FIG. 8 is a right side elevational view of the hybrid filter assembly of FIG. 5;

FIG. 9 is a front isometric view of a valve;

FIG. 10 is a left side elevational view of the valve of FIG. 9;

FIG. 11 is a right side elevational view of the valve of FIG. 9;

FIG. 12 is a front side elevational view of the valve of FIG. 9;

FIG. 13 is a rear side elevational view of the valve of FIG. 9;

FIG. 14 is a bottom plan view of the valve of FIG. 9;

FIG. 15 illustrates a schematic block diagram of a swimming pool and the hybrid filter assembly of FIG. 2 operating in a filtration mode;

FIG. 16 illustrates a schematic block diagram of a swimming pool and the hybrid filter assembly of FIG. 2 operating in a backwash mode;

FIG. 17 illustrates a schematic block diagram of a swimming pool and the hybrid filter assembly of FIG. 2 operating in a rinse mode;

FIG. 18 illustrates a schematic block diagram of a swimming pool and the hybrid filter assembly of FIG. 2 operating in a bypass mode;

FIG. 19 illustrates a schematic block diagram of a swimming pool and the hybrid filter assembly of FIG. 2 operating in a winterize mode;

FIG. 20 illustrates a flow diagram depicting a method for operating the hybrid filter assembly of FIG. 2 in a filtration configuration or a backwash configuration;

FIG. 21 illustrates a flow diagram depicting a method for operating the hybrid filter assembly of FIG. 2 in a diagnostics configuration;

FIG. 22 illustrates a flow diagram depicting a method for operating the hybrid filter assembly of FIG. 2 in a backwash configuration;

FIG. 23 illustrates a flow diagram depicting a method for operating the hybrid filter assembly of FIG. 2 in a chemical cleaning configuration;

FIG. 24 illustrates a flow diagram depicting an alternative method for operating the hybrid filter assembly of FIG. 2;

FIG. 25 illustrates a flow diagram depicting a method for scheduling a backwash cleaning operation and a chemical cleaning operation for the hybrid filter assembly of FIG. 2;

FIG. 26 illustrates a flow diagram depicting another method for scheduling a backwash cleaning operation and/or a chemical cleaning operation for the hybrid filter assembly of FIG. 2;

FIG. 27 illustrates a flow diagram depicting a method for updating one or more backwash parameter values based on pool water temperature for the hybrid filter assembly of FIG. 2;

FIG. 28 illustrates a flow diagram depicting a method for updating one or more backwash parameter values based on one or more pool operational parameter values for the hybrid filter assembly of FIG. 2;

FIG. 29 illustrates a flow diagram depicting a method for updating a permeability threshold value for the hybrid filter assembly of FIG. 2;

FIG. 30 illustrates a flow diagram depicting a method for determining a permeability value for the hybrid filter assembly of FIG. 2;

FIG. 31 illustrates a flow diagram depicting a method for performing a deaeration cycle before a backwash cycle for the hybrid filter assembly of FIG. 2;

FIG. 32 illustrates a flow diagram depicting a method for generating backwash instructions for the hybrid filter assembly of FIG. 2;

FIG. 33A is a front isometric view of another hybrid filter assembly;

FIG. 33B is an isometric view of a portion of a housing of the hybrid filter assembly in FIG. 33A;

FIG. 33C is an isometric view of another portion of the housing of the hybrid filter assembly in FIG. 33A;

FIG. 33D is a front left isometric view of the hybrid filter assembly in FIG. 33A having portions of the housing removed;

FIG. 33E is a front right isometric view of the hybrid filter assembly in FIG. 33A having portions of the housing removed;

FIG. 33F is a rear left isometric view of the hybrid filter assembly in FIG. 33A having portions of the housing removed;

FIG. 33G is a rear right isometric view of the hybrid filter assembly in FIG. 33A having portions of the housing removed;

FIG. 33H is a front elevational view of a membrane module included in the hybrid filter assembly;

FIG. 33I is a cutaway side view of the membrane module of FIG. 33H;

FIG. 33J is a partial see-through front left isometric view of the hybrid filter assembly in FIG. 33A having certain components removed;

FIG. 33K is a partial front isometric view of the hybrid filter assembly in FIG. 33A having certain components removed;

FIG. 33L is a front top isometric view of a panel included in the hybrid filter assembly in FIG. 33A;

FIG. 33M is a front top isometric view of a cross member included in the hybrid filter assembly in FIG. 33A;

FIG. 33N is a front view of a brace included in the hybrid filter assembly in FIG. 33A;

FIG. 33O is an isometric view of a reservoir included in the hybrid filter assembly in FIG. 33A;

FIG. 33P is an isometric view of a cap included in the reservoir of FIG. 33O;

FIG. 33Q is an isometric view of certain components of the cap in FIG. 33P;

FIG. 33R is an isometric view of a base portion of the cap in FIG. 33P;

FIG. 33S is an elevational see-through front view of the cap in FIG. 33P;

FIG. 33T is an isometric view of a deaeration system with some components of the hybrid filter assembly in FIG. 33A;

FIG. 33U is another isometric view of the deaeration system of FIG. 33T;

FIG. 33V is an isometric view of the hybrid filter assembly of FIG. 33A, illustrating an access door in an open position to provide access to the reservoir;

FIG. 34 illustrates a flow diagram depicting a method for updating a chlorine concentration value;

FIG. 35 illustrates a flow diagram depicting another method for updating a chlorine concentration value;

FIG. 36 illustrates a flow diagram depicting a method for dosing a hybrid filter assembly based on an updated chlorine concentration value;

FIG. 37 illustrates a flow diagram depicting a preconditioning process for a hybrid filter assembly;

FIG. 38 illustrates a flow diagram depicting a main control flow method for a hybrid filter assembly;

FIG. 39 illustrates a flow diagram depicting a backwash method for a hybrid filter assembly;

FIG. 40 illustrates a flow diagram depicting a chemical soak method for a hybrid filter assembly;

FIG. 41 illustrates a flow diagram depicting a rinse method for a hybrid filter assembly; and

FIG. 42 illustrates a flow diagram depicting a deaeration method for a hybrid filter assembly.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

Before any instances are described in detail, it is to be understood that the disclosure is not limited in its application to the details of construction and the arrangement of components set forth in the following description or illustrated in the following drawings, which is limited only by the claims that follow the present disclosure. The disclosure is capable of other instances, and of being practiced, or of being carried out, in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use instances of the disclosure. Various modifications to the illustrated instances will be readily apparent to those skilled in the art, and the generic principles herein can be applied to other instances and applications without departing from instances of the disclosure. Thus, instances of the disclosure are not intended to be limited to instances shown but are to be accorded the widest scope consistent with the principles and features disclosed herein. The following detailed description is to be read with reference to the figures, in which like elements in different figures have like reference numerals. Skilled artisans will recognize that the examples provided herein have many useful alternatives and fall within the scope of instances of the disclosure.

Additionally, while the following discussion may describe features associated with specific devices, it is understood that additional devices and/or features can be used with the described systems and methods, and that the discussed devices and features are used to provide examples of possible instances, without being limited.

The present disclosure provides a filtration system (e.g., a hybrid filter system) provided in the form of a two-stage hybrid filter assembly, the hybrid filter assembly designed for use in an aquatic application (e.g., a pool and/or a spa). The hybrid filter assembly is provided in the form of a high-efficiency, single-pass device configured to process (e.g., filter) water provided from a pool and/or a spa. In some instances, the two-stage filtration assembly is entirely retained and/or enclosed within a single vessel (e.g., a housing) and can capture both larger suspended solids and submicron particles in a single pass of the fluid through the vessel. In other instances, each stage of the two-stage filtration assembly is provided in a separate vessel (e.g., a first housing and a second housing). A first filtration stage employs depth filtration configured to capture large particulates and acts as a prefilter for a second filtration stage, thereby improving the performance and the operational lifetime of the second filtration stage. The second filtration stage is provided in the form of a membrane filtration module having one or more membranes configured to capture submicron particulates, bacteria, and/or viruses. Thus, by being able to capture both large and small suspended solids in an aquatic system, the two-stage filtration device can filter out contaminants such as skin cells, pollen, algae spores, and microorganisms such as bacteria and viruses that may not be effectively filtered out in traditional pool and spa filtration systems. Therefore, the two-stage filtration system provides improved water clarity, decreased disinfection byproduct formation, and decreased demand for a primary recreational water sanitizer and balancer, along with more consistent sanitizer and balancer levels in the water. Further, the hybrid filtration assembly can allow both filtration stages of the hybrid filter assembly to be backwashed simultaneously.

The hybrid filter assembly is configured to operate as a filtration device within a body of water or aquatic application, particularly a pool or spa system, to supplement and/or entirely replace a main filter, such as a traditional sand, cartridge, or diatomaceous earth filter. Traditional pool and spa filters are generally capable of capturing particles between about 3 to about 30 microns in size. In contrast, in some instances, the hybrid filter assembly disclosed herein is configured to capture particles larger than about 150 microns in size, particularly in the range of about 200 microns to about 300 microns in size in the first filtration stage, and is capable of capturing particles larger than about 0.005 microns in size, particularly in the range of about 0.02 to about 0.20 microns in the second filtration stage. In some forms, the first filtration stage captures particles that are about 10 microns or larger in size. In other instances, the hybrid filter assembly disclosed herein is configured to capture particles larger than 150 microns in size, particularly in the range of 200 microns to 300 microns in size in the first filtration stage, and is capable of capturing particles larger than 0.005 microns in size, particularly in the range of 0.02 to 0.20 microns in the second filtration stage. In some forms, the first filtration stage captures particles that are 10 microns or larger in size.

The present disclosure provides a hybrid filtration system that includes a two-stage filtration assembly with an automated chemical cleaning system. Fluid flow through the hybrid filtration system may be controlled, managed, or regulated via a multi-port valve that is controlled by a controller. In some instances, the hybrid filtration system can include one or more membrane filters and a prefilter in fluid communication with the membrane filters, a valve having multiple ports (e.g., a multi-port valve) configured or designed to direct fluid flow through different flow paths in the hybrid filtration system, and a chemical cleaning system configured or designed to selectively deliver a chemical cleaning agent to the membrane filters. In certain instances, the controller can be configured or designed to actuate the valve to a filtration configuration to direct water from a pump through the prefilter and the membrane filters and back to the pool or spa, direct the chemical cleaning system to dose the membrane filters with the chemical cleaning agent, and actuate the valve in a backwash configuration to reverse the flow direction (relative to the filtration flow path) and direct waste created during the backwashing to a waste system. In some instances, the controller can maintain the chemical cleaning agent within an interior of the membrane filters for a predetermined time period, such as at least about one hour, before initiating the backwash configuration. In certain instances, the controller can also actuate the valve in additional configurations, including a bypass configuration that directs water directly back to the pool or spa without passing through the filtration stages, and a rinse configuration that directs filtered water to waste.

In some instances, the controller may be configured or designed to monitor operational efficiency of the filtration system and trigger cleaning operations based on measured parameters. For example, the controller can monitor a permeability value of the one or more membrane filters during operation in the filtration configuration and may actuate the valve in a bypass configuration in response to the permeability value falling below a minimum permeability threshold value. In certain instances, the controller can determine permeability values of the one or more membrane filters at predetermined intervals (e.g., predetermined time intervals, predetermined water volumes processed by the hybrid filtration system, etc.) and may compare those predetermined values to threshold values to determine when cleaning operations may be beneficial or needed. In some instances, the controller may receive environmental parameters, such as pool temperature values, and adjust operational parameters based on those environmental parameters. For example, the controller can decrease a permeability threshold value or increase a dose value of the chemical cleaning agent in response to determining that the pool temperature is below a temperature threshold value.

In certain instances, the system can include an air relief valve and an air relief water sensor. In such instances, the controller can be configured or designed to initiate a deaeration process in which the controller opens the air relief valve, receives an indication from the air relief water sensor indicating water is present at an air relief outlet, and closes the air relief valve in response to receiving the indication. The deaeration process may be performed after actuating the valve in the bypass configuration and before dosing the membrane module with the chemical cleaning agent.

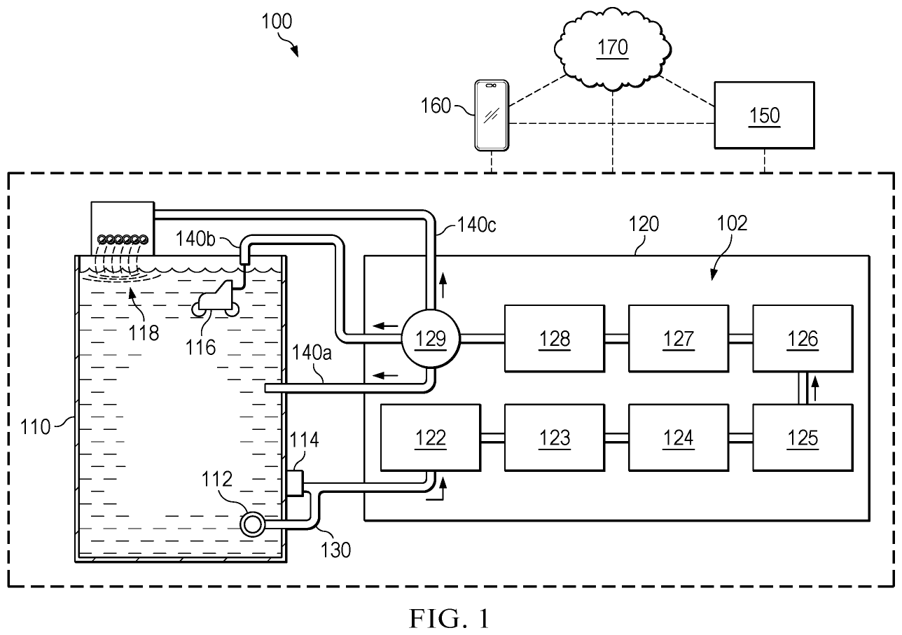

Referring to FIG. 1, a block diagram of an aquatic application 100 is depicted. The aquatic application 100 is provided in the form of one or more pool components 102 designed for use with a swimming pool 110. The pool components 102 include plumbing (e.g., conduits) and one or more pool management devices that form a closed-loop fluid circuit. The pool components 102 can include one or more of an inlet conduit 130, a variable-speed pump 122, a booster pump 123, a filter 124, a heater 125, a sanitizer 126, a water chemistry monitor 127, a water chemistry regulator 128, one or more valves 129, and one or more discharge conduits 140a-140c. One or more of the pool components 102 can be located on a pool pad 120.

In certain instances, the aquatic application 100 may be provided in the form of a spa and include components designed for use with a spa. In other instances, the aquatic application 100 may be provided in the form of a pool and a spa and include components that may be used with a pool and spa system. In yet other instances, the aquatic application 100 may be provided in the form of pool and/or spa components designed for use with a pool and/or a spa in a residential setting or a commercial setting. More particularly, the aquatic application 100 may be provided as a swimming pool, a hot tub, a spa, a plunge pool, and other recreational water venues not specifically discussed herein.

Portions of water can flow from the swimming pool 110 through the inlet conduit 130 from a drain 112 and/or a skimmer 114 and to a suction side of the variable speed pump 122. The variable speed pump 122 and/or the booster pump 123 can provide a driving force for the pool water to flow through the other downstream pool components 102. After the water from the swimming pool 110 exits one or more discharge conduits 140a-140c, the water can be optionally provided directly to the swimming pool 110 and/or provided to additional pool components 102, such as a pool cleaner 116 and a water feature 118.

Referring specifically to the pool pad 120, the sanitizer 126 and the water chemistry regulator 128 are configured to control one or more water treatment chemicals that can be added to the swimming pool 110. For example, in some instances, the sanitizer 126 is configured to add chlorine and/or bromine to the aquatic application 100. In some instances, the water chemistry regulator 128 is configured to add one or more pool chemicals, such as hydrochloric acid, sodium bisulfate, carbon dioxide, sulfuric acid, sodium carbonate, or other water treatment chemicals, to the aquatic application 100. Further, the heater 125 is optionally included and is configured to heat the water in the aquatic application 100.

It is to be understood that the pool components 102 can be provided in various configurations (i.e., the order of the pool components 102 can be altered). Further, in some instances, one or more pool components 102 may be omitted or removed from the aquatic application 100.

Still referring to FIG. 1, the aquatic application 100 can further include a central controller 150 and a user device 160 that can interface with the central controller 150 either directly over a local area network or via a cloud network 170. The central controller 150 can be a gateway, a hub, a switch, a router, a server, or other connection device to allow integration, monitoring, and control of multiple aspects of the aquatic application 100. The user device 160 can be provided in the form of a cell phone, tablet, or any other similar portable electronic device that may include a camera and a user interface.

Although FIG. 1 depicts the central controller 150 in communication with the user device 160 and the network 170, it should be noted that various communication methodologies and connections may be implemented to work in conjunction with, or independent from, one or more local controllers associated with one or more individual components associated with the aquatic application 100 (e.g., a pump controller, a heater controller, etc.). For example, one or more of the central controller and the local controllers may utilize a Local Area Network (LAN), a Wireless Local Area Network (WLAN), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information.

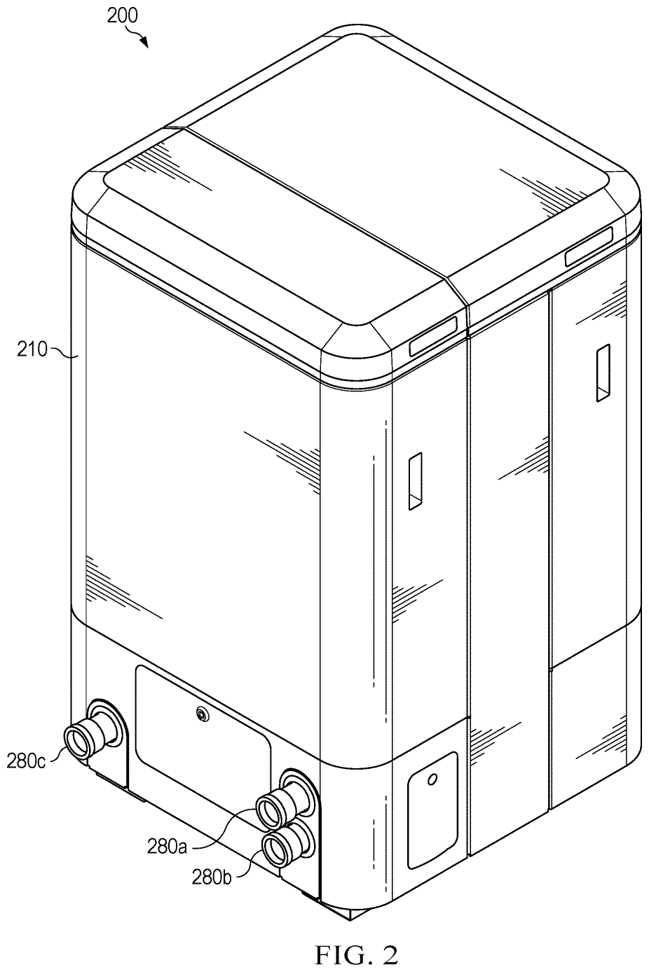

Now turning to FIGS. 2-8, a filtration system provided in the form of a hybrid filter assembly 200 according to an instance of the disclosure is shown. The hybrid filter assembly 200 may be the filter 124 of FIG. 1.

As shown in FIG. 2, the hybrid filter assembly 200 can include a housing 210 including a two-stage filtration assembly disposed therein, which is discussed in detail below. In some aspects, the housing 210 can include a plurality of rigid panels. In some aspects, one or more rigid panels included in the plurality of rigid panels can be formed from a plastic. In some aspects, one or more rigid panels included in the plurality of rigid panels can be formed from a metal.

The hybrid filter assembly 200 can include a pool inlet port 280a, a pool outlet port 280b, and a drain port 280c. In some aspects, the pool inlet port 280a, the pool outlet port 280b, and the drain port 280c can be arranged outside the housing 210, and all other components of the two-stage filtration assembly can be disposed entirely within the housing 210.

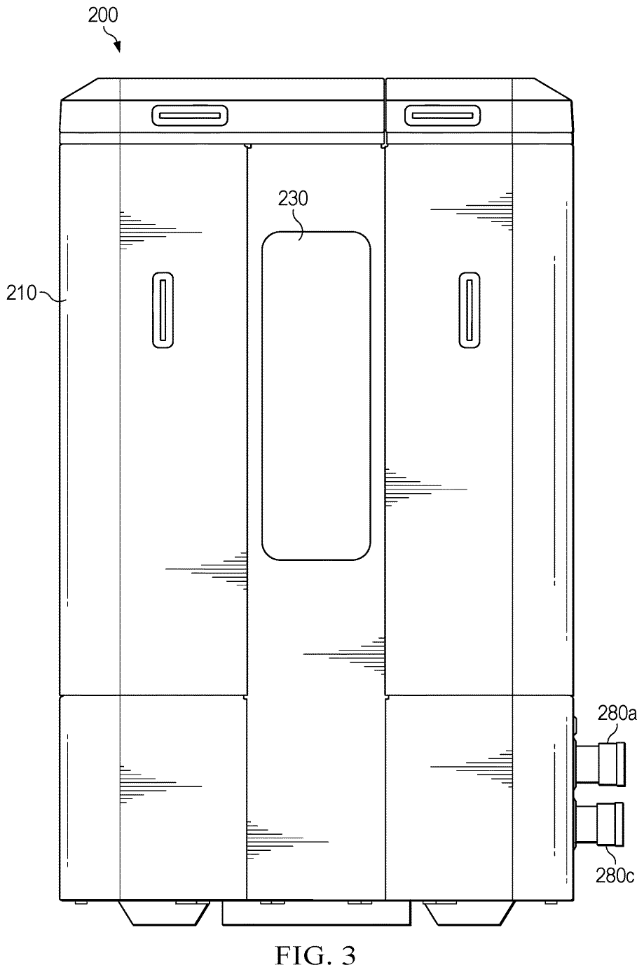

As shown in FIG. 3, the housing 210 can include an access hatch 230 configured to allow access to one or more specific components included in the hybrid filter assembly. In some aspects, the access hatch can allow a user to monitor a level of a fluid in a reservoir (not shown) and/or add additional fluid to the reservoir. In some aspects, the fluid can be a chemical, such as chlorine. In some instances, the reservoir (not shown) can include and/or be coupled to a level sensor and a temperature sensor. The level sensor can be configured to detect a level of fluid in the reservoir. The temperature sensor can be configured to sense a temperature associated with the reservoir. In some instances, the temperature sensor can be configured to sense a temperature of a surface of the reservoir.

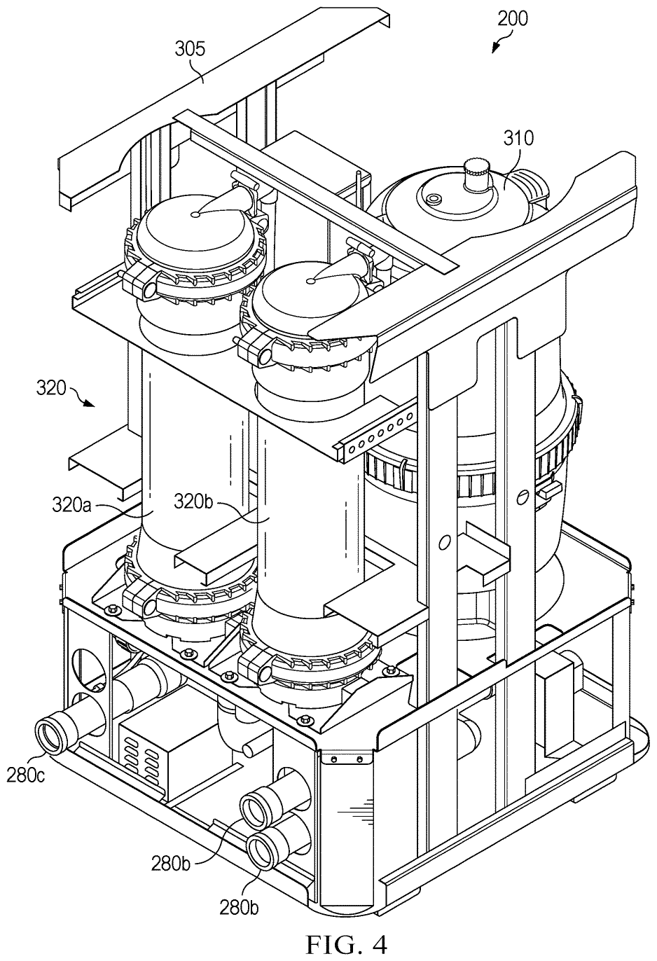

As shown in FIG. 4, the hybrid filter assembly 200 can include a frame 305 configured to retain one or more components of the two-stage filtration assembly. In some aspects, the hybrid filter assembly 200 can include a prefilter 310 and one or more membrane filters 320. As shown, the hybrid filter assembly 200 includes a first membrane filter 320a and a second membrane filter 320b. The frame 305 may retain the first membrane filter 320a, the second membrane filter 320b, and/or the prefilter 310 in a configuration that allows the hybrid filter assembly 200 to fit on existing pool pads. In addition, the frame 305 may locate and retain one or more valves (e.g., a backwash valve) and provide structural support for the one or more valves. In some aspects, a footprint of the hybrid filter assembly 200 can be about 85 cm by about 85 cm. In other aspects, the dimensions of the hybrid filter assembly 200 can be about 85 cm by about 85 cm by about 150 cm (e.g., the hybrid filter assembly 200 may be imparted with a width of about 85 cm, a length of about 85 cm, and a height of about 150 cm). In other instances, the hybrid filter assembly 200 may be imparted with dimensions that are smaller or greater than these values. Each of the one or more membrane filters 320 can include and/or be coupled to one or more sensors configured to measure values of various parameters of the one or more membrane filters 320, such as permeability, media headloss, pH, and/or other applicable parameters.

The hybrid filter assembly 200 is defined by a two-stage filtration system comprising the prefilter 310 and the one or more membrane filters 320. Each of the prefilter 310 and the one or more membrane filters 320 may be operated under the principle of using pressure-driven filtration. In some instances, the pressure used to operate the hybrid filter assembly 200 may be provided by the variable speed pump 122, the booster pump 123, and/or another pump in fluid communication with the aquatic application 100 of FIG. 1.

During forward filtration operation, the prefilter 310 can prefilter incoming pool water for the one or more membrane filters 320. Stated another way, the prefilter 310 may be arranged, positioned, or provided upstream of the one or more membrane filters 320 during the forward filtration operation. In some forms, the prefilter 310 is provided in the form of porous media. The prefilter 310 operates using depth filtration by capturing debris within the volume of the porous media. Specifically, as fluid flows through the porous media, the depth and pore size of the media create a physical barrier in which particulates get trapped in the media itself. In some instances, the prefilter 310 includes a granular media provided in the form of sand, crushed glass, an activated media such as carbon, pea gravel, activated glass media, and/or other suitable filtration media. For example, the prefilter 310 may be provided in the form of an activated filter media (e.g., an activated glass media including metal oxide catalysts) imparted with self-sterilization or antimicrobial properties. In such instances, the activated filter media may prevent bacteria-induced degradation of the efficacy of the first filtration stage via filter media mud-balling, coagulation, and channeling. In addition, in certain instances, the activated filter media (e.g., an activated glass media) may be imparted with a negative charge to facilitate the adsorption of sub-micron particulates and dissolved organic molecules. In some instances, the prefilter 310 is capable of capturing particles larger than the one or more membrane filters 320. By capturing large particles in the prefilter 310, the one or more membrane filters 320 can work more effectively because they may not become clogged with larger debris particles. In some aspects, the prefilter 310 can be a PLDE48 filter from Pentair. In certain cases, the prefilter 310 may be a modified PLDE48 filter from Pentair that is configured to retain a bed of a granular filter media (e.g., sand, crushed glass, an activated media such as carbon, pea gravel, activated glass media, and/or other suitable granular filtration media).

As discussed in more detail below, the one or more membrane filters 320 can include one or more filtration modules that are arranged in an upright orientation. The membrane filtration modules can be provided in the form of a membrane filter, such as a reverse osmosis filter, nanofiltration filter, ultrafiltration filter, or microfiltration filter. In one instance, the membrane filter is provided in the form of a hollow-fiber membrane filter. Membrane filtration captures contaminants in a physical barrier via a size-exclusion mechanism consistent with sand, diatomaceous earth, and pleated cartridge pool and spa filter media. However, membrane filtration is capable of capturing particles above about 0.005 microns in size (or 0.005 microns in size), particularly in the range of about 0.02 microns to about 0.2 microns (or 0.02 microns to 0.2 microns).

In some aspects, each of the one or more membrane filters 320 is defined by an asymmetric hollow fiber membrane produced from selective homopolymers or copolymers (e.g., polyethersulfone (PES) and polyvinylpyrrolidone (PVP) polymers). In other instances, the one or more membrane filters 320 may be formed of a blend of polymers such as, by way of example, a blend of PES and PVP polymers or a blend of PES, PEV, and polyethylene glycol (PEG) polymers. In some aspects, the hollow fibers deposited in an interior of the first membrane filter 320a and/or the second membrane filter 320b may be imparted with a surface area of at least about 20 square meters to at least about 30 square meters, although the surface area of the hollow fibers deposited within the interior of the first membrane filter 320a and/or the second membrane filter 320b may be somewhat less or even greater than these values. In other instances, the membrane filtration module 600 can be provided in a symmetric type with uniform pore structure, or as a layer deposited onto a structural core. In some aspects, the first membrane filter 320a and/or the second membrane filter 320b can be produced from silicon carbide ceramic having a controlled crystalline or lattice structure.

In some aspects, the one or more membrane filters 320 are ultrafiltration membranes imparted with a nominal pore size of about 10 to about 50 nanometers, or more particularly, about 20 to about 40 nanometers, and imparted with a lumen diameter of about 0.25 millimeters to about 2.5 millimeters. In other aspects, the one or more membrane filters 320 are ultrafiltration membranes imparted with a nominal pore size of 10 to 50 nanometers, or more particularly, 20 to 40 nanometers, and imparted with a lumen diameter of 0.25 millimeters to 2.5 millimeters. In yet other aspects, the one or more membrane filters 320 are ultrafiltration membranes imparted with a nominal pore size and lumen diameter that are larger or smaller than the values recited herein. The ultrafiltration membranes may be operated in a dead-end, inside-out deposition mode, and fouling recovery is achieved through backwashing via flux reversal. In other aspects, the one or more membrane filters 320 may be provided in the form of microfiltration membranes imparted with a nominal pore size of about 50 nanometers to about 1,500 nanometers (or 50 nanometers to 1,500 nanometers), although the pore size of the microfiltration membranes may be larger or smaller than these values. In yet other aspects, the one or more membrane filters 320 may include fibers imparted with a lumen diameter of about 0.3 millimeters to about 3 millimeters (or 0.3 millimeters to 3 millimeters). In some applications, it may be preferable to utilize fibers with a lumen diameter imparted with a value of about 0.5 millimeters to about 2 millimeters (or 0.5 millimeters to about 2 millimeters). In some aspects, the one or more membrane filters 320 are imparted with a molecular weight cut-off (MWCO) value of about 150 kilodaltons to about 200 kilodaltons (or 150 kilodaltons to 200 kilodaltons), although the MWCO value may be less than or greater than these values. In other aspects, the one or more membrane filters 320 may be imparted with a MWCO value such that the one or more membrane filters 320 are configured to retain silt, bacteria, viruses, and/or other particles that reduce water clarity and water quality. In some aspects, the one or more membrane filters 320 can be operated using an outside-in deposition mode, and/or the fibers of the membrane filtration modules 600 can be provided in a randomized arrangement or by including helically wound fibers.

In some aspects, the one or more membrane filters 320 may be imparted with chemical resistance properties. For example, the one or more membrane filters 320 may be imparted with acid-resistant properties, base-resistant properties, and/or chlorine-resistant properties. In certain aspects, the one or more membrane filters 320 may not degrade under high- or low-pH conditions, e.g., the membrane filtration module 600 may be configured to operate without significant degradation when processing fluid imparted with a pH value of about 2 to about 12 (or a pH value of 2 to 12). As an additional example, the one or more membrane filters 320 may be configured to operate without significant degradation when processing fluid imparted with a free chlorine value of no more than about 500 milligrams per liter (or no more than 500 milligrams per liter). In certain instances, the one or more membrane filters 320 may be configured to operate without significant degradation when the water supplied to the one or more membrane filters 320 is imparted with a pH value somewhat lower or higher than the values recited herein. In certain other aspects, the one or more membrane filters 320 may be configured to operate without significant degradation when the water supplied to the one or more membrane filters 320 is imparted with a free chlorine value even greater than the values recited herein. Thus, in certain aspects, the one or more membrane filters 320 may resist degradation by the chemicals provided to the one or more membrane filters 320 during the chemical cleaning process.

In some cases, each of the one or more membrane filters 320 may be provided as a Pentair X-Flow XF53 Membrane Element manufactured by X-Flow B. V. of the Netherlands. In other cases, each of the one or more membrane filters 320 may be provided as a Pentair X-Flow XM-106C Membrane Element or an XM-107B Membrane Element manufactured by X-Flow B.V. of the Netherlands.

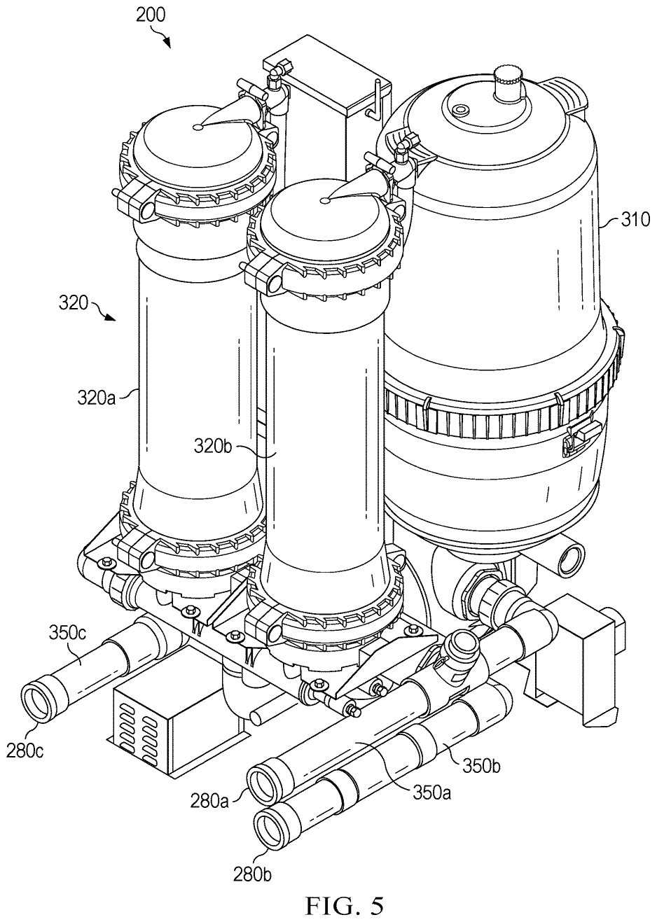

As shown in FIG. 5, the hybrid filter assembly 200 can include one or more conduits connecting the ports 280a-c, the one or more membrane filters 320, the prefilter 310, and/or other components included in the hybrid filter assembly 200. As shown, the hybrid filter assembly 200 can include an inlet conduit 350a, an outlet conduit 350b, and a waste conduit 350c. The pool inlet port 280a can be coupled to and/or in fluid communication with the inlet conduit 350a. The pool outlet port 280b can be coupled to and/or in fluid communication with the outlet conduit 350b. The drain port 280c can be coupled to and/or in fluid communication with the waste conduit 350c. The pool inlet port 280a and the pool outlet port 280b can be in fluid communication with a swimming pool (e.g., the swimming pool 110 in FIG. 1). The drain port 280c can be in fluid communication with a waste system (e.g., a sewer).

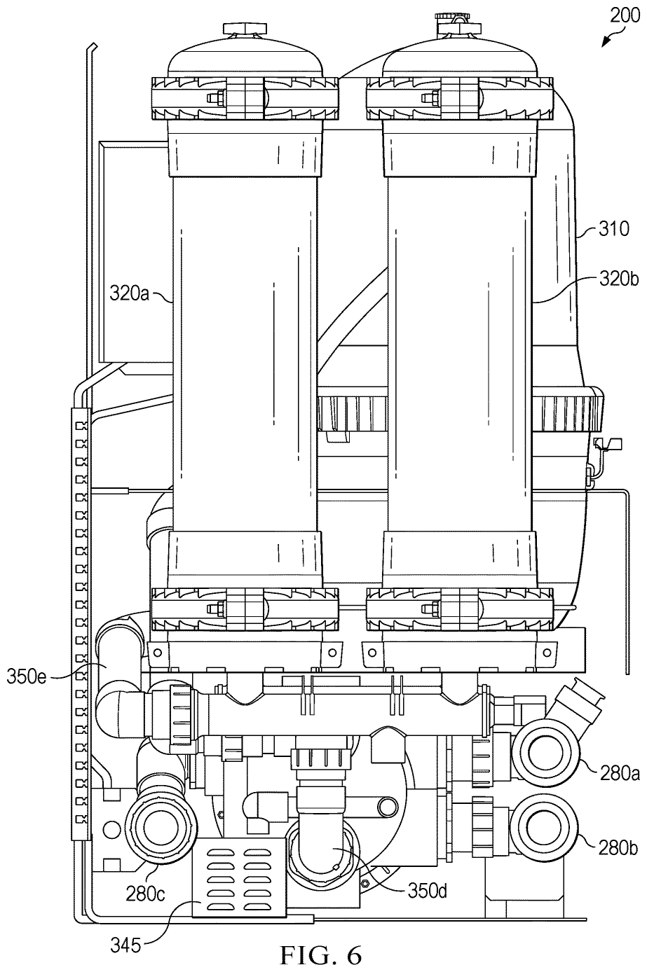

As shown in FIG. 6, the hybrid filter assembly 200 can include a membrane conduit 350d and a filtration conduit 350e. The membrane conduit 350d can be coupled to and/or in fluid communication with the one or more membrane filters 320. The filtration conduit 350e can be coupled between the one or more membrane filters 320 and the prefilter 310. More specifically, the filtration conduit 350e can be coupled between an outlet of the prefilter 310 and an inlet of the one or more membrane filters 320. In this way, the filtration conduit 350e can allow fluid filtered by the prefilter 310 to flow to the one or more membrane filters 320 for further filtering, as well as allow fluid to flow from the one or more membrane filters 320 to the prefilter 310 during a backwash mode.

Still referring to FIG. 6, the hybrid filter assembly 200 can include a clean-in-place module 345 configured to circulate one or more chemical cleaning agents and/or fluid (e.g., water) within the one or more membrane filters 320. The clean-in-place module 345 can include a pump coupled to and in communication with the one or more membrane filters 320. During a chemical soak procedure, the central controller 150 may direct the clean-in-place module 345 to circulate one or more chemical cleaning agents and/or fluid (e.g., water) within the one or more membrane filters 320.

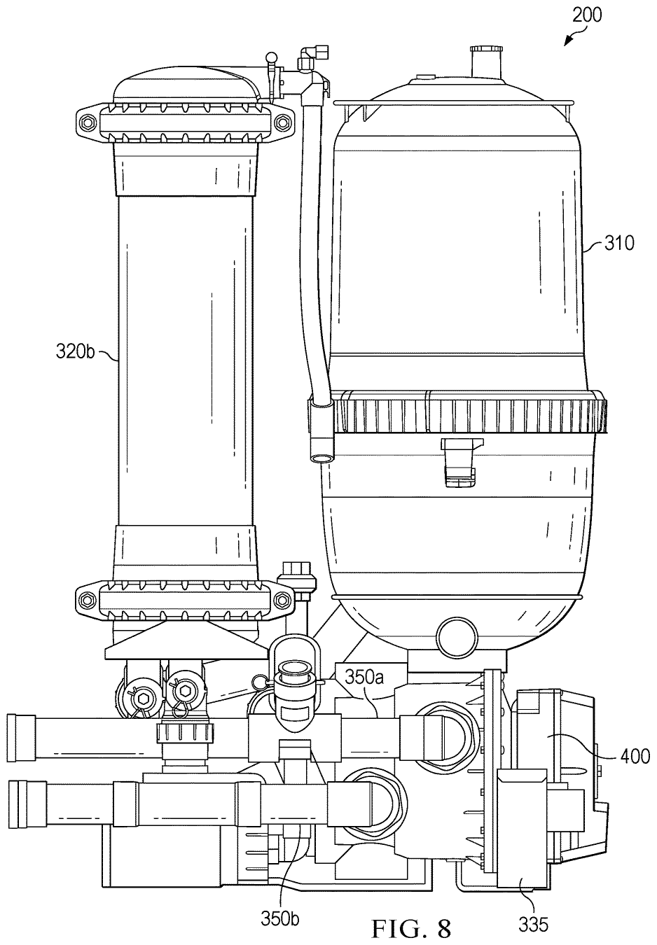

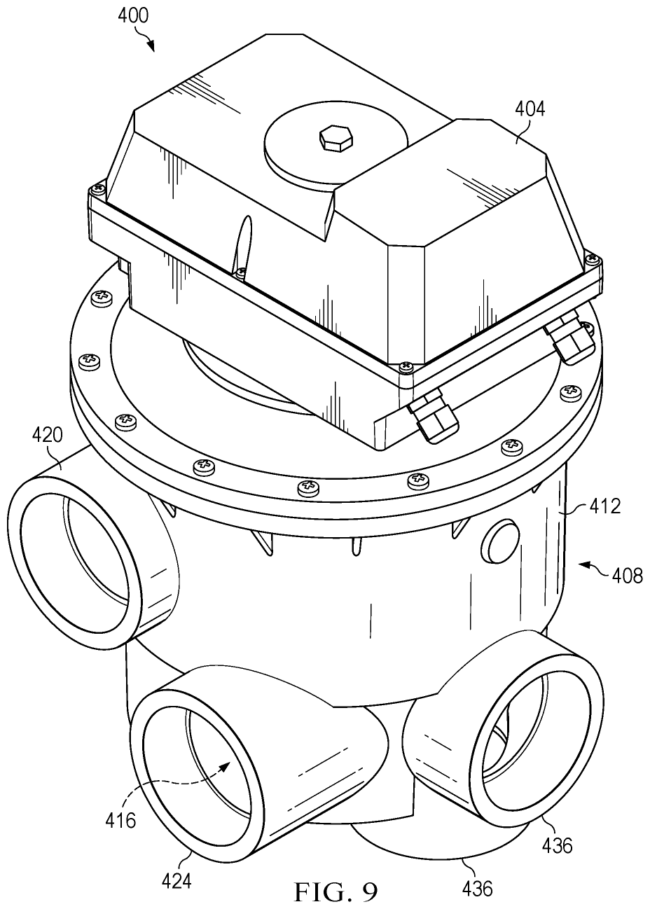

The hybrid filter assembly 200 may also include a clean-in-place (CIP) module 345. The clean-in-place module 345 is configured to deliver one or more chemical cleaning agents and/or fluid (e.g., water) to the one or more membrane filters 320a, 320b for the purpose of restoring membrane permeability and removing fouling material that has accumulated on or within the membrane filters 320a, 320b. The clean-in-place module 345 is coupled to the one or more membrane filters 320a, 320b via the membrane conduit 350d, which serves as the fluid pathway through which the clean-in-place module 345 delivers chemical cleaning agents into the one or more membrane filters 320a, 320b. The clean-in-place module 345 may include one or more of the following components: a chemical storage reservoir configured to hold a volume of one or more chemical cleaning agents; a dosing pump configured to draw chemical cleaning agent from the chemical storage reservoir and deliver a metered volume of the chemical cleaning agent to the one or more membrane filters 320a, 320b via the membrane conduit 350d; one or more valves configured to control the flow of chemical cleaning agent through the clean-in-place module 345 and into the one or more membrane filters 320a, 320b; and associated conduits or tubing providing fluid communication between the components of the clean-in-place module 345 and the one or more membrane filters 320a, 320b. In some instances, the clean-in-place module 345 further includes a pump configured to circulate one or more chemical cleaning agents and/or fluid within the one or more membrane filters 320a, 320b during a chemical soak procedure. The pump of the clean-in-place module 345 may be operated independently of, or in coordination with, the one or more system pumps that otherwise drive fluid flow through the hybrid filter assembly 200 during normal filtration operation. The chemical cleaning agents used by the clean-in-place module 345 may include, without limitation, acids, bases, oxidizers, surfactants, or combinations thereof, selected based on the nature of the fouling material present within the one or more membrane filters 320a, 320b. During a chemical soak procedure, the central controller 150 may actuate the valve 400 to a bypass configuration (as shown in FIG. 18) while the clean-in-place module 345 circulates the chemical cleaning agent within the one or more membrane filters 320a, 320b, thereby allowing continued pool circulation while the membrane filters undergo chemical cleaning. In some instances, the clean-in-place module 345 may work in coordination with the chemical dosing system 335 (shown in FIG. 8) to deliver and circulate chemical cleaning agents within the one or more membrane filters 320a, 320b. The chemical dosing system 335 may provide the initial dose of chemical cleaning agent, while the clean-in-place module 345 may circulate the agent within the membrane filters during the soak period.

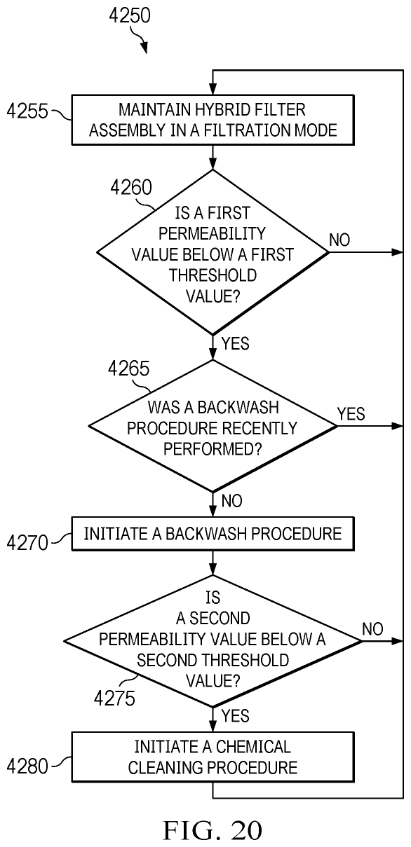

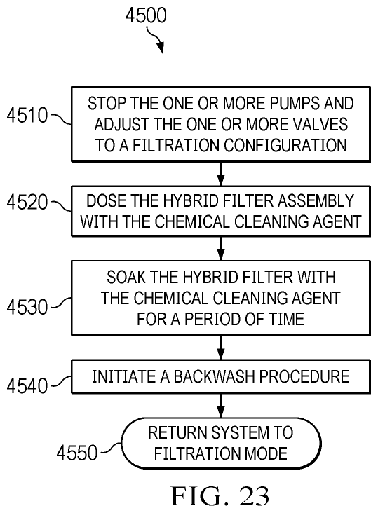

The central controller 150 is operably coupled to and in communication with the clean-in-place module 345 and is configured to direct the clean-in-place module 345 to initiate, execute, and terminate a chemical cleaning procedure. The central controller 150 may initiate a chemical cleaning procedure automatically based on one or more monitored system parameters, or in response to a user-initiated command. Referring also to FIG. 20, during normal operation, the central controller 150 is configured to maintain the hybrid filter assembly 200 in a filtration mode. The central controller 150 monitors the hybrid filter assembly 200 to determine whether a first permeability value has fallen below a first threshold value. If the first permeability value is below the first threshold value, the central controller 150 determines whether a backwash procedure has been recently performed and, if not, initiates a backwash procedure. If, following the backwash procedure, a second permeability value remains below a second threshold value, the central controller 150 is configured to initiate a chemical cleaning procedure. In this manner, the central controller 150 implements a tiered response strategy in which a backwash procedure is attempted before a chemical cleaning procedure is initiated, thereby minimizing chemical consumption while ensuring that membrane permeability is restored to an acceptable operational level. The chemical cleaning procedure implemented by the central controller 150 in cooperation with the clean-in-place module 345 is described in further detail with reference to FIG. 23.

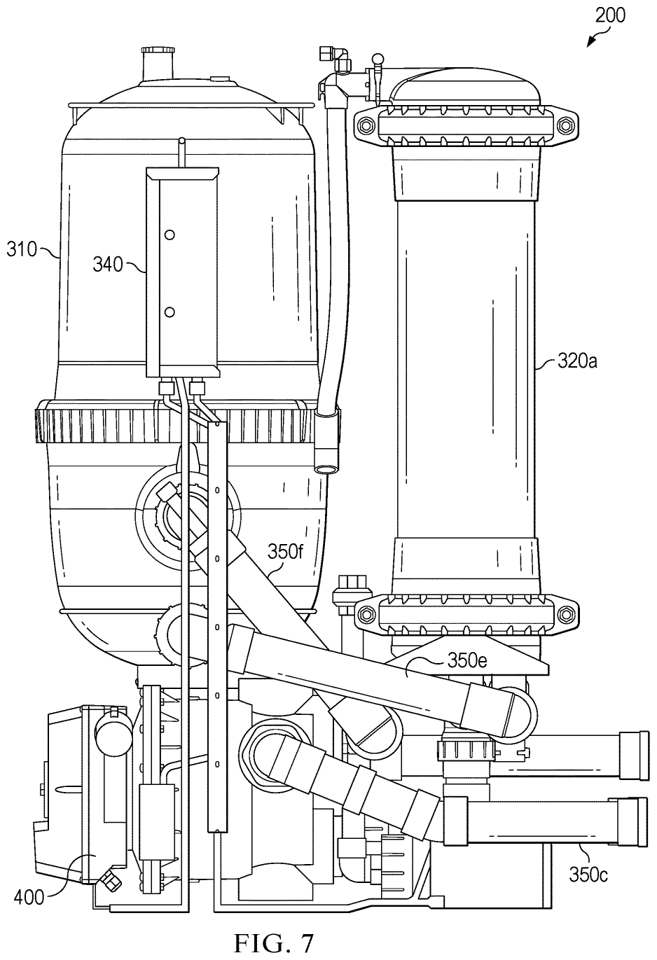

As shown in FIG. 7, the hybrid filter assembly 200 can include a prefilter conduit 350f. The hybrid filter assembly 200 can include a controller 340. In some aspects, controller 340 can be coupled to the central controller 150 in FIG. 1. In some aspects, the controller 340 can implement at least a portion of the functionality of the central controller 150 in FIG. 1.

As shown in FIG. 8, the hybrid filter assembly 200 can also include a chemical dosing system 335. The chemical dosing system 335 can be configured to apply a chemical (e.g., chlorine) to the one or more membrane filters 320 during a cleaning cycle. In some aspects, the chemical dosing system 335 can include a pump configured to dispense the chemical. In some aspects, the pump can be a peristaltic pump. As will be described further below, dosing the one or more membrane filters 320 with chlorine prior to backwashing can improve the performance of the one or more membrane filters 320. In some aspects, the chemical dosing system 335 can be positioned outside of the housing 210 and coupled to the hybrid filter assembly 200. After the chemical is dispensed, the clean-in-place module 345 may circulate the chemical within the one or more membrane filters 320 during a cleaning cycle. More specifically, the clean-in-place module 345 may circulate the chemical within the one or more membrane filters 320 during a chemical soak while the hybrid filter assembly 200 is in a bypass configuration. In some aspects, the reservoir (not shown) that is accessible by the access hatch 230 can be coupled to and in fluid communication with the chemical dosing system 335.

As shown in both FIG. 7 and FIG. 8, the hybrid filter assembly 200 can include a valve 400. The valve 400 can be coupled to and/or in fluid communication with the inlet conduit 350a, the outlet conduit 350b, the waste conduit 350c, the membrane conduit 350d, and the prefilter conduit 350f. In some configurations, the valve 400 can be in fluid communication with a swimming pool (e.g., the swimming pool 110 in FIG. 1). In some configurations, the valve 400 can be in fluid communication with a swimming pool (e.g., the swimming pool 110 in FIG. 1) and a waste system (e.g., a sewer). In various instances, the valve 400 may be provided in the form of an electrically-actuatable valve. In some cases, the valve 400 may be manually and/or electrically actuable.

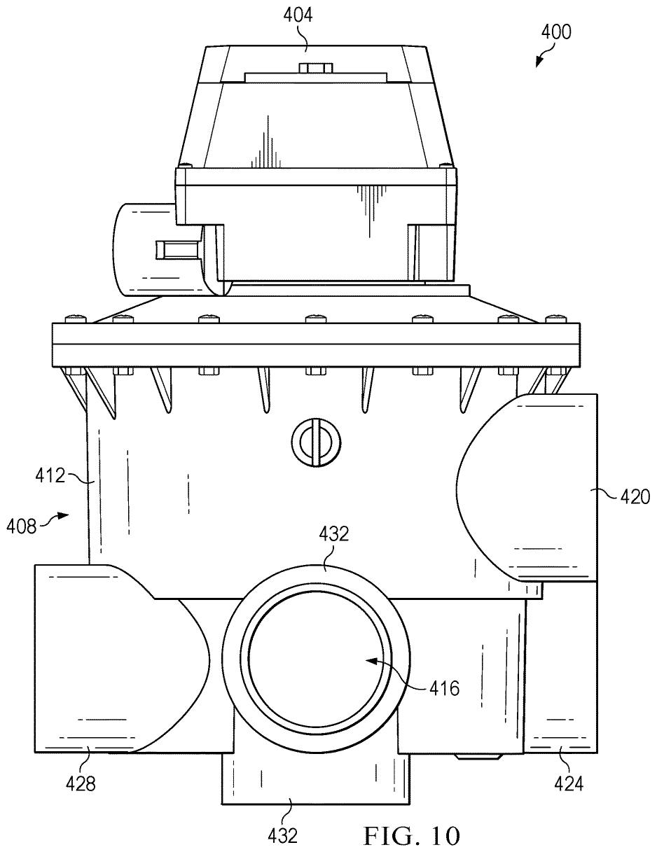

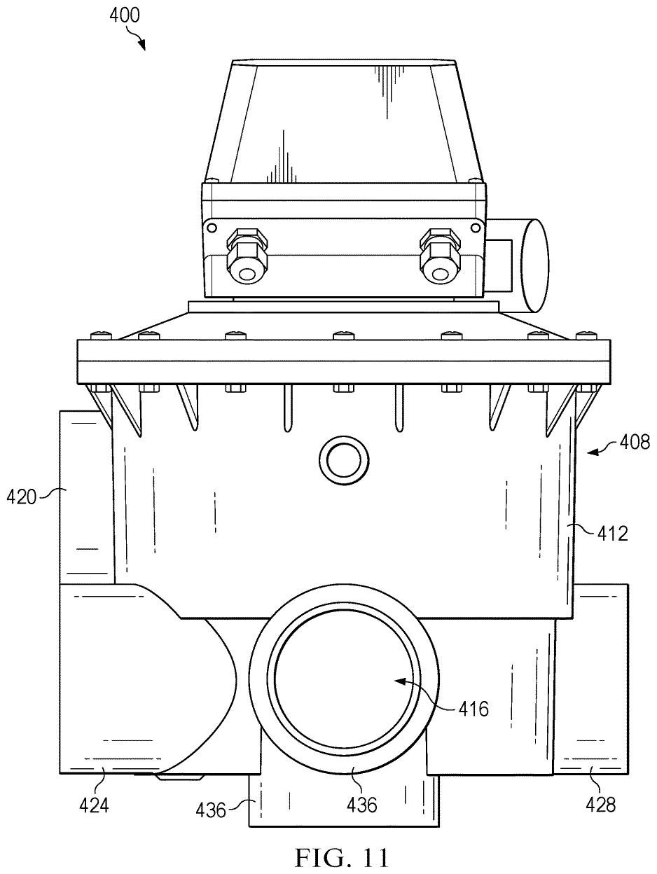

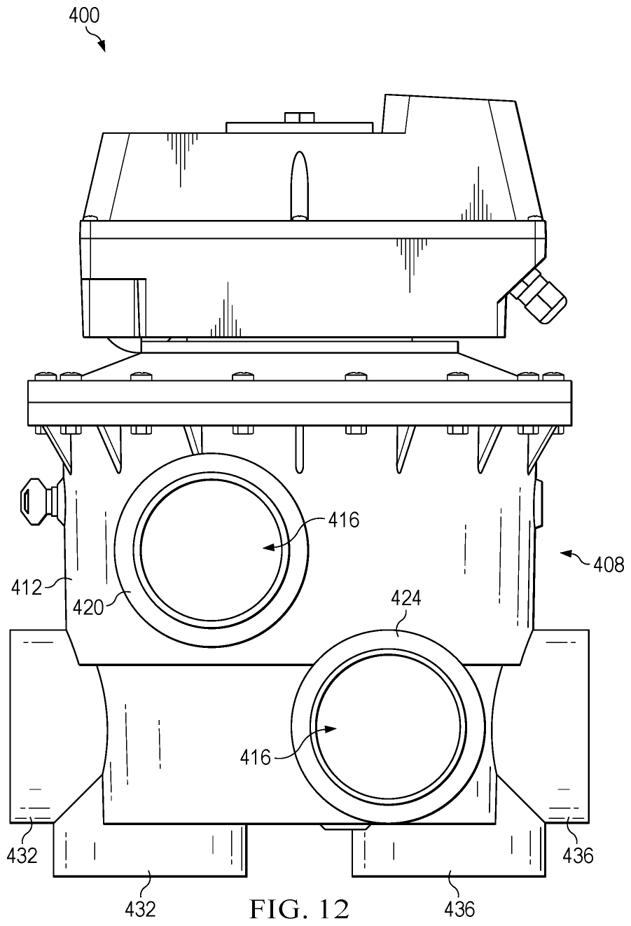

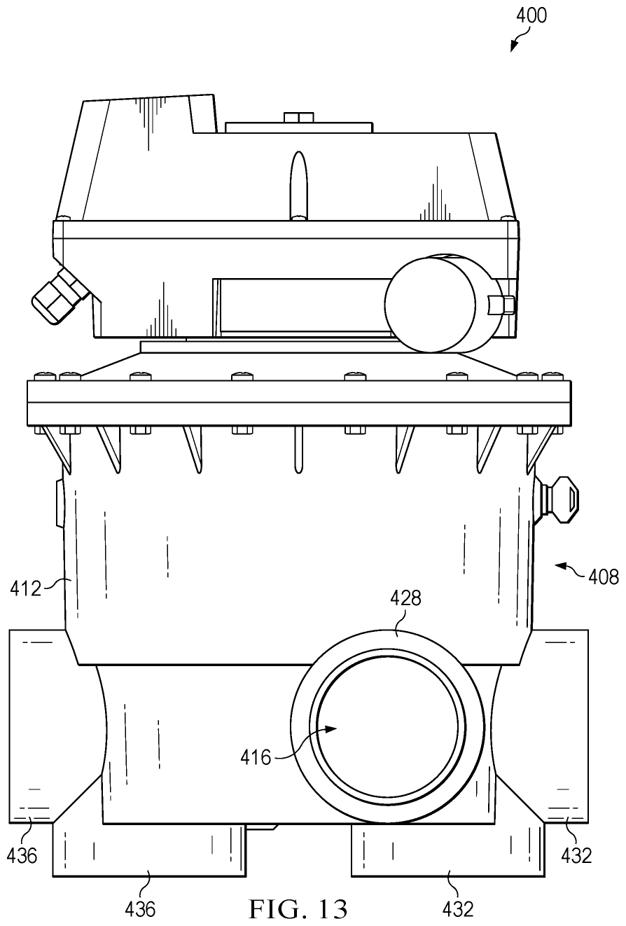

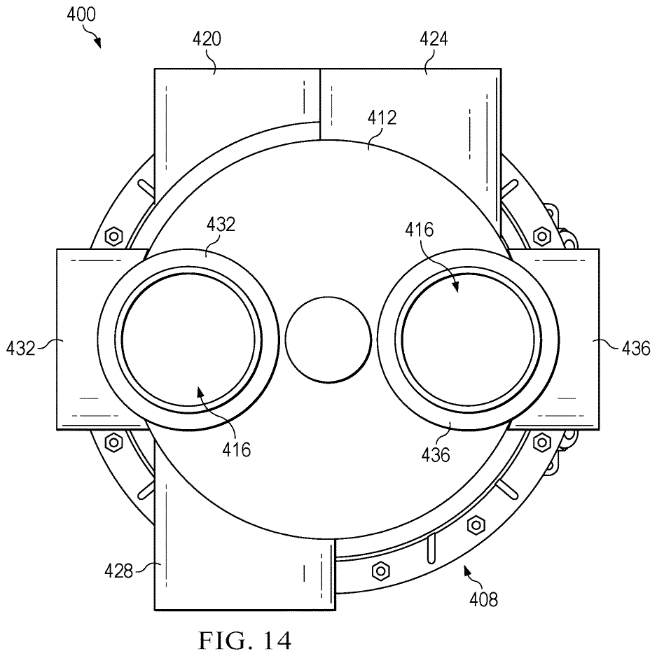

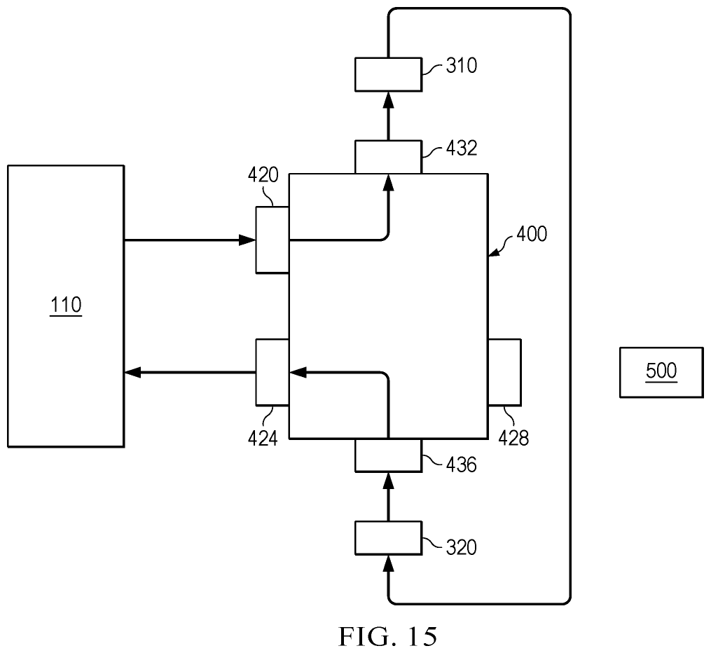

Referring to FIGS. 9-14 as well as FIGS. 1-8, the valve 400 can include a plurality of ports. In some aspects, the valve 400 can include an inlet port 420, an outlet port 424, a waste port 428, a prefilter port 432, and a membrane port 436. In some aspects, the inlet port 420, the outlet port 424, the waste port 428, the prefilter port 432, and/or the membrane port 436 can each include a single port. In some aspects, the prefilter port 432 and/or the membrane port 436 can include multiple ports. The multiple ports can allow for flexibility in coupling conduits to the valve 400.

The valve 400 may be provided in the form of a manifold 408, an actuator 404, and one or more ports (e.g., the inlet port 420, the outlet port 424, the waste port 428, the prefilter port 432, and/or the membrane port 436). The one or more ports of the valve 400 may extend from an outer surface 412 of the manifold 408 and into an interior 416 of the manifold 408. The one or more ports of the valve 400 may be configured to couple to the conduits of the hybrid filter assembly 200.

The inlet port 420 can be coupled to and/or in fluid communication with the inlet conduit 350a and in fluid communication with the pool inlet port 280a. The outlet port 424 can be coupled to and/or in fluid communication with the outlet conduit 350b and in fluid communication with the pool outlet port 280b. The waste port 428 can be coupled to and/or in fluid communication with the waste conduit 350c and in fluid communication with the drain port 280c. The prefilter port 432 can be coupled to and/or in fluid communication with the prefilter conduit 350f and in fluid communication with the prefilter 310. The membrane port 436 can be coupled to and/or in fluid communication with the membrane conduit 350d and in fluid communication with the one or more membrane filters 320.

In some aspects, the valve 400 may be configured as a five-way valve. As shown, the valve 400 is a six-way valve. In certain instances, the valve may be a six-way AQUASTAR® mp6 plc valve, manufactured by Praher Plastics Austria GmbH of Österreich, Austria.

In some aspects, the central controller 150 of FIG. 1 may direct the actuator 404 of the valve 400 to open and/or close the one or more ports of the valve 400 such that fluid flow through the hybrid filter assembly 200 may be controlled. For example, the central controller 150 may direct actuation of the valve 400 to place the hybrid filter assembly 200 in a filtration mode, a backwash mode, a rinse mode, a bypass mode, and/or a winterize mode. In some aspects, the controller 340 can be coupled to and/or in electronic communication with the valve 400.

FIGS. 15-19 illustrate non-limiting, example fluid flow paths through the hybrid filter assembly 200 when the hybrid filter assembly 200 operates in various modes (e.g., the filtration mode, the backwash mode, the rinse mode, the bypass mode, and/or the winterize mode).

Referring to FIG. 15, as well as FIGS. 1-14, an exemplary fluid path of a filtration mode of the hybrid filter assembly 200 is shown. In the filtration mode, the valve 400 can fluidly couple the inlet port 420 to the prefilter port 432 and the membrane port 436 to the outlet port 424. The hybrid filter assembly 200 can receive water from the swimming pool 110 at the inlet port 420. The water can be pressurized by the variable speed pump 122 and/or the booster pump 123 and delivered to the hybrid filter assembly 200 at the pool inlet port 280a. The water can flow from the inlet port 420 to the prefilter port 432 and on to the prefilter 310 (e.g., via the prefilter conduit 350f). The water is then filtered by the prefilter 310. The water can then flow from the prefilter 310 to the one or more membrane filters 320 (e.g., via the filtration conduit 350e) where the water is further processed. The water can then flow from the one or more membrane filters 320 to the membrane port 436 (e.g., via the membrane conduit 350d). The water can then flow from the membrane port 436 to the outlet port 424 and out from the valve 400. The outlet water, which has been filtered by the two-stage filtration assembly of the hybrid filter assembly 200, may flow from the outlet port 424 to the pool outlet port 280b and on to the swimming pool 110.

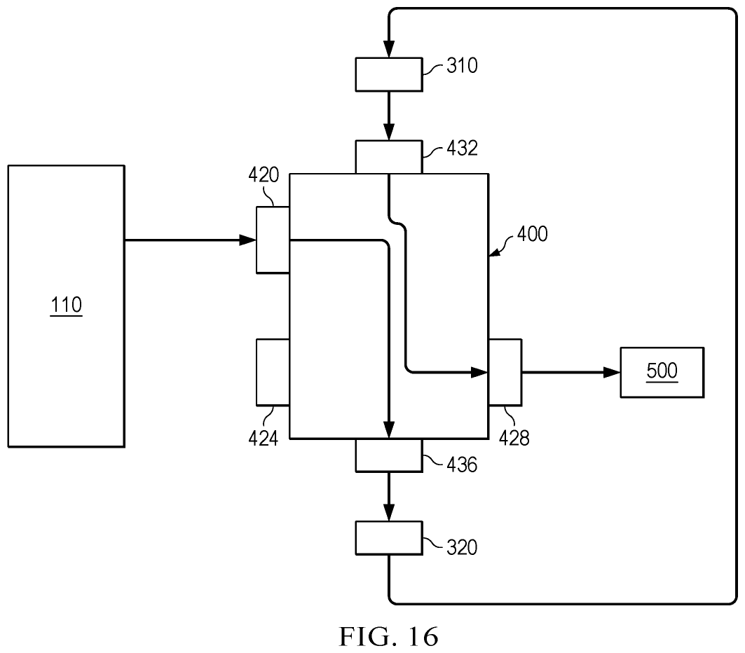

Referring to FIG. 16 as well as FIGS. 1-14, an exemplary fluid path of a backwash mode of the hybrid filter assembly 200 is shown. In the backwash mode, the valve 400 can fluidly couple the inlet port 420 to the membrane port 436 and the prefilter port 432 to the waste port 428. The hybrid filter assembly 200 can receive water from the swimming pool 110 at the inlet port 420. The water can be pressurized by the variable speed pump 122 and/or the booster pump 123 and delivered to the hybrid filter assembly 200 at the pool inlet port 280a. The water can flow from the inlet port 420 to the membrane port 436 and on to the one or more membrane filters 320 (e.g., via the membrane conduit 350d). The water then backwashes the one or more membrane filters 320. The water can then flow from the one or more membrane filters 320 to the prefilter 310 (e.g., via the filtration conduit 350e) to backwash the prefilter 310. The water can then flow from the prefilter 310 to the prefilter port 432 (e.g., via the prefilter conduit 350f). The water can then flow from the prefilter port 432 to the waste port 428 and out from the valve 400. The outlet water can then flow to a drain 500.

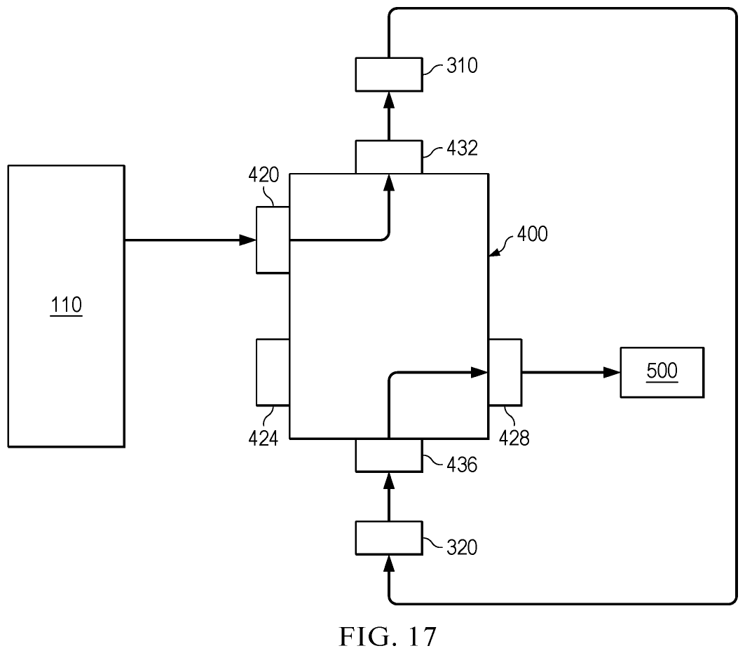

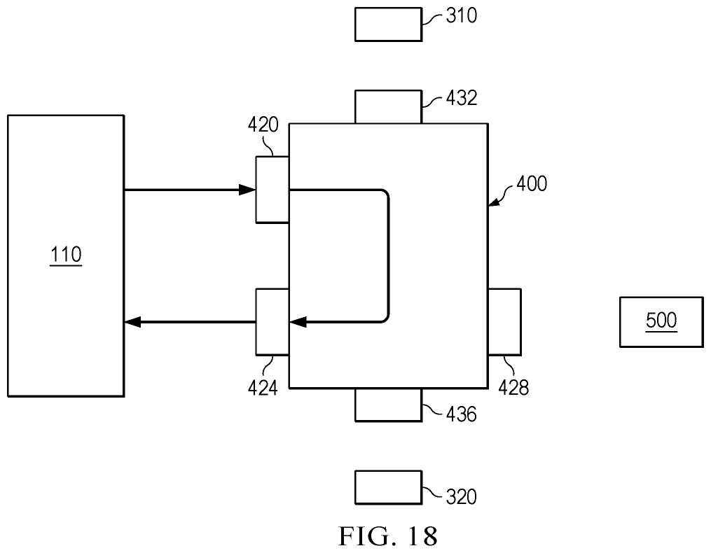

Referring to FIG. 17 as well as FIGS. 1-14, an exemplary fluid path of a rinse mode of the hybrid filter assembly 200 is shown. In the rinse mode, the valve 400 can fluidly couple the inlet port 420 to the prefilter port 432 and the membrane port 436 to the waste port 428. The hybrid filter assembly 200 can receive water from the swimming pool 110 at the inlet port 420. The water can be pressurized by the variable speed pump 122 and/or the booster pump 123 and delivered to the hybrid filter assembly 200 at the pool inlet port 280a. The water can flow from the inlet port 420 to the prefilter port 432 and on to the prefilter 310 (e.g., via the prefilter conduit 350f). The water then rinses the prefilter 310. The water can then flow from the prefilter 310 to the one or more membrane filters 320 (e.g., via the filtration conduit 350e) where the water rinses the one or more membrane filters 320. The water can then flow from the one or more membrane filters 320 to the membrane port 436 (e.g., via the membrane conduit 350d). The water can then flow from the membrane port 436 to the waste port 428 and out from the valve 400. The outlet water can then flow to the drain 500.

Referring to FIG. 18 as well as FIGS. 1-14, an exemplary fluid path of a bypass mode of the hybrid filter assembly 200 is shown. In the bypass mode, the valve 400 can fluidly couple the inlet port 420 to the outlet port 424. The hybrid filter assembly 200 can receive water from the swimming pool 110 at the inlet port 420. The water can be pressurized by the variable speed pump 122 and/or the booster pump 123 and delivered to the hybrid filter assembly 200 at the pool inlet port 280a. The water can flow from the inlet port 420 to the outlet port 424 and out from the valve 400. The outlet water, which has not been filtered by the two-stage filtration assembly of the hybrid filter assembly 200, may flow from the outlet port 424 to the pool outlet port 280b and on to the swimming pool 110.

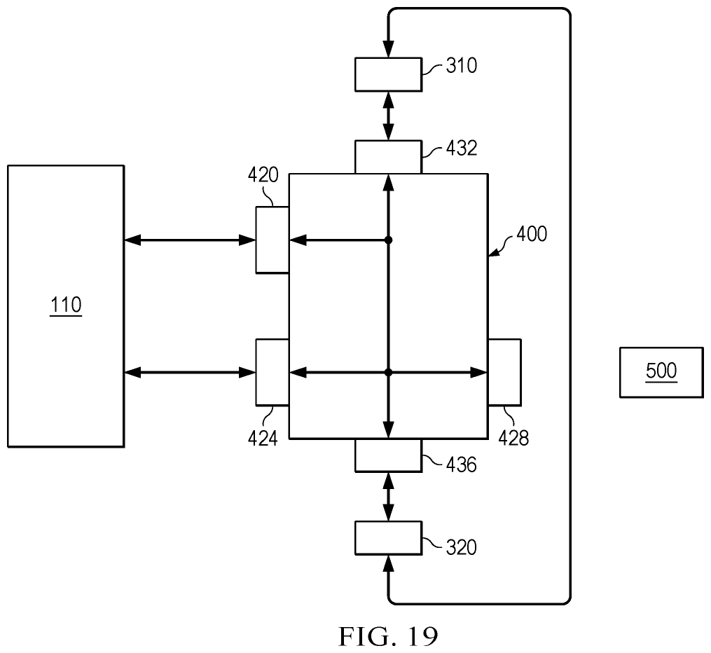

Referring to FIG. 19 as well as FIGS. 1-14, an exemplary fluid path of a winterize mode of the hybrid filter assembly 200 is shown. In the winterize mode, the valve 400 can fluidly couple the inlet port 420, the outlet port 424, the waste port 428, the prefilter port 432, and the membrane port 436 to each other. The prefilter 310 and the one or more membrane filters 320 can also be in fluid communication with each other as well as the valve 400. In some cases, the winterize mode may connect or fluidly couple all of the ports of the valve 400 (e.g., the inlet port 420, the outlet port 424, the waste port 428, the prefilter port 432, and the membrane port 436) to each other since a rotor provided in the valve 400 is lifted off a seal of the valve 400. Advantageously, this also decreases the compression set on the seal.

Referring to FIGS. 1-14, the valve 400 and/or other components of the above-described hybrid filter assembly 200 can be communicatively coupled to the central controller 150 of FIG. 1. The central controller 150 can implement a number of different methods and processes to effectuate different operational conditions and functions of the hybrid filter assembly 200 (e.g., the filtration mode, the backwash mode, the rinse mode, the bypass mode, and/or the winterization mode). For example, the chemical dosing system 335 can be automated. As an additional example, the central controller may effectuate the operational conditions (e.g., the flow paths) described with reference to FIGS. 15-19. The central controller 150 may work in conjunction with, or independent from, one or more local controllers associated with the pool components 102 disclosed herein. For conciseness, the methods of FIGS. 20-32 reference a central controller (i.e., the central controller 150), although the one or more functions described in the methods may also be performed by one or more of the central controller 150 and one or more local controllers associated with the device(s) described herein (e.g., the hybrid filter assembly, the chemical dispenser, etc.). Alternatively, one or more local controllers associated with the pool components 102 may work in conjunction with, or independent from, the central controller 150 to effectuate the operational modes and other methods described with reference to FIGS. 15-32 and 34-42.

A benefit of automating the chemical cleaning system is that it can be easier to operate and clean the filtration system and the hybrid filter assembly included therein. Accordingly, various methods for operating and cleaning the hybrid filter assembly 200 are disclosed herein. For example, any reference to a hybrid filter assembly in the methods of FIGS. 20-32 and FIGS. 34-42 as discussed below may be utilized with the hybrid filter assembly 200.

Further, automating the various cleaning modes, cleaning processes, and cleaning procedures described herein (e.g., the chemical cleaning mode and/or the backwash mode) may help maintain the operational efficiency of the hybrid filter assembly 200. In some instances, the operational efficiency of the hybrid filter assembly 200 may be determined by initiating a permeability check of one or more components of the hybrid filter assembly 200 (e.g., the first membrane filter 320a and/or the second membrane filter 320b) and/or by initiating a permeability check of the hybrid filter assembly 200 as a whole. In other instances, the operational efficiency of the hybrid filter assembly 200 may be determined by monitoring one or more parameters of the hybrid filter assembly 200 (e.g., permeability values, media headloss values).

It is to be understood that one or more of the values associated with the methods of FIGS. 20-32 and FIGS. 34-42 (e.g., a first permeability value, a second permeability value, a media headloss value, etc.) may be measured at different time intervals. The one or more values described with reference to the methods of FIGS. 20-32 and FIGS. 34-42 may be measured on demand, manually implemented, or at predetermined time intervals (e.g., continuously, once a second, once a minute, once a day, once a week, once a month, etc.). Further, it is to be understood that one or more of the values associated with the methods of FIGS. 20-32 and FIGS. 34-42 may be measured more than once. For example, a first measurement of the one or more values may be carried out at a first time period, followed by a second measurement carried out at a second time period, where the amount of time that elapses between the first time period and the second time period is determined by the predetermined time interval or another predetermined operational condition. In each instance, such measurements may be carried out by one or more systems provided with the aquatic application 100 and then received and stored by a controller (e.g., the central controller 150 of FIG. 1 and/or the local controllers of the pool components 102 of FIG. 1).

In addition, the predetermined values, thresholds, ranges, and other information described with reference to the methods of FIGS. 20-32 and FIGS. 34-42 may be manually implemented or otherwise input into the system. For example, the predetermined values and predetermined ranges may be manually input into a user interface of a controller (e.g., the central controller 150 and/or the local controllers of the pool components 102), provided to the controller via a user device (e.g., the user device 160 of FIG. 1) or otherwise associated with and retained by the controller.

In some instances, a lookup table of predetermined values, thresholds, ranges, and other information may be stored by a controller (e.g., the central controller 150 and/or the local controllers of the pool components 102), and the controller may determine an appropriate action based on one or more of the variables discussed herein. In addition, the controller may include pre-stored lookup tables. Furthermore, the controller may be in communication with a network (e.g., the network 170 of FIG. 1) and may be capable of downloading lookup tables. The controller may select threshold values (e.g., a threshold permeability value, a threshold temperature value) from the lookup tables based on a number of factors, including a determined pressure, flow rate, temperature, pH, turbidity, free chlorine content, ORP value, and/or other parameters.

Referring first to FIG. 20, a method 4250 for operating a hybrid filter assembly is illustrated. At a first step 4255, a system including a hybrid filter assembly, such as the aquatic application 100 of FIG. 1, is operated in a filtration mode. During the filtration mode, water from the swimming pool 110 can flow through the hybrid filter assembly as described in FIG. 15. Thus, the filtration mode can be the default or normal operational mode for the system.

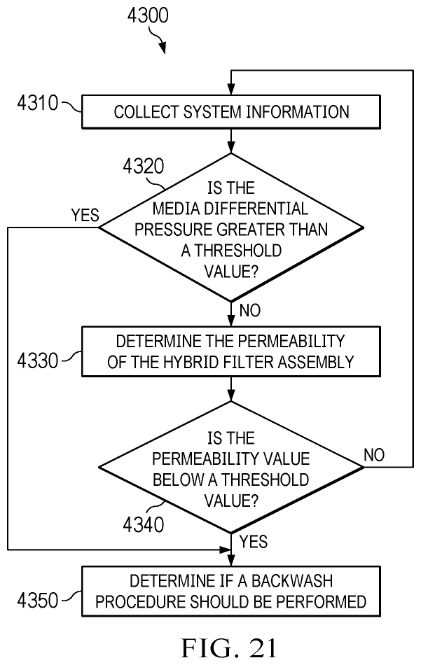

At step 4260, a controller, such as the central controller 150 of FIG. 1, can perform a first permeability check. See FIG. 21 for a detailed discussion of the procedure for the permeability check. The permeability check can determine the permeability of one or more membranes (e.g., the first membrane filter 320a and/or the second membrane filter 320b) of the hybrid filter. Thus, the first permeability check can determine whether the hybrid filter assembly has become fouled and should be cleaned. The central controller 150 can be configured to perform the first permeability check at a predetermined time or interval of time. For instance, the central controller 150 can be configured to perform the first permeability check once an hour, once a day, once a week, etc. In some instances, a user can manually prompt the central controller 150 to initiate the first permeability check.

The central controller 150 can be configured to analyze the results of the first permeability check to determine whether the hybrid filter assembly should be cleaned. In some instances, the central controller 150 can be configured to determine whether the first analyzed permeability value is above, equal to, or below a first threshold permeability value. The first threshold permeability value can be a predetermined value for the system. In some instances, the first threshold permeability value can be set at a value between about 150 to about 350 (or between 150 to 300), although the first threshold permeability value may be somewhat less or even greater than these values. For example, the first threshold permeability value may be imparted with a value of at least about 100, or at least about 125, or at least about 150, or at least about 175, or at least about 200, or at least about 225, or at least about 250, or at least about 275, or at least about 300, or at least about 325, or at least about 350. As an additional example, the first threshold permeability value may be imparted with a value of at least 100, or at least 125, or at least 150, or at least 175, or at least 200, or at least 225, or at least 250, or at least 275, or at least 300, or at least 325, or at least 350. In some instances, the first threshold permeability value may fall within a range bounded by any minimum value and any maximum value as described above. In other instances, instead of using a single threshold permeability value, the central controller 150 may utilize a first threshold permeability range that may be bounded by any minimum value and any maximum value as described above.

If the analyzed first permeability value is above the first threshold permeability value or above the first threshold permeability range, then the central controller 150 can maintain the hybrid filter assembly in the filtration mode. However, if the analyzed first permeability value is below the first threshold permeability value or below the first threshold permeability range, then at step 4265, the controller can perform a check to determine if a backwash procedure was recently performed.

At step 4265, the central controller 150 can access a maintenance log or historical data of the hybrid filter assembly to determine when the last backwash procedure was performed. If the most recent backwash procedure was performed within a threshold time period, the central controller 150 can be configured to maintain the system in the filtration mode. The threshold time period can be provided as a predetermined period of time, such as one day, one week, etc. In some instances, the predetermined period of time is 24 hours. However, if the previous backwash procedure was not performed within the threshold time period, the method can proceed to step 4270.

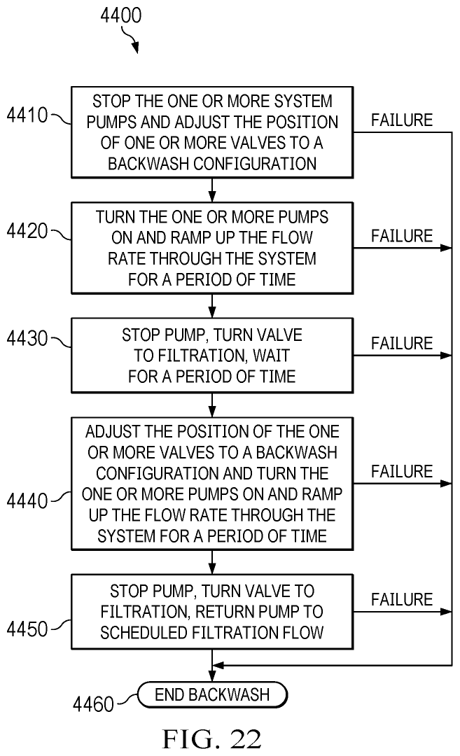

At step 4270, the central controller 150 can be configured to initiate a backwash procedure. During the backwash procedure, the water flow through the system can be as described above in FIG. 15 and in FIG. 22, discussed in more detail below. The backwash procedure can remove particulates from the system and help improve the permeability of the membranes of the hybrid filter assembly.

Thus, at step 4275, the central controller 150 can be configured to perform a second permeability check after the backwash procedure is complete to determine the effectiveness of the backwash procedure. The central controller 150 can analyze the second permeability check to determine if the second analyzed permeability value is above, equal to, or below a second threshold permeability value. In some instances, the second threshold permeability value can be the same as the first threshold permeability value. In some instances, the second threshold permeability value can be different from the first threshold permeability value. For instance, the second threshold permeability value can be greater than the first threshold permeability value because a backwash procedure may not restore the membrane filter permeability to the original permeability. However, it may not be necessary to perform additional cleaning procedures if the membrane permeability is still below an upper threshold value. In some instances, the second threshold permeability value can be imparted with a value between about 250 and about 375 (or between 250 and 375), although the second threshold permeability value may be less than or greater than these values. For example, the second threshold permeability value can be imparted with a value of between about 300 and about 350 (or between 300 and 350). As an additional example, the second threshold permeability value can be imparted with a value of at least about 225, or at least about 250, or at least about 275, or at least about 300, or at least about 310, or at least about 320, or at least about 330, or at least about 340, or at least about 350, or at least about 360, or at least about 370, or at least about 375. As yet another example, the second threshold permeability value can be imparted with a value of at least 225, or at least 250, or at least 275, or at least 300, or at least 310, or at least 320, or at least 330, or at least 340, or at least 350, or at least 360, or at least 370, or at least 375. In some instances, the second threshold permeability value may fall within a range bounded by any minimum value and any maximum value as described above. In other instances, instead of using a single threshold permeability value, the central controller 150 may utilize a second threshold permeability range that may be bounded by any minimum value and any maximum value as described above.

If the analyzed second permeability value is above the second threshold value or above the second threshold permeability range, then the central controller 150 can maintain the system in the filtration mode. However, if the analyzed second permeability value is below the second threshold permeability value or below the second threshold permeability range, then at step 4280, the central controller 150 can initiate a chemical cleaning procedure, which is described in more detail with respect to FIG. 23 below. After the chemical cleaning procedure is completed, the hybrid filter assembly resumes normal operation in the filtration mode.

Now, referring to FIG. 21, a method 4300 for performing a permeability check is illustrated in more detail. The method 4300 can be performed at steps 4260 and 4275 of the method 4250 of FIG. 20.

At step 4310, the central controller 150 can be configured to collect various details about the system in the form of system information. The system information can include one or more of a flow rate, an inlet pressure of the hybrid filter assembly, an outlet pressure of the hybrid filter assembly, an inlet pressure of the second filtration stage, a temperature of the water passing through the system, or combinations thereof. Thus, the system can include one or more sensors configured to monitor these parameters (e.g., flow meter, pressure transducer, temperature sensor, etc.) whereby the sensor(s) are in communication with the conduit, fluid, and the like.

At step 4320, the central controller 150 can determine the media differential pressure (i.e., the media headloss). The controller can determine the media headloss according to Formula I.

Media_Headloss=Inlet_Pressure−Module_Pressure Formula I

Further, the module headloss can be determined according to Formula II.

Module_Headloss=Module_Pressure−Outlet_Pressure Formula II

The central controller 150 can then determine if the media headloss is greater than or less than a media headloss threshold value. If the media headloss value is greater than the media headloss threshold value, then the method can proceed to step 4350 and determine if a backwash procedure should be performed (i.e., step 4265 and/or step 4280 of FIG. 20). However, if the media headloss value is less than the media headloss threshold value, the method can proceed to step 4330. In some instances, the media headloss threshold value is a predetermined value. For instance, the media headloss threshold value can be approximately 11 pounds per square inch (PSI). In other instances, the media headloss threshold value can be a value between about 4 PSI to about 20 PSI. In further instances, the media headloss threshold value can be a value between about 8 PSI to about 15 PSI.

At step 4330, the central controller 150 can be configured to determine the permeability of the hybrid filter assembly. In some instances, the permeability of the hybrid filter assembly can be determined according to Formula III below.

System Permeability=((Flux)/((TMP)*100000)*100000*(Viscosity/0.001)) Formula III

The Flux can be defined by Formula IV.

Flux=(System Flow)*227.125707/(membrane surface area) Formula IV

TMP can represent the Transmembrane Pressure and be described by Formula V.

TMP=(Filter Headloss)*0.06894757 Formula V

Wherein the Filter Headloss of Formula V can be determined by Formula VI.

Filter Headloss=Inlet Pressure−Outlet Pressure Formula VI

Referring back to Formula III, the Viscosity can be calculated according to Formula VII.

Viscosity=((1.855−0.05596*((Water Temperature−32)* 5/9)+0.0006533*((Water Temperature−32)* 5/9)\hat{ }2)/0.99712)/1000 Formula VII

In some aspects, there may be changes in flow caused by the bypass line. Thus, the central controller 150 can be configured to determine an adjusted permeability value that accounts for the changes in flow caused by the bypass line. In some instances, the adjusted permeability value can be determined according to Formula VIII.

$$Adjusted\_Permeability = ( ( System Flow - Bypass Flow ) * 227.125707 / ( membrane surface area ) / ( ( Module Pressure - Outlet Pressure ) * 0.06894757 * 100000 ) * 100000 * ( \frac{Viscosity}{0.001} ) \qquad Formula VIII$$

The bypass flow can be defined by Formula IX.

$$Bypass\_flow = ( ( ( ( Filter\_Headloss / 2.31 ) * 100 / ( ( bypass length ) / 12 ) ) * ( pipe diameter of bypass ) \hat{} 4.8655 ) / 0.098303 ) \hat{} ( \frac{1}{1.852} ) \qquad Formula IX$$

In other instances, when the hybrid filter assembly 200 is in the bypass mode, no calculation for the permeability value may be completed. For example, if no fluid flow is provided to both the first filtration stage and the second filtration stage (e.g., the prefilter 310 or the first and second membrane filters 320a, 320b), no calculation for the permeability value may be completed.

The central controller 150 can also be configured to determine the resistance of the hybrid filter assembly. In some instances, the resistance can be determined using the calculated permeability according to Formula X.

Resistance=(1/Permeability)*358,000,000,000,000 Formula X

In some instances, the filter resistance can be determined according to Formula XI.

$$Resistance = ( TMP * 100000 ) / ( \frac{Flux}{3600000} * Viscosity ) \qquad Formula XI$$

Table 1 summarizes the units of measure for the parameters used in Formulas I-XI.

TABLE 1

| Parameter | Unit |
|---|---|
| Inlet Pressure | Psi (pounds per square inch) |
| Outlet Pressure | Psi |
| Module Pressure | Psi |
| Filter Headloss | Psi |
| Module Headloss | Psi |
| Media Headloss | Psi |
| TMP | bar |
| System Flow | GPM (gallons per minute) |
| Flux | L/m²h (liters per square meter per hour) |
| Water Temp | Fahrenheit |
| Viscosity | N-s/m² (newton-second per square meter) |
| System Permeability | N/A |
| Bypass Flow | GPM (gallons per minute) |
| Adjusted Permeability | N/A |
| Membrane Surface Area | m² (square meters) |
| Bypass Length | feet |
| Pipe Diameter of Bypass | inches |

Still referring to FIG. 21, at step 4340, the central controller 150 can determine if the permeability of the hybrid filter assembly is above, equal to, or below a permeability threshold value. The permeability threshold value can be the first permeability threshold value and/or the second permeability threshold value from the method 4250 of FIG. 20. Thus, if the permeability value is above the threshold permeability value, then the central controller 150 can maintain the system in a filtration mode and continue to monitor and collect the system information. However, if the permeability is below the threshold permeability value, the central controller 150 can proceed to step 4350 and determine if a backwash procedure should be performed (i.e., step 4265 and/or step 4280 of FIG. 20). In some instances, the central controller 150 can be configured to confirm that the permeability of the hybrid filter assembly is below the threshold permeability value for a threshold period of time. In some instances, the threshold period of time can be at least about 10 seconds. In some instances, the threshold period of time can be at least about 20 seconds. In other instances, the threshold period of time can be no more than about 60 seconds. In yet other instances, the threshold period of time can be no more than about 30 seconds. In some instances, the threshold period of time can be at least 10 seconds. In some instances, the threshold period of time can be at least 20 seconds. In other instances, the threshold period of time can be no more than 60 seconds. In yet other instances, the threshold period of time can be no more than 30 seconds.

Now, turning to FIG. 22, a method 4400 for performing a backwash procedure is illustrated. The method 4400 can be performed at step 4270 and/or as part of the chemical cleaning procedure performed at step 4280 of the method 4250 of FIG. 20.

At step 4410, the position of one or more valves for the system can be reversed so that the flow of the water through the hybrid filter assembly is reversed. Thus, the one or more pumps included in the system (e.g., the variable speed pump 122 and/or the booster pump 123 of FIG. 1) can be stopped to adjust the valving. After the valving is adjusted, it can be beneficial to wait for a period of time (e.g., approximately 30 seconds) to allow the pressure and flow in the system to adjust.

At step 4420, the one or more pumps can be turned back on, and the hybrid filter assembly can be backwashed. The fluid flow rate through the system can be increased to a desired flow rate. In some instances, the fluid flow rate can be increased to a flow rate of between about 50 GPM to about 90 GPM (about 190 liters per minute (LPM) to about 340 LPM). In other instances, the fluid flow rate can be increased to a flow rate of between about 65 GPM to about 75 GPM (about 250 LPM to about 285 LPM). In further instances, the fluid flow rate can be increased to a flow rate of about 70 GPM (265 LPM). In some instances, the fluid flow rate can be increased to a flow rate of between 50 GPM to 90 GPM (190 LPM to 340 LPM). In other instances, the fluid flow rate can be increased to a flow rate of between 65 GPM to 75 GPM (250 LPM to 285 LPM). In further instances, the fluid flow rate can be increased to a flow rate of 70 GPM (265 LPM). In yet further instances, the fluid flow rate may fall within a range bounded by any minimum value and any maximum value as described above.

The backwash can be maintained for a predetermined period of time. However, when backwashing, there is a possibility that some media from the first filtration stage can become entrained in the backwashing fluid and be carried out of the hybrid filter assembly. Thus, the backwash time period can be adjusted so that the amount of media that may be washed out of the hybrid filter assembly is reduced or minimized. Accordingly, in some instances, the backwash is maintained for the predetermined period of time of between about 10 seconds to about 60 seconds. In further instances, the backwash is maintained for the predetermined period of time of between about 20 seconds to about 40 seconds. In some instances, the backwash is maintained for the predetermined period of time of at least approximately 30 seconds. In yet other instances, the backwash is maintained for the predetermined period of time of between 10 seconds to 60 seconds. In further instances, the backwash is maintained for the predetermined period of time of between 20 seconds to 40 seconds. In yet further instances, the backwash is maintained for the predetermined period of time of at least 30 seconds. In further instances, the backwash may also be maintained for predetermined periods of time that are somewhat less or even greater than the predetermined periods of time recited herein. In some instances, the backwash may be maintained for predetermined periods of time that fall within a range bounded by any minimum value and any maximum value as described above. In other instances, instead of using a single predetermined period of time, the central controller 150 may maintain the backwash for a predetermined range of times that may be bounded by any minimum value and any maximum value as described above.

At step 4430, the one or more pumps can be stopped, and the valving can be adjusted back to the filtration mode position. At this point, a rinse operation can be performed to flush the contaminants removed from the hybrid filter from the system's conduit lines. In some instances, the rinse operation can be maintained for at least about 1 minute. In other instances, the rinse operation can be maintained for at least 1 minute. In yet other instances, the flush operation can be maintained for at least about 1 minute to no more than about 15 minutes (or at least about 1 minute to no more than 15 minutes), although the flush operation may be maintained for longer or shorter time periods than those recited herein.

At step 4440, a second optional backwash can be performed. Thus, the pump can be stopped again, and the valve position can be adjusted to the backwash configuration. Similar to the first backwash, the one or more pumps can be increased to a desired flow rate, which can be maintained for a predetermined time period.

At step 4450, the pump can be stopped, and the valves can be adjusted back to the filtration orientation. The pump can then be turned back on so that the system is operating in the filtration mode. Thus, the backwash method ends at 4460.

As discussed above, one or more components of the system (e.g., the valves and the pumps) can be automated. Therefore, the central controller 150 can be configured to perform the above steps. However, if the central controller 150 fails to perform a step, the backwash procedure can end, and the hybrid filter assembly can be maintained or returned to the filtration mode. Additionally, in some instances, the above steps can be manually performed.

Now referring to FIG. 23, a method 4500 for chemically cleaning the hybrid filter assembly is illustrated. The method 4500 can be performed at step 4280 of the method 4250 of FIG. 20.

At step 4510, the one or more pumps of the system can be turned off or maintained off. For example, in the method 4250 of FIG. 20, the chemical cleaning procedure can be performed after a backwash procedure. In some instances, the method 4400 of FIG. 22 is performed prior to, or as the first step of, the method 4500. Thus, after the backwash procedure is completed, the one or more pumps may already be turned off. However, the one or more valves in the system can be switched back to the filtration mode orientation or maintained in the filtration mode orientation.

At step 4520, a chemical cleaning agent can be introduced into the hybrid filter assembly. The chemical cleaning agent can be introduced by the chemical dosing system 335. The chemical dosing system 335 and/or the hybrid filter assembly 200 can include one or more valves or components, such as pumps, that can control the flow of the chemical cleaning agent. Accordingly, depending on the instance, the one or more valves or components may need to be adjusted to permit the delivery of the chemical cleaning agent to the hybrid filter assembly. The amount of the chemical cleaning agent delivered to the hybrid filter assembly can depend on the size of the filter and/or the level of fouling of the filter. In some instances, the hybrid filter assembly can be dosed with between about 200 milliliters of liquid chlorine to about 450 milliliters of liquid chlorine (or 200 milliliters to 450 milliliters of liquid chlorine), although the hybrid filter assembly may be dosed with somewhat less or even more liquid chlorine than these values. In further instances, the hybrid filter assembly can be dosed with between about 275 milliliters of liquid chlorine to about 400 milliliters of liquid chlorine. In further instances, the hybrid filter assembly can be dosed with between 275 milliliters of liquid chlorine to 400 milliliters of liquid chlorine. In other cases, the hybrid filter assembly can be dosed with at least about 100 milliliters of liquid chlorine, or at least about 150 milliliters of liquid chlorine, or at least about 200 milliliters of liquid chlorine, or at least about 225 milliliters of liquid chlorine, or at least about 250 milliliters of liquid chlorine, or at least about 275 milliliters of liquid chlorine, or at least about 300 milliliters of liquid chlorine, or at least about 325 milliliters of liquid chlorine, or at least about 350 milliliters of liquid chlorine, or at least about 375 milliliters of liquid chlorine, or at least about 400 milliliters of liquid chlorine, or at least about 450 milliliters of liquid chlorine, or at least about 500 milliliters of liquid chlorine. In yet other cases, the hybrid filter assembly can be dosed with at least 100 milliliters of liquid chlorine, or at least 150 milliliters of liquid chlorine, or at least 200 milliliters of liquid chlorine, or at least 225 milliliters of liquid chlorine, or at least 250 milliliters of liquid chlorine, or at least 275 milliliters of liquid chlorine, or at least 300 milliliters of liquid chlorine, or at least 325 milliliters of liquid chlorine, or at least 350 milliliters of liquid chlorine, or at least 375 milliliters of liquid chlorine, or at least 400 milliliters of liquid chlorine, or at least 450 milliliters of liquid chlorine, or at least 500 milliliters of liquid chlorine. In some instances, the dose of the liquid chlorine provided to the hybrid filter assembly may fall within a range bounded by any minimum value and any maximum value as described above. In other instances, the dose of liquid chlorine may be provided as a dose range that may be bounded by any minimum value and any maximum value as described above.

In some instances of the step 4520, the chemical cleaning agent may be selected from the group consisting of a chlorine-containing compound, a chlorine-containing solution, a bromine-containing compound, a bromine-containing solution, a bleaching agent, an acidic solution, and combinations thereof. In some such instances, the chemical cleaning agent may be selected from the group consisting of calcium hypochlorite, trichloroisocyanuric acid, dichloro-s-triazinetrione, and combinations thereof. In each of the various instances, the hybrid filter assembly may be dosed with between about 100 milliliters to about 500 milliliters of the chemical cleaning agent, although the amount of the chemical cleaning agent provided to the hybrid filter assembly may be somewhat less than or even greater than these values. For example, the hybrid filter assembly can be dosed with at least about 100 milliliters of the chemical cleaning agent, or at least about 150 milliliters of the chemical cleaning agent, or at least about 200 milliliters of the chemical cleaning agent, or at least about 225 milliliters of the chemical cleaning agent, or at least about 250 milliliters of the chemical cleaning agent, or at least about 275 milliliters of the chemical cleaning agent, or at least about 300 milliliters of the chemical cleaning agent, or at least about 325 milliliters of the chemical cleaning agent, or at least about 350 milliliters of the chemical cleaning agent, or at least about 375 milliliters of the chemical cleaning agent, or at least about 400 milliliters of the chemical cleaning agent, or at least about 450 milliliters of the chemical cleaning agent, or at least about 500 milliliters of the chemical cleaning agent. As an additional example, the hybrid filter assembly can be dosed with at least 100 milliliters of the chemical cleaning agent, or at least 150 milliliters of the chemical cleaning agent, or at least 200 milliliters of the chemical cleaning agent, or at least 225 milliliters of the chemical cleaning agent, or at least 250 milliliters of the chemical cleaning agent, or at least 275 milliliters of the chemical cleaning agent, or at least 300 milliliters of the chemical cleaning agent, or at least 325 milliliters of the chemical cleaning agent, or at least 350 milliliters of the chemical cleaning agent, or at least 375 milliliters of the chemical cleaning agent, or at least 400 milliliters of the chemical cleaning agent, or at least 450 milliliters of the chemical cleaning agent, or at least 500 milliliters of the chemical cleaning agent. In some instances, the dose of the chemical cleaning agent provided to the hybrid filter assembly may fall within a range bounded by any minimum value and any maximum value as described above. In other instances, the dose of the chemical cleaning agent may be provided as a dose range that may be bounded by any minimum value and any maximum value as described above.

At step 4530, the flow of the chemical cleaning agent to the hybrid filter assembly can be stopped, and one or more components of the hybrid filter assembly (the first membrane filter 320a and/or the second membrane filter 320b) can be soaked with the chemical cleaning agent for a predetermined period of time. During the soak, at 4530, the hybrid filter assembly can operate in the bypass mode shown in FIG. 18. During the soak, and while the hybrid filter assembly is operating in the bypass mode, the clean-in-place module 345 can circulate one or more chemical cleaning agents and/or fluid (e.g., water) within the one or more membrane filters 320. A benefit of soaking the hybrid filter assembly with the chemical cleaning agent is that it can give the chemical cleaning agent time to neutralize contaminants. In some instances, the hybrid filter assembly can be soaked between about 1 hour to about 24 hours (or 1 hour to 24 hours), although the hybrid filter assembly may also be soaked for less time or more time than described herein. For example, the hybrid filter assembly can be soaked between about 2 hours to about 4 hours (or between 2 hours to 4 hours). As yet another example, the hybrid filter assembly can be soaked for about 3 hours to about 6 hours (or for 3 hours to 6 hours). For example, the hybrid filter assembly can be soaked between 1 hour to 5 hours (or between 1 hour to 5 hours). In further cases, the hybrid filter assembly can be soaked for at least about 30 minutes, or at least about 1 hour, or at least about 2 hours, or at least about 3 hours, or at least about 4 hours, or at least about 5 hours, or at least about 6 hours, or at least about 7 hours, or at least about 8 hours, or at least about 9 hours, or at least about 10 hours, or at least about 11 hours, or at least about 12 hours, or at least about 13 hours, or at least about 14 hours, or at least about 15 hours, or at least about 16 hours, or at least about 17 hours, or at least about 18 hours, or at least about 19 hours, or at least about 20 hours, or at least about 21 hours, or at least about 22 hours, or at least about 23 hours, or at least about 24 hours. In other cases, the hybrid filter assembly can be soaked for at least 30 minutes, or at least 1 hour, or at least 2 hours, or at least 3 hours, or at least 4 hours, or at least 5 hours, or at least 6 hours, or at least 7 hours, or at least 8 hours, or at least 9 hours, or at least 10 hours, or at least 11 hours, or at least 12 hours, or at least 13 hours, or at least 14 hours, or at least 15 hours, or at least 16 hours, or at least 17 hours, or at least 18 hours, or at least 19 hours, or at least 20 hours, or at least 21 hours, or at least 22 hours, or at least 23 hours, or at least 24 hours. In some instances, the predetermined time that one or more components of the hybrid filter assembly may be soaked with the chemical cleaning agent may fall within a range bounded by any minimum value and any maximum value as described above. In other instances, instead of using a single predetermined time, the central controller 150 may utilize a predetermined range of times that may be bounded by any minimum value and any maximum value as described above.

At step 4540, a backwash procedure can be initiated after the hybrid filter assembly has been soaked for the predetermined time or the predetermined range of times. The backwash procedure can be performed according to the method 4400 of FIG. 22. A benefit of backwashing the hybrid filter assembly after the chemical cleaning procedure is that the chemical cleaning agent and contaminants can be flushed from the system.

Thus, at step 4550, after the backwash procedure is completed, the hybrid filter assembly can be returned to the filtration mode.

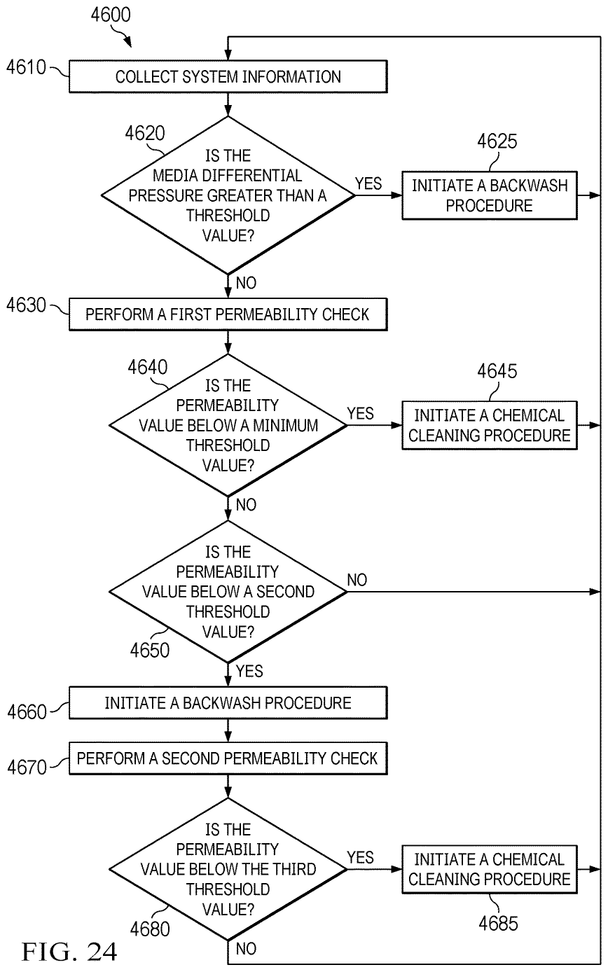

Now referring to FIG. 24, an alternative method 4600 for operating a hybrid filter assembly is illustrated. The method 4600 is similar to the method 4250 of FIG. 20. However, here, the backwash and/or the chemical cleaning procedures can differ. At a first step 4610, the central controller 150 can be configured to collect various details about the system in the form of system information. The system information can include one or more of a flow rate, an inlet pressure of the hybrid filter assembly, an outlet pressure of the hybrid filter assembly, an inlet pressure of the second filtration stage, a temperature of the water passing through the system, or combinations thereof. Thus, the system can include one or more sensors configured to monitor these parameters (e.g., flow meter, pressure transducer, temperature sensor, etc.).

At step 4620, the central controller 150 can determine the media differential pressure (i.e., the media headloss). In some instances, the media differential pressure can be determined according to Formula I above. The central controller 150 can then determine if the media headloss is greater than or less than a media headloss threshold value. If the media headloss value is greater than the media headloss threshold value, then the method can proceed to step 4625 and initiate a backwash procedure. The backwash procedure can be performed according to the method 4400 of FIG. 22. Once the backwash procedure is completed, the method can return to step 4610 and the central controller 150 can continue to monitor the system. However, if the media headloss is less than the media headloss threshold value, the method can proceed to step 4630. In some instances, the media headloss threshold value is a predetermined value. For instance, the media headloss threshold value can be approximately 11 PSI (approximately 76,000 Pa). In other instances, the media headloss threshold value can be a value between about 4 PSI to about 20 PSI (about 28,000 Pa to about 138,000 Pa). In further instances, the media headloss threshold value can be a value between about 8 PSI to about 15 PSI (about 55,000 Pa to about 103,000 Pa). In yet other instances, the media headloss threshold value can be 11 PSI (76,000 Pa). In other instances, the media headloss threshold value can be a value between 4 PSI to 20 PSI (28,000 Pa to 138,000 Pa). In further instances, the media headloss threshold value can be a value between 8 PSI to 15 PSI (55,000 Pa to 103,000 Pa). In some instances, the media headloss threshold value may fall within a range bounded by any minimum value and any maximum value as described above. In other instances, instead of using a single media headloss threshold value, the central controller 150 may utilize a media headloss threshold range that may be bounded by any minimum value and any maximum value as described above.

At step 4630, the central controller 150 can be configured to determine the permeability of the hybrid filter assembly during a first permeability check operation. In some instances, the permeability of the hybrid filter assembly can be determined according to Formula III above.

At step 4640, the central controller 150 can determine if the permeability of the hybrid filter assembly is above, equal to, or below a minimum permeability threshold value. The minimum threshold permeability value can be a predetermined value for the system. In some instances, the minimum threshold permeability value can be set at a value of between about 75 to about 225 (or a value of 75 to 225). In other instances, the minimum threshold permeability value can be set at a value of approximately 150 (or a value of 150). In other examples, the minimum threshold permeability value can be set at a value of approximately 100 (or a value of 100). In still further instances, the minimum threshold permeability value can be set at a value of approximately 200 (or a value of 200). In some instances, the minimum threshold permeability value may fall within a range bounded by any minimum value and any maximum value as described above. In other instances, instead of using a minimum threshold permeability value, the central controller 150 may utilize a minimum threshold permeability range that may be bounded by any minimum value and any maximum value as described above.

If the analyzed first permeability value is below the minimum permeability threshold value or a minimum permeability threshold range, then the central controller 150 can be configured to initiate a chemical cleaning procedure at step 4645. In some instances, step 4645 can be performed immediately or shortly after step 4640. A benefit of proceeding directly to a chemical cleaning procedure may be that the chemical cleaning procedure can be more effective at cleaning the hybrid filter assembly as compared to the backwash procedure alone.

However, if the analyzed first permeability value is above the minimum permeability threshold value, then at step 4650, the central controller 150 can further determine if the analyzed first permeability value is above, equal to, or below a second threshold permeability value. The second threshold permeability value can be a predetermined value for the system. In some instances, the second threshold permeability value can be set to a value greater than the minimum threshold permeability value. For example, the second threshold permeability value can be set to a value of between about 150 to about 350 (or between 150 to 350). In other instances, the second threshold permeability value can be set at a value of approximately 300 (or a value of 300). For example, the second threshold permeability value may be imparted with a value of at least about 100, or at least about 125, or at least about 150, or at least about 175, or at least about 200, or at least about 225, or at least about 250, or at least about 275, or at least about 300, or at least about 325, or at least about 350, or at least about 375. As an additional example, the first threshold permeability value may be imparted with a value of at least 100, or at least 125, or at least 150, or at least 175, or at least 200, or at least 225, or at least 250, or at least 275, or at least 300, or at least 325, or at least 350, or at least 375. In some instances, the second threshold permeability value may fall within a range bounded by any minimum value and any maximum value as described above. In other instances, instead of using a single second threshold permeability value, the central controller 150 may utilize a second threshold permeability range that may be bounded by any minimum value and any maximum value as described above.

If the analyzed first permeability value is above the second threshold permeability value or the second threshold permeability range, then the central controller 150 can maintain the system in the filtration mode and continue to monitor the system. However, if the analyzed first permeability value is below the second threshold permeability value or the second threshold permeability range, then at step 4660, the central controller 150 can initiate a backwash procedure.

At step 4660, the backwash procedure can be performed according to the method 4400 of FIG. 22.

Then, at step 4670, the central controller can be configured to perform a second permeability check to determine the effectiveness of the backwash procedure. Similar to the first permeability check, the permeability of the hybrid filter assembly can be determined according to Formula III above.

At step 4680, the central controller 150 can analyze the second permeability check to determine if the second analyzed permeability value is above, equal to, or below a third threshold permeability value. In some instances, the third threshold permeability value can be the same as the second threshold permeability value. In some instances, the third threshold permeability value can be different than the second threshold permeability value. For instance, the third threshold permeability value can be greater than the second threshold permeability value because a backwash procedure may not restore the membrane filter permeability to the original permeability. However, it may not be necessary to perform additional cleaning procedures if the membrane permeability is still below an upper threshold value. In some instances, the third threshold permeability value can be equal to an upper threshold value. In some instances, the third threshold permeability value can be imparted with a value of about 250 to about 375 (or 250 to 375), although the third threshold permeability value may be imparted with a value that is somewhat less or greater than the aforementioned values. For example, the third threshold permeability value may be imparted with a value of or at least about 225, or at least about 250, or at least about 275, or at least about 300, or at least about 325, or at least about 350, or at least about 375, or at least about 400. As an additional example, the first threshold permeability value may be imparted with a value of at least 100, or at least 125, or at least 150, or at least 175, or at least 200, or at least 225, or at least 250, or at least 275, or at least 300, or at least 325, or at least 350, or at least 375, or at least 400. In some instances, the third threshold permeability value may fall within a range bounded by any minimum value and any maximum value as described above. In other instances, instead of using a single third threshold permeability value, the central controller 150 may utilize a third threshold permeability range that may be bounded by any minimum value and any maximum value as described above.

However, if the analyzed second permeability value is below the third threshold permeability value or the third threshold permeability range, at step 4685, the central controller 150 can be configured to initiate a chemical cleaning procedure. In some instances, the chemical cleaning procedure can be performed immediately or shortly after step 4680. However, the chemical cleaning procedure may also be delayed. It can be beneficial to delay a cleaning procedure, such as the backwash and/or chemical cleaning procedure, because it may not be ideal to swim in the swimming pool 110 while the hybrid filter assembly is being cleaned. Thus, the following instances discuss methods for delaying (e.g., scheduling) one or more cleaning procedures.

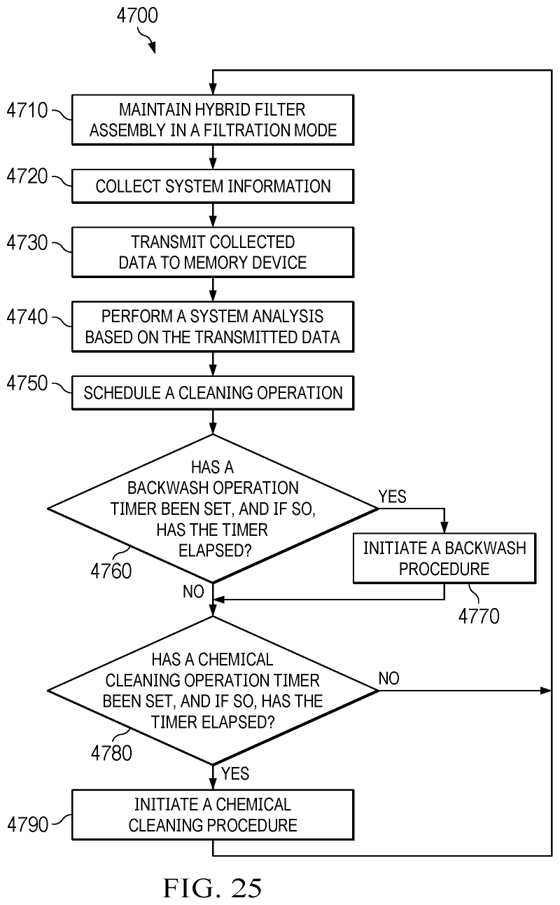

Turning to FIG. 25, a first method 4700 for scheduling a backwash cleaning operation and a chemical cleaning operation is illustrated. The method 4700 can be used in conjunction with the methods 4250-4600 of FIGS. 20-24.

At a first step 4710, the system including the hybrid filter assembly is operated in a filtration mode. As discussed above, during the filtration mode, water from the swimming pool 110 can flow through the hybrid filter assembly as described in FIG. 15. Thus, the filtration mode can be the default or normal operational mode for the system.

At step 4720, the central controller 150 can be configured to collect various details about the system in the form of system information. Similar to step 4310, here the system information can include one or more of a flow rate, an inlet pressure of the hybrid filter assembly, an outlet pressure of the hybrid filter assembly, an inlet pressure of the second filtration stage, a temperature of the water passing through the system, or combinations thereof. Thus, the system can include one or more sensors configured to monitor these parameters (e.g., flow meter, pressure transducer, temperature sensor, etc.), whereby the sensors are disposed in the appropriate location for measurement and are in communication with the conduit, housing, fluid, and the like.

At step 4730, the central controller 150 can transmit the collected data to a memory device. Referring back to FIG. 1, the memory device can be communicatively coupled to the central controller 150 via the network 170.

At step 4740, the central controller 150 can be configured to perform a system analysis based on the transmitted data. The system analysis can include at least one of a permeability check, a check to determine when the most recent backwash procedure was performed, a check to determine when the most recent chemical cleaning procedure was performed, an analysis to determine a media differential pressure (i.e., a media headloss), and any other analysis of a system operational parameter such as a flow rate, an inlet pressure of the hybrid filter assembly, an outlet pressure of the hybrid filter assembly, an inlet pressure of the second filtration stage, and a temperature of the water passing through the system. The transmitted data can include historical data. Thus, in some instances, the system analysis can be based on current data. In other instances, the system analysis can be performed on historical data. Further, in some instances, the system analysis can be based on both current and historical data. Utilizing both current and historical data can be beneficial because not all system parameters may be monitored at the same frequency. However, it can be desirable to perform a system analysis without having to collect updated information.

At step 4750, the central controller 150 can schedule a cleaning operation based on the analyzed system data. In some instances, the cleaning operation can be scheduled to be initiated immediately or in the near future. For example, it can be beneficial to perform a cleaning operation immediately if the system analysis determines that the permeability of the hybrid filter assembly is below a minimum permeability threshold. In other instances, the cleaning operation can be scheduled for a later time period. It can be desirable to delay a cleaning operation if the aquatic application 100 is currently in use. Thus, in some instances, the cleaning operation can be delayed by a set period of time (e.g., one hour, four hours, etc.). In other instances, the cleaning operation can be delayed until a predetermined time (e.g., a specific time of day). The predetermined time can be a time when the aquatic application 100 is not typically being used by swimmers, for example, at nighttime. A benefit of scheduling the cleaning operation for a time when the aquatic application 100 is unlikely to be in use is that the cleaning operation may not interrupt swimmers from enjoying the aquatic application 100. The cleaning operation can include at least one of a backwash operation and a chemical cleaning operation. Thus, the below steps illustrate a portion of a scheduling operation.

At step 4760, the central controller 150 can determine if a backwash operation timer has been set. In some instances, the central controller 150 can automatically set the backwash operation timer. For example, following a backwash procedure, the central controller 150 can start a backwash operation timer to indicate when a subsequent backwash procedure may need to be performed. Thus, the backwash timer can be set for a specific time period so that a backwash cleaning operation is performed on a routine basis. In some instances, the backwash operation time period can be manually selected by a user and input into the aquatic application 100 via the user device 160 or another user interface. In other instances, the central controller 150 can determine an optimal backwash operation time period based on the analyzed system data. For instance, the analyzed data may show that the hybrid filter assembly tends to experience the most fouling over weekends. Therefore, the central controller 150 can determine that an optimal time period to clean the hybrid filter assembly is before, during, and/or after the weekend.

The central controller 150 can further determine whether the backwash operation timer has elapsed. If the backwash operation timer has elapsed, then at step 4770, the central controller 150 can initiate a backwash procedure. The backwash procedure can be performed according to the method 4400 of FIG. 22. Once the backwash procedure is completed, the method can proceed to step 4780 to determine if a chemical cleaning operation timer has been set. However, if the backwash operation timer has not elapsed, then the method can proceed directly to step 4780.

At step 4780, the central controller 150 can determine if a chemical cleaning operation timer has been set. Similar to the backwash operation timer, the chemical cleaning timer can be set by the user or the central controller 150. If the chemical cleaning operation timer has elapsed, then at step 4790, the central controller 150 can initiate a chemical cleaning procedure. The chemical cleaning procedure can be performed according to the method 4500 of FIG. 23. Once the chemical cleaning procedure is completed, the central controller 150 can return the system to a filtration mode. However, if the chemical cleaning operation timer has not elapsed, then the central controller 150 can return the system to the filtration mode after the backwash procedure is completed.

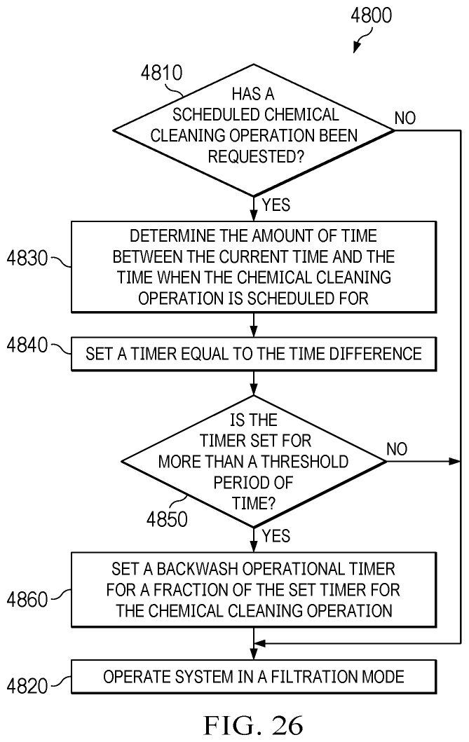

Now turning to FIG. 26, a second method 4800 for scheduling a backwash cleaning operation and/or a chemical cleaning operation is illustrated. The method 4800 can be used in conjunction with the methods 4250-4600 of FIGS. 20-24.

At step 4810, the central controller 150 can determine if a scheduled cleaning operation has been requested. If the central controller 150 determines that no request for a chemical cleaning procedure has been made, then the central controller 150 can maintain or return the system to the filtration mode at step 4820. However, if the central controller 150 determines that a request for a chemical cleaning procedure has been made, then the central controller 150 can proceed to step 4830. Thus, the method 4800 can be initiated after a cleaning operation has been scheduled. Therefore, although not shown, the method 4800 can include steps 4710-4750 of the method 4700 of FIG. 25. In some instances, the method 4800 can be performed at step 4750 of method 4700 of FIG. 25 (e.g., to schedule the timer).

At step 4830, the central controller 150 can determine the amount of time between the current time and the time for when the scheduled chemical cleaning operation has been requested. In some instances, the central controller 150 can determine when the chemical cleaning operation is scheduled by analyzing data stored in the memory, which is communicatively coupled to the central controller 150.

At step 4840, the central controller 150 can set a timer approximately equal to the time difference determined at step 4830.

Then, at step 4850, the central controller 150 can determine if the set timer is more than or less than a threshold period of time. The threshold period of time can be a predetermined period of time. In some instances, the threshold period of time is about one day, although the threshold period of time can be even greater than one day. In other instances, the threshold period of time is approximately half a day. In other examples, the predetermined period of time is at least about 10 hours. In still further instances, the predetermined period of time can be set to at least about 8 hours, or at least about 6 hours, or at least about 4 hours, or at least about 2 hours, or for smaller increments of time. In yet other instances, the threshold period of time is no more than one day. In other instances, the threshold period of time is no more than half a day. In other examples, the predetermined period of time is at least 10 hours. In still further instances, the predetermined period of time can be set to at least 8 hours or at least 6 hours, or at least 4 hours, or at least 2 hours, or for smaller increments of time. In some instances, the threshold period of time can be set by a user and input into the aquatic application 100 via the user device 160 or another user interface. In some instances, the threshold period of time may fall within a range bounded by any minimum value and any maximum value as described above. In other instances, instead of using a single value for the threshold period of time, the central controller 150 may utilize a threshold time range that may be bounded by any minimum value and any maximum value as described above. In some instances, the central controller 150 can determine an optimal threshold period of time based on system information (e.g., the system information discussed with reference to FIG. 21).

If the set timer is less than the threshold period of time or the threshold time range, then the central controller 150 can be configured to maintain or return the system to the filtration mode until the timer elapses and the cleaning operation is initiated. However, if the set timer is greater than the threshold period of time, then at step 4860, the controller can set a backwash operational timer.

At step 4860, the central controller 150 can set the backwash operational timer for a timer period that is a fraction of (i.e., less than) the time set for the chemical cleaning operation. In some instances, the backwash operational timer is set for approximately half the time as the chemical cleaning operational timer. In other instances, the backwash operational timer is set for approximately one-third the time as the chemical cleaning operational timer. In yet other instances, the backwash operational timer is set for no more than about half the time as the chemical cleaning operational timer. In some other instances, the backwash operational timer is set for no more than about one-third the time as the chemical cleaning operational timer. In yet other instances, the backwash operational timer is set for no more than half the time as the chemical cleaning operational timer. In some other instances, the backwash operational timer is set for no more than one-third the time as the chemical cleaning operational timer. The backwash operational timer may be set for time periods that are even smaller fractions of the chemical cleaning operational timer than those previously recited. Thus, a backwash operational procedure can be performed prior to the chemical operational procedure. Because the backwash operational procedure may not be scheduled to be immediately performed, the central controller 150 can be configured to maintain or return the system to the filtration mode until the backwash operational timer elapses and the system is transitioned to the backwash operational mode.

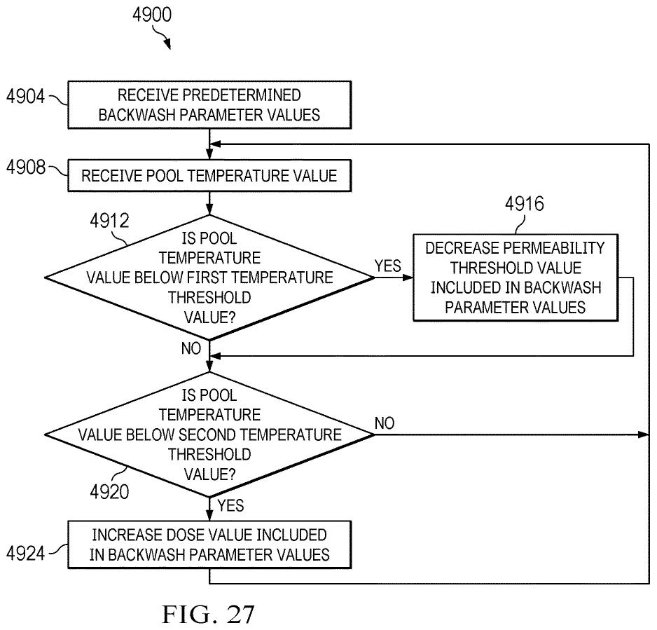

FIG. 27 illustrates a method 4900 for updating backwash parameter values based on pool water temperature. In certain instances, the method 4900 may be implemented by a controller (e.g., the central controller 150 of FIG. 1). The method 4900 can be utilized in a pool automation system or in an aquatic environment (e.g., aquatic application 100 of FIG. 1) that includes any of the hybrid filter assemblies described herein. For example, the hybrid filter assembly may be provided in the form of a first filtration stage and a second filtration stage (e.g., a prefilter and one or more membrane filters). In some instances, the first filtration stage can be a granular-bed depth-type filter, such as a sand filter or a glass filter (e.g., an activated glass filter). In some instances, the depth-type filter can include a pre-coat type media, such as diatomaceous earth. In some instances, the method 4900 can be implemented as computer-readable instructions on a non-transitory medium (e.g., a random access memory, a hard drive, etc.) and executed by a processor (e.g., a CPU, a GPU, etc.).

At a step 4904, the central controller 150 can receive one or more predetermined backwash parameter values. The one or more predetermined backwash parameter values can include values for one or more backwash parameters. In some instances, the one or more predetermined backwash parameter values can include a permeability threshold value and/or a dose value. The permeability threshold value can be associated with one or more filters, such as membrane filters. The permeability threshold value can represent a threshold value at which the one or more membrane filters may require a chemical soak and/or a backwash process in order to maintain filter performance. The one or more predetermined backwash parameter values can include one or more temperature threshold values.

In some instances, the dose value can be an amount or quantity of a chemical cleaning agent provided to the one or more membrane filters during a soak cycle prior to backwashing the one or more membrane filters. The soaking cycle may provide the chemical cleaning agent with time to neutralize contaminants within the one or more membrane filters and may facilitate a more effective cleaning process as compared to simply backwashing the one or more membrane filters without previously executing a soak cycle. In some instances, the chemical cleaning agent may be selected from the group consisting of a chlorine-containing compound, a chlorine-containing solution, a bromine-containing compound, a bromine-containing solution, a bleaching agent, an acidic solution, and combinations thereof. In some such instances, the chemical cleaning agent may be selected from the group consisting of calcium hypochlorite, trichloroisocyanuric acid, dichloro-s-triazinetrione, and combinations thereof. In yet other instances, the chemical cleaning agent can be chlorine.

In some instances, the predetermined backwash parameter values can be default and/or factory values (e.g., the preset values of an automation controller as shipped from a production facility). In some instances, the predetermined backwash parameter values can be provided by a user. In other instances, the predetermined backwash parameter values may be determined by the central controller 150 after the hybrid filter assembly is initialized for the first time and the controller receives performance information from the hybrid filter assembly.

At a step 4908, the central controller 150 can receive a pool water temperature value. The central controller 150 can receive the pool temperature value from a temperature sensor located within, proximate to, or adjacent to the pool. For example, the temperature sensor can be in fluid communication with the pool. In certain instances, the temperature sensor may be fluidly coupled to the plumbing or conduits forming a closed-loop fluid circuit associated with the pool components of the pool (e.g., the pool components 102 designed for use with the swimming pool 110 of FIG. 1).

At a step 4912, the central controller 150 can determine whether the pool water temperature value is below a first temperature threshold value. The first temperature threshold value may be a predetermined temperature threshold value at which the effectiveness of the one or more membrane filters may be impacted if the one or more membrane filters are not backwashed. For example, at lower pool water temperatures, the one or more membrane filters may require more frequent backwashing.

In certain instances, the first temperature threshold may be imparted with a value of about 10 °C to about 40 °C (or 10 °C to 40 °C), although the first temperature threshold may be somewhat less or somewhat greater than these values. For example, the first temperature threshold may be imparted with a value of about 10 to 15 °C (or 10 to 15 °C). As an additional example, the first temperature threshold may be imparted with a value of about 25 to 28 °C (or 25 to 28 degrees Celsius). As yet another example, the first temperature threshold may be imparted with a value of about 28 to 31 °C (or 28 to 31 °C). For example, the first temperature threshold may be imparted with a value of about 35 to 40 °C (or 35 to 40 degrees Celsius). In certain instances, the first temperature threshold value may be imparted with a value of at least about 15 °C, or a value of at least about 20 °C, or a value of at least about 21 °C, or a value of at least about 22 °C, or a value of at least about 23 °C, or a value of at least about 24 °C, or a value of at least about 25 °C, or a value of at least about 26 °C, or a value of at least about 27 °C, or a value of at least about 28 °C, or a value of at least about 29 °C, or a value of at least about 30 °C, or a value of at least about 31 °C, or a value of at least about 32 °C, or a value of at least about 33 °C, or a value of at least about 34 °C, or a value of at least about 35 °C, or a value of at least about 36 °C, or a value of at least about 37 °C, or a value of at least about 38 °C, or a value of at least about 39 °C, or a value of at least about 40 °C. As a further example, the first temperature threshold value may be imparted with a value of at least 15 °C, or a value of at least 20 °C, or a value of at least 21 °C, or a value of at least 22 °C, or a value of at least 23 °C, or a value of at least 24 °C, or a value of at least 25 °C, or a value of at least 26 °C, or a value of at least 27 °C, or a value of at least 28 °C, or a value of at least 29°C, or a value of at least 30 °C, or a value of at least 31 °C, or a value of at least 32 °C, or a value of at least 33 °C, or a value of at least 34 °C, or a value of at least 35 °C, or a value of at least 36 degrees Celsius, or a value of at least 37 °C, or a value of at least 38 °C, or a value of at least 39 °C, or a value of at least 40 °C. In some instances, the first temperature threshold value may fall within a range bounded by any minimum value and any maximum value as described above. In other instances, instead of using a single first temperature threshold value, the central controller 150 may utilize a first temperature threshold range that may be bounded by any minimum value and any maximum value as described above.

In some instances, the one or more predetermined backwash parameter values can include the first temperature threshold value. If the pool water temperature value is below the first temperature threshold value or the first temperature threshold range (i.e., “YES” at the step 4912), the central controller 150 can proceed to a step 4916. If the pool water temperature value is not below the first temperature threshold value (i.e., “NO” at the step 4912), the central controller 150 can proceed to a step 4920.

At the step 4916, the central controller 150 can decrease a permeability threshold value included in the backwash parameter values in response to determining that the pool water temperature value is below the first temperature threshold value. The permeability threshold value can be a value at which the membrane filters should be backwashed. In some instances, the central controller 150 can decrease the permeability threshold value by a predetermined amount (e.g., ten lmh/b) and/or a percentage (e.g., ten percent). For example, the predetermined amount that the central controller 150 decreases the permeability threshold value may be at least about 10 lmh/b, or at least about 20 lmh/b, or at least about 30 lmh/b, or at least about 40 lmh/b, or at least about 50 lmh/b, or at least about 60 lmh/b, or at least about 70 mh/b, or at least about 80 lmh/b, or at least about 90 lmh/b, or at least about 100 lmh/b, or at least about 110 lmh/b, or at least about 120 lmh/b, or at least about 130 lmh/b, or at least about 140 lmh/b, or at least about 150 lmh/b, or at least about 160 lmh/b, or at least about 170 lmh/b, or at least about 180 lmh/b, or at least about 190 lmh/b, or at least about 200 lmh/b. As an additional example, the predetermined amount that the central controller 150 decreases the permeability threshold value may be at least 10 lmh/b, or at least 20 lmh/b, or at least 30 lmh/b, or at least 40 lmh/b, or at least 50 lmh/b, or at least 60 lmh/b, or at least 70 lmh/b, or at least 80 lmh/b, or at least 90 lmh/b, or at least 100 lmh/b, or at least 110 lmh/b, or at least 120 lmh/b, or at least 130 lmh/b, or at least 140 lmh/b, or at least 150 lmh/b, or at least 160 lmh/b, or at least 170 lmh/b, or at least 180 lmh/b, or at least 190 lmh/b, or at least 200 lmh/b. As another example, the predetermined amount that the central controller 150 decreases the permeability threshold value may be at least about 5 percent, or at least about 10 percent, or at least about 15 percent, or at least about 20 percent, or at least about 25 percent, or at least about 30 percent, or at least about 35 percent, or at least about 40 percent, or at least about 45 percent, or at least about 50 percent. As an additional example, the predetermined amount that the central controller 150 decreases the permeability threshold value may be at least 5 percent, or at least 10 percent, or at least 15 percent, or at least 20 percent, or at least 25 percent, or at least 30 percent, or at least 35 percent, or at least 40 percent, or at least 45 percent, or at least 50 percent. In certain instances, the predetermined amount that the central controller 150 decreases the permeability threshold value may be somewhat less or even greater than the values recited herein. In some instances, the predetermined value may fall within a range bounded by any minimum value and any maximum value as described above. In other instances, instead of using a single predetermined value, the central controller 150 may utilize a predetermined range that may be bounded by any minimum value and any maximum value as described above.

At the step 4920, the central controller 150 can determine whether the pool water temperature value is below a second temperature threshold value. The second temperature threshold value can be a predetermined temperature threshold value (e.g., 20 °C) at which the effectiveness of a chemical cleaning agent used in a chemical soak may be affected. Lower pool water temperatures may require a higher dose of chemical cleaning agent to provide an effective chemical soak as compared to instances in which the pool water temperature is higher. In some instances, the second temperature threshold value may be the same as the first temperature threshold value. In some instances, the second temperature threshold value may be different from the first temperature threshold value. In certain instances, the second temperature threshold value may be between about 10 °C and about 25 °C (or between 10 degrees Celsius and 25 °C), although the second temperature threshold value may be greater than or less than these values. For example, the second temperature threshold value may be no more than about 25 °C, or no more than about 24 °C, or no more than about 23 °C, or no more than about 22 °C, or no more than about 21 °C, or no more than about 20 °C, or no more than about 19°C, or no more than about 18 °C, or no more than about 17 °C, or no more than about 16 °C, or no more than about 15 °C, or no more than about 14 °C, or no more than about 13 °C, or no more than about 12 °C, or no more than about 11 °C, or no more than about 10 degrees Celsius. As an additional example, the second temperature threshold value may be no more than 25 °C, or no more than 24 °C, or no more than 23 °C, or no more than 22 °C, or no more than 21 °C, or no more than 20 degrees Celsius, or no more than 19 °C, or no more than 18 °C, or no more than 17 °C, or no more than 16 °C, or no more than 15 °C, or no more than 14 °C, or no more than 13 °C, or no more than 12 degrees Celsius, or no more than 11 °C, or no more than 10 °C. In some instances, the second temperature threshold value may fall within a range bounded by any minimum value and any maximum value as described above. In other instances, instead of using a single second temperature threshold value, the central controller 150 may utilize a second temperature threshold range that may be bounded by any minimum value and any maximum value as described above. In some instances, the one or more predetermined backwash parameter values can include the second temperature threshold value.

If the pool water temperature value is below the second temperature threshold value (i.e., “YES” at the step 4920), the central controller 150 can proceed to a step 4924. If the pool water temperature value is not below the second temperature threshold value (i.e., “NO” at the step 4920), the central controller 150 can proceed to the step 4908.

At the step 4924, the central controller 150 can increase the dose value included in the backwash parameter values in response to determining that the pool water temperature value is below the second temperature threshold value. In some instances, the central controller 150 can increase the dose value a predetermined amount (e.g., twenty ml) and/or a percentage (e.g., ten percent). For example, the central controller 150 can increase the dose value by at least about 1 ml, or at least about 5 ml, or at least about 10 ml, or at least about 15 ml, or at least about 20 ml, or at least about 25 ml, or at least about 30 ml, or at least about 35 ml, or at least about 40 ml, or at least about 45 ml, or at least about 50 ml, or at least about 60 ml, or at least about 70 ml, or at least about 80 ml, or at least about 90 ml, or at least about 100 ml, or at least about 125 ml, or at least about 150 ml, or at least about 175 ml, or at least about 200 ml, or at least about 250 ml, or at least about 300 ml, or at least about 350 ml, or at least about 400 ml, or at least about 450 ml, or at least about 500 ml, or at least about 600 ml, or at least about 700 ml, or at least about 800 ml, or at least about 900 ml, or at least about 1000 ml. As another example, the central controller 150 can increase the dose value by at least 1 ml, or at least 5 ml, or at least 10 ml, or at least 15 ml, or at least 20 ml, or at least 25 ml, or at least 30 ml, or at least 35 ml, or at least 40 ml, or at least 45 ml, or at least 50 ml, or at least 60 ml, or at least 70 ml, or at least 80 ml, or at least 90 ml, or at least 100 ml, or at least 125 ml, or at least 150 ml, or at least 175 ml, or at least 200 ml, or at least 250 ml, or at least 300 ml, or at least 350 ml, or at least 400 ml, or at least 450 ml, or at least 500 ml, or at least 600 ml, or at least 700 ml, or at least 800 ml, or at least 900 ml, or at least 1000 ml. As an additional example, the central controller 150 can increase the dose value by at least about 5 percent, or at least about 10 percent, or at least about 15 percent, or at least about 20 percent, or at least about 25 percent, or at least about 30 percent, or at least about 35 percent, or at least about 40 percent, or at least about 45 percent, or at least about 50 percent, or at least about 60 percent, or at least about 70 percent, or at least about 80 percent, or at least about 90 percent, or at least about 100 percent. As another example, the central controller 150 can increase the dose value by at least 5 percent, or at least 10 percent, or at least 15 percent, or at least 20 percent, or at least 25 percent, or at least 30 percent, or at least 35 percent, or at least 40 percent, or at least 45 percent, or at least 50 percent, or at least 60 percent, or at least 70 percent, or at least 80 percent, or at least 90 percent, or at least 100 percent. In certain instances, the predetermined amount that the central controller 150 increases the dose value may be somewhat less or even greater than the values recited herein. In some instances, the increase of the dose value may fall within a range bounded by any minimum value and any maximum value as described above. In other instances, instead of using a single value for the amount the dose is increased by, the central controller 150 may utilize a predetermined range that may be bounded by any minimum value and any maximum value as described above.

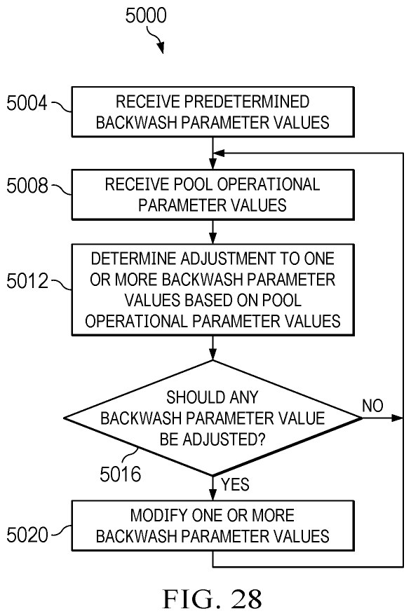

Turning now to FIG. 28, a method 5000 for updating one or more backwash parameter values based on one or more pool operational parameter values is shown. The method 5000 can be utilized in a pool automation system or in an aquatic environment (e.g., aquatic application 100 of FIG. 1) that includes any of the hybrid filter assemblies described herein. For example, the hybrid filter assembly may be provided in the form of a first filtration stage and a second filtration stage (e.g., a prefilter and one or more membrane filters). In some instances, the first filtration stage can be a granular-bed depth-type filter, such as a sand filter or a glass filter (e.g., an activated glass filter). In some instances, the depth-type filter can include a pre-coat type media, such as diatomaceous earth. In some instances, the method 5000 can be implemented as computer-readable instructions on a non-transitory medium (e.g., a random access memory, a hard drive, etc.) and executed by a processor (e.g., a CPU, a GPU, etc.).

At a step S004, the central controller 150 can receive one or more predetermined backwash parameter values. In some instances, the predetermined backwash parameter values can be similar to or the same as the one or more predetermined backwash parameter values described above in conjunction with the method 4900 in FIG. 27.

In some instances, the one or more predetermined backwash parameter values can include a permeability threshold value, a dose value, a soak time value, a flux rate threshold value, an oxidation-reduction potential (ORP) threshold value, a run time value, and/or a usage value. The one or more predetermined backwash parameter values can include one or more temperature threshold values.

The permeability threshold value can be associated with one or more filters, such as membrane filters. The permeability threshold value can represent a threshold at which the one or more membrane filters may require a chemical soak and/or backwash process in order to maintain suitable filter performance.

The dose value can be an amount of a chemical that is applied to one or more membrane filters during a soak cycle prior to backwashing the one or more membrane filters. The soaking cycle can allow the chemical to better prepare the one or more membrane filters for cleaning as compared to simply backwashing the one or more membrane filters without previously executing a soak cycle. In some instances, the chemical cleaning agent may be selected from the group consisting of a chlorine-containing compound, a chlorine-containing solution, a bromine-containing compound, a bromine-containing solution, a bleaching agent, an acidic solution, and combinations thereof. In some such instances, the chemical cleaning agent may be selected from the group consisting of calcium hypochlorite, trichloroisocyanuric acid, dichloro-s-triazinetrione, and combinations thereof. In yet other instances, the chemical cleaning agent can be chlorine.

The soak time value can be a length of time that the chemical cleaning agent is applied to a membrane before flushing. In some instances, the soak time can be about 1 hour to about 24 hours (or 1 hour to 24 hours), although the soak time may be imparted with a value that is less than or greater than the times described herein. For example, the soak time may be imparted with a value of at least about 30 minutes, or at least about 1 hour, or at least about 2 hours, or at least about 3 hours, or at least about 4 hours, or at least about 5 hours, or at least about 6 hours, or at least about 7 hours, or at least about 8 hours, or at least about 9 hours, or at least about 10 hours, or at least about 11 hours, or at least about 12 hours, or at least about 13 hours, or at least about 14 hours, or at least about 15 hours, or at least about 16 hours, or at least about 17 hours, or at least about 18 hours, or at least about 19 hours, or at least about 20 hours, or at least about 21 hours, or at least about 22 hours, or at least about 23 hours, or at least about 24 hours. As an additional example, the soak time may be imparted with a value of at least 30 minutes, or at least 1 hour, or at least 2 hours, or at least 3 hours, or at least 4 hours, or at least 5 hours, or at least 6 hours, or at least 7 hours, or at least 8 hours, or at least 9 hours, or at least 10 hours, or at least 11 hours, or at least 12 hours, or at least 13 hours, or at least 14 hours, or at least 15 hours, or at least 16 hours, or at least 17 hours, or at least 18 hours, or at least 19 hours, or at least 20 hours, or at least 21 hours, or at least 22 hours, or at least 23 hours, or at least 24 hours.

In some instances, the flux rate threshold value can represent a threshold at which debris may be present in the filter. In some instances, the flux rate threshold value can represent a threshold at which fluid may be flowing through the one or more membrane filters or the hybrid filter assembly at a rate that reduces the need to backwash the one or more membrane filters or the hybrid filter assembly. In some instances, the flux rate threshold value may be imparted with a value of about 100 to about 300 (or a value of 100 to 300), although the flux rate threshold value may be somewhat less or even greater than these values. For example, the flux rate threshold value may be imparted with a value of at least about 100 lmh/b, or at least about 125 lmh/b, or at least about 150 lmh/b, or at least about 175 lmh/b, or at least about 200 lmh/b, or at least about 225 lmh/b, or at least about 250 lmh/b, or at least about 275 lmh/b, or at least about 300 lmh/b. As an additional example, the flux rate threshold value may be imparted with a value of at least 100 lmh/b, or at least 125 lmh/b, or at least 150 lmh/b, or at least 175 lmh/b, or at least 200 lmh/b, or at least 225 lmh/b, or at least 250 lmh/b, or at least 275 lmh/b, or at least 300 lmh/b. In some instances, the flux rate threshold value may fall within a range bounded by any minimum value and any maximum value as described above. In other instances, instead of using a single flux rate threshold value, the central controller 150 may utilize a flux rate threshold range that may be bounded by any minimum value and any maximum value as described above.

The ORP threshold value can be an ORP value at which the membrane may require different backwash settings. In some instances, the ORP threshold value may be imparted with a value of about 650 to about 750, although the ORP threshold value may be less than or greater than these values. For example, the ORP threshold value may be imparted with a value of about 650, or about 675, or about 700, or about 725, or about 750. As an additional example, the ORP threshold value may be imparted with a value of 650, or 675, or 700, or 725, or 750. In some instances, the ORP threshold value may fall within a range bounded by any minimum value and any maximum value as described above. In other instances, instead of using a single ORP threshold value, the central controller 150 may utilize a first ORP range that may be bounded by any minimum value and any maximum value as described above.

In some instances, the predetermined backwash parameter values can be default and/or factory values (e.g., the preset values of an automation controller as shipped from a production facility). In other instances, the predetermined backwash parameter values can be provided by a user. In yet other instances, the predetermined backwash parameter values may be determined by the central controller 150 after the hybrid filter assembly is initialized for the first time and the controller receives performance information from the hybrid filter assembly.

In some instances, the run time value can be an amount of time in which the hybrid filter assembly has been used. In some instances, the run time value can be represented in minutes, hours, and/or days. In some instances, the usage value can be generated based on multiple parameter values. For example, the usage value can be generated based on the run time value and a volume value. For example, the usage value can be calculated as a number of days the hybrid filter assembly has been in service multiplied by a daily volume that flows through the filter. In some instances, the usage value can be a total amount of water that has flowed through the hybrid filter assembly.

At step S008, the central controller 150 can receive one or more pool operational parameter values. In some instances, the one or more pool operational parameter values can include a pool water temperature value, an ORP value, and/or a flux rate value. The central controller 150 can receive the pool temperature value from a temperature sensor located within, proximate to, or adjacent to the pool. For example, the temperature sensor can be in fluid communication with the pool. In certain instances, the temperature sensor may be fluidly coupled to the plumbing or conduits forming a closed-loop fluid circuit associated with the pool components of the pool (e.g., the pool components 102 designed for use with the swimming pool 110 of FIG. 1). The central controller 150 can receive the ORP value from an ORP sensor located within, proximate to, or adjacent to the pool. For example, the ORP sensor can be in fluid communication with the pool. In certain instances, the ORP sensor may be fluidly coupled to the plumbing or conduits forming a closed-loop fluid circuit associated with the pool components of the pool (e.g., the pool components 102 of FIG. 1). The central controller 150 can receive the flux rate value from a flow meter in fluid communication with the membrane. The flux rate value can be associated with a forward flow and/or filtering direction within the membrane.

In some instances, the one or more pool operational parameter values can include one or more timer values. In some instances, the timer value can correspond to a time elapsed since installation of the filter. In some instances, the timer value can correspond to the time elapsed since a backwash or soak cycle. In some instances, the one or more timer values can be generated based on timers initiated at step S004.

In some instances, the one or more pool operational parameter values can include an updated run time value and/or an updated usage value. In some instances, the updated run time value can be an amount of time in which the one or more membrane filters and/or the hybrid filter assembly has been used. In some instances, the updated run time value can be represented in hours and/or days. In some instances, the updated usage value can be generated based on multiple parameter values. For example, the updated usage value can be generated based on the run time value and a volume value. For example, the updated usage value can be calculated as a number of days the one or more membrane filters and/or the hybrid filter assembly has been in service multiplied by a daily volume that flows through the one or more membrane filters and/or the hybrid filter assembly. In some instances, the updated usage value can be a total amount of water that has flowed through the one or more membrane filters and/or the hybrid filter assembly.

At a step S012, the central controller 150 can determine whether to adjust the one or more backwash parameter values based on the one or more pool operational parameter values. In some instances, the central controller 150 may determine not to adjust any of the backwash parameter values based on the one or more pool operational parameter values.

In some instances, the central controller 150 can determine that the permeability threshold value should be decreased based on the pool water temperature value. The central controller 150 can determine whether the pool water temperature value is below a first temperature threshold value. The first temperature threshold value can be a predetermined temperature threshold value (e.g., 22 °C, any of the first temperature threshold values discussed with reference to FIG. 27) at which the effectiveness of the one or more membrane filters and/or the hybrid filter assembly may be impacted if not backwashed. In some instances, the one or more predetermined backwash parameter values can include the first temperature threshold value. The central controller 150 can determine that the permeability threshold value should be decreased in response to determining that the pool water temperature value is below the first temperature threshold value. In some instances, the central controller 150 can determine that the permeability threshold value should be decreased by a predetermined amount (e.g., ten lmh/b) and/or a percentage (e.g., ten percent). At lower pool water temperatures, the one or more membrane filters may require more frequent backwashing.

In some instances, the central controller 150 can determine that the dose value should be increased based on the pool water temperature value. The central controller 150 can determine that the pool water temperature value is below a second temperature threshold value. The second temperature threshold value can be a predetermined temperature threshold value (e.g., 20 degrees Celsius, any of the second temperature threshold values discussed with reference to FIG. 27) at which the effectiveness of a chemical cleaning agent used in a chemical soak may be affected. Lower pool water temperatures may require a higher dose of chemical cleaning agent to provide an effective chemical soak as compared to instances in which the pool water temperature is higher. In some instances, the second temperature threshold value may be the same as the first temperature threshold value. In some instances, the second temperature threshold value may be different from the first temperature threshold value. In some instances, the one or more predetermined backwash parameter values can include the second temperature threshold value. The central controller 150 can determine that the dose value included in the backwash parameter values should be increased in response to determining that the pool water temperature value is below the second temperature threshold value. In some instances, the central controller 150 can increase the dose value by a predetermined amount (e.g., twenty ml) and/or a percentage (e.g., ten percent).

In some instances, the central controller 150 can determine that the dose value should be increased based on the ORP value. The central controller 150 can determine that the ORP value is below the ORP threshold value, and in response, determine that the dose value should be increased. If the ORP value is below the ORP threshold value, the membrane may require greater cleaning. In some instances, the central controller 150 can determine that the dose value should be decreased based on the ORP value. The central controller 150 can determine that the ORP value is above the ORP threshold value, and in response, determine that the dose value should be decreased.

In some instances, the central controller 150 can determine that the permeability threshold value should be decreased based on the ORP value. The central controller 150 can determine that the ORP value is above the ORP threshold value, and in response, determine that the permeability threshold value should be decreased. In some instances, the central controller 150 can determine that the permeability threshold value should be increased based on the ORP value. The central controller 150 can determine that the ORP value is below the ORP threshold value, and in response, determine that the permeability threshold value should be increased.

In some instances, the central controller 150 can determine that the soak time value should be decreased based on the ORP value. The central controller 150 can determine that the ORP value is above the ORP threshold value, and in response, determine that the soak time value should be decreased. In some instances, the central controller 150 can determine that the soak time value should be increased based on the ORP value. The central controller 150 can determine that the ORP value is below the ORP threshold value, and in response, determine that the soak time value should be increased.

In some instances, the central controller 150 can determine that the permeability threshold value should be decreased based on the flux rate value. The central controller 150 can determine that the flux rate value is above the flux rate threshold value, and in response, determine that the permeability threshold value should be decreased based on the flux rate value. If the flux rate value is above the flux rate threshold value, the membrane may require greater and/or more frequent cleaning in order to clear debris from the membrane. In some instances, the central controller 150 can determine that the permeability threshold value should be increased based on the flux rate value. The central controller 150 can determine that the flux rate value is below the flux rate threshold value, and in response, determine that the permeability threshold value should be increased based on the flux rate value. If the flux rate value is below the flux rate threshold value, the membrane may require lesser and/or less frequent cleaning in order to clear debris from the membrane.

At a step S016, if the central controller 150 determines to make an adjustment to one or more backwash parameter values (i.e., “YES” at the step S016), the central controller 150 can proceed to a step S020. If the central controller 150 determines not to make an adjustment to any backwash parameter values (i.e., “NO” at the step S016), the central controller 150 can proceed to the step S008.

At the step S020, the central controller 150 can modify one or more backwash parameter values as determined at the step S012.

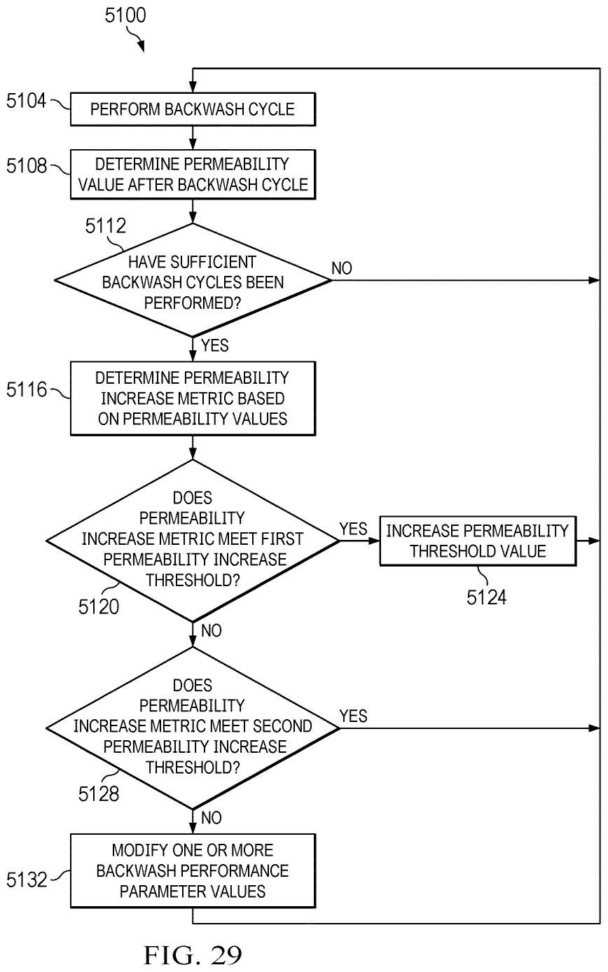

Turning now to FIG. 29, a method 5100 for updating a permeability threshold value is shown. The method 5100 can be utilized in a pool automation system or in an aquatic environment (e.g., aquatic application 100 of FIG. 1) that includes any of the hybrid filter assemblies described herein. For example, the hybrid filter assembly may be provided in the form of a first filtration stage and a second filtration stage (e.g., a prefilter and one or more membrane filters). In some instances, the first filtration stage can be a granular-bed depth-type filter, such as a sand filter or a glass filter (e.g., an activated glass filter). In some instances, the glass filter can include glass media such as diatomaceous earth. In some instances, the method 5100 can be implemented as computer-readable instructions on a non-transitory medium (e.g., a random access memory, a hard drive, etc.) and executed by a processor (e.g., a CPU, a GPU, etc.).

At a step S104, the central controller 150 can perform a backwash cycle. The backwash cycle may include one or more of a chemical soak stage and a backwash stage. The chemical soak stage can include an application of a chemical cleaning agent (e.g., chlorine) to one or more membrane filters, followed by a predetermined time period to let the chemical cleaning agent soak into the one or more membrane filters (e.g., at least eight hours, any of the soak time values discussed with reference to FIG. 28). During the soak, the central controller 150 can direct the clean-in-place module 345 to circulate the chemical cleaning agents within the one or more membrane filters 320. The backwash stage can include an application of water in a reverse flow direction as compared to regular operation of the one or more membrane filters. In some instances, the central controller 150 may receive a notification that a backwash cycle has been performed rather than or in addition to causing a filter system (i.e., the hybrid filter assembly) to run a backwash cycle.

At a step S108, the central controller 150 can determine a permeability value after the backwash cycle has completed. The permeability value can be associated with the hybrid filter assembly and/or the one or more membranes of the hybrid filter assembly. The central controller 150 can determine the permeability value based on a number of preset, sensed, and/or calculated parameter values such as flux, system flow, membrane surface area, transmembrane pressure, filter headloss, inlet pressure, outlet pressure, viscosity, water temperature, and constant values. In some instances, the process can determine permeability of the hybrid filter assembly and/or the one or more membranes based on Formula III above.

At a step S112, the central controller 150 can determine if sufficient backwash cycles have been performed. In some instances, the central controller 150 can determine if sufficient backwash cycles have been performed based on a predetermined threshold number of backwash cycles (e.g., five cycles). In some instances, the central controller 150 can determine if sufficient backwash cycles have been performed based on a predetermined number of backwash cycles that have occurred over a predetermined time period (e.g., a backwards-looking time window). In some instances, the predetermined number of backwash cycles may be five backwash cycles, and the predetermined time period may be thirty days. For example, the central controller 150 may determine that four backwash cycles have been performed in the past thirty days and determine that sufficient backwash cycles have been performed. As an additional example, when evaluating the number of backwash cycles performed over a predetermined time period of 30 days, the predetermined number of backwash cycles may be imparted with a value of at least about 0 backwashes, or at least about 2 backwashes, or at least about 5 backwashes, or at least about 10 backwashes, or at least about 15 backwashes, or at least about 20 backwashes, or at least about 25 backwashes, or at least about 30 backwashes. As another example, when evaluating the number of backwash cycles performed over a predetermined time period of 30 days, the predetermined number of backwash cycles may be imparted with a value of at least 0 backwashes, or at least 2 backwashes, or at least 5 backwashes, or at least 10 backwashes, or at least 15 backwashes, or at least 20 backwashes, or at least 25 backwashes, or at least 30 backwashes. In certain instances, the predetermined number of backwash cycles may be somewhat less or even greater than the values recited herein. In some instances, the predetermined number of backwash cycles may fall within a range bounded by any minimum value and any maximum value as described above. In other instances, instead of using a single value for the predetermined number of backwash cycles, the central controller 150 may utilize a range of values that may be bounded by any minimum value and any maximum value as described above. In some instances, the predetermined time period may be imparted with a value other than 30 days. For example, the predetermined time period may be imparted with a value of about 7 days, or about 14 days, or about 21 days, or about 30 days, or about 45 days, or about 60 days. As an additional example, the predetermined time period may be imparted with a value of 7 days, or 14 days, or 21 days, or 30 days, or 45 days, or 60 days. In certain instances, the predetermined time period may be somewhat less or somewhat greater than the values recited herein. In some instances, the predetermined time period may fall within a range bounded by any minimum value and any maximum value as described above. In other instances, instead of using a single value for the predetermined time period, the central controller 150 may utilize a range of values that may be bounded by any minimum value and any maximum value as described above.

In some instances, the central controller 150 may determine if the number of backwash cycles performed is less than the predetermined threshold number of backwash cycles, and thereby determine that sufficient backwash cycles have not been performed. Alternatively, if the number of backwash cycles performed is equal to or greater than the predetermined threshold number of backwash cycles, the central controller 150 can determine that sufficient backwash cycles have been performed. If sufficient backwash cycles have been performed (i.e., “YES” at a step S112), the central controller 150 can proceed to a step S116. If sufficient backwash cycles have not been performed (i.e., “NO” at the step S112), the central controller 150 can proceed to step S104.

At the step S116, the central controller 150 can determine a permeability increase metric based on at least a portion of the permeability values generated at 5108. The central controller 150 may calculate the increase in permeability based on a most recent permeability value (i.e., the most recent permeability value generated at 5108) and a historical permeability value generated at the step S108. The historical permeability value can be the permeability value generated after a backwash cycle a predetermined number of backwash cycles before the most recent permeability value. In some instances, the predetermined number of backwash cycles can be equal to the predetermined threshold number of backwash cycles. For example, the historical permeability value may be associated with a backwash cycle that occurred five backwash cycles before the backwash cycle associated with the most recent permeability value. In some instances, the permeability increase metric can be the difference between the most recent permeability value and the historical value. In some instances, the permeability increase metric can be the ratio between the most recent permeability value and the historical value.

At a step S120, the central controller 150 can determine if the permeability increase metric meets a predetermined first permeability increase threshold value. In some instances, the predetermined first permeability increase threshold value may be a predetermined permeability value (e.g., if the permeability increase metric is the difference between the most recent permeability value and the historical value). For example, the first permeability increase threshold may be about two hundred lmh/b. As an additional example, the first permeability increase threshold may be imparted with a value of no more than about 250 lmh/b, or no more than about 225 lmh/b, or no more than about 200 lmh/b, or no more than about 175 lmh/b, or no more than about 150 lmh/b, or no more than about 125 lmh/b, or no more than about 100 lmh/b, or no more than about 75 lmh/b, or no more than about 50 lmh/b, or no more than about 25 lmh/b. As another example, the first permeability increase threshold may be imparted with a value of no more than 250 lmh/b, or no more than 225 lmh/b, or no more than 200 lmh/b, or no more than 175 lmh/b, or no more than 150 lmh/b, or no more than 125 lmh/b, or no more than 100 lmh/b, or no more than 75 lmh/b, or no more than 50 lmh/b, or no more than 25 lmh/b. In certain instances, the first permeability increase threshold may be somewhat less or even greater than the values recited herein. In some instances, the first permeability increase threshold may fall within a range bounded by any minimum value and any maximum value as described above. In some instances, the predetermined first permeability increase threshold value may be a predetermined ratio (e.g., if the permeability increase metric is the ratio between the most recent permeability value and the historical value) or a range of values. The first permeability increase threshold value can be used to determine if the permeability threshold value can be increased if the previous backwashes have substantially improved the permeability of the one or more membrane filters and/or the hybrid filter assembly. In particular, if the permeability has improved substantially, then the central controller 150 can determine to increase the permeability threshold value, which may potentially reduce the number of backwashes required and/or extend the life of the one or more membrane filters. The central controller 150 may determine that the permeability increase metric meets the predetermined first permeability increase threshold value if the permeability increase metric is greater than or equal to the predetermined first permeability increase threshold value. The central controller 150 may determine that the permeability increase metric does not meet the predetermined first permeability increase threshold value if the permeability increase metric is less than the predetermined first permeability increase threshold value. If the permeability increase metric meets the predetermined first permeability increase threshold value (i.e., “YES” at the step 5120), the central controller 150 can proceed to a step S124. If the permeability increase metric does not meet the predetermined first permeability increase threshold value (i.e., “NO” at the step 5120), the central controller 150 can proceed to a step S128.

At the step S124, the central controller 150 can increase the permeability threshold value in response to determining that the permeability increase metric meets the predetermined first permeability increase threshold value. The permeability threshold value can be a value at which the one or more membrane filters and/or the hybrid filter assembly require backwashing. In some instances, the central controller 150 can increase the permeability threshold value by a predetermined amount (e.g., twenty lmh/b) and/or a percentage (e.g., ten percent).

At the step S128, the central controller 150 can determine if the permeability increase metric meets a predetermined second permeability increase threshold value. In some instances, the predetermined second permeability increase threshold value may be a predetermined permeability value (e.g., if the permeability increase metric is the difference between the most recent permeability value and the historical value). For example, the second permeability increase threshold may be about twenty lmh/b. As an additional example, the second permeability increase threshold may be imparted with a value of no more than about 250 lmh/b, or no more than about 225 lmh/b, or no more than about 200 lmh/b, or no more than about 175 lmh/b, or no more than about 150 lmh/b, or no more than about 125 lmh/b, or no more than about 100 lmh/b, or no more than about 75 lmh/b, or no more than about 50 lmh/b, or no more than about 25 lmh/b. As another example, the second permeability increase threshold may be imparted with a value of no more than 250 lmh/b, or no more than 225 lmh/b, or no more than 200 lmh/b, or no more than 175 lmh/b, or no more than 150 lmh/b, or no more than 125 lmh/b, or no more than 100 lmh/b, or no more than 75 lmh/b, or no more than 50 lmh/b, or no more than 25 lmh/b, or no more than 15 lmh/b. In certain instances, the second permeability increase threshold may be somewhat less or even greater than the values recited herein. In some instances, the second permeability increase threshold may fall within a range bounded by any minimum value and any maximum value as described above. In some instances, the predetermined second permeability increase threshold value may be a predetermined ratio (e.g., if the permeability increase metric is the ratio between the most recent permeability value and the historical value) or a range of values. The central controller 150 may determine that the permeability increase metric meets the predetermined second permeability increase threshold value if the permeability increase metric is greater than or equal to the predetermined second permeability increase threshold value. The central controller 150 may determine that the permeability increase metric does not meet the predetermined second permeability increase threshold value if the permeability increase metric is less than the predetermined second permeability increase threshold value. If the permeability increase metric meets the predetermined second permeability increase threshold value (i.e., “YES” at the step S128), the central controller 150 can proceed to 5104. If the permeability increase metric does not meet the predetermined second permeability increase threshold value (i.e., “NO” at the step S128), the central controller 150 can proceed to a step S132.

At the step S132, the central controller 150 can modify one or more backwash performance parameter values in response to determining that the permeability increase metric does not meet the predetermined second permeability increase threshold value. The central controller 150 can modify one or more backwash performance parameter values to potentially increase permeability after future backwash cycles. In some instances, the backwash performance parameters can include a chemical dosage amount value (e.g., an amount of chemical agent provided to the one or more membrane filters) and/or a soak time value (e.g., a time period to let the chemical soak into the one or more membrane filters). In some instances, the central controller 150 can increase the chemical dosage amount value and/or increase the soak time value. In some instances, the central controller 150 may direct that a notification be sent to a user (e.g., a pool owner) to check the hybrid filter assembly.

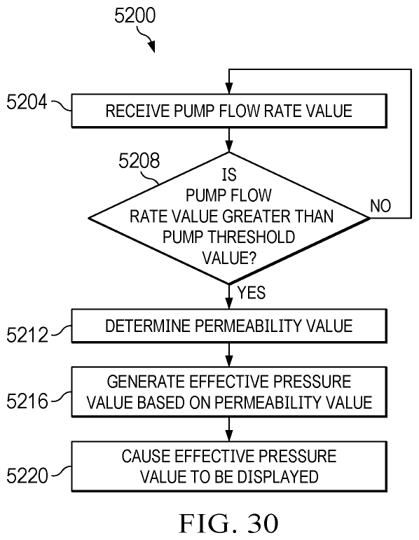

Referring now to FIG. 30, a method 5200 for determining a permeability value is shown. The method 5200 can be utilized in a pool automation system or in an aquatic environment (e.g., aquatic application 100 of FIG. 1) that includes any of the hybrid filter assemblies described herein. For example, the hybrid filter assembly may be provided in the form of a first filtration stage and a second filtration stage (e.g., a prefilter and one or more membrane filters). In some instances, the first filtration stage can be a granular-bed depth-type filter, such as a sand filter or a glass filter (e.g., an activated glass filter). In some instances, the glass filter can include glass media such as diatomaceous earth. In some instances, the method 5200 can be implemented as computer-readable instructions on a non-transitory medium (e.g., a random access memory, a hard drive, etc.) and executed by a processor (e.g., a CPU, a GPU, etc.).

At a step S204, the central controller 150 can receive a pump flow rate value. In some instances, the central controller 150 can receive the pump flow rate value from a pump and/or a flow sensor.

At a step S208, the central controller 150 can determine if the pump flow rate value is greater than a pump threshold value. The pump threshold value can be a predetermined value. In some instances, the predetermined value can be about forty-five GPM to about sixty GPM (or forty-five GPM to sixty GPM), although the predetermined value may be less than or greater than these values. In some instances, the predetermined value can be at least about forty-five GPM (or at least forty-five GPM). In some instances, the predetermined value can be at least about sixty GPM (or at least sixty GPM). If the pump flow rate value is greater than the pump threshold value (i.e., “YES” at the step S208), the central controller 150 can proceed to a step S212. If the pump flow rate value is not greater than the pump threshold value (i.e., “NO” at the step S208), the central controller 150 can proceed to the step S204.

At the step S212, the central controller 150 can determine a permeability value in response to determining that the pump flow rate value is greater than the pump threshold value. In this way, the central controller 150 can determine the permeability value at a relatively lower pump flow rate, which may provide more accurate permeability value determinations. The central controller 150 can determine the permeability value based on a number of preset, sensed, and/or calculated parameter values such as flux, system flow, membrane surface area, transmembrane pressure, filter headloss, inlet pressure, outlet pressure, viscosity, water temperature, and constant values. In some instances, the central controller 150 can determine the permeability of the hybrid filter assembly and/or the one or more membranes based on Formula III above. In some instances, the central controller 150 can output the permeability value. In some instances, the central controller 150 can proceed to end after step S212.

At a step S216, the central controller 150 can generate an effective pressure value based on the permeability value. In some instances, the effective pressure value can be a pressure drop value.

At a step S220, the central controller 150 can direct the effective pressure value to be displayed to a user. Certain users may prefer to see a pressure drop value or other effective pressure value instead of a permeability value.

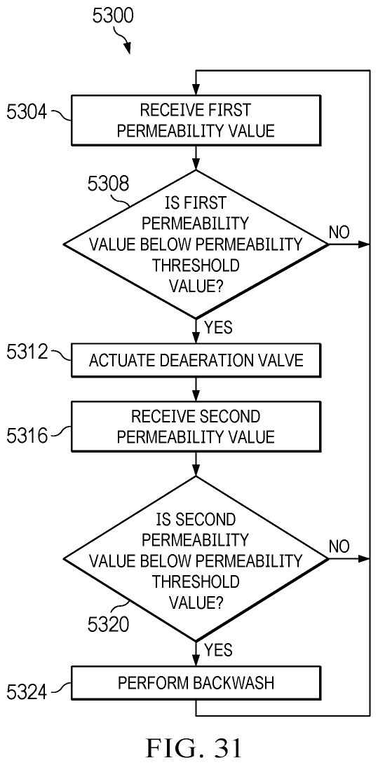

Turning now to FIG. 31, a method 5300 for performing a preliminary deaeration cycle before a backwash cycle is shown. The method 5300 can be utilized in a pool automation system or in an aquatic environment (e.g., aquatic application 100 of FIG. 1) that includes any of the hybrid filter assemblies described herein. For example, the hybrid filter assembly may be provided in the form of a first filtration stage and a second filtration stage (e.g., a prefilter and one or more membrane filters). In some instances, the first filtration stage can be a granular-bed depth-type filter, such as a sand filter or a glass filter (e.g., an activated glass filter). In some instances, the depth-type filter can include a pre-coat type media, such as diatomaceous earth. In some instances, the method 5300 can be implemented as computer-readable instructions on a non-transitory medium (e.g., a random access memory, a hard drive, etc.) and executed by a processor (e.g., a CPU, a GPU, etc.).

At a step S304, the central controller 150 can receive a first permeability value. In some instances, the first permeability value can be associated with one or more membrane filters included in the hybrid filter assembly. In some instances, the first permeability value can be generated based on Formula III above.

At a step S308, the central controller 150 can determine if the first permeability value is below a permeability threshold value. The permeability threshold value can be associated with one or more of the membrane filters included in the hybrid filter assembly. The permeability threshold value can represent a threshold at which the one or more membrane filters may require a chemical cleaning agent soak and/or backwash process in order to maintain suitable filter performance. If the central controller 150 determines that the first permeability value is not below the permeability threshold value (i.e., “NO” at the step S308), the central controller 150 can proceed to the step S304. If the central controller 150 determines that the first permeability value is below the permeability threshold value (i.e., “YES” at the step S308), the central controller 150 can proceed to a step S312.

At the step S312, the central controller 150 can actuate a deaeration valve included in the one or more membrane filters and/or the hybrid filter assembly. In some instances, the deaeration valve may be provided in each housing of the one or more membrane filtration modules provided with the hybrid filter assemblies discussed herein. Permeability values may be affected by excess pressure in the one or more membranes and/or a housing containing the one or more membranes. The central controller 150 can actuate the deaeration valve to potentially reduce a pressure in the one or more membranes and/or a housing retaining the one or more membranes (e.g., the housing of the membrane filtration modules). Reducing the pressure of the one or more membranes and/or a housing retaining the one or more membranes may improve permeability value accuracy.

At a step S316, the central controller 150 can receive a second permeability value. In some instances, the second permeability value can be associated with one or more membrane filters included in the hybrid filter. In some instances, the second permeability value can be generated based on Formula III above.

At a step S320, the central controller 150 can determine if the second permeability value is below the permeability threshold value. If the central controller 150 determines that the second permeability value is not below the permeability threshold value (i.e., “NO” at the step S320), the central controller 150 can proceed to the step S304. If the central controller 150 determines that the second permeability value is below the permeability threshold value (i.e., “YES” at the step S320), the central controller 150 can proceed to a step S324.

At the step S324, the central controller 150 can perform a backwash cycle. In some instances, the backwash cycle can include a rinse cycle. In some instances, the backwash cycle can include a chemical soak cycle followed by a rinse cycle.

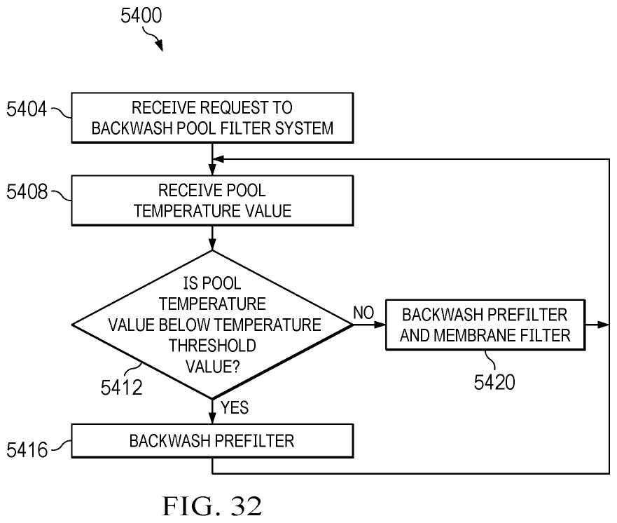

Turning now to FIG. 32, a method 5400 for generating backwash instructions is shown. The method 5400 can be utilized in a pool automation system or an aquatic environment (e.g., aquatic application 100 of FIG. 1) that includes a hybrid filter assembly provided in the form of a first filtration stage and a second filtration stage (e.g., a prefilter and one or more membrane filters). In some instances, the prefilter can be a granular-bed depth-type filter, such as a sand filter or a glass filter (e.g., an activated glass filter). In some instances, the depth-type filter can include a pre-coat type media, such as diatomaceous earth. In some instances, the method 5400 can be implemented as computer-readable instructions on a non-transitory medium (e.g., a random access memory, a hard drive, etc.) and executed by a processor (e.g., a CPU, a GPU, etc.).

At 5404, the central controller 150 can receive a request to backwash a pool filter system. The filter system can include any of the hybrid filter assemblies discussed herein. In some instances, the central controller 150 can receive the request from the pool automation system. For example, the central controller 150 can receive the request from a controller included in the pool automation system. In some instances, the central controller 150 can receive the request from a user device operably coupled to and in communication with the pool automation system. In other instances, the request can be provided by the central controller to one or more local controllers associated with the pool components 102 of FIG. 1. In yet other instances, the request can be provided to the local controllers of the pool components 102 independently of the central controller 150.

At 5408, the central controller 150 can receive a pool water temperature value. The central controller 150 can receive the pool water temperature value from a temperature sensor located within, proximate to, or adjacent to the pool. For example, the temperature sensor can be in fluid communication with the pool. In certain instances, the temperature sensor may be fluidly coupled to the plumbing or conduits forming a closed-loop fluid circuit associated with the pool components of the pool (e.g., the pool components 102 of FIG. 1 designed for use with the swimming pool 110).

At 5412, the central controller 150 can determine whether the pool water temperature value is below a temperature threshold value. The temperature threshold value can be a predetermined temperature threshold value. In some instances, the temperature threshold value can be a value below which the one or more membranes may not require as frequent backwashing or, in certain instances, any backwashing. More particularly, below certain temperatures (e.g., about 13 °C), bacteria may not grow as quickly, and backwash cycles may not be needed as frequently or at all as compared to higher temperatures. In some instances, the pool water temperature threshold value can be about 10 °C to about 13 °C (or 10 °C to 13 °C), although the pool water temperature threshold value may be somewhat higher or even lower than these values. For example, the pool water temperature threshold value may be imparted with a value of no more than about 13 °C, or no more than about 12 °C, or no more than about 11 °C, or no more than about 10 °C. As an additional example, the pool water temperature threshold value may be imparted with a value of no more than 13 °C, or no more than 12 degrees Celsius, or no more than 11 °C, or no more than 10 °C. In some instances, the predetermined temperature threshold value may fall within a range bounded by any minimum value and any maximum value as described above. In other instances, instead of using a single predetermined temperature threshold value, the central controller 150 may utilize a predetermined temperature threshold range that may be bounded by any minimum value and any maximum value as described above. If the pool water temperature value is below the temperature threshold value (i.e., “YES” at 5412), the central controller 150 can proceed to 5416. If the pool water temperature value is not below the temperature threshold value (i.e., “NO” at 5412), the central controller 150 can proceed to 5420.

At 5416, the central controller 150 can backwash the prefilter without backwashing the one or more membrane filters. In some instances, the central controller 150 can backwash the prefilter without a chemical soak stage. In some instances, the central controller 150 can backwash the prefilter by performing a chemical soak stage followed by a water-based backwash stage. By not backwashing the one or more membrane filters, the central controller 150 can potentially extend the life of the one or more membrane filters.

At 5420, method 5400 can backwash the prefilter and the one or more membrane filters. In some instances, the central controller 150 can backwash the one or more membrane filters without a chemical soak stage. In some instances, the central controller 150 can backwash the one or more membrane filters by performing a chemical soak stage followed by a water-based backwash stage.

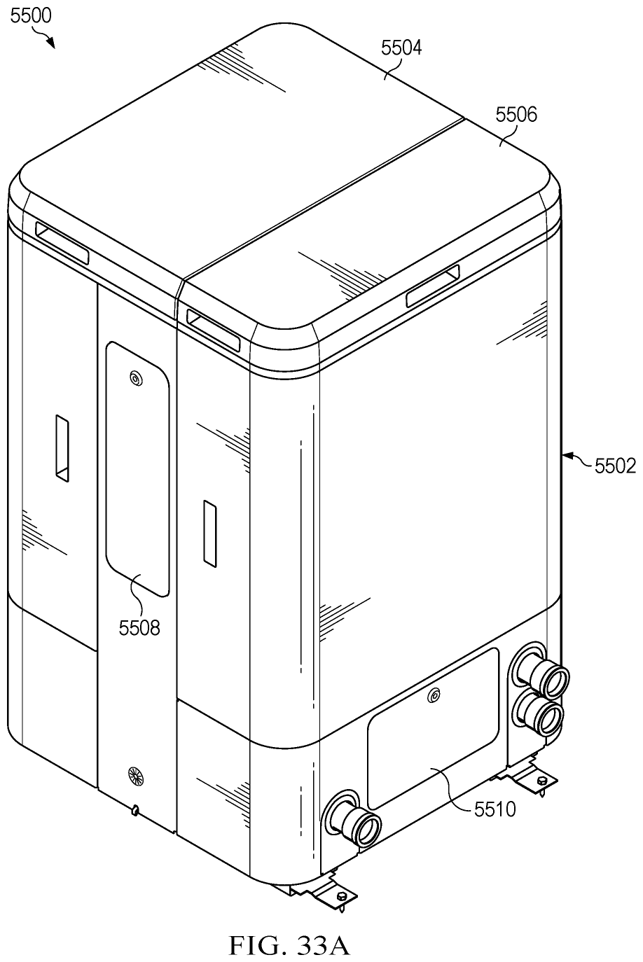

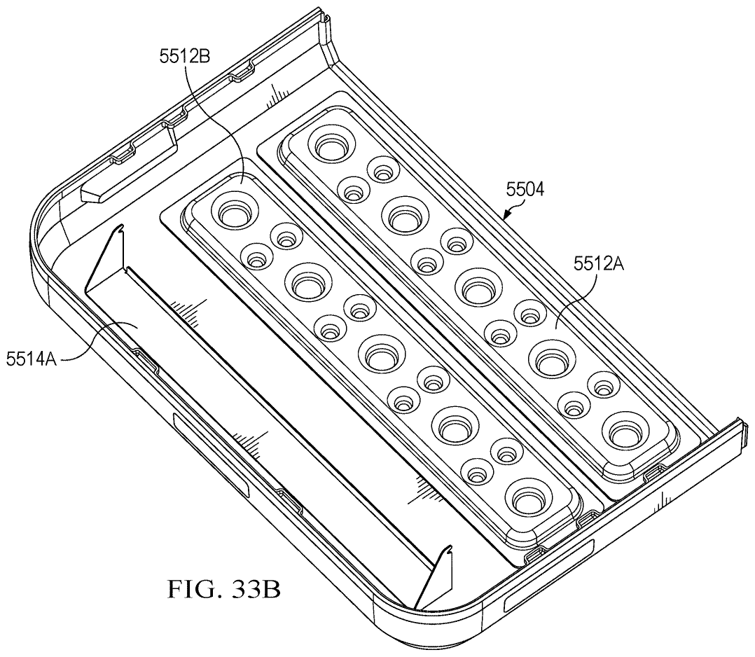

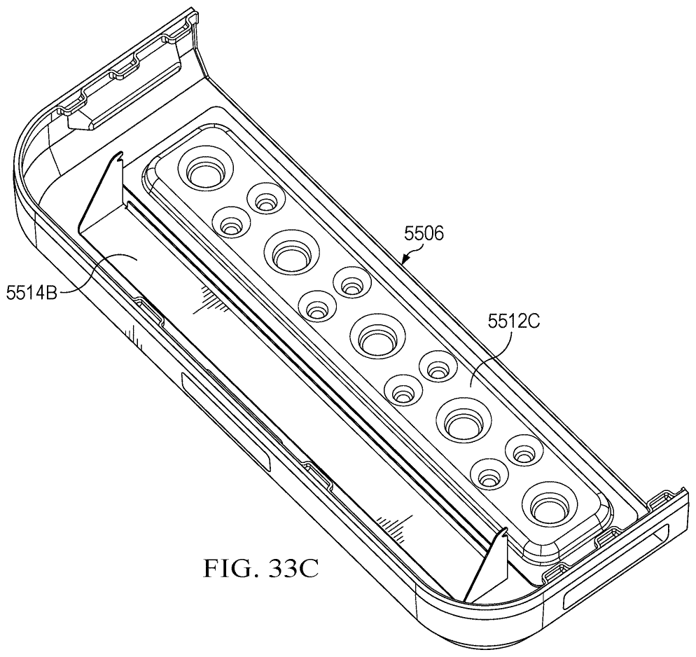

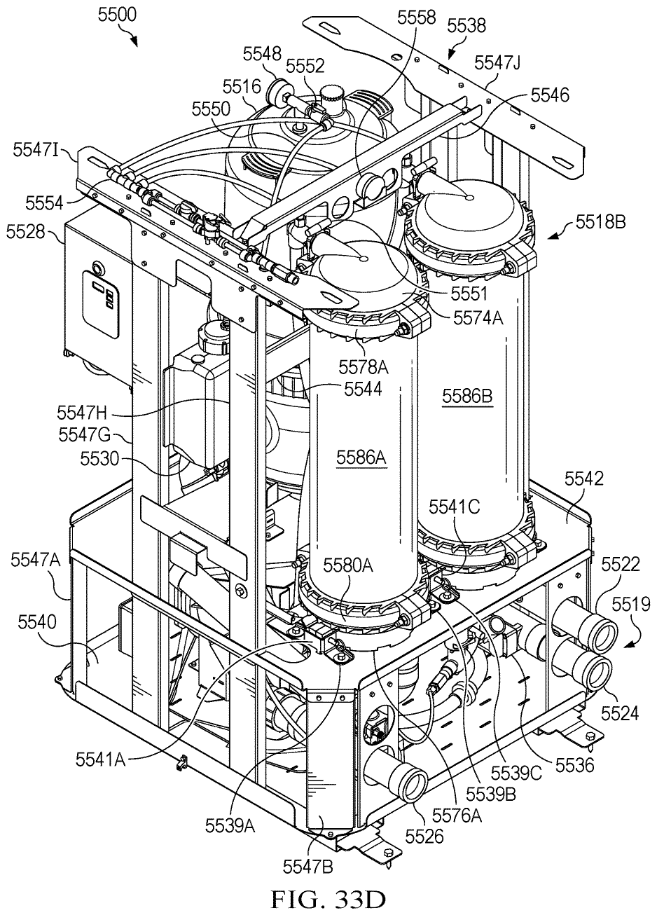

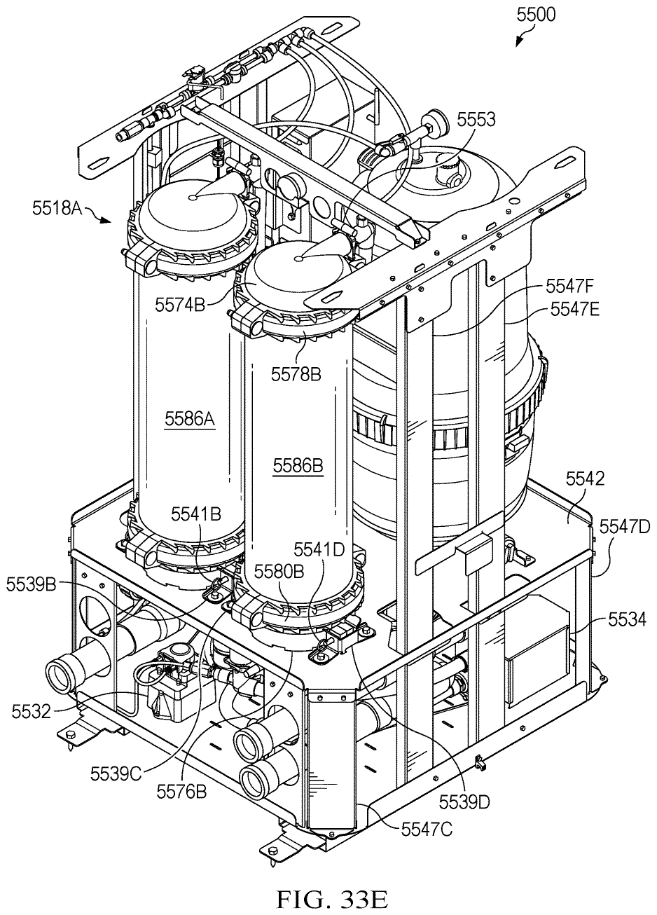

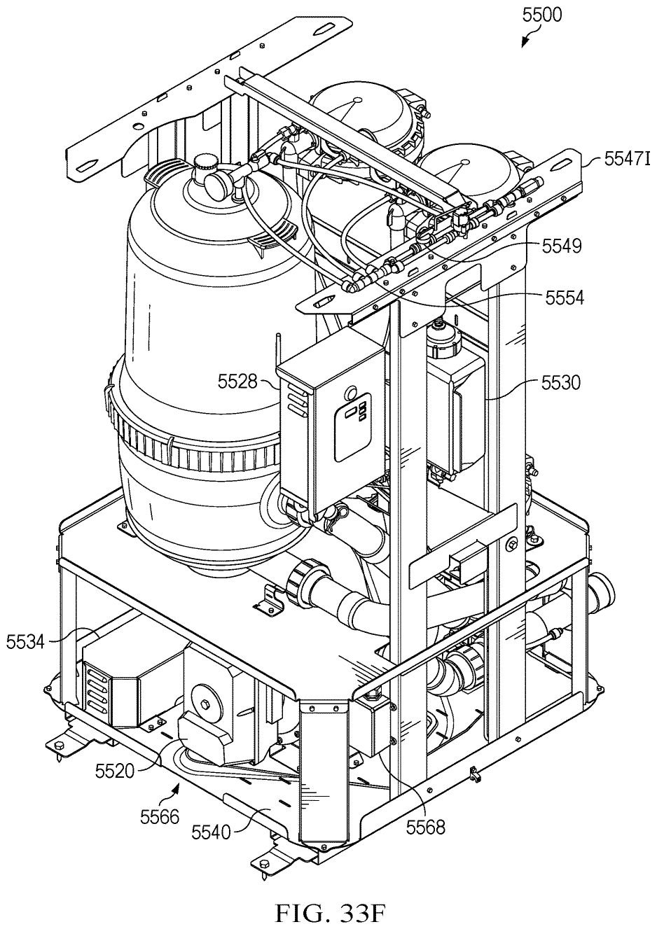

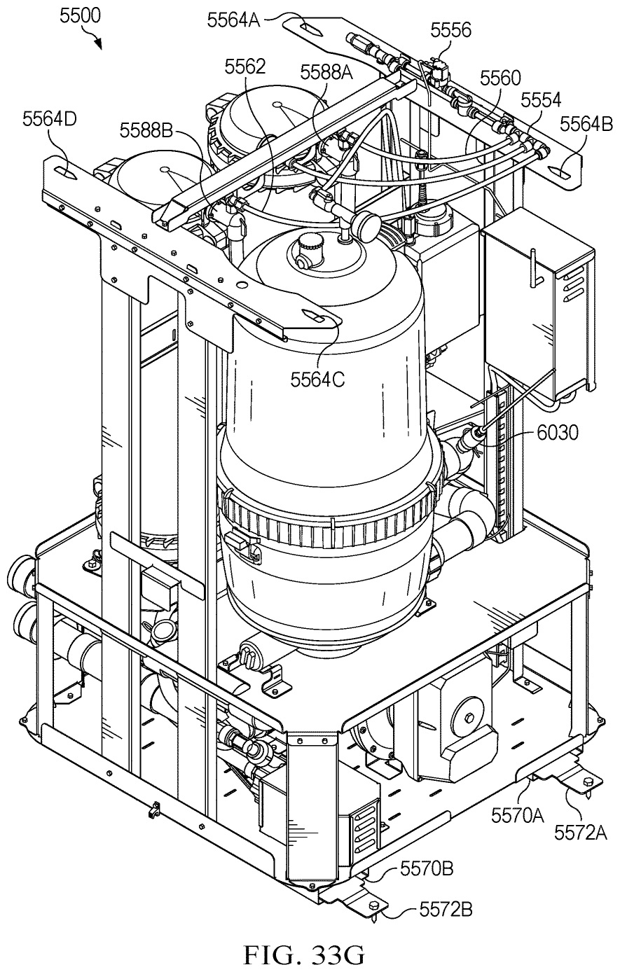

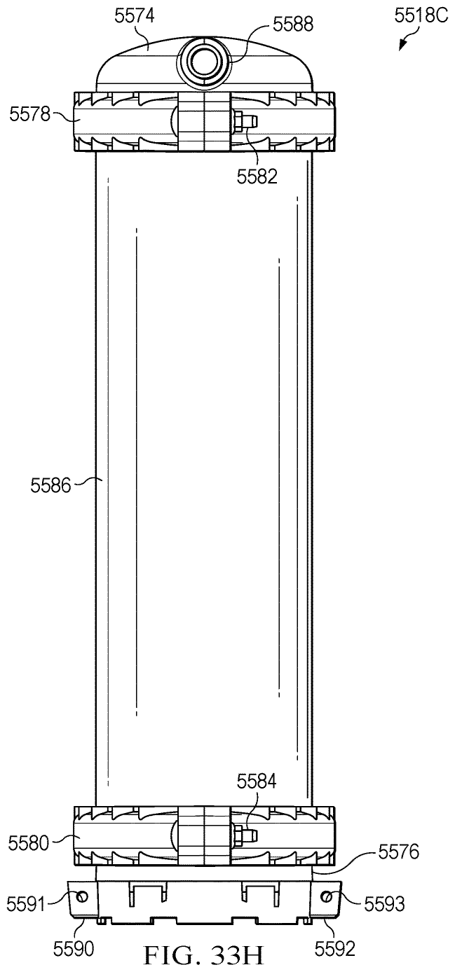

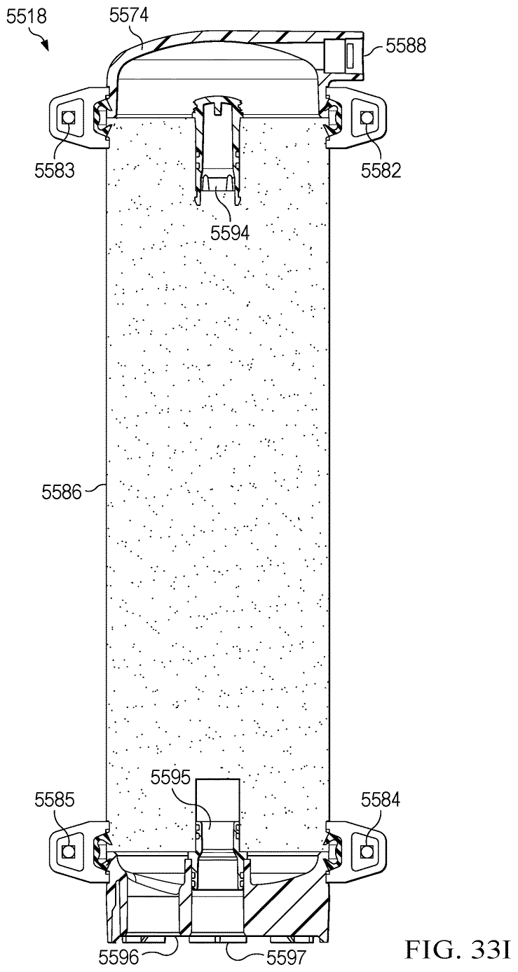

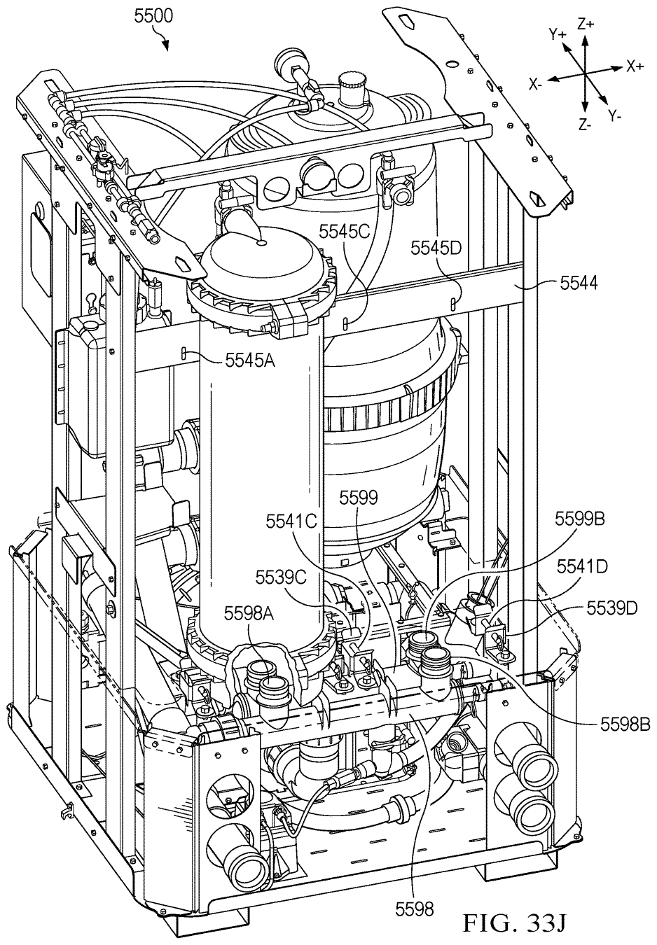

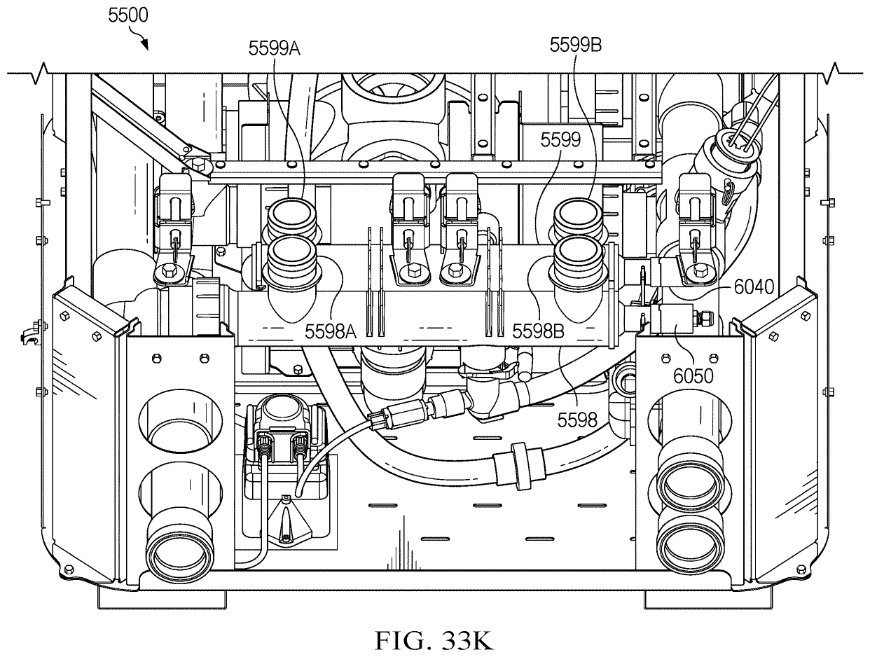

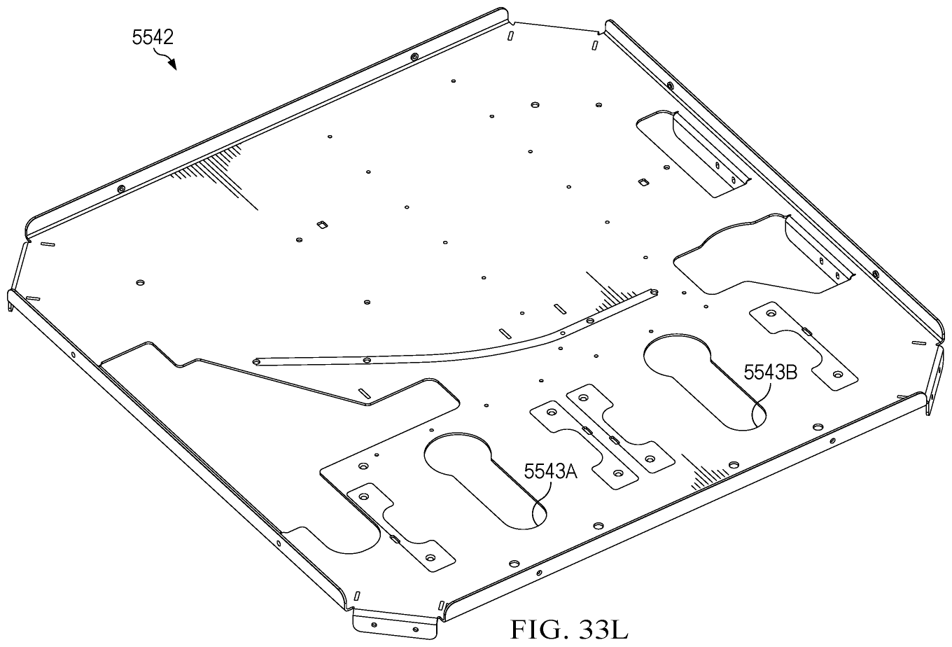

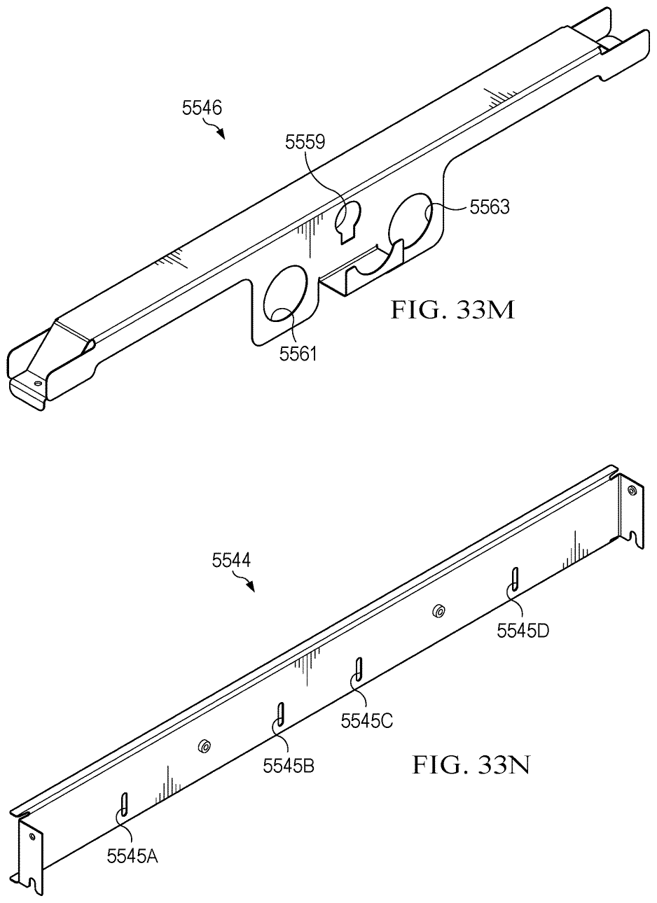

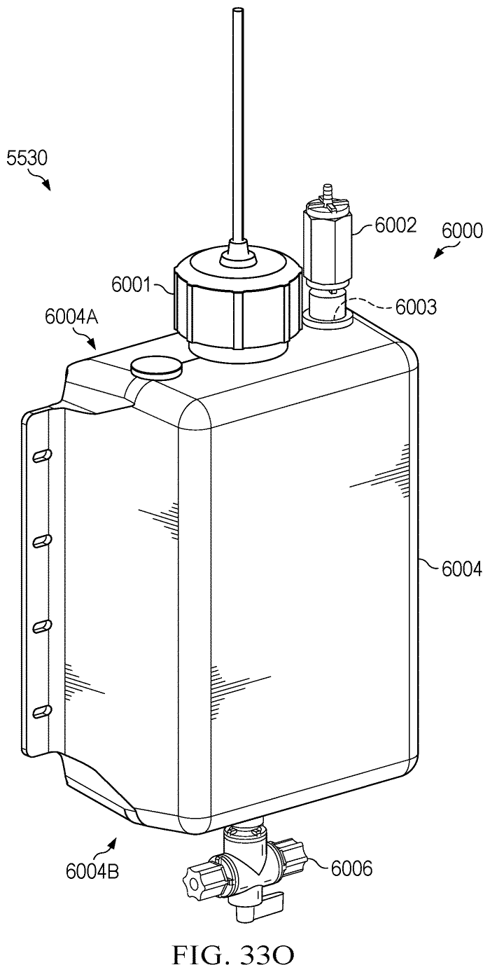

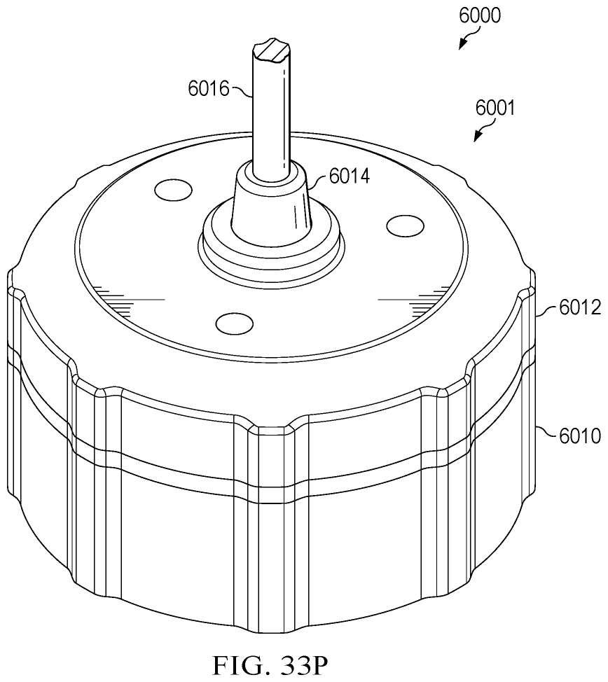

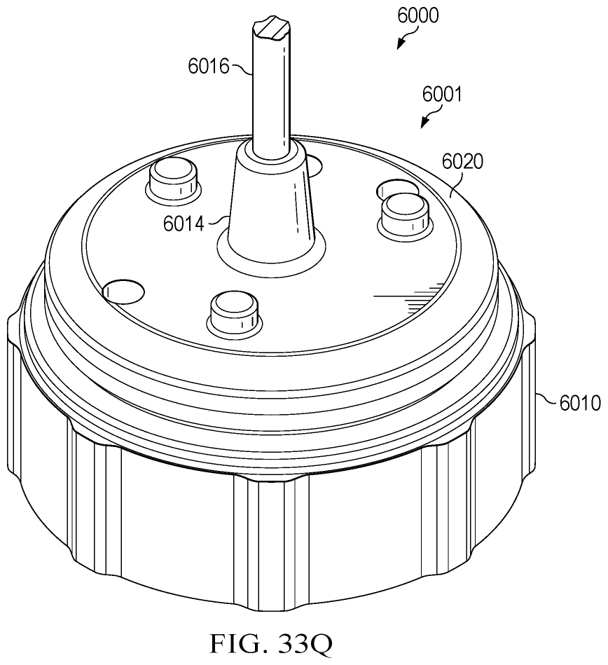

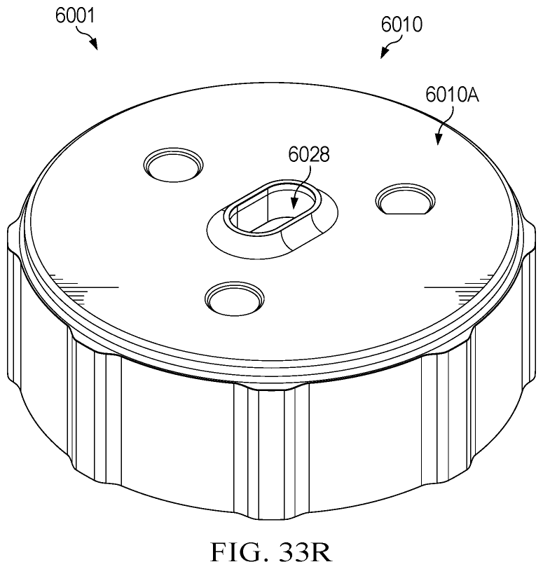

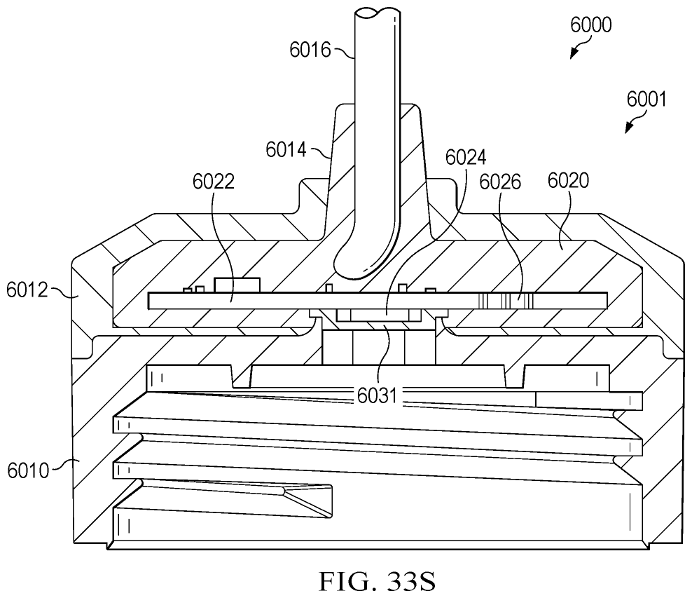

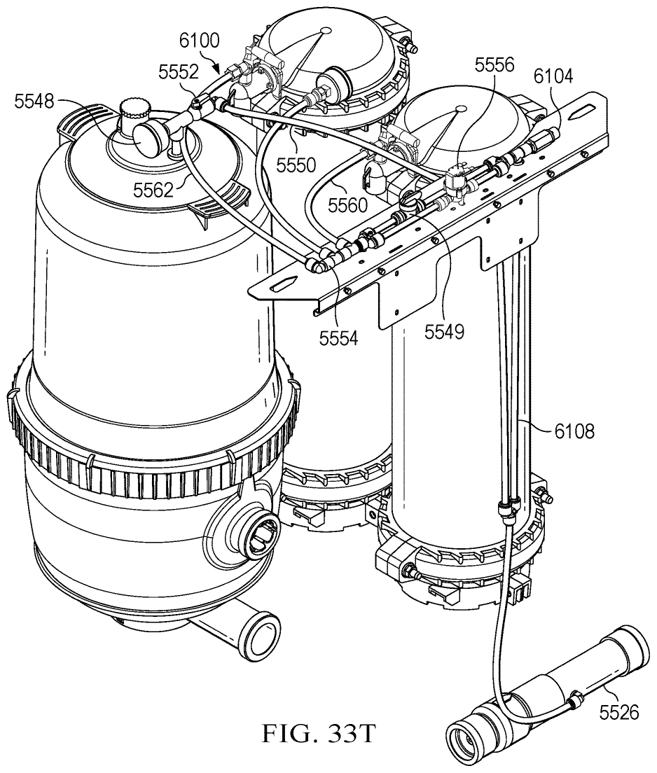

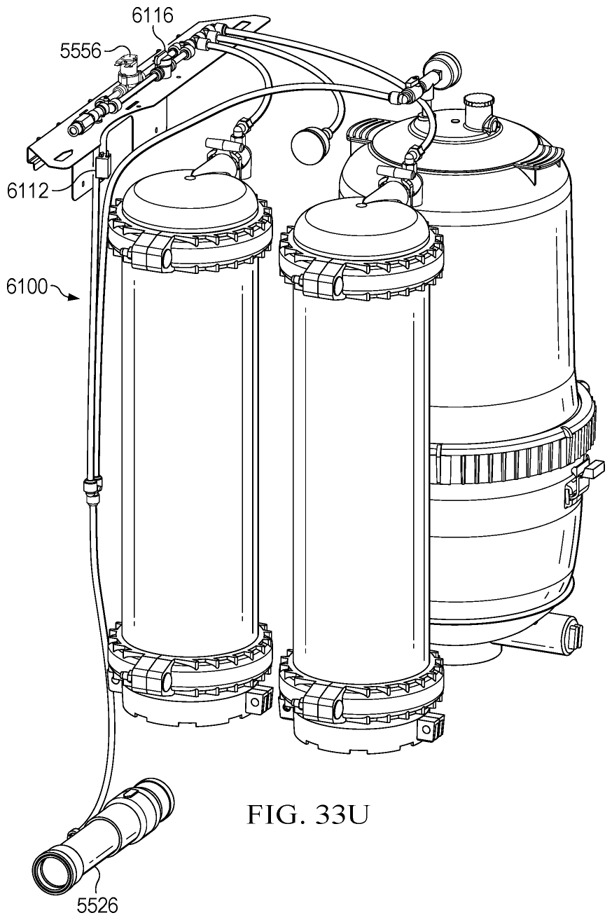

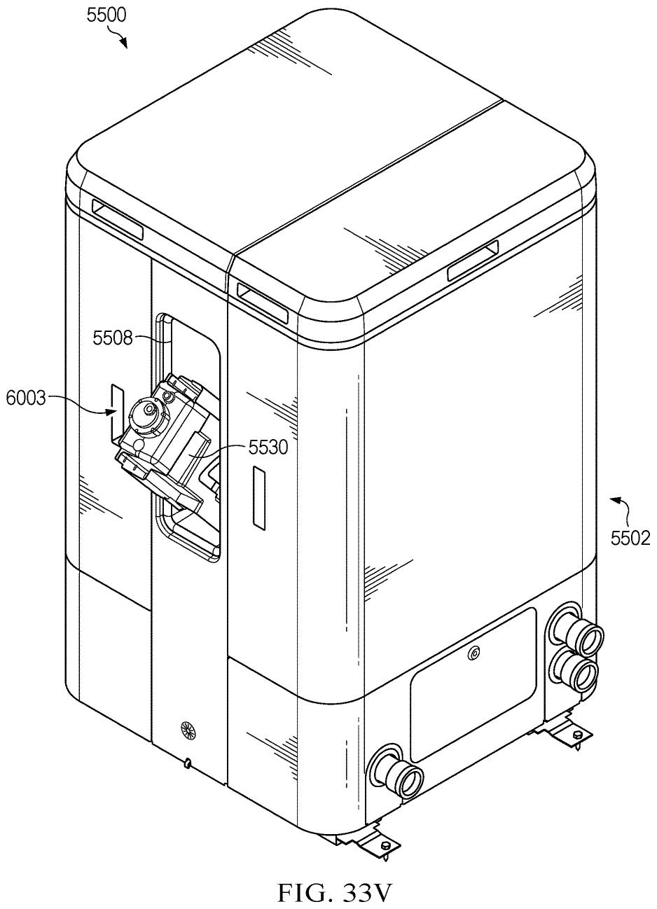

Referring broadly to FIGS. 33A-33V, another hybrid filter assembly 5500 is shown. In some instances, the hybrid filter assembly 5500 can be included in the aquatic application 100. In some instances, at least a portion of the methods described with reference to FIGS. 20-32 can be implemented in the hybrid filter assembly 5500. In some aspects, the methods 4250-5400 can include more or fewer steps depending on the instance.

Referring to FIG. 33A in particular, the hybrid filter assembly 5500 can include a housing 5502. In some instances, the housing 5502 can include a plurality of panels. In some instances, the housing 5502 can include a first panel 5504, a second panel 5506, a third panel 5508, and a fourth panel 5510. In some instances, one or more of the first panel 5504, the second panel 5506, the third panel 5508, and the fourth panel 5510 can be individually removed from the housing 5502. In this way, the housing 5502 can provide access to a technician to service one or more areas of the hybrid filter assembly 5500.

In some instances, the first panel 5504 and the second panel 5506 can collectively form a top surface or roof of the hybrid filter assembly 5500. In some instances, the third panel 5508 can be removed to provide access to a reservoir 5530 that will be described in conjunction with FIG. 33O below. The third panel may be removed to allow a user (e.g., a technician) to refill the reservoir 5530 with a chemical cleaning agent (see, e.g., FIG. 33V). Still referring to FIG. 33A, in some instances, the fourth panel 5510 can be removed to provide access to one or more components of the hybrid filter assembly 5500.

Still referring to FIG. 33A, the housing 5502 of the hybrid filter assembly 5500 has a generally rectangular geometric form defined by a plurality of panels arranged in cooperative relation to one another. As shown in FIG. 33A by non-limiting example, the housing 5502 may be formed by the first panel 5504, the second panel 5506, the third panel 5508, and the fourth panel 5510, where each of which defines one or more faces or surfaces of the housing 5502. When assembled, the first panel 5504, the second panel 5506, the third panel 5508, and the fourth panel 5510 are arranged to collectively define an enclosed interior volume within the housing 5502 in which one or more components of the hybrid filter assembly 5500 are housed and protected from the surrounding environment. It will be appreciated that the particular arrangement of panels described herein is illustrative, and that alternative arrangements, including housings formed by a greater or lesser number of panels, or panels of differing sizes, shapes, or orientations, would fall within the scope of the invention.

As shown in FIG. 33A by non-limiting example, the first panel 5504 and the second panel 5506 are arranged adjacent to one another and collectively form a top surface of the housing 5502 of the hybrid filter assembly 5500. In some instances, the first panel 5504 and the second panel 5506 can each extend horizontally and can be positioned in a side-by-side relationship along the top of the housing 5502, with each of the first panel 5504 and the second panel 5506 spanning a portion of the total width or depth of the top surface of the housing 5502. The first panel 5504 and the second panel 5506 can abut one another along a shared edge or seam to form a continuous top surface that encloses the interior of the housing 5502 from above. Although the first panel 5504 and the second panel 5506 are shown as forming the top surface of the housing 5502 in the illustrated instances, in other instances the top surface of the housing 5502 may be formed by a single panel or by more than two panels without departing from the scope of the invention.

The third panel 5508 and the fourth panel 5510 are each arranged to occupy one or more side, front, or rear faces of the housing 5502. As shown in FIG. 33A by non-limiting example, the third panel 5508 is arranged on a side or front face of the housing 5502 and, when in place, defines a portion of the outer perimeter wall of the housing 5502 enclosing the interior volume of the hybrid filter assembly 5500. The fourth panel 5510 is arranged on a side face of the housing 5502 and similarly defines a portion of the outer perimeter wall of the housing 5502. Together with the first panel 5504 and the second panel 5506, the third panel 5508 and the fourth panel 5510 cooperate to form the complete outer enclosure of the housing 5502. In some instances, one or more of the panels 5504, 5506, 5508, 5510 can be coupled to one another, or to an underlying frame or support structure of the hybrid filter assembly 5500, by way of one or more fasteners, clips, latches, hinges, or other releasable attachment mechanisms, such that the respective panel may be individually removed from the housing 5502 without requiring removal of any other panel. In other embodiments, one or more of the panels 5504, 5506, 5508, 5510 can be coupled to the housing 5502 by way of a sliding, snap-fit, or tool-free connection mechanism. It will be appreciated that alternative panel attachment configurations would fall within the scope of the invention. It is to be appreciated that the housing 5502 may be provided in other forms (e.g., with additional or fewer panels) and that the housing 5502 (or portions of the housing 5502) may be provided in a unitary structure.

By arranging the first panel 5504, the second panel 5506, the third panel 5508, and the fourth panel 5510 in the manner described above, the housing 5502 provides a structurally complete enclosure that helps to protect the internal components of the hybrid filter assembly 5500 while also allowing selective access to different areas of the hybrid filter assembly 5500 through individual panel removal. Because each panel can be independently removed without requiring disassembly of the remainder of the housing 5502, a technician can access specific internal components of the hybrid filter assembly 5500, such as the reservoir 5530 accessible through the third panel 5508, without disturbing or exposing other components within the housing 5502. This modular panel arrangement helps facilitate efficient maintenance and servicing of the hybrid filter assembly 5500 while maintaining the structural integrity of the housing 5502 during operation. It will be appreciated that in other instances, the housing 5502 may have a non-rectangular geometric form, including, by non-limiting example, a trapezoidal, L-shaped, or irregular profile, and may include additional panels or structural members arranged to define that alternative form, all of which would fall within the scope of the invention.

Referring to FIGS. 33B and 33C, the first panel 5504 and the second panel 5506 may include and/or be coupled to one or more support panels. As shown, in some instances, the first panel 5504 can include and/or be coupled to a first support panel 5512A and a second support panel 5512B. In some instances, the second panel 5506 can include and/or be coupled to a third support panel 5512C. Each of the one or more support panels 5512A-C can include a plurality of dimples. The one or more support panels 5512A-C can provide reinforcement to the first panel 5504 and/or the second panel 5506, which in turn may help provide the housing 5502 with the structural integrity to withstand snow load or other loads applied to the upper portion of the housing 5502.

In some instances, each of the first panel 5504 and/or the second panel 5506 may include and/or be coupled to a bracket for mounting the respective panel to a chassis (e.g., chassis 5538 shown in FIG. 33D) included in the hybrid filter assembly 5500. As shown, in some instances, the first panel 5504 can include and/or be coupled to a first bracket 5514A, and the second panel 5506 can include and/or be coupled to a second bracket 5514B.

Referring now to FIGS. 33D-33G, as well as FIGS. 33A-33C, in some instances, the hybrid filter assembly 5500 can include one or more of a prefilter 5516, one or more membrane module assemblies 5518, one or more conduits 5519, a valve 5520, a controller 5528, the reservoir 5530, a chemical dosing system 5532, a clean-in-place module 5534, a water quality monitor 5536, and/or a chassis 5538. In some instances, the prefilter 5516 can include and/or be the prefilter 310. Components of the hybrid filter assembly 5500 having the same or similar reference numerals and/or names as components of the hybrid filter assembly 200 may have substantially the same structure, function, and operation as the correspondingly numbered and/or named components of the hybrid filter assembly 200.

As shown, in some instances, the one or more membrane module assemblies 5518 can include a first membrane module assembly 5518A and a second membrane module assembly 5518B, although additional or fewer membrane module assemblies may also be provided in the hybrid filter assembly 5500. In some instances, the one or more membrane module assemblies 5518 can include one or more membrane modules. As shown, in some instances, the first membrane module assembly 5518A can include a membrane module 5586A. As shown, in some instances, the second membrane module assembly 5518B can include a membrane module 5586B.

In some instances, the membrane module 5586A of the first membrane module assembly 5518A can include a plurality of membranes. In some instances, the membrane module 5586A of the first membrane module assembly 5518A can perform substantially the same function as the first membrane filter 320a described above with reference to the hybrid filter assembly 200. In some instances, the membrane module 5586B of the second membrane module assembly 5518B can include a plurality of membranes. In some instances, the membrane module 5586B of the second membrane module assembly 5518B can include at least a portion of the second membrane filter 320b.

In some instances, the hybrid filter assembly 5500 can include a pool inlet port 5522, a pool outlet port 5524, and a drain port 5526. In some instances, the one or more conduits 5519 can include one or more of the inlet conduit 350a, the outlet conduit 350b, the waste conduit 350c, the membrane conduit 350d, the filtration conduit 350e, and the prefilter conduit 350f included in the hybrid filter assembly 200 of FIG. 2 described above. In some instances, the pool inlet port 5522, the pool outlet port 5524, and the drain port 5526 can be coupled to the valve 5520 via the one or more conduits 5519 as the pool inlet port 280a, the pool outlet port 280b, and the drain port 280c are coupled to the valve 400 via the inlet conduit 350a, the outlet conduit 350b, the waste conduit 350c, the membrane conduit 350d, the filtration conduit 350e, and the prefilter conduit 350f as described above in conjunction with the hybrid filter assembly 200 of FIG. 2. In some aspects, the valve 5520 may be configured as a five-way valve. In some instances, the valve 5520 may be the same valve as, or a valve of the same type as, the valve 400 described above in conjunction with FIGS. 9-14. For example, in certain instances, the valve 5520 may be a six-way AQUASTAR® mp6 plc valve, manufactured by Praher Plastics Austria GmbH of Österreich, Austria, as described above. It is to be appreciated that the valve 5520 may, in some instances, be provided as two or more valves that are configured to provide the functionality of a single five-way or six-way valve.

In some instances, the controller 5528 can be coupled to and in communication with one or more of the reservoir 5530, the chemical dosing system 5532, the clean-in-place module 5534, the water quality monitor 5536, and/or the valve 5520. In some instances, the controller 5528 can be coupled to the central controller 150 in FIG. 1. In some instances, the controller 5528 can implement at least a portion of the functionality of the central controller 150 in FIG. 1. In some instances, the controller 5528 can be the controller 340 in FIG. 7.

The reservoir 5530 can hold a chemical cleaning agent. In some instances, the chemical cleaning agent can be a chlorine solution or a chlorine-containing solution. In some instances, the chlorine solution can be a sodium hypochlorite solution. In some instances, the sodium hypochlorite solution can be a 10%-12.5% concentration sodium hypochlorite solution, although the sodium hypochlorite solution may also be provided in other concentrations.

The chemical cleaning agent held by the reservoir 5530 can be configured to clean one or more components of the hybrid filter assembly 5500. For example, the chemical cleaning agent can be configured to clean the membrane elements of the one or more membrane modules 5586A, 5586B of the one or more membrane module assemblies 5518A, 5518B. In this way, the chemical cleaning agent can remove fouling material, biological matter, scale, or other deposits that have accumulated on or within the membrane elements during filtration operation, thereby restoring membrane permeability and extending the operational life of the one or more membrane modules 5586A, 5586B. In some instances, the chemical cleaning agent can additionally be configured to clean one or more other components of the hybrid filter assembly 5500, including but not limited to internal conduits, ports, or other fluid-contacting surfaces of the hybrid filter assembly 5500 through which the chemical cleaning agent flows during a chemical cleaning procedure.

The reservoir 5530 can include one or more temperature sensors and/or one or more level sensors. In some instances, the reservoir 5530 can include a temperature sensor and/or a level sensor. In certain cases, the temperature sensor and/or a level sensor may be in contact with the chemical cleaning agent or may use other methods for indirectly measuring characteristics of the chemical cleaning agent (e.g., ultrasonic sensing, sensing the temperature of the air within the reservoir 5530). For example, and as illustrated and described with respect to FIG. 33S, the level sensor 6024 and the temperature sensor 6026 can each be disposed within the interior of a reservoir body 6000, in contact with the chemical cleaning agent held therein. For example, the level sensor 6024 and the temperature sensor 6026 can each be disposed and may be positioned and located in a cap 6001. In some instances, the level sensor 6024 and the temperature sensor 6026 can each be operably coupled to the central controller 150 to provide level and temperature information regarding the chemical cleaning agent within the reservoir 5530. The temperature sensor can be configured to sense the temperature associated with the reservoir 5530. In some instances, the temperature sensor can be configured to sense a temperature of a surface of the reservoir 5530. The level sensor can be configured to detect a level of fluid in the reservoir 5530. The fluid can be the chemical cleaning agent.

The reservoir 5530 can be coupled to and in fluid communication with the chemical dosing system 5532. More specifically, the reservoir 5530 can provide the chemical cleaning agent to the chemical dosing system 5532. The reservoir 5530 is described in detail further below in conjunction with FIGS. 330-33S.

Referring to FIGS. 33D, 33F, and 330, the reservoir 5530 of the hybrid filter assembly 5500 may include, in certain instances, a generally rectangular or box-shaped form defining an enclosed interior volume configured to hold a volume of the chemical cleaning agent. However, it is to be appreciated that the reservoir 5530 may also be provided in other geometric forms. As shown in FIG. 33O, the reservoir 5530 may include the reservoir body 6000, which defines the primary interior volume of the reservoir 5530. In some instances, the reservoir body 6000 can include a top surface, a bottom surface, and a plurality of side walls extending between the top surface and the bottom surface to define the enclosed interior volume. In some instances, the reservoir body 6000 can include a fill opening 6003 formed in the top surface of the reservoir body 6000, through which a user or technician may access the interior volume of the reservoir 5530 to refill the reservoir 5530 with a chemical cleaning agent. In some instances, the fill opening 6003 can be configured to receive a lid, cap, or top side 6004A that is removably coupled to the reservoir body 6000 to selectively seal the fill opening 6003 during operation of the hybrid filter assembly 5500. In some instances, the reservoir 5530 can further include one or more ports or fittings formed in or extending from the reservoir body 6000, through which the chemical cleaning agent within the interior volume of the reservoir 5530 can be delivered to the one or more membrane modules 5586A, 5586B during a chemical cleaning procedure. Referring also to FIGS. 33P and 33S, the reservoir 5530 can include additional structural features (e.g., 6012, 6014, 6016, 6020, 6022, 6024, 6026, and 6031), which may include one or more of a sensor port, a level indicator, a vent, additional inlet or outlet fittings, and structural mounting features configured to secure the reservoir 5530 within the housing 5502 of the hybrid filter assembly 5500. It will be appreciated that in other embodiments, the reservoir 5530 may have a different geometric form (including, for example, a cylindrical, tapered, or irregularly shaped body) without departing from the scope of the invention. Similarly, the size and interior volume of the reservoir 5530 may be varied to accommodate different volumes of chemical cleaning agent depending on the desired cleaning frequency and the capacity requirements of the hybrid filter assembly 5500.

In some instances, and referring to FIGS. 33E and 33F, the chemical dosing system 5532 can be configured to dispense the chemical cleaning agent to the one or more membrane modules 5586A, 5586B during a cleaning cycle. In some aspects, the chemical dosing system 5532 can include a pump configured to dispense the chemical. In some aspects, the pump can be a peristaltic pump. In some instances, the chemical dosing system 5532 can be the chemical dosing system 335 in FIG. 8 and described above.

In some instances, the clean-in-place module 5534 can be configured to circulate one or more chemical cleaning agents and/or fluid (e.g., water) within the one or more membrane modules 5586A, 5586B. In some instances, the one or more chemical cleaning agents circulated by the clean-in-place module 5534 can be sourced from the reservoir 5530, which holds a volume of the chemical cleaning agent available for use during a cleaning cycle. In some instances, the chemical dosing system 5532 can be configured to dispense the chemical cleaning agent from the reservoir 5530 to the clean-in-place module 5534 and/or directly to the one or more membrane modules 5586A, 5586B during a cleaning cycle.

The clean-in-place module 5534 can include a pump coupled to and in communication with the one or more membrane modules 5586A, 5586B. In some instances, during a chemical soak procedure, the central controller 150 may direct the clean-in-place module 5534 to circulate one or more chemical cleaning agents and/or fluid (e.g., water) within the one or more membrane modules 5586A, 5586B. In some instances, the clean-in-place module 5534 can be the clean-in-place module 345 in FIG. 6 and described above.

The water quality monitor 5536 (see FIG. 33D) can sense one or more water quality parameters of water exiting the hybrid filter assembly 5500. In some instances, the one or more water quality parameters sensed by the water quality monitor 5536 can include one or more of pH, turbidity, oxidation-reduction potential (ORP), free chlorine content, temperature, and/or other applicable water quality parameters of the water exiting the hybrid filter assembly 5500. In some instances, the water quality monitor 5536 can be coupled to and/or in fluid communication with a portion of the one or more conduits 5519 near the pool outlet port 5524.

As shown in FIG. 33F, in some instances, the hybrid filter assembly 5500 can include an electrical junction box 5568. In some instances, the electrical junction box 5568 can be coupled to an external power source. In some instances, the external power source can be an AC voltage power source.

The chassis 5538 can include one or more components configured to support, retain, and/or orient other components of the hybrid filter assembly 5500. In some instances, the chassis 5538 can support, retain, and/or orient one or more of the prefilter 5516, the one or more membrane module assemblies 5518, the one or more conduits 5519, the valve 5520, the controller 5528, the reservoir 5530, the chemical dosing system 5532, and/or the clean-in-place module 5534.

Referring to FIGS. 33D-33N, in some instances, the chassis 5538 can include one or more of a first chassis panel 5540, a second chassis panel 5542, a module brace 5544, a cross member 5546, and a plurality of support members 5547. The first chassis panel 5540 can form a base of the hybrid filter assembly 5500. In some instances, the first chassis panel 5540 can include a plurality of feet 5570. As shown, the first chassis panel 5540 can include a first foot 5570A and a second foot 5570B. In some instances, the feet 5570 can be sized to accept the forks of a forklift or other lifting machine. In some instances, each of the feet 5570 can be sized to accept a 2×4 piece of lumber. In some instances, the hybrid filter assembly 5500 can include one or more straps 5572. As shown, the hybrid filter assembly 5500 can include a first strap 5572A and a second strap 5572B. Each of the one or more straps 5572 can be sized to pass through one of the feet 5570 and be used to affix the hybrid filter assembly 5500 to a surface (e.g., a concrete pad). In some instances, the one or more straps 5572 can be passed through the feet 5570 and used to affix the hybrid filter assembly 5500 to a pool pad. In some instances, the one or more straps 5572 can be affixed to the pool pad using a plurality of fasteners. In some instances, the plurality of fasteners can include bolts and/or screws.

In some instances, the first chassis panel 5540 can be coupled to the chemical dosing system 5532 and/or the clean-in-place module 5534 and support at least a portion of the weight of the chemical dosing system 5532 and/or the clean-in-place module 5534. In some instances, the first chassis panel 5540 can be coupled to the valve 5520 and support at least a portion of the weight of the valve 5520.

The second chassis panel 5542 can form a second level of the hybrid filter assembly 5500. The second chassis panel 5542 can support at least a portion of the weight of the prefilter 5516 and the one or more membrane module assemblies 5518. In some instances, the second chassis panel 5542 can be coupled to and supported off of the first chassis panel 5540 by a first support member 5547A, a second support member 5547B, a third support member 5547C, and a fourth support member 5547D included in the plurality of support members 5547. In some instances, the first chassis panel 5540 can form a cutout 5566 that allows the valve 5520 to be removed from the hybrid filter assembly 5500 (e.g., for maintenance). In some instances, the second chassis panel 5542 can have a thickness of between about 0.05 inches and about 0.5 inches. In some instances, the second chassis panel 5542 can have a thickness of between about 0.08 inches and about 0.15 inches. In some instances, the second chassis panel 5542 can be about 0.1 inches thick. In some instances, the second chassis panel 5542 can be 0.1084 inches thick. It will be appreciated that the second chassis panel 5542 may have a thickness greater than or less than the values described herein without departing from the scope of the invention.

In some instances, the plurality of support members 5547 can include a fifth support member 5547E, a sixth support member 5547F, a seventh support member 5547G, an eighth support member 5547H, a ninth support member 5547I, and a tenth support member 5547J. The fifth support member 5547E and the sixth support member 5547F can be coupled to the first chassis panel 5540 and the tenth support member 5547J and support the tenth support member 5547J off of the first chassis panel 5540. The seventh support member 5547G and the eighth support member 5547H can be coupled to the first chassis panel 5540 and the ninth support member 5547I and support the ninth support member 5547I off of the first chassis panel 5540. In some instances, the seventh support member 5547G can be coupled to the controller 5528 and support at least a portion of the weight of the controller 5528.

In some instances, the cross member 5546 can be coupled to the ninth support member 5547I and the tenth support member 5547J. In some instances, the module brace 5544 can be coupled to the ninth support member 5547I and the tenth support member 5547J.

Referring to FIGS. 33T and 33U as well as FIGS. 33A-G, in some instances, the hybrid filter assembly 5500 can include a deaeration system 6100. In some instances, the deaeration system 6100 can include a first deaeration line 5550, a first manual deaeration valve 5552, a deaeration manifold 5554, an actuated deaeration valve 5556, a second deaeration line 5560, a third deaeration line 5562, a second manual deaeration valve 5549, a vacuum relief valve 6104, a drain line 6108, and a check valve 6116. In some instances, the hybrid filter assembly 5500 can include a first pressure sensor 5548, a second pressure sensor 5558, and a water presence sensor 6112. In some instances, the first pressure sensor 5548, the second pressure sensor 5558, and the water presence sensor 6112 can be included in the deaeration system 6100. In some instances, the first pressure sensor 5548 and/or the second pressure sensor 5558 can be manual pressure gauges. In this way, the first pressure sensor 5548 and/or the second pressure sensor 5558 may provide pressure readings to a user (e.g., a technician) who is servicing the hybrid filter assembly 5500.

In some instances, the first deaeration line 5550 can be coupled to and/or in fluid communication with the prefilter 5516. In some instances, the first pressure sensor 5548 can be coupled to and/or in fluid communication with the prefilter 5516 and configured to sense an internal pressure of the prefilter 5516. In some instances, the first manual deaeration valve 5552 can be coupled to and/or in fluid communication with the prefilter 5516 and configured to allow manual deaeration of the prefilter 5516 (e.g., by a technician). In some instances, the prefilter 5516 can be configured to passively deaerate by transferring entrapped air to the first membrane module assembly 5518A and/or the second membrane module assembly 5518B via the one or more conduits 5519.

In some instances, the second deaeration line 5560 can be coupled to and/or in fluid communication with the first membrane module assembly 5518A and the third deaeration line 5562 can be coupled to and/or in fluid communication with the second membrane module assembly 5518B. In some instances, the second deaeration line 5560 and the third deaeration line 5562 can be coupled to and/or in fluid communication with the deaeration manifold 5554. In some instances, the deaeration manifold 5554 can include a plurality of push-fit fittings.

In some instances, the second pressure sensor 5558 can be coupled to and/or in fluid communication with the deaeration manifold 5554 and configured to sense an internal pressure of one or more of the first membrane module assembly 5518A and/or the second membrane module assembly 5518B. In some instances, the actuated deaeration valve 5556 can be coupled to and/or in fluid communication with the deaeration manifold 5554 and configured to direct deaeration of one or more of the first membrane module assembly 5518A and/or the second membrane module assembly 5518B.

In some instances, the second manual deaeration valve 5549 can be coupled to and/or in fluid communication with the deaeration manifold 5554 and configured to direct deaeration of one or more of the first membrane module assembly 5518A and/or the second membrane module assembly 5518B. The second manual deaeration valve 5549 may be actuated by a user (e.g., a technician) during installation and/or maintenance.

Referring now to FIG. 33K as well as FIGS. 33A-G and 33T-U, in some instances, the hybrid filter assembly 5500 can include a third pressure sensor 6030, a fourth pressure sensor 6040, and a fifth pressure sensor 6050. In some instances, the third pressure sensor 6030 can be coupled to and/or in fluid communication with an inlet of the hybrid filter assembly 5500. In some instances, the fourth pressure sensor 6040 can be coupled to and/or in fluid communication with an outlet of the hybrid filter assembly 5500. In some instances, the fourth pressure sensor 6040 can be coupled to and/or in fluid communication with the effluent manifold 5599. In some instances, the fifth pressure sensor 6050 can be coupled to and/or in fluid communication with a portion of the one or more conduits 5519 between the prefilter 5516 and the membrane module assemblies 5518A, 5518B. In some instances, the fifth pressure sensor 6050 can be coupled to and/or in fluid communication with the influent manifold 5598. In some instances, the actuated deaeration valve 5556, the third pressure sensor 6030, the fourth pressure sensor 6040, and the fifth pressure sensor 6050 can be coupled to and/or in communication with the controller 5528. In some instances, the controller 5528 can receive pressure information from the third pressure sensor 6030, the fourth pressure sensor 6040, and/or the fifth pressure sensor 6050. In some instances, the controller 5528 can actuate the actuated deaeration valve 5556 to an open position and/or a closed position.

The drain line 6108 can be coupled to and/or in fluid communication with the deaeration manifold 5554, the actuated deaeration valve 5556, and the second manual deaeration valve 5549, and the drain port 5526, and configured to allow for drainage of the first membrane module assembly 5518A and/or the second membrane module assembly 5518B. The vacuum relief valve 6104 can allow air into the drain line 6108 during a deaeration process. The check valve 6116 can be coupled to and/or in fluid communication with the deaeration manifold 5554 and the actuated deaeration valve 5556. The check valve 6116 can allow fluid to flow into the actuated deaeration valve 5556 from the first membrane module assembly 5518A and/or the second membrane module assembly 5518B while preventing flow from the actuated deaeration valve 5556 to the first membrane module assembly 5518A and/or the second membrane module assembly 5518B.

The water presence sensor 6112 can be operably coupled to and in communication with the controller 5528. The water presence sensor 6112 can be coupled to and/or in fluid communication with the drain line 6108 and configured to detect the presence of water in the drain line 6108. In some instances, the controller 5528 can determine if the deaeration is complete and/or a valve position of the actuated deaeration valve 5556 based on information from the water presence sensor 6112.

In some instances, the controller 5528 can determine that deaeration is complete if water has been detected in the drain line 6108 for a predetermined time period based on information from the water presence sensor 6112. In some instances, the predetermined time period can be about twenty seconds. In some instances, the controller 5528 can determine that the valve is open or closed based on information from the water presence sensor 6112. In some instances, the controller 5528 can determine that the valve is open if water has been detected for a predetermined period of time. In some instances, the controller 5528 can determine that the valve is closed if water has not been detected for a predetermined period of time.

The chassis 5538 can be coupled to at least a portion of the deaeration system 6100. In some instances, the chassis 5538 can be coupled to the deaeration manifold 5554, the actuated deaeration valve 5556, and the second pressure sensor 5558. In some instances, the deaeration manifold 5554 and the actuated deaeration valve 5556 can be coupled to the ninth support member 5547I. The second pressure sensor 5558 can be coupled to the cross member 5546.

In some instances, the chassis 5538 can be selectively coupled to the first panel 5504 and/or the second panel 5506. In some instances, the ninth support member 5547I can include a first slot 5564A and a second slot 5564B, and the tenth support member 5547J can include a third slot 5564C and a fourth slot 5564D. The slots 5564A-D can receive the first bracket 5514A and the second bracket 5514B. More specifically, the second slot 5564B and the third slot 5564C can receive the first bracket 5514A, and the first slot 5564A and the fourth slot 5564D can receive the second bracket 5514B.

Referring to FIGS. 33H-I, as well as FIGS. 33A-33G, an illustrative membrane module assembly 5518C included in the one or more membrane module assemblies 5518 is shown. In some instances, each membrane module assembly included in the one or more membrane module assemblies 5518 can be the membrane module assembly 5518C. In some instances, the first membrane module assembly 5518A included in the hybrid filter assembly 5500 can be the membrane module assembly 5518C shown in FIGS. 33H-I. In some instances, the second membrane module assembly 5518B included in the hybrid filter assembly 5500 can be the membrane module assembly 5518C shown in FIGS. 33H-I.

In some instances, the membrane module assembly 5518C can include a membrane module 5586, a top cap 5574, a bottom cap 5576, an upper grooved coupling 5578, and a lower grooved coupling 5580. In some instances, the membrane module 5586 can include a plurality of membranes. In some instances, the plurality of membranes can include a plurality of hollow fiber membranes. In some instances, the upper grooved coupling 5578 can selectively couple the top cap 5574 to the membrane module 5586. In some instances, the lower grooved coupling 5580 can selectively couple the bottom cap 5576 to the membrane module 5586.

In some instances, the top cap 5574 can include a deaeration port 5588. In some instances, the bottom cap 5576 can include one or more wings or ears. In some instances, the bottom cap 5576 can include a first ear 5590 and a second ear 5592. In some instances, each ear included in the one or more ears can include an opening configured to accept a pin or other fastener. In some instances, the first ear 5590 can include a first opening 5591, and the second ear 5592 can include a second opening 5593.

In some instances, the upper grooved coupling 5578 can be selectively coupled to the top cap 5574 and the membrane module 5586 with one or more fasteners. In some instances, the membrane module assembly 5518C can include a first fastener 5582 and a second fastener 5583. In some instances, the upper grooved coupling 5578 can be selectively coupled to the top cap 5574 and the membrane module 5586 with the first fastener 5582 and the second fastener 5583. In some instances, each of the first fastener 5582 and the second fastener 5583 can be a nut and bolt.

In some instances, the lower grooved coupling 5580 can be selectively coupled to the bottom cap 5576 and the membrane module 5586 with one or more fasteners. In some instances, the membrane module assembly 5518C can include a third fastener 5584 and a fourth fastener 5585. In some instances, the lower grooved coupling 5580 can be selectively coupled to the bottom cap 5576 and the membrane module 5586 with the third fastener 5584 and the fourth fastener 5585. In some instances, each of the third fastener 5584 and the fourth fastener 5585 can be a nut and bolt.

In some instances, the membrane module assembly 5518C can include a permeate plug 5594 configured to prevent permeate generated by the membrane module 5586 from traveling into the top cap 5574. In some instances, the membrane module assembly 5518C can include an interconnector 5595, an influent port 5596, and an effluent port 5597. In some instances, the bottom cap 5576 can include one or more of the interconnector 5595, the influent port 5596, and the effluent port 5597. The influent port 5596 can provide incoming fluid to the membrane module 5586. In some instances, the incoming fluid can be water from the prefilter 5516. The interconnector 5595 can fluidly couple the effluent port 5597 to the membrane module 5586. Permeate produced by the membrane module 5586 can be output at the effluent port 5597.

In some instances, each of the first membrane module assembly 5518A and the second membrane module assembly 5518B included in the hybrid filter assembly 5500 can include at least a portion of the membrane module assembly 5518C shown in FIGS. 33H-I. In some instances, each of the first membrane module assembly 5518A and the second membrane module assembly 5518B included in the hybrid filter assembly 5500 can be the membrane module assembly 5518C shown in FIGS. 33H-I.

As shown in FIGS. 33D-G, the first membrane module assembly 5518A can include a top cap 5574A, a bottom cap 5576A, an upper grooved coupling 5578A, a lower grooved coupling 5580A, the membrane module 5586A, and a deaeration port 5588A. In some instances, the top cap 5574A, the bottom cap 5576A, the upper grooved coupling 5578A, the lower grooved coupling 5580A, the membrane module 5586A, and the deaeration port 5588A included in the first membrane module assembly 5518A can be the top cap 5574, the bottom cap 5576, the upper grooved coupling 5578, the lower grooved coupling 5580, the membrane module 5586, and the deaeration port 5588, respectively, included in the membrane module assembly 5518C shown in FIGS. 33H-I. In some instances, the second deaeration line 5560 can include an elbow or other connector that can be coupled to and/or in fluid communication with the deaeration port 5588A included in the first membrane module assembly 5518A. In some instances, the elbow or other connector can be a compression fitting. In some instances, the second deaeration line 5560 can be coupled to and/or in fluid communication with the deaeration port 5588A along with a clean-in-place line. In some instances, the clean-in-place line can be coupled to and/or in fluid communication with the deaeration port 5588A via a first connector, and the second deaeration line 5560 can be coupled to the first connector via a second connector. In some instances, a first clip 5551 included in the hybrid filter assembly 5500 can hold the first connector in place, further holding the second connector in place. It is noted that the deaeration port 5588A serves a dual function: in addition to routing air out of the membrane module 5586A during deaeration, the deaeration port 5588A also functions as a CIP port through which the corresponding clean-in-place line is coupled. While the port is referred to herein as the deaeration port 5588A consistent with its reference numeral designation throughout the drawings, it will be appreciated that this port facilitates both deaeration and clean-in-place functions.

As shown in FIGS. 33D-G, the second membrane module assembly 5518B can include a top cap 5574B, a bottom cap 5576B, an upper grooved coupling 5578B, a lower grooved coupling 5580B, the membrane module 5586B, and a deaeration port 5588B. In some instances, the top cap 5574B, the bottom cap 5576B, the upper grooved coupling 5578B, the lower grooved coupling 5580B, the membrane module 5586B, and the deaeration port 5588B included in the second membrane module assembly 5518B can be the top cap 5574, the bottom cap 5576, the upper grooved coupling 5578, the lower grooved coupling 5580, the membrane module 5586, and the deaeration port 5588, respectively, included in the membrane module assembly 5518C shown in FIGS. 33H-I. In some instances, the third deaeration line 5562 can include an elbow or other connector that can be coupled to the deaeration port 5588B included in the second membrane module assembly 5518B. In some instances, the elbow or other connector can be a compression fitting. In some instances, the third deaeration line 5562 can be coupled to and/or in fluid communication with the deaeration port 5588B along with a second clean-in-place line. In some instances, the second clean-in-place line can be coupled to and/or in fluid communication with the deaeration port 5588B via a third connector, and the third deaeration line 5562 can be coupled to the third connector via a fourth connector. In some instances, a second clip 5553 included in the hybrid filter assembly 5500 can hold the third connector in place, further holding the fourth connector in place.

Referring to FIGS. 33J-L as well as FIGS. 33A-33I, the one or more conduits 5519 can include an influent manifold 5598 and an effluent manifold 5599. The influent manifold 5598 can include a first influent manifold port 5598A and a second influent manifold port 5598B. The effluent manifold 5599 can include a first effluent manifold port 5599A and a second effluent manifold port 5599B.

The influent manifold 5598 can be coupled to and/or in fluid communication with an influent port included in each of the first membrane module assembly 5518A and the second membrane module assembly 5518B. More specifically, the first influent manifold port 5598A and the second influent manifold port 5598B can be coupled to and/or in fluid communication with the influent port (e.g., the influent port 5596 in FIG. 33I) included in each of the bottom cap 5576A of the first membrane module assembly 5518A and the bottom cap 5576B of the second membrane module assembly 5518B, respectively. In some instances, the influent manifold 5598 can also interface with the CIP system and can be retained using a retention method that is identical or substantially similar to the retention method used at the tops of the membrane module assemblies 5518A, 5518B, including the use of pins and mounts as described herein. However, unlike the tops of the membrane module assemblies 5518A, 5518B, the influent manifold 5598 does not interface with the deaeration system 6100. In some instances, the CIP system can further interact with a chlorine injector.

Similarly, the effluent manifold 5599 can be coupled to and/or in fluid communication with an effluent port included in each of the first membrane module assembly 5518A and the second membrane module assembly 5518B. More specifically, the first effluent manifold port 5599A and the second effluent manifold port 5599B can be coupled to and/or in fluid communication with the effluent port (e.g., the effluent port 5597 in FIG. 33I) included in each of the bottom cap 5576A of the first membrane module assembly 5518A and the bottom cap 5576B of the second membrane module assembly 5518B, respectively.

The first membrane module assembly 5518A and/or the second membrane module assembly 5518B may periodically require removal from the hybrid filter assembly 5500 for certain reasons, such as maintenance, replacement, and/or other servicing. The hybrid filter assembly 5500 can include multiple features that may assist a user (e.g., a technician) in removing, installing, and/or manufacturing the first membrane module assembly 5518A and/or the second membrane module assembly 5518B.

First, the hybrid filter assembly 5500 can help control alignment of the influent manifold 5598 and the effluent manifold 5599. The second chassis panel 5542 can form a first membrane module assembly slot 5543A and a second membrane module assembly slot 5543B. The first influent manifold port 5598A and the first effluent manifold port 5599A can extend upward (i.e., along the positive direction of the Z-axis in FIG. 33J) through the first membrane module assembly slot 5543A. The second influent manifold port 5598B and the second effluent manifold port 5599B can extend upward (i.e., along the positive direction of the Z-axis in FIG. 33J) through the second membrane module assembly slot 5543B. The first membrane module assembly slot 5543A and the second membrane module assembly slot 5543B may prevent excessive longitudinal movement (i.e., movement along the X-axis in FIG. 33J) of the influent manifold 5598 and the effluent manifold 5599, while allowing for lateral movement (i.e., along the Y-axis in FIG. 33J), which may ease installation of the first membrane module assembly 5518A and the second membrane module assembly 5518B during the initial manufacturing of the hybrid filter assembly 5500. The influent manifold 5598 and the effluent manifold 5599 may “float” and allow some movement before being tightened into place when coupled to the one or more conduits 5519. This movement can allow a user to couple the first membrane module assembly 5518A and the second membrane module assembly 5518B to the influent manifold 5598 and the effluent manifold 5599 before tightening the influent manifold 5598 and the effluent manifold 5599 into place, which can set the influent manifold 5598 and the effluent manifold 5599 at a proper alignment to receive replacement module assemblies.

Second, the hybrid filter assembly 5500 can retain each of the first membrane module assembly 5518A and the second membrane module assembly 5518B with a low number of connectors, which may result in faster installation and/or removal compared to other techniques. In some instances, the hybrid filter assembly 5500 can include a plurality of mounts and a plurality of pins. The plurality of mounts can include a first mount 5539A, a second mount 5539B, a third mount 5539C, a fourth mount 5539D, a first pin 5541A, a second pin 5541B, a third pin 5541C, and a fourth pin 5541D. In some instances, the first mount 5539A can be configured to accept the first pin 5541A, the second mount 5539B can be configured to accept the second pin 5541B, the third mount 5539C can be configured to accept the third pin 5541C, and the fourth mount 5539D can be configured to accept the fourth pin 5541D.

Each of the mounts 5539A-D can be coupled to the second chassis panel 5542. In some instances, one or more fasteners can affix each of the mounts 5539A-D to the second chassis panel 5542. Each of the pins 5541A-D can be inserted into an opening formed by an ear included in the bottom cap 5576A of the first membrane module assembly 5518A and/or the bottom cap 5576B of the second membrane module assembly 5518B.

The first pin 5541A and the second pin 5541B can be inserted into a portion of the first mount 5539A and the second mount 5539B, respectively, passed through openings (e.g., the first opening 5591 and the second opening 5593 in FIG. 33H) formed by ears (e.g., the first ear 5590 and the second ear 5592 in FIG. 33H) included in the bottom cap 5576A of the first membrane module assembly 5518A, and passed through another portion of the first mount 5539A and the second mount 5539B, respectively. When the first pin 5541A and the second pin 5541B are fully inserted into the first mount 5539A and the second mount 5539B, respectively, and passed through the ears included in the bottom cap 5576A of the first membrane module assembly 5518A, the first mount 5539A, the second mount 5539B, the first pin 5541A, and the second pin 5541B can collectively retain the first membrane module assembly 5518A.

The third pin 5541C and the fourth pin 5541D can be inserted into a portion of the third mount 5539C and the fourth mount 5539D, respectively, passed through openings (e.g., the first opening 5591 and the second opening 5593 in FIG. 33H) formed by ears (e.g., the first ear 5590 and the second ear 5592 in FIG. 33H) included in the bottom cap 5576B of the second membrane module assembly 5518B, and passed through another portion of the third mount 5539C and the fourth mount 5539D, respectively. When the third pin 5541C and the fourth pin 5541D are fully inserted into the third mount 5539C and the fourth mount 5539D, respectively, and passed through the ears included in the bottom cap 5576B of the second membrane module assembly 5518B, the third mount 5539C, the fourth mount 5539D, the third pin 5541C, and the fourth pin 5541D can collectively retain the second membrane module assembly 5518B.

In some instances, the first mount 5539A, the second mount 5539B, the first pin 5541A, and the second pin 5541B can allow for some lateral travel of the first membrane module assembly 5518A along the Y-axis in FIG. 33J without permitting much vertical travel along the Z-axis or longitudinal travel along the X-axis. Similarly, the third mount 5539C, the fourth mount 5539D, the third pin 5541C, and the fourth pin 5541D can allow for some lateral travel of the second membrane module assembly 5518B along the Y-axis in FIG. 33J without permitting much vertical travel along the Z-axis or longitudinal travel along the X-axis.

Allowing lateral travel without longitudinal or vertical travel may allow for coupling of the first membrane module assembly 5518A and/or the second membrane module assembly 5518B to the influent manifold 5598 and the effluent manifold 5599 for a range of lateral positions of the influent manifold 5598 and the effluent manifold 5599, which may vary based on the manufacturing process, while preventing other movement of the first membrane module assembly 5518A and/or the second membrane module assembly 5518B. In particular, the first mount 5539A, the second mount 5539B, the first pin 5541A, and the second pin 5541B can keep the first membrane module assembly 5518A in place and coupled to the influent manifold 5598 and the effluent manifold 5599 when the hybrid filter assembly 5500 is undergoing pressurization. Similarly, the third mount 5539C, the fourth mount 5539D, the third pin 5541C, and the fourth pin 5541D can keep the second membrane module assembly 5518B in place and coupled to the influent manifold 5598 and the effluent manifold 5599 when the hybrid filter assembly 5500 is undergoing pressurization.

The user can remove the first pin 5541A and the second pin 5541B and then remove the first membrane module assembly 5518A from the influent manifold 5598 and the effluent manifold 5599 (e.g., by moving the first membrane module assembly 5518A in a positive direction along the Z-axis) to dismount the first membrane module assembly 5518A. The user can remove the third pin 5541C and the fourth pin 5541D and then remove the second membrane module assembly 5518B from the influent manifold 5598 and the effluent manifold 5599 (e.g., by moving the second membrane module assembly 5518B in a positive direction along the Z-axis) to dismount the second membrane module assembly 5518B.

After mounting the first membrane module assembly 5518A and the second membrane module assembly 5518B, the second deaeration line 5560 and the third deaeration line 5562 can be coupled to the first membrane module assembly 5518A and the second membrane module assembly 5518B, respectively. The user can couple the second deaeration line 5560 and the third deaeration line 5562, along with the corresponding clean-in-place lines, to the first membrane module assembly 5518A and the second membrane module assembly 5518B, respectively, then secure the second deaeration line 5560 by securing a connector coupled to the second deaeration line 5560 and the corresponding clean-in-place line with the first clip 5551 and the third deaeration line 5562 and the corresponding clean-in-place line with the second clip 5553, respectively. Each of the first clip 5551 and the second clip 5553 can be a snap-fit CIP retention clip.

Third, during installation or removal of the first membrane module assembly 5518A and the second membrane module assembly 5518B, the hybrid filter assembly 5500 can temporarily retain the second deaeration line 5560 and/or the third deaeration line 5562 while they are decoupled from the first membrane module assembly 5518A and/or the second membrane module assembly 5518B, respectively. Turning to FIG. 33M as well as FIGS. 33A-33L, the cross member 5546 can include a first docking opening 5561 and a second docking opening 5563.

The first docking opening 5561 can be configured to accept a portion of the second deaeration line 5560 and/or the corresponding clean-in-place line and temporarily retain the second deaeration line 5560 and/or the corresponding clean-in-place line near the first membrane module assembly 5518A. In some instances, the first docking opening 5561 can be configured to accept an elbow or other connector included in the second deaeration line 5560 and/or the corresponding clean-in-place line. The second docking opening 5563 can be configured to accept a portion of the third deaeration line 5562 and/or the corresponding clean-in-place line and temporarily retain the third deaeration line 5562 and/or the corresponding clean-in-place line near the second membrane module assembly 5518B. In some instances, the second docking opening 5563 can be configured to accept an elbow or other connector included in the third deaeration line 5562 and/or the corresponding clean-in-place line. The first docking opening 5561 and/or the second docking opening 5563 can assist a user installing or removing the first membrane module assembly 5518A and/or the second membrane module assembly 5518B by retaining the second deaeration line 5560 and/or the corresponding clean-in-place line, and/or the third deaeration line 5562 and/or the corresponding clean-in-place line in a manner that keeps the second deaeration line 5560 and/or the corresponding clean-in-place line, and/or the third deaeration line 5562 and/or the corresponding clean-in-place line out of the way of the mounting of the first membrane module assembly 5518A and/or the second membrane module assembly 5518B. Furthermore, the first docking opening 5561 and/or the second docking opening 5563 may keep the second deaeration line 5560 and/or the corresponding clean-in-place line, and/or the third deaeration line 5562 and/or the corresponding clean-in-place line from getting tangled or otherwise disorganized as a result of being dropped when decoupled from the first membrane module assembly 5518A and/or the second membrane module assembly 5518B. In some instances, once the elbows or other connectors included in the second deaeration line 5560 and/or the third deaeration line 5562 and/or the corresponding clean-in-place lines are seated in the first docking opening 5561 and/or the second docking opening 5563, respectively, the first clip 5551 and/or the second clip 5553 can be applied to further retain the elbows or other connectors within the first docking opening 5561 and/or the second docking opening 5563. Retaining the elbows or other connectors in this manner using the first clip 5551 and/or the second clip 5553 can help prevent the elbows or other connectors from becoming lost or misplaced during servicing of the hybrid filter assembly 5500.

The cross member 5546 can include a pressure gauge mount 5559. The pressure gauge mount 5559 can retain the second pressure sensor 5558, which in some instances can be a pressure gauge configured to provide an analog pressure reading rather than a digital output signal. In some instances, the pressure gauge mount 5559 can be an opening formed in the cross member 5546, such as a notched opening formed in a sheet metal panel, through which the pressure gauge assembly can be inserted and then dropped down into place. In some instances, the pressure gauge assembly can include a square notch configured to key the pressure gauge in the correct orientation when seated in the pressure gauge mount 5559, thereby ensuring consistent alignment of the pressure gauge during installation.

Referring now to FIG. 33N as well as FIGS. 33A-33M, the module brace 5544 can include and/or form one or more attachment points. In some instances, the module brace 5544 can include a first attachment point 5545A, a second attachment point 5545B, a third attachment point 5545C, and a fourth attachment point 5545D. In some instances, each of the first attachment point 5545A, the second attachment point 5545B, the third attachment point 5545C, and the fourth attachment point 5545D can be openings formed in the module brace 5544 and configured to accept a zip tie.

In some instances, a zip tie can be passed through the first attachment point 5545A and the second attachment point 5545B and around the first membrane module assembly 5518A to retain the first membrane module assembly 5518A during certain applications, such as shipping and/or transport of the hybrid filter assembly 5500. In some instances, a zip tie can be passed through the third attachment point 5545C and the fourth attachment point 5545D and around the second membrane module assembly 5518B to retain the second membrane module assembly 5518B during certain applications, such as shipping and/or transport of the hybrid filter assembly 5500.

In some instances, the module brace 5544 can provide a stabilizing force to the first membrane module assembly 5518A and/or the second membrane module assembly 5518B. During operation, the first membrane module assembly 5518A and/or the second membrane module assembly 5518B may rotate around the X-axis towards the module brace 5544 as a result of influent and effluent fluids entering and exiting the first membrane module assembly 5518A and/or the second membrane module assembly 5518B. The module brace 5544 may impede further movement of the first membrane module assembly 5518A and/or the second membrane module assembly 5518B by preventing further rotation of the first membrane module assembly 5518A and/or the second membrane module assembly 5518B past the module brace 5544.

Referring now to FIG. 33O, as well as FIGS. 33A-N, an illustrative instance of the reservoir 5530 can include the cap 6001, a one-way check valve 6002, a tank 6004, and a diverter valve 6006. In some instances, the cap 6001, the one-way check valve 6002, the tank 6004, and the diverter valve 6006 may together comprise the reservoir body 6000, although each of the cap 6001, the one-way check valve 6002, the tank 6004, and the diverter valve 6006 may also be provided as separate, standalone components from the reservoir body 6000. The tank 6004 can be an HDPE blow-molded tank. In some instances, the tank can include threads configured to allow coupling with the cap 6001. In some instances, the threads can include buttress threads. The tank 6004 can be configured to hold a volume of the chemical cleaning agent.

The one-way check valve 6002 can be coupled to and/or in fluid communication with the tank 6004. In some instances, the one-way check valve 6002 can be coupled to and/or in fluid communication with a top side 6004A of the tank 6004. In some instances, the one-way check valve 6002 can be configured to allow air into the tank 6004 when the chemical cleaning agent leaves the tank 6004 (e.g., during dosing). In some instances, the one-way check valve 6002 can actuate to an open position, allowing air to enter the tank 6004 at a cracking pressure. In some instances, the cracking pressure can be less than 1 psi. In some instances, the cracking pressure can be less than 0.5 psi. In some instances, the cracking pressure can be about 0.33 psi. In some instances, the cracking pressure can be 0.33 psi.

The diverter valve 6006 can be coupled to and/or in fluid communication with the tank 6004. In some instances, the diverter valve 6006 can be coupled to and/or in fluid communication with a bottom side 6004B of the tank 6004. In some instances, the diverter valve 6006 can be a manually actuated valve. In some instances, the diverter valve 6006 can be configured to selectively fluidly couple the tank 6004 to either the chemical dosing system 5532 or to a drain and/or the drain port 5526.

Referring now to FIGS. 33P-S, as well as FIGS. 33A-O, in some instances, the cap 6001 can include a base portion 6010 and a top portion 6012, and a printed circuit board assembly (PCBA) portion 6020. The base portion 6010 can form an opening 6028 in a top surface 6010A of the base portion 6010. The PCBA portion 6020 can be coupled to the base portion 6010. In some instances, the PCBA portion 6020 can be coupled to at least a portion of the top surface 6010A of the base portion 6010 and positioned over the opening 6028.

In some instances, the cap 6001 can include and/or be coupled to an electrical cord 6016. The electrical cord 6016 may be coupled to the PCBA portion 6020. The electrical cord 6016 may provide power and/or communication to the cap 6001.

In some instances, the PCBA portion 6020 can include a tapered portion 6014 configured to provide physical protection to the electrical cord 6016. More specifically, the tapered portion 6014 may prevent the electrical cord 6016 from being decoupled from the PCBA portion 6020 due to forces pulling on the electrical cord 6016 and/or kinking of the electrical cord 6016 near the PCBA portion 6020.

In some instances, the PCBA portion 6020 can include a board 6022, a level sensor 6024, and a temperature sensor 6026. In some instances, the level sensor 6024 and the temperature sensor 6026 can be coupled to the board 6022. In some instances, the board 6022 can be a printed circuit board. In some instances, the board 6022 can be operably coupled to the electrical cord 6016.

The level sensor 6024 can be coupled to the board 6022 and positioned over the opening 6028. When the cap 6001 is coupled to the tank 6004, the level sensor 6024 can detect a level of fluid in the tank 6004. In some instances, the level sensor 6024 can be a time-of-flight sensor. In some instances, the time-of-flight sensor can be an infrared sensor. In some instances, the infrared sensor can include an infrared emitting laser configured to measure distance by timing reflected infrared light. In some instances, the level sensor 6024 can be a VL53L5CX time-of-flight sensor.

In some instances, the level sensor 6024 can be positioned over the opening 6028 and configured to measure a level of fluid in the tank 6004. In some instances, the level sensor 6024 can be positioned over the opening 6028 and configured to measure a level of fluid in the tank 6004 using time of flight from the sensor 6024 to the top of the fluid (e.g., the chemical cleaning agent) in the tank 6004. In some instances, the level sensor 6024 can be positioned over the opening 6028 and configured to measure a level of fluid in the tank 6004 by emitting and receiving infrared light through the opening 6028. The opening 6028 can be sized large enough to allow for a sufficient field of view for the level sensor 6024 while also being small enough to minimize exposure of the board 6022 to the chemical cleaning agent in the tank 6004. In some instances, the board 6022 and/or the cap 6001 can include a slide 6031 positioned between the level sensor 6024 and the opening 6028. In some instances, the slide 6031 can be formed from a see-through material. In some instances, the slide 6031 can be a plastic. In some instances, the slide 6031 can be a CG-VL53L5 VL53L5 cover glass.

In some instances, the temperature sensor 6026 can be a thermistor. In some instances, the thermistor can be a negative temperature coefficient (NTC) thermistor. In some instances, the temperature sensor 6026 can be a digital temperature sensor.

The temperature sensor 6026 can be configured to sense a temperature of the reservoir 5530. In some instances, the temperature sensor 6026 can be configured to sense a temperature of the cap 6001. In some aspects, the temperature of the cap 6001 can be correlated to the temperature of the tank 6004 and/or the chemical cleaning agent in the tank 6004, which may be helpful in determining chlorine concentration. As best seen in FIG. 33S, the PCBA portion 6020 can be an overmolded construction overmolding at least a portion of the board 6022.

Referring now to FIG. 33V as well as FIG. 33A, the hybrid filter assembly 5500 is shown with the third panel 5508 in an open position to illustrate access to the reservoir 5530 disposed within the housing 5502. As described above with reference to FIG. 33A, the third panel 5508 is arranged on a side front face of the housing 5502 and defines a portion of the outer perimeter wall of the housing 5502. In the instance shown in FIG. 33V, the third panel 5508 has been moved to the open position to expose the reservoir 5530 and one or more internal components of the hybrid filter assembly 5500 accessible through the third panel 5508. As shown, with the third panel 5508 in the open position, a user (e.g., a technician) may access the reservoir 5530 and, in particular, refill the reservoir 5530 with a chemical cleaning agent. As described above with reference to FIG. 33O, the reservoir 5530 may include a reservoir body 6000 having a fill opening 6003 formed in the top surface of the reservoir body 6000, through which a user or technician may access the interior volume of the reservoir 5530 to refill the reservoir 5530 with a chemical cleaning agent. As described above, the chemical cleaning agent held by the reservoir 5530 can be a chlorine solution, such as a sodium hypochlorite solution, and can be configured to clean one or more components of the hybrid filter assembly 5500, including the membrane elements of the one or more membrane modules 5586A, 5586B. Because the third panel 5508 can be independently removed or opened without requiring disassembly of the remainder of the housing 5502, a technician can access the reservoir 5530 without disturbing or exposing other components within the housing 5502.

As also shown in FIG. 33V, in some instances, the third panel 5508 can be coupled to the housing 5502 by way of one or more hinges, latches, fasteners, or other releasable attachment mechanisms that permit the third panel 5508 to be selectively moved between a closed position and an open position without requiring removal of any other panel of the housing 5502. In some instances, the third panel 5508 can be coupled to the housing 5502 along one edge by one or more hinges such that the third panel 5508 swings outwardly away from the housing 5502 when moved to the open position. In other instances, the third panel 5508 can be fully detached from the housing 5502 and removed entirely to provide access to the reservoir 5530. In some instances, one or more latches or fasteners may secure the third panel 5508 in the closed position during normal operation of the hybrid filter assembly 5500, and a technician may release those latches or fasteners to open or remove the third panel 5508 as needed for servicing. It will be appreciated that alternative attachment and access configurations for the third panel 5508 would fall within the scope of the invention.

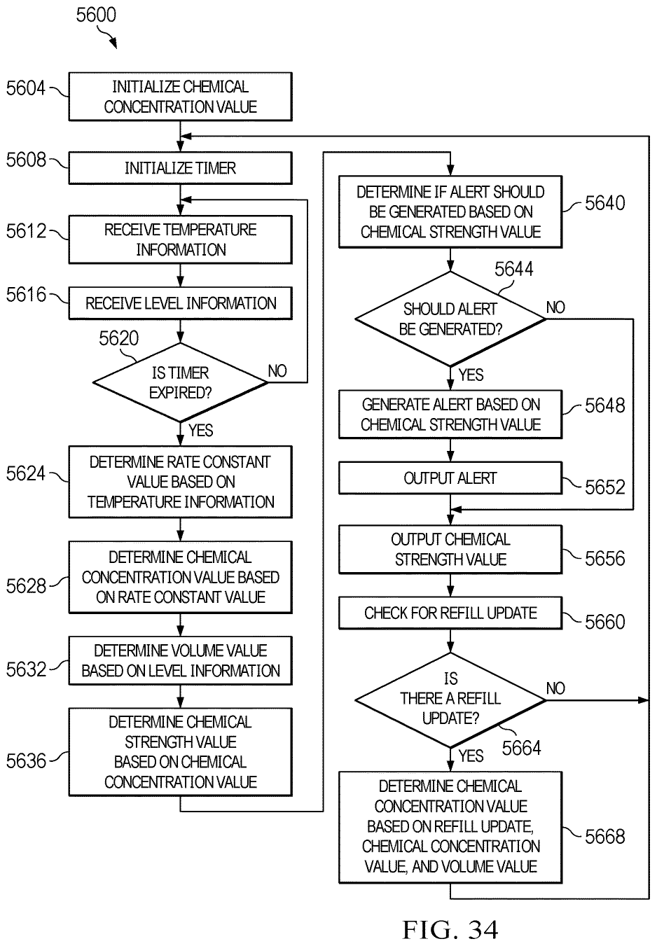

Turning now to FIG. 34, a method 5600 for updating a chlorine concentration value is shown. The method 5600 can be utilized in a pool automation system, a controller (e.g., the central controller 150 of FIG. 1, the controller 5528 of FIG. 33D, and/or any other controller associated with the pool components 102), or an aquatic environment (e.g., aquatic application 100 of FIG. 1) that includes a hybrid filter assembly provided in the form of a first filtration stage and a second filtration stage (e.g., a prefilter and one or more membrane filters). In some instances, the prefilter can be a granular-bed depth-type filter, such as a sand filter or a glass filter (e.g., an activated glass filter). In some instances, the depth-type filter can include a pre-coat type media, such as diatomaceous earth. In some instances, the method 5600 can be implemented as computer-readable instructions on a non-transitory medium (e.g., a random access memory, a hard drive, etc.) and executed by a processor (e.g., a CPU, a GPU, etc.). For example, the method 5600 may be implemented on a non-transitory medium and executed by a processor of a central controller (e.g., the central controller 150).

At 5604, the central controller 150 can initialize a chemical concentration value. The chemical concentration value can be denoted as C in Formula XI described further below. In some instances, the chemical concentration value can be a percentage value. The chemical concentration value can indicate a relative strength of a chemical cleaning agent. In some instances, an initial volume of the chemical cleaning agent can be added to the clean-in-place module 345. In some instances, the chemical cleaning agent can be a chlorine solution. In some instances, the chlorine solution can be a sodium hypochlorite solution. In some instances, the sodium hypochlorite solution can be a 10%-12% concentration sodium hypochlorite solution, although the concentration of the sodium hypochlorite solution may be greater than or less than these values. In some instances, the central controller 150 can set the chemical concentration value equal to the concentration of the chemical cleaning agent (e.g., the chlorine solution, the sodium hypochlorite solution, etc.). For example, in some instances, the central controller 150 can set the chemical concentration value equal to the concentration of the sodium hypochlorite solution.

In some instances, at 5604, the central controller 150 can initialize a volume value. In some instances, the central controller 150 can set the volume value equal to a predetermined maximum fill volume value. In some instances, the central controller 150 can determine the volume value based on level information from the level sensor coupled to and/or included in a reservoir retaining the chemical cleaning agent (e.g., the reservoir 5530).

At 5608, the central controller 150 can initialize a timer. In some instances, the timer can be configured to count down from a predetermined time period value. In some instances, the predetermined time period value can be about 30 minutes to about 120 minutes (or 30 minutes to 120 minutes), although the predetermined time period may be less than or greater than these values. For example, the predetermined time period value may be about 40 minutes to about 100 minutes (or 40 minutes to 100 minutes), or about 60 minutes to about 80 minutes (or 60 minutes to 80 minutes). In some instances, the predetermined time period can be about sixty minutes. In an instance, the predetermined time period is sixty minutes. In various cases, the predetermined time period may be less than about 60 minutes (or less than 60 minutes).

At 5612, the central controller 150 can receive temperature information. In some instances, the central controller 150 can receive the temperature information from the temperature sensor coupled to and/or included in the reservoir (e.g., the reservoir 5530). In some instances, the temperature information can include one or more temperature values. In some instances, the temperature values can be Celsius temperature values or Fahrenheit temperature values. In some instances, each temperature value included in the one or more temperature values can be associated with a time value.

At 5616, the central controller 150 can receive level information. In some instances, the central controller 150 can receive the level information from the level sensor coupled to and/or included in the reservoir 5530. In some instances, the level information can include one or more level values. In some instances, each of the one or more level values can indicate a relative fill level of the reservoir (e.g., 60%). In some instances, each of the one or more level values can indicate a fill volume of the reservoir (e.g., 0.5 gallons). In some instances, the level values can be percentage values (e.g., 75%). In some instances, each level value included in the one or more level values can be associated with a time value.

At 5620, the central controller 150 can determine if the timer is expired. The central controller 150 can determine that the timer is expired if the timer is equal to zero (e.g., zero seconds). The central controller 150 can determine that the timer is not expired if the timer is greater than zero (e.g., twelve minutes). If the central controller 150 determines that the timer is not expired (e.g., “NO” at 5620), the method 5600 can proceed to 5612. If the central controller 150 determines that the timer is expired (e.g., “YES” at 5620), the method 5600 can proceed to 5624.

At 5624, the central controller 150 can determine a rate constant value based on the temperature information. In some instances, the central controller 150 can calculate the rate constant value based on Formula X.

$$k = m * {n}^{( \frac{( T - o )}{p} )} \qquad Formula X$$

In Formula X, k is the rate constant value, m is a first constant value, n is a second constant value, T is temperature value, o is a third constant value, and p is a fourth constant value. In some instances, the first constant value can be 0.000073, the second constant value can be 2.6929, the third constant value can be 20, and the fourth constant value can be 10. In some instances, the first constant value can be about 0.001 to 0.00001, and the second constant value can be 1.21 to 4.68. In some instances, the first constant value can be 0.001, and the second constant value can be 1.21. In some instances, the first constant value can be 0.00001, and the second constant value can be 4.68. In some instances, the third constant value can be a calculation reference temperature value, and may vary in different applications based on the first constant value, the second constant value, and/or the fourth constant value. In some instances, the fourth constant value can be a temperature range parameter value, and may vary in different applications based on the first constant value, the second constant value, and/or the third constant value. The central controller 150 can calculate the temperature value based on the temperature information received at 5612. In some instances, the central controller 150 can calculate the temperature value as the mean of the one or more temperature values included in the temperature information. In this way, the temperature value can indicate an average temperature of the reservoir 5530 over the preceding timer period (e.g., the previous sixty minutes).

At 5628, the central controller 150 can determine a chemical concentration value based on the rate constant value. In some instances, the central controller 150 can determine the chemical concentration value based on Formula XI.

C=C₀*exp(−k*1.0) Formula XI

In Formula XI, C is the chemical concentration value, C₀ is the starting concentration value, and k is the rate constant value from Formula X.

At 5632, the central controller 150 can determine a volume value based on the level information. In some instances, the central controller 150 can set the volume value equal to a mean value of the one or more level values included in the level information. In some instances, the central controller 150 can set the volume value equal to the difference between the mean value and a predetermined constant value. In some instances, the predetermined constant value can be 0.00125.

At 5636, the central controller 150 can determine a chemical strength value based on the chemical concentration value. In some instances, the central controller 150 can set the chemical strength value to a product of the chemical concentration value and a predetermined constant value. In some instances, the predetermined constant value can be 800.

At 5640, the central controller 150 can determine if an alert should be generated based on the chemical strength value. In some instances, the central controller 150 can determine that the alert should be generated if the chemical strength value is less than a predetermined strength threshold value. In some instances, the predetermined strength threshold value can be 60%. In some aspects, when the chemical strength value is below 60%, the effectiveness of the chemical cleaning agent is significantly diminished.

At 5644, if the central controller 150 determined that the alert should not be generated (e.g., “NO” at 5644), the method 5600 can proceed to 5656. If the central controller 150 determined that the alert should be generated (e.g., “YES” at 5644), the method 5600 can proceed to 5648.

At 5648, the central controller 150 can generate an alert based on the chemical strength value. In some instances, the alert can include the chemical strength value and/or an indication that the effectiveness of the chemical cleaning agent is diminished.

At 5652, the central controller 150 can output the alert. In some instances, the central controller 150 can direct the alert to be displayed to a user. In some instances, the central controller 150 can direct the alert to be displayed at the user device 160.

At 5656, the central controller 150 can output the chemical strength value. In some instances, the central controller 150 can direct the chemical strength value to be displayed to a user. In some instances, the central controller 150 can direct the chemical strength value to be displayed at the user device 160.

At 5660, the central controller 150 can check for a refill update. In some instances, the central controller 150 can receive an indication that the reservoir 5530 has been filled with an additional volume of chemical cleaning agent. In some instances, the indication can include a refill strength value. In some instances, the refill strength value can be a relative strength value indicating the relative strength of the additional volume compared to the initial strength of a previous fill of the chemical cleaning agent. For example, if the previous fill was 12.5% sodium hypochlorite, and the additional volume was 10% sodium hypochlorite, the relative strength value can be 80%. In some instances, the refill strength value can be the concentration of the additional volume of the chemical cleaning agent. In some instances, the central controller 150 can receive level information from the level sensor coupled to and/or included in the reservoir 5530 and determine a refill volume value indicative of the volume of the additional volume. In some instances, the central controller 150 can determine that a refill has occurred based on level information from the level sensor coupled to and/or included in the reservoir 5530.

At 5664, if the central controller 150 received an indication that the reservoir 5530 had been filled with an additional volume of chemical cleaning agent (i.e., “YES” at 5664), the method 5600 can proceed to 5668. If the central controller 150 did not receive an indication that the reservoir 5530 had been filled with an additional volume of chemical cleaning agent (i.e., “NO” at 5664), the method 5600 can proceed to 5608.

At 5668, the central controller 150 can determine an updated chemical concentration value based on the indication that the reservoir 5530 has been filled with an additional volume of chemical cleaning agent, the chemical concentration value, and the volume value. In some instances, the method 5600 can determine the updated chemical concentration value based on a product of the volume value and the chemical concentration value. In some instances, the central controller 150 can set the updated chemical concentration value equal to a sum of a predetermined constant value and the product of the volume value and the chemical concentration value. In some instances, the predetermined constant value can be 0.1125. The predetermined constant value may be used at a predetermined refill volume and refill strength setpoint. For example, if the additional volume is a 90% refill of 12.5% sodium hypochlorite, the predetermined constant value can be 0.1125. The predetermined constant value can be associated with the additional volume of chemical cleaning agent added to the reservoir 5530. In some instances, the central controller 150 can determine a refill concentration value based on the refill volume value and the refill strength value. In some instances, the central controller 150 can set the refill concentration value equal to the product of the refill volume value and the refill strength value. In some instances, the central controller 150 can calculate an actual concentration value based on the refill strength value if the refill strength value is a relative strength value, and then set the refill concentration value equal to the product of the refill volume value and the actual concentration value.

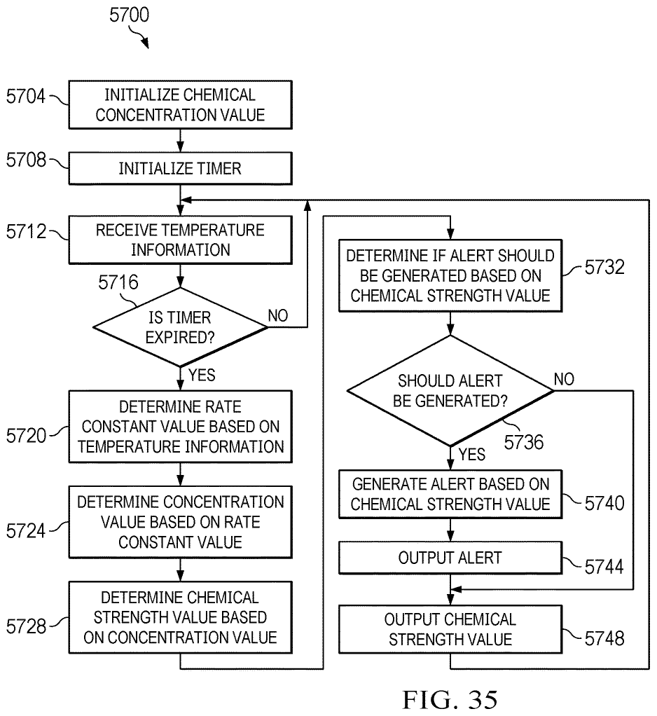

Turning now to FIG. 35, another method 5700 for updating a chlorine concentration value is shown. The method 5700 can be utilized in a pool automation system or an aquatic environment (e.g., aquatic application 100 of FIG. 1) that includes a hybrid filter assembly provided in the form of a first filtration stage and a second filtration stage (e.g., a prefilter and one or more membrane filters). In some instances, the prefilter can be a granular-bed depth-type filter, such as a sand filter or a glass filter (e.g., an activated glass filter). In some instances, the depth-type filter can include a pre-coat type media, such as diatomaceous earth. In some instances, the method 5700 can be implemented as computer-readable instructions on a non-transitory medium (e.g., a random access memory, a hard drive, etc.) and executed by a processor (e.g., a CPU, a GPU, etc.).

In some aspects, the method 5700 can be used when the reservoir 5530 is filled, either partially or completely, after previously being empty.

At 5704, the central controller 150 can initialize a chemical concentration value. The central controller 150 may perform some or all of 5604.

At 5708, the central controller 150 can initialize a timer. The central controller 150 may perform some or all of 5608.

At 5712, the central controller 150 can receive temperature information. The central controller 150 may perform some or all of 5612.

At 5716, the central controller 150 can determine if the timer is expired. The central controller 150 may perform some or all of 5620. If the central controller 150 determines that the timer is not expired (e.g., “NO” at 5716), the method 5700 can proceed to 5712. If the central controller 150 determines that the timer is expired (e.g., “YES” at 5716), the method 5700 can proceed to 5720.

At 5720, the central controller 150 can determine a rate constant value based on the temperature information. The central controller 150 may perform some or all of 5624.

At 5724, the central controller 150 can determine a chemical concentration value based on the rate constant value. The central controller 150 may perform some or all of 5628.

At 5728, the central controller 150 can determine a chemical strength value based on the chemical concentration value. The central controller 150 may perform some or all of 5636.

At 5732, the central controller 150 can determine if an alert should be generated based on the chemical strength value. The central controller 150 may perform some or all of 5640.

At 5736, if the central controller 150 determined that the alert should not be generated (e.g., “NO” at 5736), the method 5700 can proceed to 5748. If the central controller 150 determined that the alert should be generated (e.g., “YES” at 5736), the method 5700 can proceed to 5740. At 5740, the central controller 150 can generate an alert based on the chemical strength value. The central controller 150 may perform some or all of 5648.

At 5744, the central controller 150 can output the alert. The central controller 150 may perform some or all of 5652.

At 5748, the central controller 150 can output the chemical strength value. The central controller 150 may perform some or all of 5656.

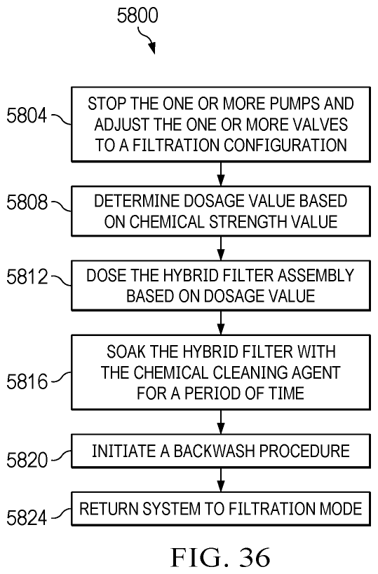

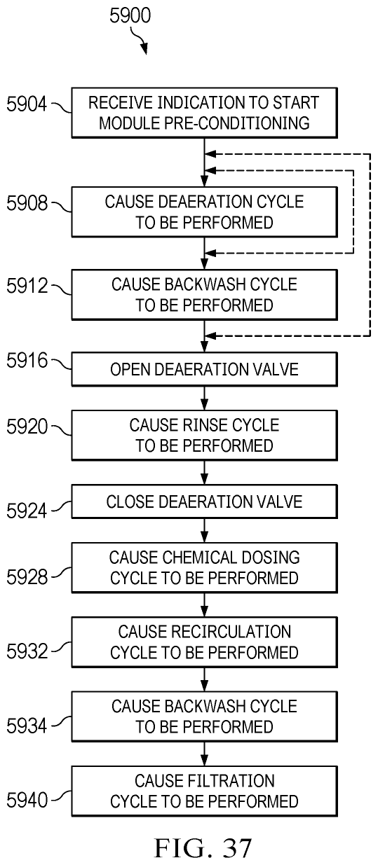

Now referring to FIG. 36, a method 5800 for chemically cleaning the hybrid filter assembly is illustrated. The method 5800 can be utilized in a pool automation system or an aquatic environment (e.g., aquatic application 100 of FIG. 1) that includes a hybrid filter assembly provided in the form of a first filtration stage and a second filtration stage (e.g., a prefilter and one or more membrane filters). In some instances, the prefilter can be a granular-bed depth-type filter, such as a sand filter or a glass filter (e.g., an activated glass filter). In some instances, the depth-type filter can include a pre-coat type media, such as diatomaceous earth. In some instances, the method 5800 can be implemented as computer-readable instructions on a non-transitory medium (e.g., a random access memory, a hard drive, etc.) and executed by a processor (e.g., a CPU, a GPU, etc.).

At step S804, the central controller 150 can direct one or more pumps of the hybrid filter assembly to be turned off or maintained off. After a backwash procedure is completed, one or more pumps may already be turned off. However, one or more valves in the hybrid filter assembly can be switched back to the filtration mode orientation or maintained in the filtration mode orientation.

At 5808, the central controller 150 can determine a dosage value based on a chemical strength value. In some instances, the central controller 150 can determine the chemical strength value by executing some or all of the method 5600 and/or some or all of the method 5700 described above. The central controller 150 may determine the dosage value based on a predetermined standard chemical dosage. The predetermined standard chemical dosage can be a dosage that can be used when the chemical cleaning agent is at 100% strength (i.e., a chemical strength value of 100%). In some instances, the central controller 150 can determine a dosage multiplier value equal to a quotient of 100% and the chemical strength value. The central controller 150 can then determine the dosage value by multiplying the predetermined standard chemical dosage by the dosage multiplier value.

At 5812, the central controller 150 can dose the hybrid filter assembly with a dosage of the chemical cleaning agent equal to the dosage value determined at 5808. The dosage of the chemical cleaning agent can be introduced by the chemical dosing system 335. In some aspects, the central controller 150 may execute at least some of 4520 in FIG. 23.

At 5816, the central controller 150 can stop the flow of the chemical cleaning agent to the hybrid filter assembly, and direct one or more components of the hybrid filter assembly (e.g., the first membrane filter 320a and/or the second membrane filter 320b) to be soaked with the chemical cleaning agent for a predetermined period of time. During the soak, at 5816, the hybrid filter assembly can operate in the bypass mode shown in FIG. 18. During the soak, and while the hybrid filter assembly is operating in the bypass mode, the clean-in-place module 345 can circulate one or more chemical cleaning agents and/or fluid (e.g., water) within the one or more membrane filters 320. A benefit of soaking the hybrid filter assembly with the chemical cleaning agent is that it can give the chemical cleaning agent time to neutralize contaminants. In some instances, the hybrid filter assembly can be soaked between about 1 hour to about 24 hours (or 1 hour to 24 hours), although the hybrid filter assembly may also be soaked for less time or more time than described herein. For example, the hybrid filter assembly can be soaked between about 2 hours to about 4 hours (or between 2 hours to 4 hours). As yet another example, the hybrid filter assembly can be soaked for about 3 hours to about 6 hours (or for 3 hours to 6 hours). For example, the hybrid filter assembly can be soaked between 1 hour to 5 hours (or between 1 hour to 5 hours). In further cases, the hybrid filter assembly can be soaked for at least about 30 minutes, or at least about 1 hour, or at least about 2 hours, or at least about 3 hours, or at least about 4 hours, or at least about 5 hours, or at least about 6 hours, or at least about 7 hours, or at least about 8 hours, or at least about 9 hours, or at least about 10 hours, or at least about 11 hours, or at least about 12 hours, or at least about 13 hours, or at least about 14 hours, or at least about 15 hours, or at least about 16 hours, or at least about 17 hours, or at least about 18 hours, or at least about 19 hours, or at least about 20 hours, or at least about 21 hours, or at least about 22 hours, or at least about 23 hours, or at least about 24 hours. In other cases, the hybrid filter assembly can be soaked for at least 30 minutes, or at least 1 hour, or at least 2 hours, or at least 3 hours, or at least 4 hours, or at least 5 hours, or at least 6 hours, or at least 7 hours, or at least 8 hours, or at least 9 hours, or at least 10 hours, or at least 11 hours, or at least 12 hours, or at least 13 hours, or at least 14 hours, or at least 15 hours, or at least 16 hours, or at least 17 hours, or at least 18 hours, or at least 19 hours, or at least 20 hours, or at least 21 hours, or at least 22 hours, or at least 23 hours, or at least 24 hours. In some instances, the predetermined time that one or more components of the hybrid filter assembly may be soaked with the chemical cleaning agent may fall within a range bounded by any minimum value and any maximum value as described above. In other instances, instead of using a single predetermined time, the central controller 150 may utilize a predetermined range of times that may be bounded by any minimum value and any maximum value as described above.

At 5820, the central controller 150 can initiate a backwash procedure after the hybrid filter assembly has been soaked for the predetermined time or the predetermined range of times. The backwash procedure can be performed according to the method 4400 of FIG. 22. A benefit of backwashing the hybrid filter assembly after the chemical cleaning procedure is that the chemical cleaning agent and contaminants can be flushed from the system.

At 5824, the central controller 150 can direct the hybrid filter assembly to be returned to the filtration mode after the backwash procedure is completed.

Turning now to FIG. 37, a method 5900 of a preconditioning process for a hybrid filter assembly is illustrated. The method 5900 can be utilized in a pool automation system or an aquatic environment (e.g., aquatic application 100 of FIG. 1) that includes a hybrid filter assembly provided in the form of a first filtration stage and a second filtration stage (e.g., a prefilter and one or more membrane filters). In some instances, the prefilter can be a granular-bed depth-type filter, such as a sand filter or a glass filter (e.g., an activated glass filter). In some instances, the depth-type filter can include a pre-coat type media, such as diatomaceous earth. In some instances, the method 5900 can be implemented as computer-readable instructions on a non-transitory medium (e.g., a random access memory, a hard drive, etc.) and executed by a processor (e.g., a CPU, a GPU, etc.).

At 5904, the central controller 150 can receive an indication to start module preconditioning. In some instances, the indication can be a message or notification from the user device 160 to start the module pre-conditioning. In some instances, the central controller 150 can proceed to 5908 after 5904. In some instances, the central controller 150 can proceed to 5912 after 5904. In some instances, the central controller 150 can proceed to 5916 after 5904.

At 5908, the central controller 150 can cause a deaeration cycle to be performed. In some instances, the central controller 150 can actuate one or more deaeration valves included in the one or more membrane filters and/or the hybrid filter assembly. In some instances, the one or more deaeration valves may be provided in each housing of the one or more membrane filtration modules provided with the hybrid filter assemblies discussed herein. Permeability values may be affected by excess entrapped air in the one or more membranes and/or a housing containing the one or more membranes. The central controller 150 can actuate the one or more deaeration valves to potentially reduce entrapped air in the one or more membranes and/or a housing retaining the one or more membranes (e.g., the housing of the membrane filtration modules). Reducing entrapped air in the one or more membranes and/or a housing retaining the one or more membranes may improve permeability value accuracy. In some instances, the central controller 150 can actuate the one or more deaeration valves to an open position for a predetermined time period before returning the one or more deaeration valves to a closed position. In some instances, the predetermined time period can be about twenty seconds. In some instances, the predetermined time period can be about twenty seconds. In some instances, the predetermined time period can be about one second to two hundred and fifty-five seconds. In some instances, the central controller 150 may compare permeability values detected in the one or more membrane filters and/or the hybrid filter assembly against one or more predetermined threshold values to determine if subsequent deaeration cycles are needed.

At 5912, the central controller 150 can cause a backwash cycle to be performed. In some aspects, the backwash cycle can be performed according to the method 4400 of FIG. 22.

At 5916, the central controller 150 can open one or more deaeration valves. In some instances, the central controller 150 can actuate each of the one or more deaeration valves included in the one or more membrane filters and/or the hybrid filter assembly to an open position. In some instances, the central controller 150 can actuate a subset of the one or more deaeration valves included in the one or more membrane filters and/or the hybrid filter assembly to an open position. In some instances, the central controller 150 can open a single deaeration valve coupled to the one or more membrane filters.

At 5920, the central controller 150 can cause a rinse cycle to be performed. In some instances, the rinse cycle can be maintained for at least about 1 minute. In other instances, the rinse operation can be maintained for at least 1 minute. In yet other instances, the rinse operation can be maintained for at least about 1 minute to no more than about 10 minutes (or at least about 1 minute to no more than 10 minutes), although the rinse operation may be maintained for longer or shorter time periods than those recited herein. In some instances, the rinse cycle can be maintained for about 2 minutes. In other instances, the rinse cycle can be maintained for 2 minutes.

At 5924, the central controller 150 can close one or more deaeration valves. In some instances, the central controller 150 can actuate each of the one or more deaeration valves included in the one or more membrane filters and/or the hybrid filter assembly to a closed position. In some instances, the central controller 150 can actuate a subset of the one or more deaeration valves included in the one or more membrane filters and/or the hybrid filter assembly to a closed position. In some instances, the central controller 150 can close a single deaeration valve coupled to the one or more membrane filters.

At 5928, the central controller 150 can cause a chemical dosing cycle to be performed. In some instances, the central controller 150 can cause a predetermined amount of a chemical cleaning agent to be dosed into the one or more membrane filters and/or the hybrid filter assembly. In some instances, the chemical cleaning agent can be stored in the reservoir 5530. In some instances, the chemical cleaning agent is sodium hypochlorite. In some instances, the predetermined amount of the chemical cleaning agent can be about 130 ml to 325 ml of 10-12.5% concentration sodium hypochlorite, resulting in dilution to about 400 ppm in a subsequent recirculation process. In some instances, the predetermined amount of the chemical cleaning agent can be about 65 ml of 10-12.5% concentration sodium hypochlorite. In some instances, the central controller 150 can dose the chemical cleaning agent over about 30 seconds to 5 minutes. In some instances, the central controller 150 can dose the chemical cleaning agent over about two minutes. In some instances, the central controller 150 can actuate the deaeration valve to an open position for some or all of the chemical dosing cycle. In some instances, the central controller 150 can actuate the deaeration valve to the open position before causing the chemical cleaning agent to be dosed. The central controller 150 can actuate the deaeration valve to a closed position after completion of the chemical dosing cycle.

Using a higher amount of chlorine dosing than is typically used in a cleaning cycle operation can help prepare the one or more membrane filters for operation. New membrane filters may include additives and preservatives from production and shipping, including glycerin and/or sodium bisulfite. Additionally, the membranes may contain PVP. The preservatives, additives, and/or PVP may cause chlorine demand from the pool to oxidize. If the pool has a low chlorine residual and/or ORP when the hybrid filter assembly is being installed, this additional demand from the additives and preservatives may result in partial or total consumption of available free chlorine and loss of breakpoint. If total consumption occurs, the pool must be “shocked” with a large amount of chlorine to destroy all combined chlorine and re-establish breakpoint. By dosing with the chemical cleaning agent at 5928, the method 5900 may help prevent the need for chlorine shocking after installation of the hybrid filter assembly. More specifically, the method 5900 can remove a portion of PVP in the membranes that would otherwise consume pool chlorine and oxidize, along with the additives and preservatives, by preemptively dosing with chlorine.

At 5932, the central controller 150 can cause a recirculation cycle to be performed. The central controller 150 can cause the clean-in-place module 345 to circulate the chemical cleaning agent within the one or more membrane filters. More specifically, the central controller 150 can cause the clean-in-place module 345 to circulate the chemical within the one or more membrane filters during a chemical soak while the hybrid filter assembly is in a bypass configuration. The recirculation cycle can last about 30 minutes to 2 hours. In some instances, the recirculation cycle can last about 60 minutes.

At 5936, the central controller 150 can cause a backwash cycle to be performed. In some aspects, the backwash cycle can be performed according to the method 4400 of FIG. 22. In some aspects, the backwash cycle can last for about 2 minutes to 5 minutes. In some aspects, the backwash cycle can last for about 3 minutes.

At 5940, the central controller 150 can cause a filtration cycle to be performed. The central controller 150 can cause the hybrid filter assembly to shift to a filtration mode orientation. The central controller 150 can then perform one or more deaeration cycles interspersed with forward filtration. During actuation of the valve (e.g., valve 5520), air may be introduced to the hybrid filter assembly 5500. Performing deaeration at the start of each filtration cycle may help remove entrapped air before the filtration, which may result in better performance for the hybrid filter assembly 5500 as compared to if no deaeration was performed.

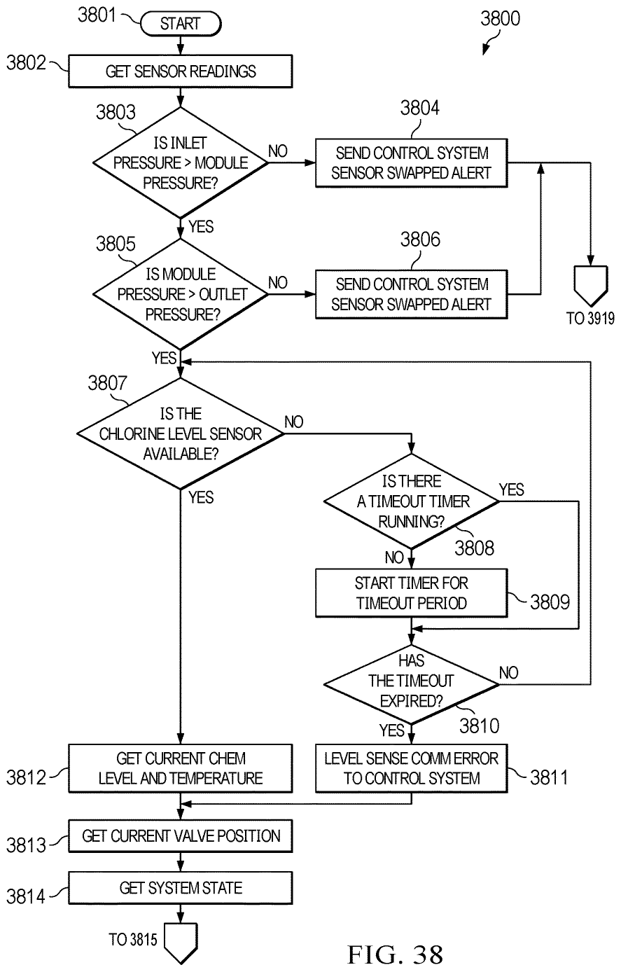

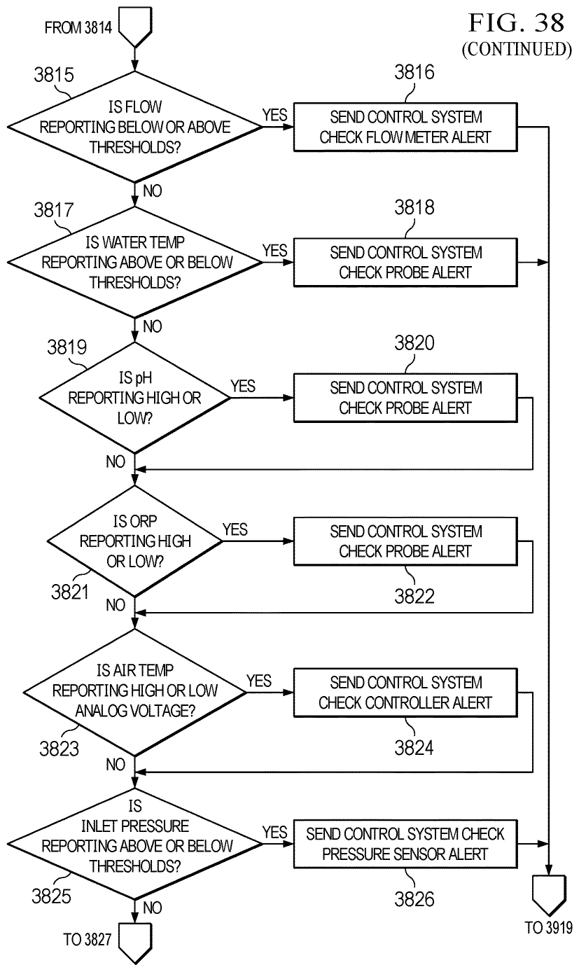

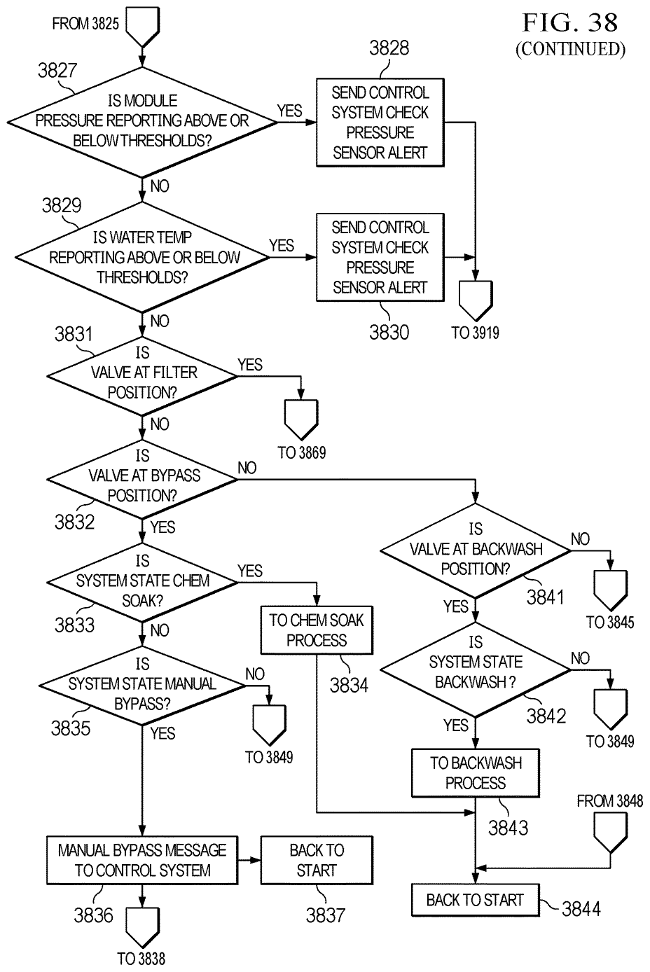

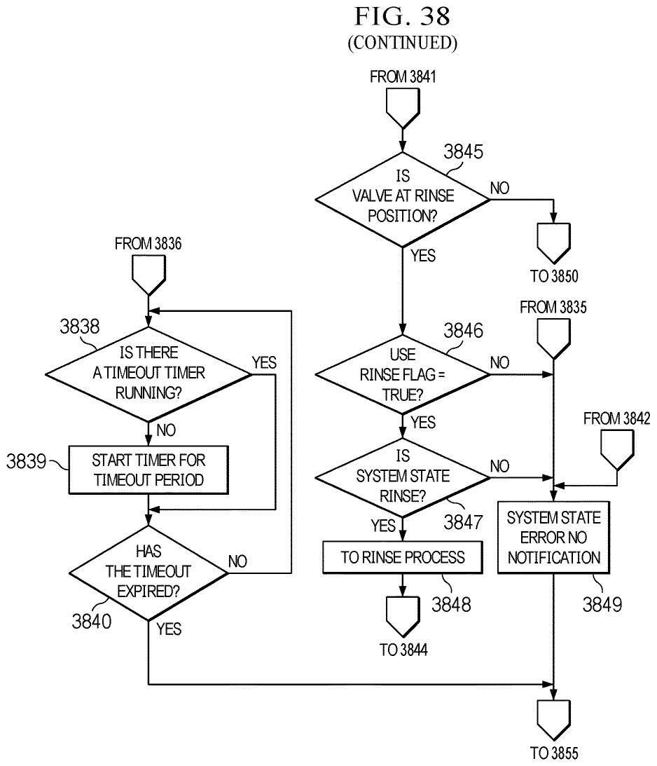

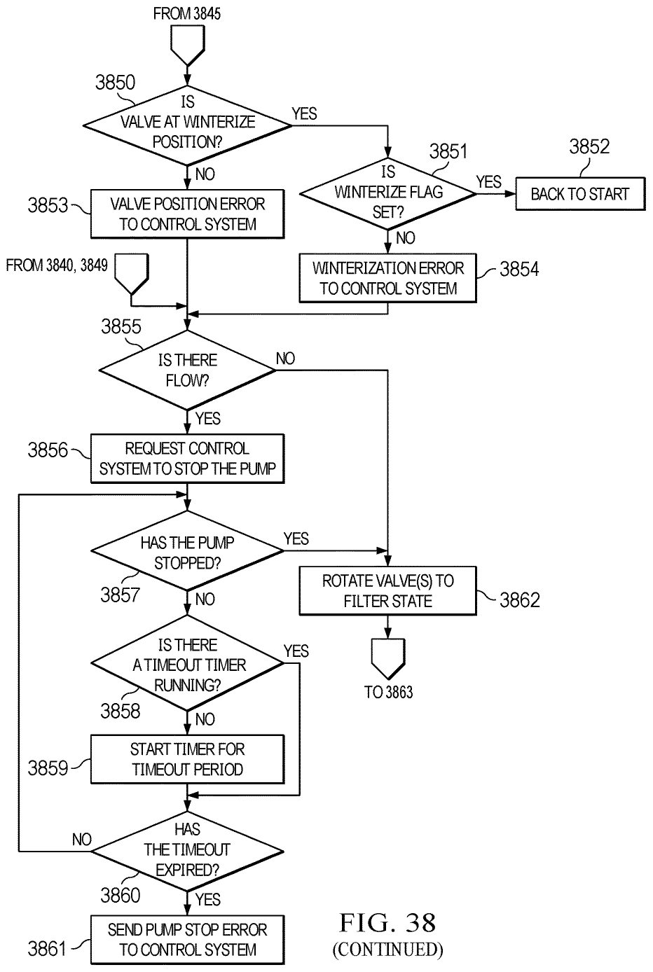

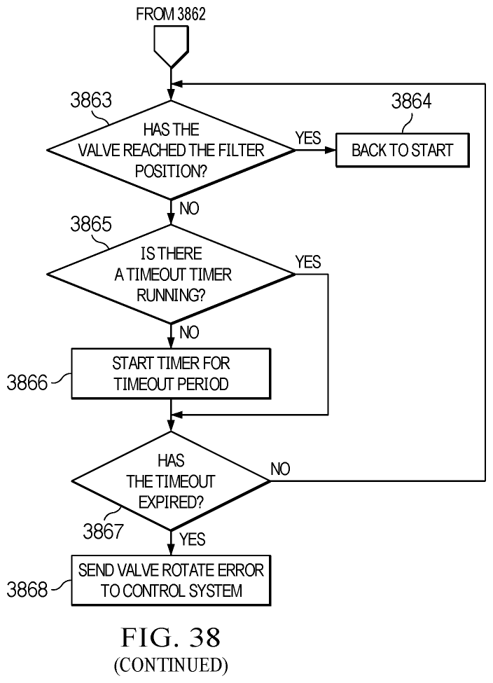

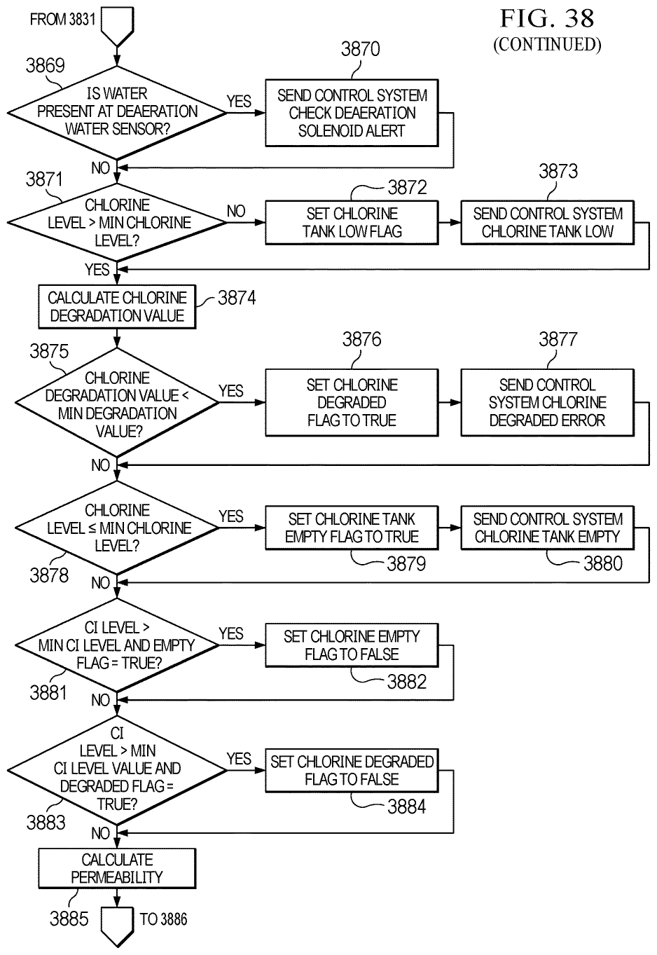

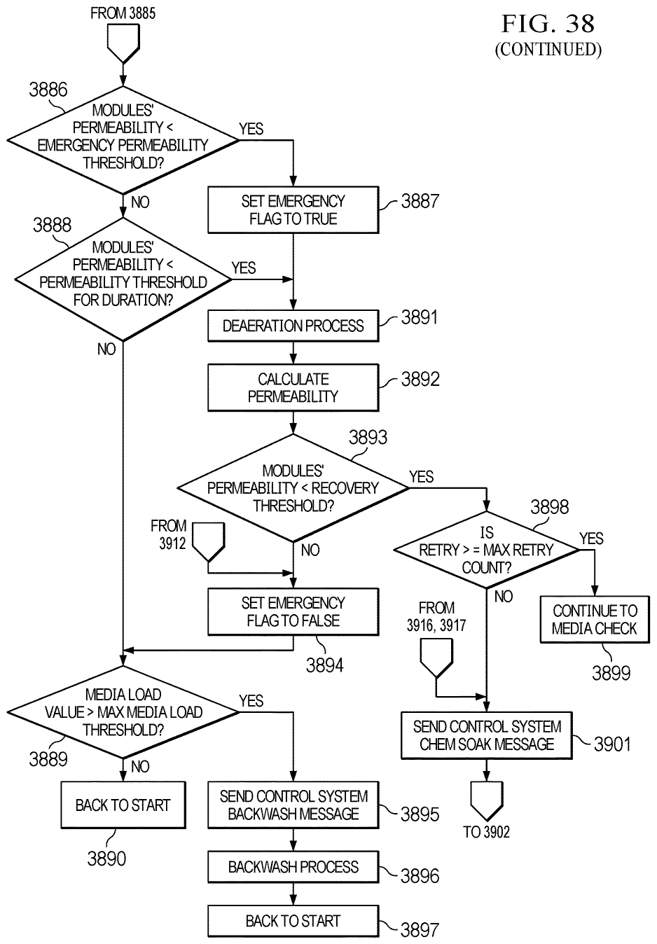

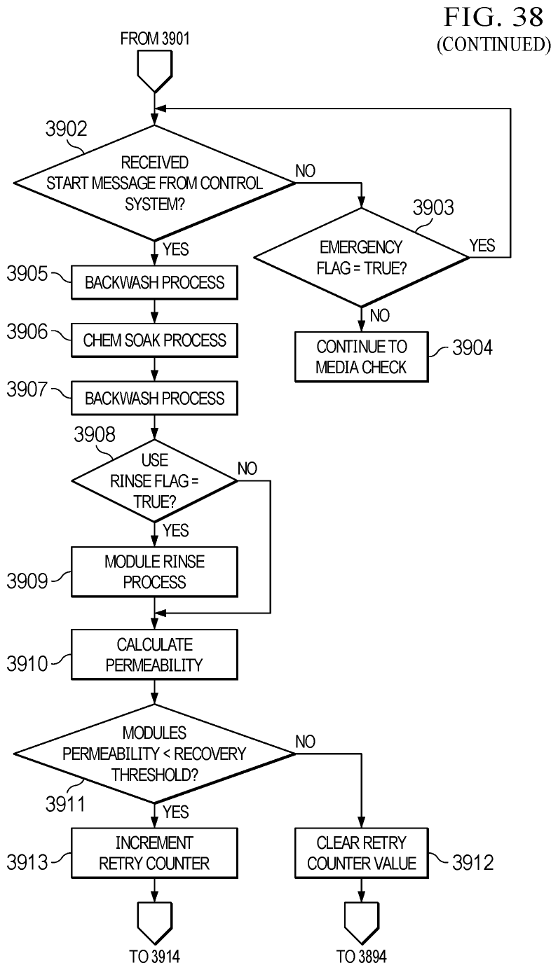

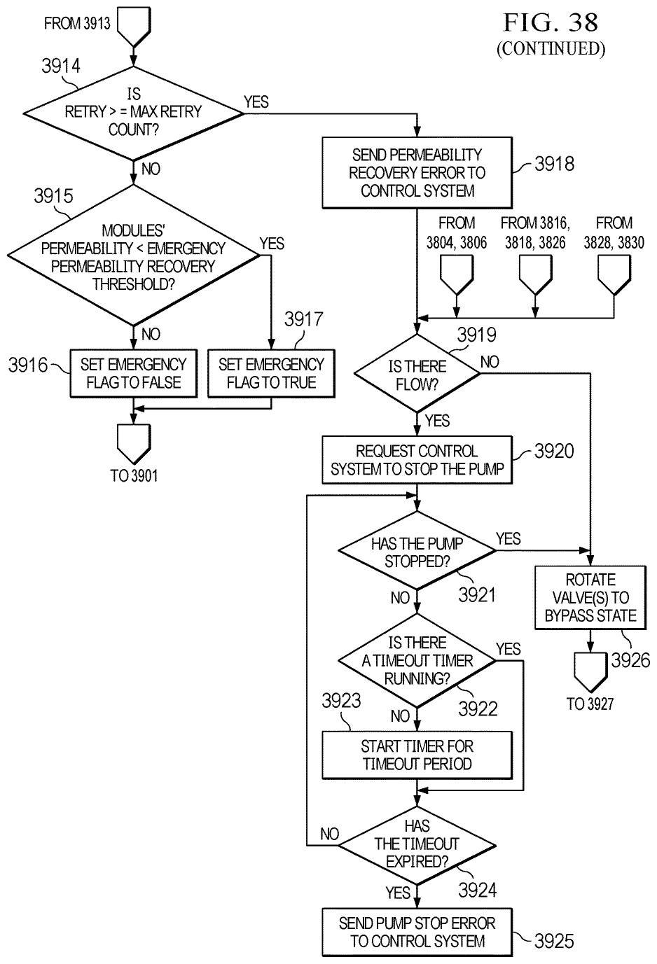

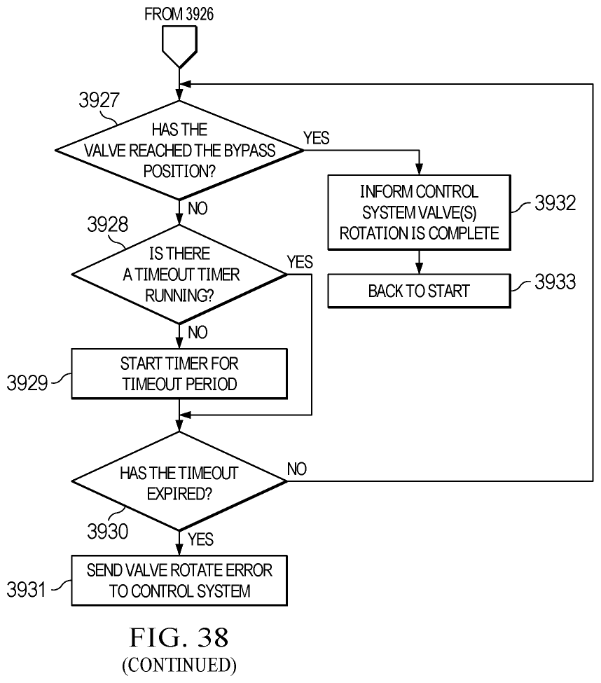

FIG. 38 is a flowchart illustrating a method 3800 performed by a local or central controller (e.g., the central controller 150) for monitoring and managing the filtration system. The method 3800 operates as a continuous monitoring loop in which the central controller 150 repeatedly evaluates sensor data, system state, valve positions, and chemical levels to ensure safe and efficient operation of the filtration system.

The method 3800 can be utilized in a pool automation system or an aquatic environment (e.g., aquatic application 100 of FIG. 1) that includes any of the hybrid filter assemblies described herein, including the hybrid filter assembly 200 of FIG. 2 and/or the hybrid filter assembly 5500 of FIG. 33A. In some instances, the method 3800 can be performed as a main control flow that the central controller 150 executes as a continuous monitoring loop, repeatedly evaluating sensor data, system state, valve positions, and chemical levels to help ensure safe and efficient operation of the aquatic application 100. In some instances, the method 3800 can be implemented as computer-readable instructions on a non-transitory medium (e.g., a random access memory, a hard drive, etc.) and executed by a processor (e.g., a CPU, a GPU, etc.). In some aspects, the method 3800 can include more or fewer steps depending on the instance, and one or more steps may be performed more than once or omitted. The method 3800 begins at step 3801.

At step 3802, the central controller 150 retrieves sensor readings from at least one, some, most, or all sensors in electronic communication with the central controller 150. The sensors may include, for example, one or more sensors associated with the hybrid filter assembly 200 of FIG. 2 and/or the hybrid filter assembly 5500 of FIG. 33A.

For example, the central controller 150 may obtain readings from all sensors in communication with the central controller 150. The sensors in communication with the central controller 150 may include, but are not limited to, flow, water temperature, air temperature, pH, ORP, inlet pressure, module pressure, outlet pressure, and deaeration water sensors.

At step 3803, the central controller 150 determines whether the inlet pressure is greater than the module pressure. If the inlet pressure is not greater than the module pressure (e.g., if the inlet pressure is less than or equal to the module pressure), the central controller 150 proceeds to step 3804. At step 3804, the central controller 150 sends a swapped sensor alert to a control system and then proceeds to step 3919. In some instances of step 3804, the sensor swapped alert may include information regarding which sensors (e.g., which pressure sensors) have been swapped. If the inlet pressure is greater than the module pressure, the central controller 150 proceeds to step 3805.

In various instances, the control system may be provided in the form of the IntelliCenter® provided by Pentair Pool & Spa, Inc. Although IntelliCenter may be used herein interchangeably with a control system, the use of “IntelliCenter” is not to be construed as being limited to only one possible control system and may include any similar control systems as recognizable by one of ordinary skill in the art. In some cases, the central controller 150 may be provided in the form of a control system load center as described in U.S. patent application Ser. No. 18/763,233, entitled “Systems and Methods for Controlling Pool/Spa Devices,” the contents of which are incorporated by reference in its entirety herein.

At step 3805, the central controller 150 determines whether the module pressure is greater than the outlet pressure. If the module pressure is not greater than the outlet pressure (e.g., if the module pressure is less than or equal to the outlet pressure), the central controller 150 proceeds to step 3806, where it sends a sensor swapped alert to the control system, and then proceeds to step 3919. In some instances of step 3805, the sensor swapped alert may include information regarding which sensors (e.g., which pressure sensors) have been swapped. If the module pressure is greater than the outlet pressure, the central controller 150 proceeds to step 3807.

At step 3807, the central controller 150 determines whether a chlorine level sensor is available. If the chlorine level sensor is not available, the central controller 150 proceeds to step 3808. At step 3808, the central controller 150 determines whether a timeout timer is already running. If a timeout timer is not running, the central controller 150 proceeds to step 3809 and starts a timer. In various cases, the timer may be configured to monitor or count time for a timeout period. The central controller 150 then proceeds to step 3810. If a timeout timer is already running at step 3808, the central controller 150 proceeds directly to step 3810. At step 3810, the central controller 150 determines whether the timeout period has expired. If the timeout period has not expired, the central controller 150 loops back to step 3810. If the timeout has expired, the central controller 150 proceeds to step 3811 and sends a level sense communication error to the control system. In various cases, the timeout period associated with step 3810 may be about 1 second to about 30 seconds, or about 2 seconds to about 20 seconds, or about 4 seconds to about 8 seconds, although the timeout period may be less than or greater than these values. For example, the timeout period may be at least about 2 seconds, or at least about 4 seconds, or at least about 6 seconds, or at least about 10 seconds, or at least about 15 seconds, or at least about 20 seconds, or at least about 30 seconds, or no more than about 30 seconds.

If the chlorine level sensor is available at step 3807, or after sending the level sense communication error at step 3811, the central controller 150 proceeds to step 3812 and retrieves the current chemical level (e.g., a current chlorine level) and a temperature value. The central controller 150 then proceeds to step 3813 and retrieves the current valve position of the one or more valves (e.g., the valve 400 and/or the valve 5520).

The central controller 150 then proceeds to step 3814 and retrieves the current system state. In some instances, when the current system state has changed from a previous configuration, the system may save the new system state to prevent loss of information in the event of equipment or electrical failure (e.g., a power outage).

At step 3815, the central controller 150 determines whether the flow sensor is reporting a value below, equal to, or above the acceptable thresholds. If the flow sensor is reporting a value outside acceptable thresholds (e.g., above, equal to, or below acceptable thresholds), the central controller 150 proceeds to step 3816, where the central controller 150 sends a check flow meter alert to the control system, and then proceeds to step 3919. If the flow sensor is reporting a value within acceptable thresholds (e.g., the flow sensor provides a value that falls within a predetermined threshold range), the central controller 150 proceeds to step 3817.

At step 3817, the central controller 150 determines whether the water temperature sensor is reporting a value above, equal to, or below the acceptable thresholds. If the water temperature sensor is reporting a value outside acceptable thresholds (e.g., above, equal to, or below acceptable thresholds), the central controller 150 proceeds to step 3818, where the central controller 150 sends a check probe alert to the control system, and then proceeds to step 3919. If the water temperature sensor is reporting within acceptable thresholds (e.g., the water temperature sensor provides a value that falls within a predetermined threshold range), the central controller 150 proceeds to step 3819.

At step 3819, the central controller 150 determines whether the pH sensor is reporting a high value or a low value falling outside acceptable thresholds. If the pH sensor reports a value falling above, equal to, or below the acceptable thresholds, the central controller 150 proceeds to step 3820, where the central controller 150 sends a check probe alert to the control system, and then proceeds to step 3821. If the pH sensor is reporting within acceptable thresholds (e.g., the pH sensor provides a value that falls within a predetermined threshold range), the central controller 150 also proceeds to step 3821.

At step 3821, the central controller 150 determines whether the ORP sensor is reporting a high value or a low value outside acceptable thresholds. If the ORP sensor reports a value falling above or below the acceptable thresholds, the central controller 150 proceeds to step 3822, where the central controller 150 sends a check probe alert to the control system, and then proceeds to step 3823. If the ORP sensor is reporting within acceptable thresholds (e.g., the ORP sensor provides a value that falls within a predetermined threshold range), the central controller 150 also proceeds to step 3823.

At step 3823, the central controller 150 determines whether the air temperature sensor is reporting an analog voltage above, equal to, or below the acceptable thresholds. If the air temperature sensor reports a value falling above or below the acceptable thresholds, the central controller 150 proceeds to step 3824, where the central controller 150 sends a check controller alert to the control system, and then proceeds to step 3825. If the air temperature sensor is reporting within acceptable thresholds (e.g., the air temperature sensor provides a value that falls within a predetermined threshold range), the central controller 150 also proceeds to step 3825.

At step 3825, the central controller 150 determines whether the inlet pressure sensor is reporting a value above, equal to, or below the acceptable thresholds. If the inlet pressure sensor is reporting a value outside acceptable thresholds (e.g., above or below acceptable thresholds), the central controller 150 proceeds to step 3826, where it sends a check pressure sensor alert to the control system, and then proceeds to step 3919. If the inlet pressure sensor is reporting within acceptable thresholds (e.g., the inlet pressure sensor provides a value that falls within a predetermined threshold range), the central controller 150 proceeds to step 3827.

At step 3827, the central controller 150 determines whether the module pressure sensor is reporting a value above, equal to, or below the acceptable thresholds. If the module pressure sensor is reporting a value outside acceptable thresholds (e.g., above or below acceptable thresholds), the central controller 150 proceeds to step 3828, where it sends a check pressure sensor alert to the control system, and then proceeds to step 3919. If the module pressure sensor is reporting within acceptable thresholds (e.g., the module pressure sensor provides a value that falls within a predetermined threshold range), the central controller 150 proceeds to step 3829.

At step 3829, the central controller 150 determines whether the outlet pressure sensor is reporting a value above, equal to, or below the acceptable thresholds. If the outlet pressure sensor is reporting a value outside the acceptable thresholds (e.g., above or below the acceptable thresholds), the central controller 150 proceeds to step 3830, where it sends a check pressure sensor alert to the control system, and then proceeds to step 3919. If the outlet pressure sensor is reporting within the acceptable thresholds (e.g., the outlet pressure sensor provides a value that falls within a predetermined threshold range), the central controller 150 proceeds to step 3831.

At step 3831, the central controller 150 determines whether the one or more valves (e.g., the valve 400 and/or the valve 5520) are at the filter position. If the valve is at the filter position, the central controller 150 proceeds to step 3869, described below. If the valve is not at the filter position, the central controller 150 proceeds to step 3832.

At step 3832, the central controller 150 determines whether the valve is at the bypass position. If the valve is at the bypass position, the central controller 150 proceeds to step 3855, described below. If the valve is not at the bypass position, the central controller 150 proceeds to step 3833.

At step 3833, the central controller 150 determines whether the system state is manual bypass (e.g., a manual bypass has been initiated). If the system state is manual bypass, the central controller 150 proceeds to step 3834 and initiates the chemical soak process. If the system state is not manual bypass, the central controller 150 proceeds to step 3835.

At step 3835, the central controller 150 determines whether the system is in manual bypass. If the system is in manual bypass, the central controller 150 proceeds to step 3836 and sends a manual bypass message to the control system. The central controller 150 then proceeds to step 3837 and returns to step 3801 to restart the monitoring cycle. If the system is not in manual bypass at step 3835, the central controller 150 proceeds to step 3838.

At step 3838, the central controller 150 determines whether a timeout timer is already running. If a timeout timer is not running, the central controller 150 proceeds to step 3839 and starts a timer for the timeout period. The central controller 150 then proceeds to step 3840. If a timeout timer is already running at step 3838, the central controller 150 proceeds directly to step 3840. At step 3840, the central controller 150 determines whether the timeout period has expired. If the timeout has not expired, the central controller 150 loops back to step 3838. If the timeout has expired, the central controller 150 proceeds to step 3855. In various cases, the duration of the timeout period associated with the steps 3838-3840 may be the same as the duration of the timeout period associated with step 3810, although the duration of the timeout period associated with the steps 3838-3840 need not be the same as the duration of the timeout period associated with step 3810. For example, the timeout period associated with the steps 3838-3840 may be about 2 seconds to about 60 seconds, or more or less. In some such cases, the duration of the timeout period may be adjustable by a service technician or a manufacturer of the control system. In various cases, the timer may run while the system is in a manual bypass mode.

At step 3841, the central controller 150 determines whether the valve is at the backwash position. If the valve is at the backwash position, the central controller 150 proceeds to step 3842. At step 3842, the central controller 150 determines whether the system state is backwash. If the system state is backwash, the central controller 150 proceeds to step 3843 and initiates the backwash process. If the system state is not backwash at step 3842, the central controller 150 proceeds to step 3844 and returns to step 3801 to restart the monitoring cycle.

If the valve is not at the backwash position at step 3841, the central controller 150 proceeds to step 3845. At step 3845, the central controller 150 determines whether the valve is at the rinse position. If the valve is at the rinse position, the central controller 150 proceeds to step 3846. At step 3846, the central controller 150 determines whether the rinse time flag is true (see, e.g., step 3908 for when the rinse flag may be set to true). If the rinse time flag is not true, the central controller 150 proceeds to step 3849. If the rinse time flag is true, the central controller 150 proceeds to step 3847. At step 3847, the central controller 150 determines whether the system state is rinse. If the system state is rinse, the central controller 150 proceeds to step 3848 and initiates the rinse process. If the system state is not rinse at step 3847, the central controller 150 proceeds to step 3849.

At step 3849, the central controller 150 records a system state error without a notification being provided. Thus, an inadvertent or out-of-sequence rinse operation may be prevented. Step 3849 is also reached if the system state is not backwash at step 3842 (thereby preventing unwanted or unintended backwash operation) and if the system is not in manual bypass at step 3835 (thereby preventing unwanted or unintended manual bypass operation). After step 3849, the central controller 150 proceeds to step 3855.

If the valve is not at the rinse position at step 3845, the central controller 150 proceeds to step 3850. At step 3850, the central controller 150 determines whether the valve is at the winterize position. If the valve is not at the winterize position, the central controller 150 proceeds to step 3853 and sends a valve position error to the control system, then proceeds to step 3855. If the valve is at the winterize position, the central controller 150 proceeds to step 3851. At step 3851, the central controller 150 determines whether the winterize flag is set. If the winterize flag is not set, the central controller 150 proceeds to step 3852 and returns to step 3801 to restart the monitoring cycle. If the winterize flag is set, the central controller 150 proceeds to step 3854 and sends a winterization error to the control system, then proceeds to step 3855. Thus, a winterization error may signal when the valve is at a winterize position in improper or unintended circumstances, thereby triggering an error notification rather than allowing normal operation to continue.

At step 3855, the central controller 150 determines whether there is flow through the hybrid filter assembly (e.g., if a flow rate through the hybrid filter assembly is greater than zero). In various cases, whether there is flow through the hybrid filter may be determined by a flow sensor that is positioned at or near the inlet, outlet, pump, or membrane module, or any other system component. Step 3855 may be reached from the bypass position branch at step 3832, from the timeout expiration at step 3840, from step 3849, from step 3853, and from step 3854. If there is flow at step 3855, the central controller 150 may proceed to step 3856 and request the control system to stop the pump. If there is no flow at step 3855, the central controller 150 proceeds to step 3862.

At step 3856, the central controller 150 requests the control system to stop the pump. The central controller 150 then proceeds to step 3857. At step 3857, the central controller 150 determines whether the pump has stopped. If the pump has not stopped, the central controller 150 proceeds to step 3858. At step 3858, the central controller 150 determines whether a timeout timer is already running. If a timeout timer is not running, the central controller 150 proceeds to step 3859 and starts a timer for the timeout period. The central controller 150 then proceeds to step 3860. If a timeout timer is already running at step 3858, the central controller 150 proceeds directly to step 3860. At step 3860, the central controller 150 determines whether the timeout period has expired. If the timeout has not expired, the central controller 150 loops back to step 3857. If the timeout has expired, the central controller 150 proceeds to step 3861 and sends a pump stop error to the control system.

If the pump has stopped (e.g., the pump is off or in a standby condition) at step 3857, or if the pump was already stopped, the central controller 150 proceeds to step 3862. At step 3862, the central controller 150 directs the valve or valves of the hybrid filter assembly to rotate to the filter state. The central controller 150 then proceeds to step 3863. At step 3863, the central controller 150 determines whether the valve has reached the filter position. If the valve has reached the filter position, the central controller 150 proceeds to step 3864 and returns to step 3801 to restart the monitoring cycle. If the valve has not reached the filter position, the central controller 150 proceeds to step 3865. At step 3865, the central controller 150 determines whether a timeout timer is already running. If a timeout timer is not running, the central controller 150 proceeds to step 3866 and starts a timer for the timeout period. The central controller 150 then proceeds to step 3867. If a timeout timer is already running at step 3865, the central controller 150 proceeds directly to step 3867. At step 3867, the central controller 150 determines whether the timeout period has expired. If the timeout period has not expired, the central controller 150 loops back to step 3863. If the timeout period has expired, the central controller 150 proceeds to step 3868 and sends a valve rotate error to the control system. In various cases, the duration of the timeout period associated with the steps 3865-3867 may be the same as the duration of the timeout period associated with the steps 3810 or 3838-3840, although the duration of the timeout period associated with the steps 3865-3867 need not be the same as the duration of the timeout period associated with the steps 3810 or 3838-3840. For example, the timeout period associated with the steps 3865-3867 may be about 2 seconds to about 60 seconds, or more or less.

At step 3869, the central controller 150 determines whether water is present at the deaeration water sensor. Step 3869 is reached when the valve is confirmed to be at the filter position at step 3831. If water is present at the deaeration water sensor, the central controller 150 proceeds to step 3870 and sends a check deaeration solenoid alert to the control system. The central controller 150 then proceeds to step 3871. If water is not present at the deaeration water sensor, the central controller 150 also proceeds to step 3871.

At step 3871, the central controller 150 determines whether the amount of chlorine provided in the chemical tank or reservoir (i.e., the chlorine level) is greater than a minimum chlorine level. If the chlorine level is not greater than the minimum chlorine level (e.g., the chlorine level is less than or equal to the minimum chlorine level), the central controller 150 proceeds to step 3872 and sets a chlorine tank low flag. The central controller 150 then proceeds to step 3873 and sends a chlorine tank low notification to the control system. The control system may communicate the notification to another remote system, such as a cloud network or a user device. The central controller 150 then proceeds to step 3874. If the chlorine level is greater than the minimum chlorine level at step 3871, the central controller 150 also proceeds to step 3874.

At step 3874, the central controller 150 calculates a chlorine degradation value. In some instances, the chlorine degradation value can represent a measure of the reduction in effective concentration of the chemical cleaning agent (e.g., a chlorine solution such as a sodium hypochlorite solution) held in the reservoir relative to its initial or previously recorded concentration. In some instances, the central controller 150 can calculate the chlorine degradation value based on a rate constant value and a chemical concentration value determined in accordance with the method 5600 (FIG. 34) and/or the method 5700 (FIG. 35). In some instances, the rate constant value can be calculated based on temperature information received from the temperature sensor coupled to and/or included in the reservoir (e.g., the reservoir 5530), for example in accordance with Formula X described above. In some instances, the chemical concentration value can be calculated based on the rate constant value, for example in accordance with Formula XI described above. In some instances, the chlorine degradation value can be the chemical concentration value, a chemical strength value derived from the chemical concentration value, or a value derived from the difference between the initial concentration of the chemical cleaning agent and the current chemical concentration value. In some instances, the chlorine degradation value can be expressed as a percentage value.

The central controller 150 then proceeds to step 3875. At step 3875, the central controller 150 determines whether the chlorine degradation value is less than a minimum degradation value. In some instances, the minimum degradation value can represent a minimum acceptable concentration or minimum acceptable strength of the chemical cleaning agent below which the effectiveness of the chemical cleaning agent for membrane cleaning is considered to be significantly diminished. In some instances, the minimum degradation value can be a predetermined threshold value stored in the memory of the central controller 150. In some instances, the minimum degradation value can be an adjustable value configurable by an operator or a technician. In some instances, the minimum degradation value can correspond to a chemical strength value of about 60%, although the minimum degradation value may be less than or greater than this value.

If the chlorine degradation value is less than the minimum degradation value, the central controller 150 proceeds to step 3876 and sets the chlorine degraded flag to true. The central controller 150 then proceeds to step 3877 and sends the chlorine degradation value to the control system. The central controller 150 then proceeds to step 3878. If the chlorine degradation value is not less than the minimum degradation value at step 3875, the central controller 150 also proceeds to step 3878.

At step 3878, the central controller 150 determines whether the chlorine value is less than or equal to the minimum chlorine level. If so, the central controller 150 proceeds to step 3879 and sets the chlorine tank empty flag to true. The central controller 150 then proceeds to step 3880 and sends a chlorine tank empty notification to the control system. The central controller 150 then proceeds to step 3881. If the chlorine value is not less than or equal to the minimum chlorine level at step 3878, the central controller 150 also proceeds to step 3881.

At step 3881, the central controller 150 determines whether the chlorine level is greater than the minimum chlorine level and the empty flag is equal to true. If the chlorine level is greater than the minimum chlorine level and the empty flag is equal to true, the central controller 150 proceeds to step 3882 and sets the chlorine empty flag to false. The central controller 150 then proceeds to step 3883. If the chlorine level is not greater than the minimum chlorine level and the empty flag is not set equal to true, the central controller 150 also proceeds to step 3883.

At step 3883, the central controller 150 determines whether the chlorine level is greater than the minimum chlorine level value and the degraded flag is equal to true. If the chlorine level is greater than the minimum chlorine level value and the degraded flag is equal to true, the central controller 150 proceeds to step 3884 and sets the chlorine degraded flag to false. The central controller 150 then proceeds to step 3885. If the chlorine level is not greater than the minimum chlorine level value and the degraded flag is not equal to true at step 3883, the central controller 150 also proceeds to step 3885.

At step 3885, the central controller 150 calculates the permeability of the filtration modules. In some instances, the central controller 150 can calculate the permeability of the filtration modules based on one or more of the sensor readings retrieved at step 3802, including the flow sensor reading, the inlet pressure, the module pressure, and the outlet pressure, as well as the water temperature reading. In some instances, the central controller 150 can calculate the permeability of the filtration modules in accordance with Formula III above. More specifically, in some instances, the central controller 150 can determine a flux value based on the system flow rate value and the membrane surface area value in accordance with Formula IV above. The central controller 150 can then determine a transmembrane pressure (TMP) value based on the filter headloss value, which can be determined from the inlet pressure and the outlet pressure in accordance with Formulas V and VI above. The central controller 150 can further determine a viscosity value based on the water temperature value in accordance with Formula VII above. The central controller 150 can then calculate the permeability of the filtration modules based on the flux value, the TMP value, and the viscosity value in accordance with Formula III above. In some instances, when the hybrid filter assembly is operating with a bypass line, the central controller 150 can calculate an adjusted permeability value that accounts for changes in flow caused by the bypass line in accordance with Formula VIII above. In some instances, the permeability of the filtration modules can be expressed as a dimensionless value. In some instances, the permeability value calculated at step 3885 can be based on the same sensor readings and calculation methodology as the permeability values determined in the methods described with reference to FIGS. 21, 29, 30, and 31, as described in greater detail herein.

The central controller 150 then proceeds to step 3886, at which the central controller 150 determines whether the permeability of the filtration modules is less than the emergency permeability threshold. In various cases, the emergency permeability threshold may be adjusted by a service technician or the manufacturer of the hybrid filter assembly, and not the user.

At step 3886, the central controller 150 determines whether the permeability of the filtration modules is less than the emergency permeability threshold. If so, the central controller 150 proceeds to step 3887 and sets the emergency flag to true. In some cases, setting the emergency flag to true is given a high priority (e.g., a first priority) by the control system to help prevent damage to the filtration modules. The central controller 150 then proceeds to step 3888. If the permeability of the filtration modules is not less than the emergency permeability threshold at step 3886, the central controller 150 also proceeds to step 3888.

At step 3888, the central controller 150 determines whether the permeability of the filtration modules is less than a permeability threshold for a duration. In some instances, the permeability threshold for the duration can be a predetermined threshold value stored in the memory of the central controller 150. In some instances, the permeability threshold for the duration can be an adjustable value configurable by a service provider or manufacturer, for example, via the control system or a user interface in communication with the central controller 150. In some instances, the permeability threshold for the duration can be set at a value of between about 150 to about 350, although the permeability threshold for the duration may be somewhat less or even greater than these values. In some instances, the permeability threshold for the duration can be set at a value of at least about 100, or at least about 150, or at least about 200, or at least about 250, or at least about 300, or at least about 350. In some instances, the permeability threshold for the duration can be selected from a lookup table stored in the memory of the central controller 150, and may be adjusted based on one or more environmental or operational parameters, such as pool water temperature.

In some instances, the “duration” refers to a threshold period of time during which the permeability of the filtration modules must remain below the permeability threshold before the central controller 150 proceeds to step 3892. In some instances, the threshold period of time can be at least about 10 seconds. In some instances, the threshold period of time can be at least about 20 seconds. In other instances, the threshold period of time can be no more than about 60 seconds. In yet other instances, the threshold period of time can be no more than about 30 seconds. By requiring the permeability to remain below the threshold for the duration, the central controller 150 can avoid triggering a cleaning cycle in response to a transient or erroneous permeability reading. It is to be appreciated that the duration may be greater or less than the values described herein.

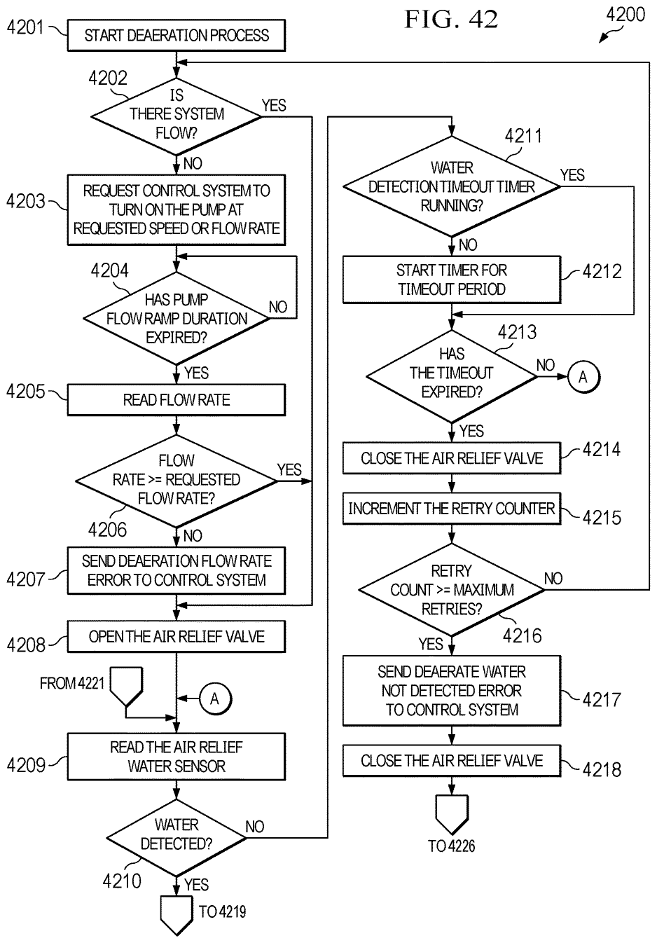

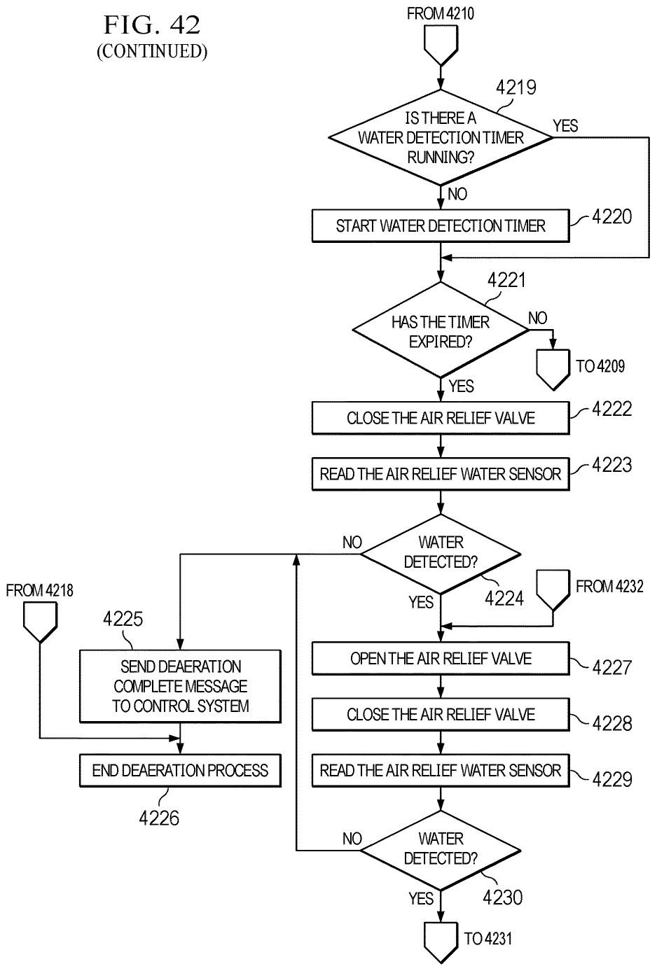

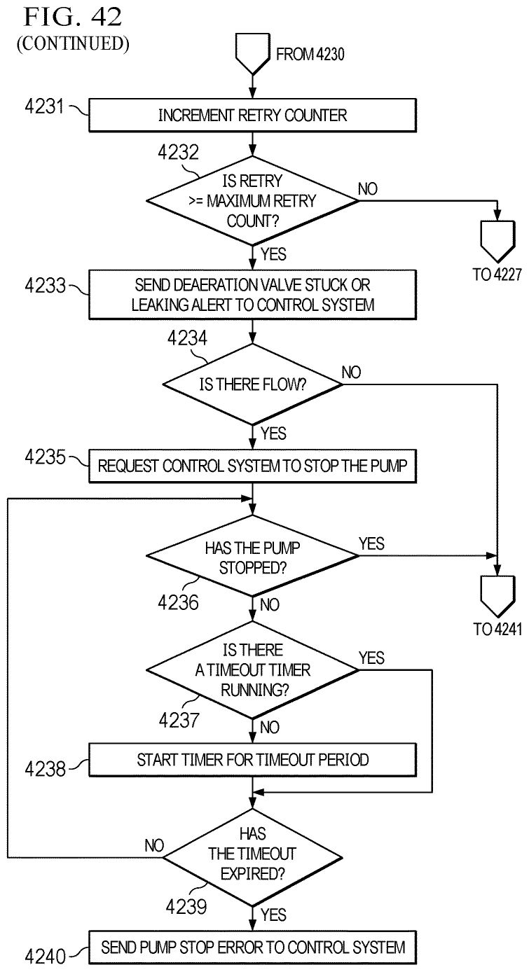

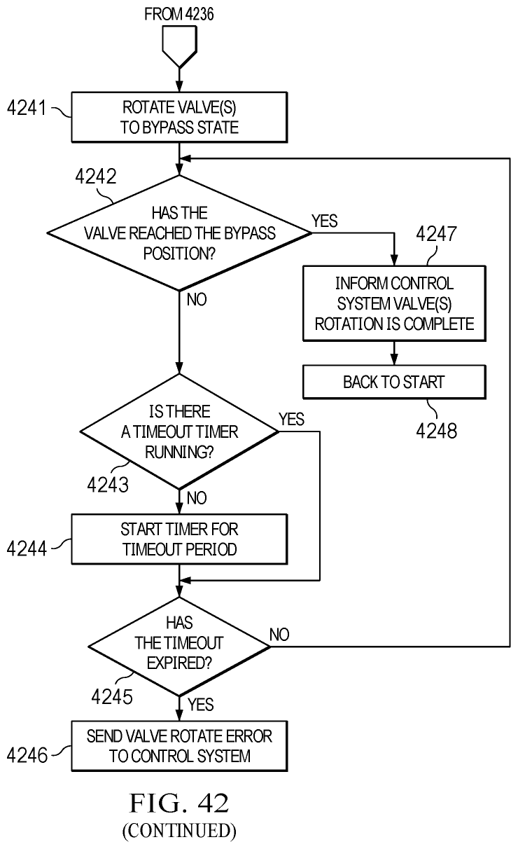

If the permeability of the filtration modules is less than the permeability threshold for the duration at step 3888, the central controller 150 also proceeds to step 3892 after completing step 3891. At step 3891, the central controller 150 may complete or implement the deaeration process (see, e.g., FIG. 42)

At step 3893, the central controller 150 determines whether the permeability of the filtration modules is less than the recovery threshold. In various instances, the recovery threshold may be imparted with a value of at least about a 10% increase over a reference permeability value, although the recovery threshold may be somewhat less or even greater than this value. For example, the recovery threshold may be imparted with a value of at least about 10%, or at least about 50%, or at least about 100%, or at least about 150%, or at least about 200%, or at least about 250%, or at least about 300%, or at least about 350%, or at least about 400%, or at least about 450%, or at least about 500%, or more. If the permeability of the filtration modules is not less than the recovery threshold, the central controller 150 proceeds to step 3894 and sets the emergency flag to false. The central controller 150 then proceeds to step 3889. If the permeability of the filtration modules is less than the recovery threshold at step 3893, the central controller 150 proceeds to step 3898.

At step 3889, the controller determines if a media load value is greater than a maximum medium load threshold. In certain instances, the media load value may be associated with the accumulated particulate burden in the prefilter and/or the membrane modules of the hybrid filter assembly. In various instances, the media load value may be determined from, among other items, analysis of the differential pressure across the prefilter and/or the membrane modules, analysis of changes in flow rates through the hybrid filter assembly, and analysis of historical data associated with the performance of the prefilter, membrane modules, or hybrid filter assembly as a whole. If the media load value is not greater than a maximum medium load threshold, then the central controller 150 proceeds to step 3890, and the method 3800 may restart. If the media load value is greater than the maximum media load value, then the central controller 150 may proceed to step 3895.

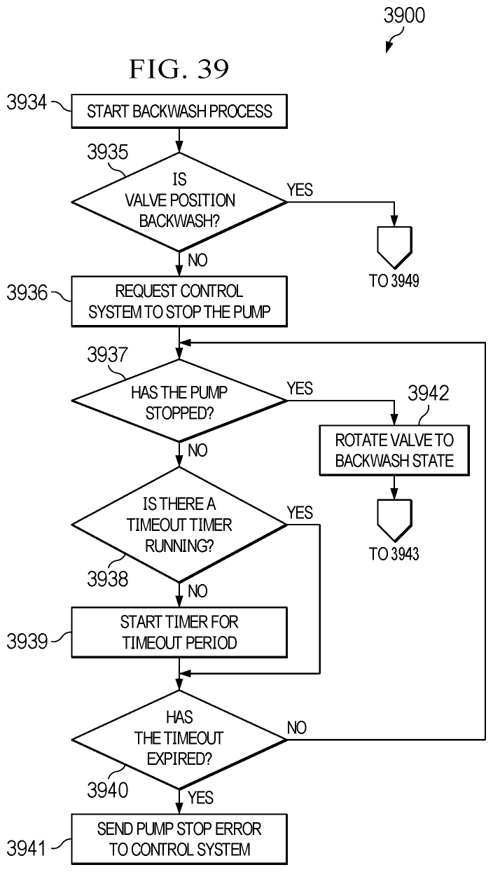

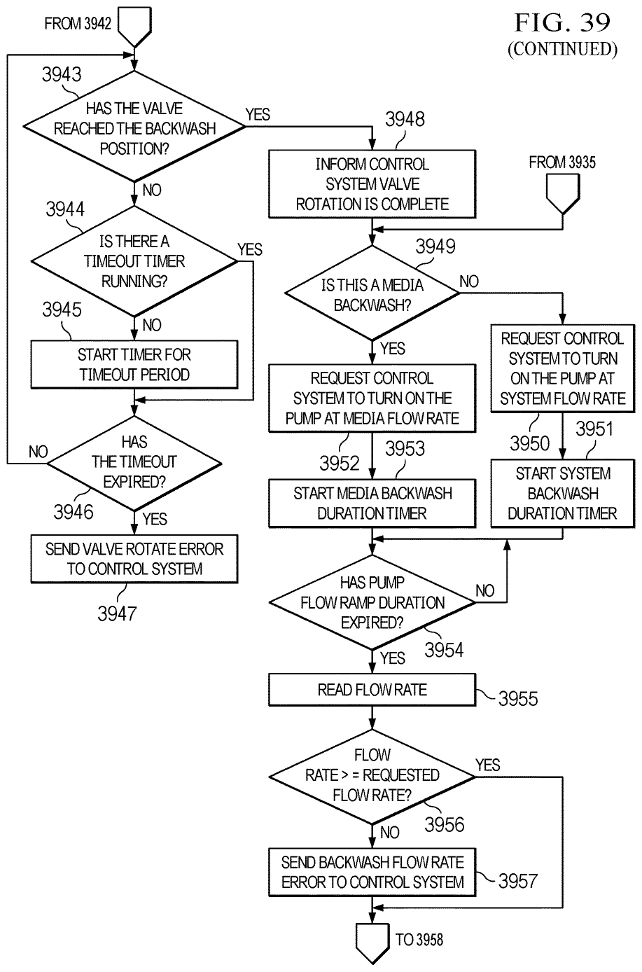

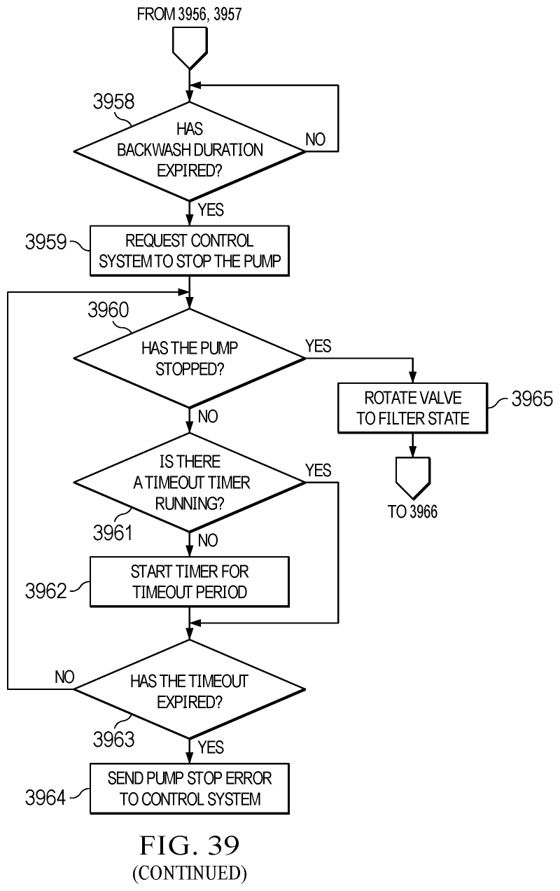

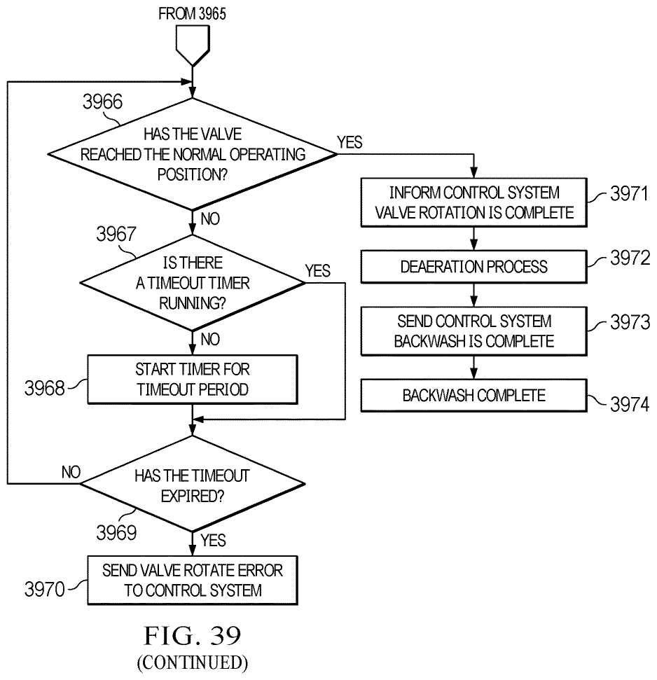

At step 3895, the central controller 150 sends a backwash message to the control system. The central controller 150 then proceeds to step 3896 and initiates the backwash process (see, e.g., FIGS. 22 and 39). The central controller 150 then proceeds to step 3897 and returns to step 3801 to restart the monitoring cycle.

At step 3898, the central controller 150 determines whether the retry count is greater than or equal to the maximum retry count. If the retry count is greater than or equal to the maximum retry count, the central controller 150 proceeds to step 3899 and returns to step 3889 to continue the main monitoring flow. In various instances, the maximum retry count may be imparted with a value of one, two, three, four, five, or more.

If the retry count is not greater than or equal to the maximum retry count at step 3898, the central controller 150 proceeds to step 3901. At step 3901, the central controller 150 sends a chemical soak message to the control system. At step 3902, the central controller 150 determines whether a start message has been received from the control system. If a start message has not been received, the central controller 150 proceeds to step 3904 and continues to the media check process.

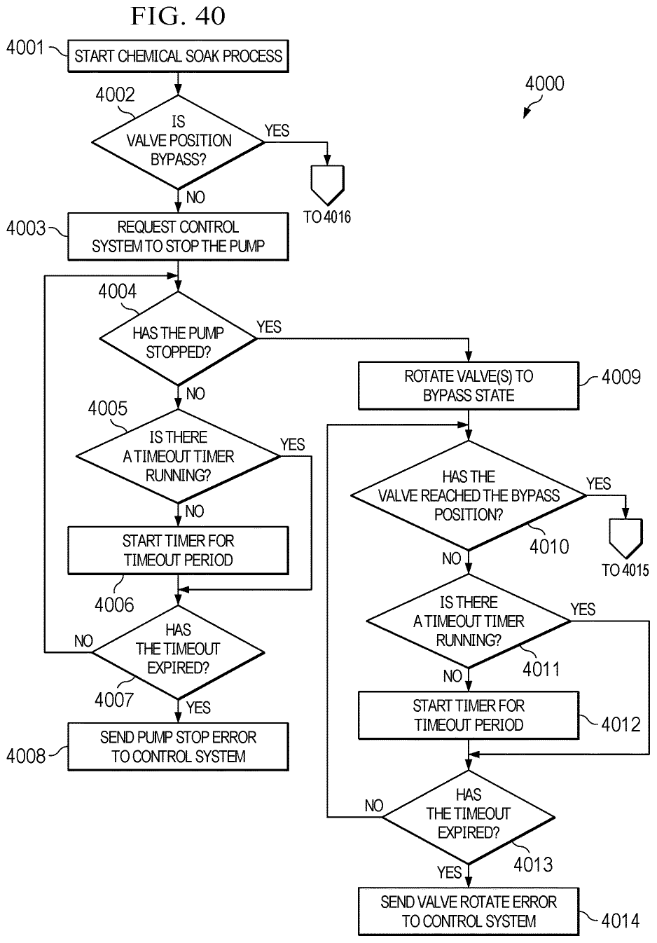

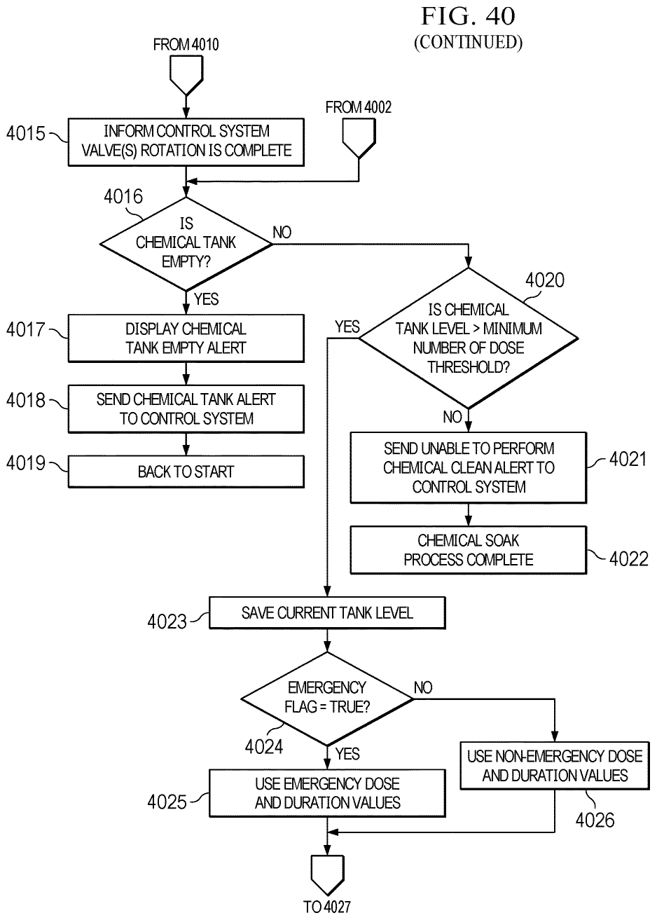

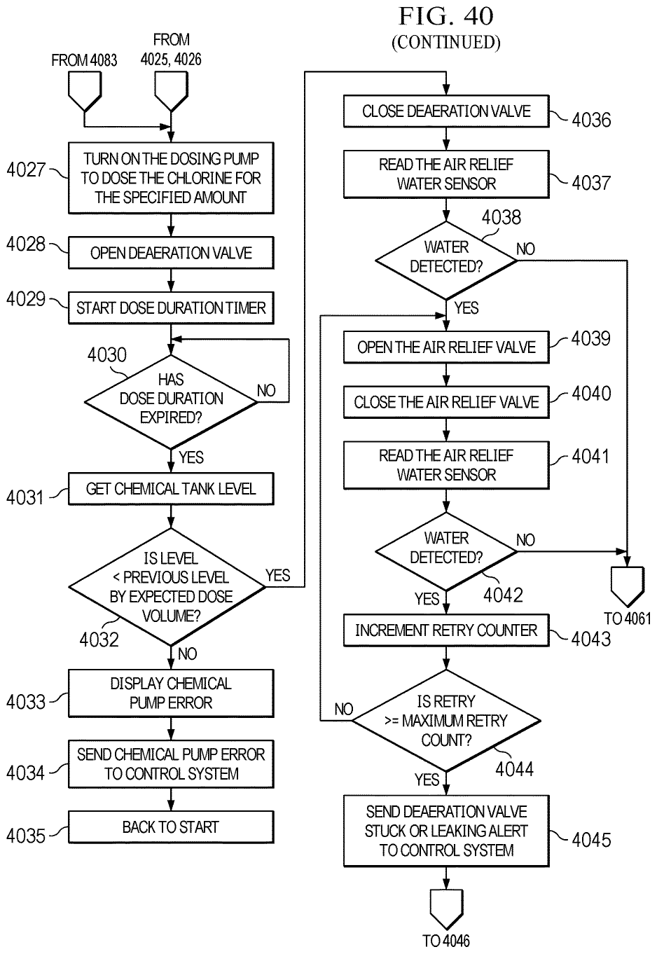

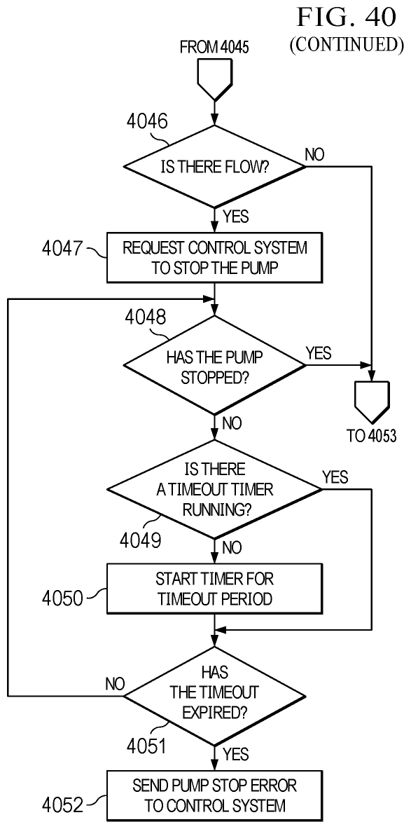

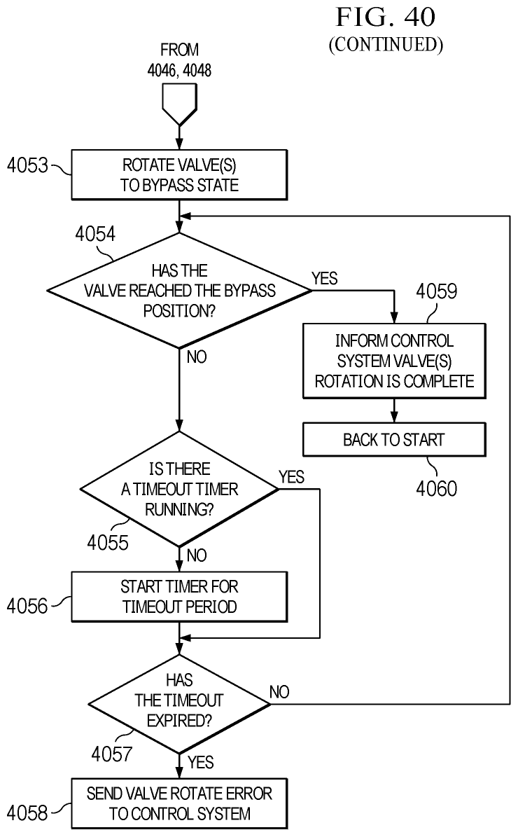

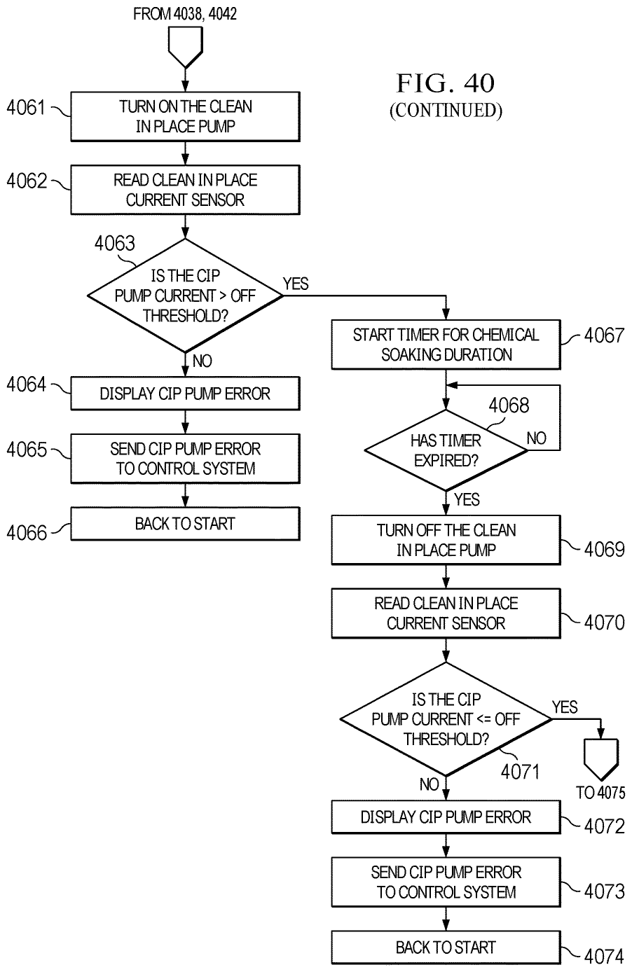

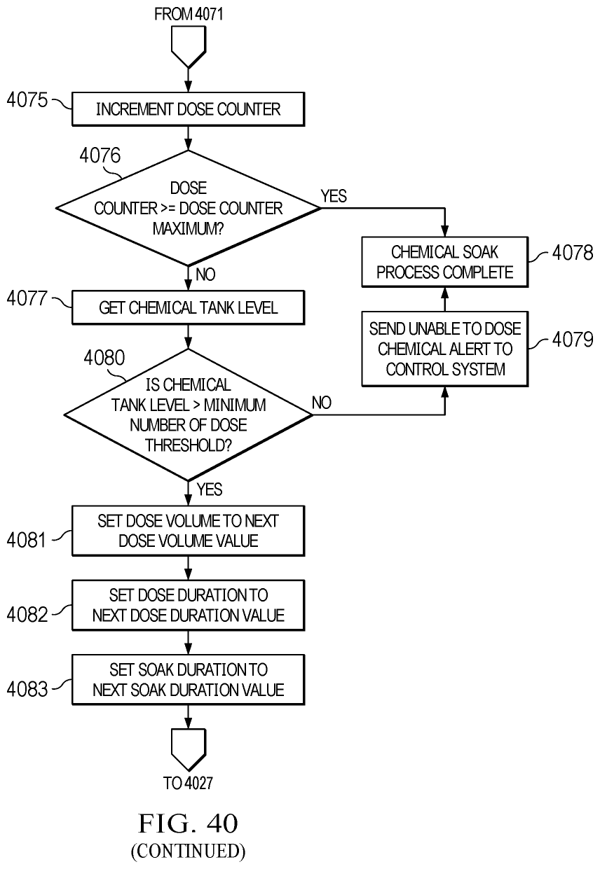

If a start message has been received at step 3902, the central controller 150 proceeds to step 3903. At step 3903, the central controller 150 determines whether the emergency flag is equal to true. If the emergency flag is not equal to true, the central controller 150 proceeds to step 3905 and initiates the backwash process (see, e.g., FIGS. 22 and 39). After step 3905 is complete, the central controller 150 proceeds to step 3906 and initiates the chemical soak process (see, e.g., FIGS. 23 and 40). After step 3906 is complete, the central controller 150 then proceeds to step 3907 and initiates another backwash process.

After steps 3905-3907 are complete, the central controller 150 proceeds to step 3908. At step 3908, the central controller 150 determines if the rinse flag is set to true. If the rinse flag is set to true, the central controller 150 then proceeds to step 3909 and initiates the module rinse process, after which the central controller 150 proceeds to step 3910. If the rinse flag is not set to true, the central controller 150 then proceeds to step 3910 and calculates the permeability.

At step 3911, the central controller 150 determines whether the permeability of the filtration modules is less than the recovery threshold. The recovery threshold used at step 3911 may be the same as, or different from, the recovery threshold discussed with respect to step 3893. If the permeability of the filtration modules is not less than the recovery threshold, the central controller 150 proceeds to step 3912 and clears the retry counter value (e.g., sets the retry counter value to zero). The central controller 150 then proceeds to step 3894, where the emergency flag is set to false. If the permeability of the filtration modules is less than the recovery threshold at step 3911, the central controller 150 proceeds to step 3913 and increments the retry counter.

At step 3914, the central controller 150 determines whether the retry count is greater than or equal to the maximum retry count. The maximum retry count may have the same value as, or be different from, the maximum retry count discussed with reference to step 3898. If the retry count is not greater than or equal to the maximum retry count, the central controller 150 proceeds to step 3915. At step 3915, the central controller 150 determines whether the permeability of the filtration modules is less than the emergency permeability recovery threshold. If the permeability of the filtration modules is not less than the emergency permeability recovery threshold, the central controller 150 proceeds to step 3916 and sets the emergency flag to false. The central controller 150 then returns to step 3901. If the permeability of the filtration modules is less than the emergency permeability recovery threshold at step 3915, the central controller 150 proceeds to step 3917 and sets the emergency flag to true. The central controller 150 then returns to step 3901.

If the retry count is greater than or equal to the maximum retry count at step 3914, the central controller 150 proceeds to step 3918 and sends a permeability recovery error to the control system. The central controller 150 then proceeds to step 3919.

At step 3919, the central controller 150 determines whether there is flow through the hybrid filter assembly. In various instances, step 3919 is reached from steps 3804, 3806, 3816, 3818, 3826, 3828, 3830, and 3918. If there is flow, the central controller 150 proceeds to step 3920 and requests the control system to stop the pump. The central controller 150 then proceeds to step 3921. At step 3921, the central controller 150 determines whether the pump has stopped. If the pump has not stopped, the central controller 150 proceeds to step 3922. At step 3922, the central controller 150 determines whether a timeout timer is already running. If a timeout timer is not running, the central controller 150 proceeds to step 3923 and starts a timer for the timeout period. The central controller 150 then proceeds to step 3924. If a timeout timer is already running at step 3922, the central controller 150 proceeds directly to step 3924. At step 3924, the central controller 150 determines whether the timeout period has expired. If the timeout period has not expired, the central controller 150 loops back to step 3924. If the timeout period has expired, the central controller 150 proceeds to step 3925 and sends a pump stop error to the control system. In various cases, the duration of the timeout period associated with the steps 3922-3924 may be the same as the duration of the timeout period associated with any of the steps 3810, 3838-3840, or 3865-3867, although the duration of the timeout period associated with the steps 3922-3924 need not be the same as the duration of the timeout period associated with any of the steps 3810, 3838-3840, or 3865-3867. For example, the timeout period associated with the steps 3922-3924 may be about 2 seconds to about 60 seconds, or more or less.

If the pump has stopped at step 3921, or if no flow is detected in the hybrid filter assembly at step 3919, the central controller 150 proceeds to step 3926. At step 3926, the central controller 150 directs the valve or valves to rotate to the bypass state. The central controller 150 then proceeds to step 3927. At step 3927, the central controller 150 determines whether the valve has reached the bypass position. If the valve has reached the bypass position, the central controller 150 proceeds to step 3932 and informs the control system that the rotation of the valve or valves is complete. The central controller 150 then proceeds to step 3933 and returns to step 3801 to restart the monitoring cycle.

If the valve has not reached the bypass position at step 3927, the central controller 150 proceeds to step 3928. At step 3928, the central controller 150 determines whether a timeout timer is already running. If a timeout timer is not running, the central controller 150 proceeds to step 3929 and starts a timer for the timeout period. The central controller 150 then proceeds to step 3930. If a timeout timer is already running at step 3928, the central controller 150 proceeds directly to step 3930. At step 3930, the central controller 150 determines whether the timeout period has expired. If the timeout period has not expired, the central controller 150 loops back to step 3930. If the timeout period has expired, the central controller 150 proceeds to step 3931 and sends a valve rotate error to the control system. In various cases, the duration of the timeout period associated with the steps 3928-3930 may be the same as the duration of the timeout period associated with any of the steps 3810, 3838-3840, 3865-3867, or 3922-3924, although the duration of the timeout period associated with the steps 3928-3930 need not be the same as the duration of the timeout period associated with any of the steps 3810, 3838-3840, 3865-3867, or 3922-3924. For example, the timeout period associated with the steps 3928-3930 may be about 2 seconds to about 60 seconds, or more or less. As an additional example, the timeout period may be less than about 30 seconds.

In some instances, any of the steps of the method 3800 may be performed more than once. Furthermore, in some instances, any of the steps of the method 3800 may be omitted depending on the instance.

Turning now to FIG. 39, a method 3900 for performing a backwash process for a hybrid filter assembly is illustrated. The method 3900 can be utilized in a pool automation system or an aquatic environment (e.g., aquatic application 100 of FIG. 1) that includes any of the hybrid filter assemblies described herein, including the hybrid filter assembly 200 of FIG. 2 and/or the hybrid filter assembly 5500 of FIG. 33A. In some instances, the method 3900 can be performed as part of the main control flow described with reference to FIG. 38, for example in response to the central controller 150 determining that a permeability value of one or more membrane filters falls below a permeability threshold value, or in response to a scheduled backwash event. In some instances, the method 3900 can be implemented as computer-readable instructions on a non-transitory medium (e.g., a random access memory, a hard drive, etc.) and executed by a processor (e.g., a CPU, a GPU, etc.). In some aspects, the method 3900 can include more or fewer steps depending on the instance.

At a step 3934, the backwash process is initiated. At a step 3935, the central controller 150 can determine whether the one or more valves (e.g., the valve 400 and/or the valve 5520) are already in the backwash position. If the one or more valves are already in the backwash position (i.e., “YES” at the step 3935), the central controller 150 can proceed directly to the step 3949 as described below, thereby bypassing the pump stop sequence. If the one or more valves are not already in the backwash position (i.e., “NO” at the step 3935), the central controller 150 can proceed to a step 3936, at which the central controller 150 can request the control system (e.g., IntelliCenter) to stop the pump (e.g., the variable speed pump 122 and/or the booster pump 123). At a step 3937, the central controller 150 can determine whether the pump has stopped. In some instances, the central controller 150 can receive a signal or data packet from the control system indicating that the pump has stopped. If the pump has not stopped (i.e., “NO” at the step 3937), the central controller 150 can determine, at a step 3938, whether a timeout timer is running. If a timeout timer is not running (i.e., “NO” at the step 3938), the central controller 150 can start a timer for a timeout period at a step 3939. If a timeout timer is already running (i.e., “YES” at the step 3938), or upon starting the timer at the step 3939, the central controller 150 can determine, at a step 3940, whether the timeout has expired. If the timeout has not expired (i.e., “NO” at the step 3940), the central controller 150 can loop back to the step 3937 to continue checking whether the pump has stopped. If the timeout has expired (i.e., “YES” at the step 3940), the central controller 150 can proceed to a step 3941, at which the central controller 150 can send a pump stop error to the control system. In some instances, the duration of the timeout period can be an adjustable value configurable via the backend. In some cases, the timeout period may be imparted with a value of about 2 seconds to about 60 seconds, or more or less.

Upon confirming that the pump has stopped (i.e., “YES” at the step 3937), the central controller 150 can proceed to a step 3942, at which the central controller 150 can rotate the one or more valves to a backwash state. At a step 3943, the central controller 150 can determine whether the one or more valves have reached the backwash position. In some instances, the central controller 150 can receive a signal or data packet from an actuator associated with the one or more valves indicating that the one or more valves have arrived at the backwash position. In some instances, the central controller 150 can be designed to receive either a signal or a data packet from the actuator to confirm that the valve has arrived at the specified location.

If the one or more valves have not yet reached the backwash position (i.e., “NO” at the step 3943), the central controller 150 can determine, at a step 3944, whether a timeout timer is running. If a timeout timer is not running (i.e., “NO” at the step 3944), the central controller 150 can start a timer for a timeout period at a step 3945. If a timeout timer is already running (i.e., “YES” at the step 3944), or upon starting the timer at the step 3945, the central controller 150 can determine, at a step 3946, whether the timeout has expired. If the timeout has not expired (i.e., “NO” at the step 3946), the central controller 150 can loop back to the step 3943 to continue checking whether the one or more valves have reached the backwash position. If the timeout has expired (i.e., “YES” at the step 3946), the central controller 150 can proceed to a step 3947, at which the central controller 150 can send a valve rotate error to the control system. In some instances, the duration of the timeout period can be an adjustable value configurable via the backend. In other instances, the timeout period associated may be set at a predetermined value (which may be configurable at the backend), where the timeout period may be about 2 seconds to about 60 seconds, or more or less. As an additional example, the timeout period may be less than about 30 seconds.

Upon confirming that the one or more valves have reached the backwash position (i.e., “YES” at the step 3943), the central controller 150 can proceed to a step 3948, at which the central controller 150 can inform the control system that valve rotation is complete. At a step 3949, the central controller 150 can determine whether the backwash process is a media backwash (e.g., a backwash of the first filtration stage including a particulate media). If the backwash process is not a media backwash (i.e., “NO” at the step 3949), the central controller 150 can proceed to a step 3950, at which the central controller 150 can request the control system to turn on the pump at a system flow rate, and then proceed to a step 3951, at which the central controller 150 can start a system backwash duration timer. In some instances, the system backwash duration timer can correspond to a system backwash maintained for a predetermined period of time of about 30 seconds to about 5 minutes, or greater or less periods of time. In some instances, the system backwash duration timer can be between about 1 minute to about 3 minutes. In some instances, the system backwash duration timer can be at least approximately 2 minutes. If the backwash process is a media backwash (i.e., “YES” at the step 3949), the central controller 150 can proceed to a step 3952, at which the central controller 150 can request the control system to turn on the pump at a media flow rate, and then proceed to a step 3953, at which the central controller 150 can start a media backwash duration timer. In some instances, the media backwash duration timer can correspond to a media backwash maintained for a predetermined period of time of about 30 seconds to about 5 minutes, or greater or less periods of time. In some instances, the media backwash duration timer can be between about 1 minute to about 3 minutes. In some instances, the media backwash duration timer can be at least approximately 2 minutes. In some instances, the system flow rate and the media flow rate can each be adjustable values configurable via the backend. In some instances, a media backwash can be performed using a higher flow rate and/or a longer duration than a standard system backwash to more aggressively dislodge particulates that have accumulated in the prefilter media (e.g., sand, glass, or diatomaceous earth) of the hybrid filter assembly.

At a step 3954, the central controller 150 can determine whether the pump flow ramp duration has expired. In some instances, the pump flow ramp duration is the period of time allotted for the pump to ramp up to the requested flow rate before the flow rate is read, thereby allowing the pump sufficient time to ramp before reading the flow rate. In various cases, the pump flow ramp duration may be imparted with a value of about 5 seconds to about 30 seconds, or greater or less periods of time. If the pump flow ramp duration has not expired (i.e., “NO” at the step 3954), the central controller 150 can loop back to continue waiting. If the pump flow ramp duration has expired (i.e., “YES” at the step 3954), the central controller 150 can proceed to a step 3955, at which the central controller 150 can read the flow rate. At a step 3956, the central controller 150 can determine whether the flow rate is greater than or equal to the requested flow rate. If the flow rate is less than the requested flow rate (i.e., “NO” at the step 3956), the central controller 150 can proceed to a step 3957, where the central controller 150 can send a backwash flow rate error to the control system. If the flow rate is meeting or exceeding the requested flow rate (i.e., “YES” at the step 3956), the central controller 150 can proceed to a step 3958, at which the central controller 150 can determine whether the backwash duration has expired. If the backwash duration has not expired (i.e., “NO” at the step 3958), the central controller 150 can loop back to the step 3955 to continue reading the flow rate and monitoring the backwash duration (e.g., the media backwash duration timer, the system backwash duration timer). If the backwash duration has expired (i.e., “YES” at the step 3958), the central controller 150 can proceed to a step 3959, at which the central controller 150 can request the control system to stop the pump.

At a step 3960, the central controller 150 can determine whether the pump has stopped. If the pump has not stopped (i.e., “NO” at the step 3960), the central controller 150 can determine, at a step 3961, whether a timeout timer is running. If a timeout timer is not running (i.e., “NO” at the step 3961), the central controller 150 can start a timeout timer for a timeout period at a step 3962. If a timeout timer is already running (i.e., “YES” at the step 3961), or upon starting the timeout timer at the step 3962, the central controller 150 can determine, at a step 3963, whether the timeout period has expired. If the timeout period has not expired (i.e., “NO” at the step 3963), the central controller 150 can loop back to the step 3960 to continue checking whether the pump has stopped. If the timeout period has expired (i.e., “YES” at the step 3963), the central controller 150 can proceed to a step 3964, where the central controller 150 can send a pump stop error to the control system. In some instances, the duration of the timeout period can be an adjustable value configurable via the backend. In other instances, the timeout period associated may be set at a predetermined value (which may be configurable at the backend), where the timeout period may be about 2 seconds to about 60 seconds, or more or less. As an additional example, the timeout period may be less than about 30 seconds.

Upon confirming that the pump has stopped (i.e., “YES” at the step 3960), the central controller 150 can proceed to a step 3965, at which the central controller 150 can rotate the one or more valves to a filtration state. At a step 3966, the central controller 150 can determine whether the one or more valves have reached the normal operating position. If the one or more valves have not reached the normal operating position (i.e., “NO” at the step 3966), the central controller 150 can determine, at a step 3967, whether a timeout timer is running. If a timeout timer is not running (i.e., “NO” at the step 3967), the central controller 150 can start a timer for a timeout period at a step 3968. If a timeout timer is already running (i.e., “YES” at the step 3967), or upon starting the timer at the step 3968, the central controller 150 can determine, at a step 3969, whether the timeout has expired. If the timeout has not expired (i.e., “NO” at the step 3969), the central controller 150 can loop back to the step 3966 to continue checking whether the one or more valves have reached the normal operating position. If the timeout has expired (i.e., “YES” at the step 3969), the central controller 150 can proceed to a step 3970, at which the central controller 150 can send a valve rotate error to the control system. In some instances, the duration of the timeout period can be an adjustable value configurable via the backend. In other instances, the timeout period associated may be set at a predetermined value (which may be configurable at the backend), where the timeout period may be about 2 seconds to about 60 seconds, or more or less. As an additional example, the timeout period may be less than about 30 seconds.

Upon confirming that the one or more valves have reached the normal operating position (i.e., “YES” at the step 3966), the central controller 150 can proceed to a step 3971, at which the central controller 150 can inform the control system that valve rotation is complete. At a step 3972, the central controller 150 can send a “Backwash Complete” or similar message to the control system. At a step 3973, the method 3900 can proceed to the deaeration process as described with reference to FIG. 42. At a step 3974, the backwash process is complete.

In some instances, any of the steps of the method 3900 may be performed more than once. Furthermore, in some instances, any of the steps of the method 3900 may be omitted depending on the instance.

Turning now to FIG. 40, a method 4000 for performing a chemical soak process for a hybrid filter assembly is illustrated. The method 4000 can be utilized in a pool automation system or an aquatic environment (e.g., aquatic application 100 of FIG. 1) that includes any of the hybrid filter assemblies described herein, including the hybrid filter assembly 200 of FIG. 2 and/or the hybrid filter assembly 5500 of FIG. 33A. In some instances, the method 4000 can be performed as part of the main control flow described with reference to FIG. 38, for example, in response to the central controller 150 determining that a permeability value of the one or more membrane filters remains below a permeability threshold value following completion of the backwash process described with reference to FIG. 39. In some instances, the method 4000 can be implemented as computer-readable instructions on a non-transitory medium (e.g., a random access memory, a hard drive, etc.) and executed by a processor (e.g., a CPU, a GPU, etc.). In some aspects, the method 4000 can include more or fewer steps depending on the instance.

At a step 4001, the chemical soak process is initiated. At a step 4002, the central controller 150 can determine whether the one or more valves (e.g., the valve 400 and/or the valve 5520) are already in the bypass position. If the one or more valves are already in the bypass position (i.e., “YES” at the step 4002), the central controller 150 can proceed directly to step 4016 as described below, thereby bypassing the pump stop and valve rotation sequence. If the one or more valves are not already in the bypass position (i.e., “NO” at the step 4002), the central controller 150 can proceed to a step 4003, at which the central controller 150 can request the control system (e.g., IntelliCenter) to stop the pump (e.g., the variable speed pump 122 and/or the booster pump 123). At a step 4004, the central controller 150 can determine whether the pump has stopped. In some instances, the central controller 150 can receive a signal or data packet from the control system indicating that the pump has stopped. If the pump has not stopped (i.e., “NO” at the step 4004), the central controller 150 can determine, at a step 4005, whether a timeout timer is running. If a timeout timer is not running (i.e., “NO” at the step 4005), the central controller 150 can start a timer for a timeout period at a step 4006. If a timeout timer is already running (i.e., “YES” at the step 4005), or upon starting the timer at the step 4006, the central controller 150 can determine, at a step 4007, whether the timeout has expired. If the timeout has not expired (i.e., “NO” at the step 4007), the central controller 150 can loop back to the step 4004 to continue checking whether the pump has stopped. If the timeout has expired (i.e., “YES” at the step 4007), the central controller 150 can proceed to a step 4008, at which the central controller 150 can send a pump stop error to the control system. In some instances, the duration of the timeout period can be an adjustable value configurable via the backend. In other instances, the timeout period associated may be set at a predetermined value (which may be configurable at the backend), where the timeout period may be about 2 seconds to about 60 seconds, or more or less. As an additional example, the timeout period may be less than about 30 seconds.

Upon confirming that the pump has stopped (i.e., “YES” at the step 4004), the central controller 150 can proceed to a step 4009, at which the central controller 150 can rotate the one or more valves to a bypass state. At a step 4010, the central controller 150 can determine whether the one or more valves have reached the bypass position. In some instances, the central controller 150 can receive a signal or data packet from an actuator associated with the one or more valves indicating that the one or more valves have arrived at the bypass position. In some instances, the central controller 150 can be designed to receive either a signal or a data packet from the actuator to confirm that the valve has arrived at the specified location. If the one or more valves have not yet reached the bypass position (i.e., “NO” at the step 4010), the central controller 150 can determine, at a step 4011, whether a timeout timer is running. If a timeout timer is not running (i.e., “NO” at the step 4011), the central controller 150 can start a timeout timer for a timeout period at a step 4012. If a timeout timer is already running (i.e., “YES” at the step 4011), or upon starting the timeout timer at the step 4012, the central controller 150 can determine, at a step 4013, whether the timeout period has expired. If the timeout period has not expired (i.e., “NO” at the step 4013), the central controller 150 can loop back to the step 4010 to continue checking whether the one or more valves have reached the bypass position. If the timeout period has expired (i.e., “YES” at the step 4013), the central controller 150 can proceed to a step 4014, at which the central controller 150 can send a valve rotate error to the control system. In some instances, the duration of the timeout period can be an adjustable value configurable via the backend. In other instances, the timeout period associated may be set at a predetermined value (which may be configurable at the backend), where the timeout period may be about 2 seconds to about 60 seconds, or more or less. As an additional example, the timeout period may be less than about 30 seconds.

Upon confirming that the one or more valves have reached the bypass position (i.e., “YES” at the step 4010), the central controller 150 can proceed to a step 4015, at which the central controller 150 can inform the control system that valve rotation is complete. At a step 4016, the central controller 150 can determine whether the chemical tank or reservoir is empty. If the chemical tank is empty (i.e., “YES” at the step 4016), the central controller 150 can proceed to a step 4017, at which the central controller 150 can display a chemical tank empty alert and send a chemical tank alert to the control system, which in turn may provide the alert to a remote location (e.g., a user device). At a step 4017, a chem tank empty alert can be displayed if the chem tank is empty (i.e., “YES” at the step 4016). At a step 4018, the central controller 150 can transmit an alert to a control system. Then, the central controller 150 can proceed to step 4019, where the method 4000 may begin again.

If the chemical tank is not empty (i.e., “NO” at the step 4016), the central controller 150 can proceed to a step 4020, at which the central controller 150 can determine whether the chemical tank level is greater than the minimum dose threshold. If the chemical tank level is not greater than the minimum threshold (i.e., “NO” at the step 4020), the central controller 150 can proceed to a step 4021, at which the central controller 150 can send an alert indicating that the central controller 150 is unable to perform a chemical cleaning of the hybrid filter assembly, and then proceed to a step 4022, where the chemical soak process is complete. If the chemical tank level is greater than the minimum dose threshold (i.e., “YES” at the step 4020), the central controller 150 can proceed to a step 4023, where the central controller 150 can save the current tank level for use as a reference during subsequent dose verification checks.

At a step 4024, the central controller 150 can determine whether an emergency flag is true. In some instances, the emergency flag can be set by the central controller 150 in response to a determination that the permeability value of the one or more membrane filters has fallen below an emergency permeability threshold (e.g., a value indicating a reduction in membrane performance that warrants a more aggressive cleaning response). If the emergency flag is true (i.e., “YES” at the step 4024), the central controller 150 can proceed to a step 4025, at which the central controller 150 can use emergency dose and duration values for the chemical soak process. If the emergency flag is not true (i.e., “NO” at the step 4024), the central controller 150 can proceed to a step 4026, at which the central controller 150 can use non-emergency dose and duration values for the chemical soak process. In some instances, the emergency dose and duration values can be higher than the non-emergency dose and duration values to provide a more aggressive chemical cleaning. Following the step 4025 or the step 4026, the central controller 150 can proceed to a step 4027.

In some instances, the emergency dose volume can be between about 350 milliliters to about 500 milliliters of the chemical cleaning agent, although the emergency dose volume value may be somewhat less or even greater than these values. In some instances, the emergency dose volume value may be imparted with a value of at least about 300 milliliters, or at least about 350 milliliters, or at least about 400 milliliters, or at least about 450 milliliters, or at least about 500 milliliters. Similarly, the non-emergency dose volume value can be between about 200 milliliters to about 450 milliliters of the chemical cleaning agent, although the non-emergency dose volume value may be somewhat less or even greater than these values. In some instances, the non-emergency dose volume value may be imparted with a value of at least about 100 milliliters, or at least about 150 milliliters, or at least about 200 milliliters, or at least about 250 milliliters, or at least about 275 milliliters, or at least about 300 milliliters, or at least about 350 milliliters, or at least about 400 milliliters. In various instances, the dose duration may be imparted with a value of about 60 seconds to about 5 minutes, although the dose duration may be less than or greater than these values.

It is to be appreciated that, as previously described, the dose volumes may be temperature-adjusted. Further, the dose volumes may also be adjusted based on the strength or concentration of the chemical cleaning agent to be applied.

At a step 4027, the central controller 150 can turn on the dosing pump to dose the chemical cleaning agent (e.g., a chlorine solution such as a sodium hypochlorite solution) to the one or more membrane filters (e.g., to the second filtration stage) for the specified dose amount. At a step 4028, the central controller 150 can open the deaeration valve. At a step 4029, the central controller 150 can start the dose duration timer. At a step 4030, the central controller 150 can determine whether the dose duration has expired. If the dose duration has not expired (i.e., “NO” at the step 4030), the central controller 150 can loop back to the step 4030 to continue waiting until the dose duration has expired. Upon expiration of the dose duration (i.e., “YES” at the step 4030), the central controller 150 can proceed to a step 4031, at which the central controller 150 can obtain the current chemical tank level. At a step 4032, the central controller 150 can determine whether the current chemical tank level is less than the previous level by the expected dose volume, thereby verifying that the dosing pump has successfully delivered the expected volume of chemical cleaning agent. If the chemical tank level is not less than the previous level by the expected dose volume (i.e., “NO” at the step 4032), the central controller 150 can proceed to a step 4033, where the central controller 150 can display a chemical pump error, and then proceed to a step 4034, where the central controller 150 can send a chemical pump error to the control system. The control system may in turn provide the error information to a remote location, such as a user device. At a step 4035, the central controller 150 can loop back to the step 4032 to recheck the chemical tank level.

If the chemical tank level is less than the previous level by the expected dose volume (i.e., “YES” at the step 4032), the central controller 150 can proceed to a step 4036, at which the central controller 150 can close the deaeration valve. At a step 4037, the central controller 150 can read the air relief water sensor. At a step 4038, the central controller 150 can determine whether water has been detected at the air relief water sensor. If water has not been detected (i.e., “NO” at the step 4038), the central controller 150 can proceed directly to the step 4061 as described below. If water has been detected (i.e., “YES” at the step 4038), the central controller 150 can proceed to a step 4039, at which the central controller 150 can open the air relief valve. At a step 4040, the central controller 150 can close the air relief valve. At a step 4041, the central controller 150 can read the air relief water sensor again. At a step 4042, the central controller 150 can determine whether water has been detected. If water has not been detected (i.e., “NO” at the step 4042), the central controller 150 can proceed directly to the step 4061 as described below. If water has been detected (i.e., “YES” at the step 4042), the central controller 150 can proceed to a step 4043, at which the central controller 150 can increment the retry counter. At a step 4044, the central controller 150 can determine whether the retry counter is greater than or equal to the maximum retry count. If the retry counter is greater than or equal to the maximum retry count (i.e., “YES” at the step 4044), the central controller 150 can proceed to a step 4045, at which the central controller 150 can send a deaeration valve stuck or leaking alert to the control system, and then proceed to a step 4046. If the retry counter is not greater than or equal to the maximum retry count (i.e., “NO” at the step 4044), the central controller 150 can also proceed to the step 4046. In various cases, the maximum retry count may be imparted with a value of one, two, three, four, five, or more.

At the step 4046, the central controller 150 can determine whether there is fluid flowing through the hybrid filter assembly. If there is fluid flow (i.e., “YES” at the step 4046), the central controller 150 can proceed to a step 4047, at which the central controller 150 can request the control system to stop the pump. At a step 4048, the central controller 150 can determine whether the pump has stopped. If the pump has not stopped (i.e., “NO” at the step 4048), the central controller 150 can determine, at a step 4049, whether a timeout timer is running. If a timeout timer is not running (i.e., “NO” at the step 4049), the central controller 150 can start a timer for a timeout period at a step 4050. If a timeout timer is already running (i.e., “YES” at the step 4049), or upon starting the timer at the step 4050, the central controller 150 can determine, at a step 4051, whether the timeout period has expired. In various cases, the timeout period may be imparted with a value of about 2 seconds to about 60 seconds, or greater or smaller periods of time. If the timeout period has not expired (i.e., “NO” at the step 4051), the central controller 150 can loop back to the step 4048 to continue checking whether the pump has stopped. If the timeout period has expired (i.e., “YES” at the step 4051), the central controller 150 can proceed to a step 4052, at which the central controller 150 can send a pump stop error to the control system.

Upon confirming that the pump has stopped (i.e., “YES” at the step 4048), or if there is no system flow (i.e., “NO” at the step 4046), the central controller 150 can proceed to a step 4053, at which the central controller 150 can rotate the one or more valves to a bypass state. At a step 4054, the central controller 150 can determine whether the one or more valves have reached the bypass position. If the one or more valves have not reached the bypass position (i.e., “NO” at the step 4054), the central controller 150 can determine, at a step 4055, whether a timeout timer is running. If a timeout timer is not running (i.e., “NO” at the step 4055), the central controller 150 can start a timeout timer for a timeout period at a step 4056. If a timeout timer is already running (i.e., “YES” at the step 4055), or upon starting the timeout timer at the step 4056, the central controller 150 can determine, at a step 4057, whether the timeout period has expired. In various cases, the timeout period may be imparted with a value of about 2 seconds to about 60 seconds (e.g., about 30 seconds or less), or greater or smaller periods of time. If the timeout period has not expired (i.e., “NO” at the step 4057), the central controller 150 can loop back to the step 4054 to continue checking whether the one or more valves have reached the bypass position. If the timeout period has expired (i.e., “YES” at the step 4057), the central controller 150 can proceed to a step 4058, at which the central controller 150 can send a valve rotate error to the control system. Upon confirming that the one or more valves have reached the bypass position (i.e., “YES” at the step 4054), the central controller 150 can proceed to a step 4059, at which the central controller 150 can inform the control system that valve rotation is complete. At a step 4060, the central controller 150 can loop back to the start of the chemical soak process at the step 4001.

At the step 4061, the central controller 150 can turn on the clean-in-place (CIP) pump to circulate the chemical cleaning agent through the one or more membrane filters during the soak period. At a step 4062, the central controller 150 can read the CIP pump current sensor. At a step 4063, the central controller 150 can determine whether the CIP pump current is greater than the off threshold, thereby confirming that the CIP pump is operating correctly. If the CIP pump current is not greater than the off threshold (i.e., “NO” at the step 4063), the central controller 150 can proceed to a step 4064, at which the central controller 150 can display a CIP pump error, and then proceed to a step 4065, at which the central controller 150 can send a CIP pump error to the control system. In some cases, the control system may provide the error notification to a remote location, such as a user device. At a step 4066, the central controller 150 can loop back to the start of the chemical soak process at the step 4001.

If the CIP pump current is greater than the off threshold (i.e., “YES” at the step 4063), the central controller 150 can proceed to a step 4067, at which the central controller 150 can start a chemical soaking duration timer for the chemical soaking duration. In some instances, the chemical soaking duration timer can correspond to a duration for which the CIP pump actively circulates the chemical cleaning agent within the one or more membrane filters during the chemical soak process. In some instances, the chemical soaking duration timer can be set to a value of between about 30 minutes to about 2 hours, although the chemical soaking duration timer may be somewhat less or even greater than these values. In some instances, the chemical soaking duration timer can be set to a value of at least about 30 minutes, or at least about 45 minutes, or at least about 1 hour, or at least about 1.5 hours, or at least about 2 hours. In some instances, the chemical soaking duration timer can be set to at least approximately 60 minutes. In some instances, the chemical soaking duration timer can be an adjustable value configurable by a technician, for example, via the backend or a user interface in communication with the central controller 150. In some instances, the chemical soaking duration timer can be the soak duration value set at step 4083, which can differ depending on whether the emergency flag is true at step 4024. For example, a longer chemical soaking duration timer can be used for an emergency chemical soak than for a non-emergency chemical soak.

At a step 4068, the central controller 150 can determine whether the chemical soaking duration timer has expired. If the chemical soaking duration timer has not expired (i.e., “NO” at the step 4068), the central controller 150 can loop back to continue waiting. Upon expiration of the chemical soaking duration timer (i.e., “YES” at the step 4068), the central controller 150 can proceed to a step 4069, at which the central controller 150 can turn off the CIP pump. At a step 4070, the central controller 150 can read the CIP pump current sensor. At a step 4071, the central controller 150 can determine whether the CIP pump current is less than or equal to the off threshold, thereby confirming that the CIP pump has successfully turned off. If the CIP pump current is not less than or equal to the off threshold (i.e., “NO” at the step 4071), the central controller 150 can proceed to a step 4072, at which the central controller 150 can display a CIP pump error, and then proceed to a step 4073, at which the central controller 150 can send a CIP pump error to the control system. At a step 4074, the central controller 150 can loop back to the step 4071 to continue checking the CIP pump current.

If the CIP pump current is less than or equal to the off threshold (i.e., “YES” at the step 4071), the central controller 150 can proceed to a step 4075, at which the central controller 150 can increment the dose counter. At a step 4076, the central controller 150 can determine whether the dose counter is greater than or equal to the dose counter maximum. In some instances, the dose counter maximum may be set at a value of one, two, three, four, five, or more. If the dose counter is greater than or equal to the dose counter maximum (i.e., “YES” at the step 4076), the central controller 150 can proceed to a step 4078, at which the chemical soak process is complete. If the dose counter is not greater than or equal to the dose counter maximum (i.e., “NO” at the step 4076), the central controller 150 can proceed to a step 4077, at which the central controller 150 can obtain the current chemical tank level. At a step 4080, the central controller 150 can determine whether the chemical tank level is greater than or equal to the minimum dose threshold. If the chemical tank level is not greater than or equal to the minimum dose threshold (i.e., “NO” at the step 4080), the central controller 150 can proceed to a step 4079, where the central controller 150 can send an alert to the control system indicating the central controller 150 is unable to dose a chemical, and then proceed to the step 4078, at which the chemical soak process is complete. If the chemical tank level is greater than or equal to the minimum dose threshold (i.e., “YES” at the step 4080), the central controller 150 can proceed to the steps 4081, 4082, 4083 to set the dose volume, dose duration, and soak duration values for the next dosing cycle, and then proceed to the step 4027 to begin the next dosing cycle.

In some instances, any of the steps of the method 4000 may be performed more than once. Furthermore, in some instances, any of the steps of the method 4000 may be omitted depending on the instance.

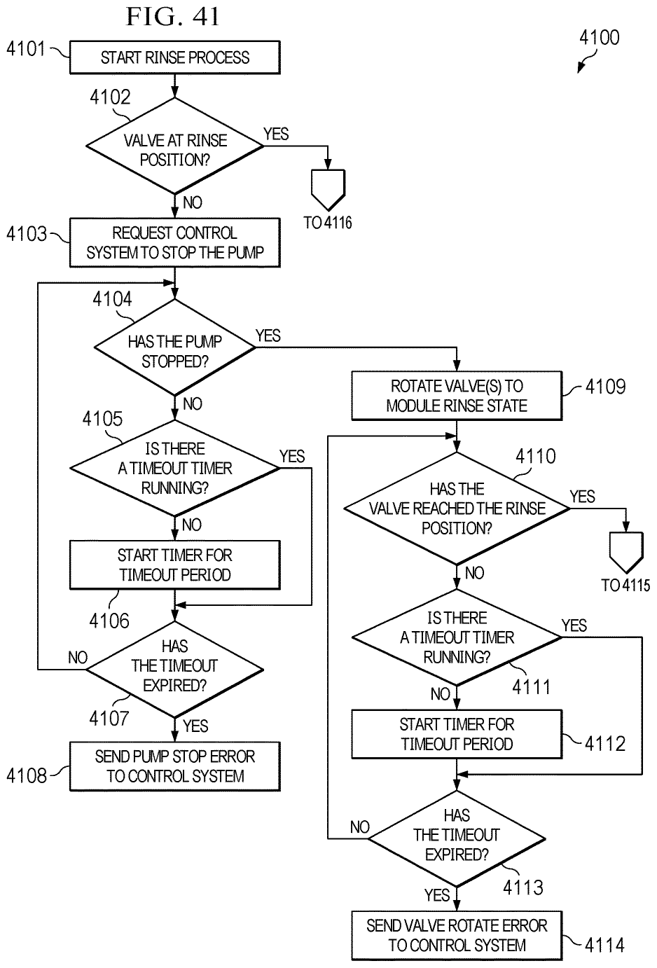

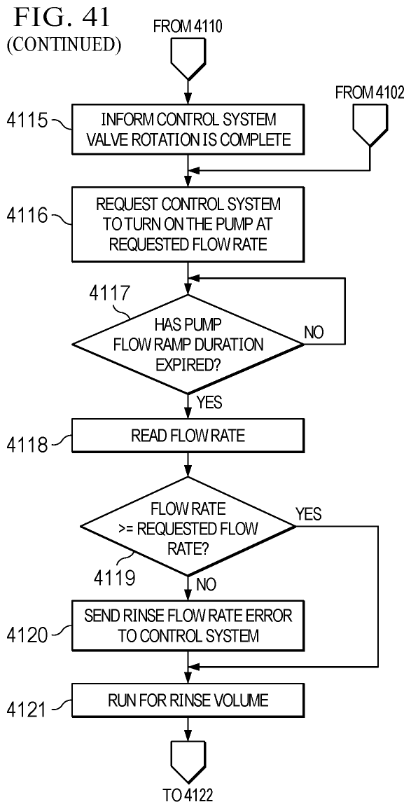

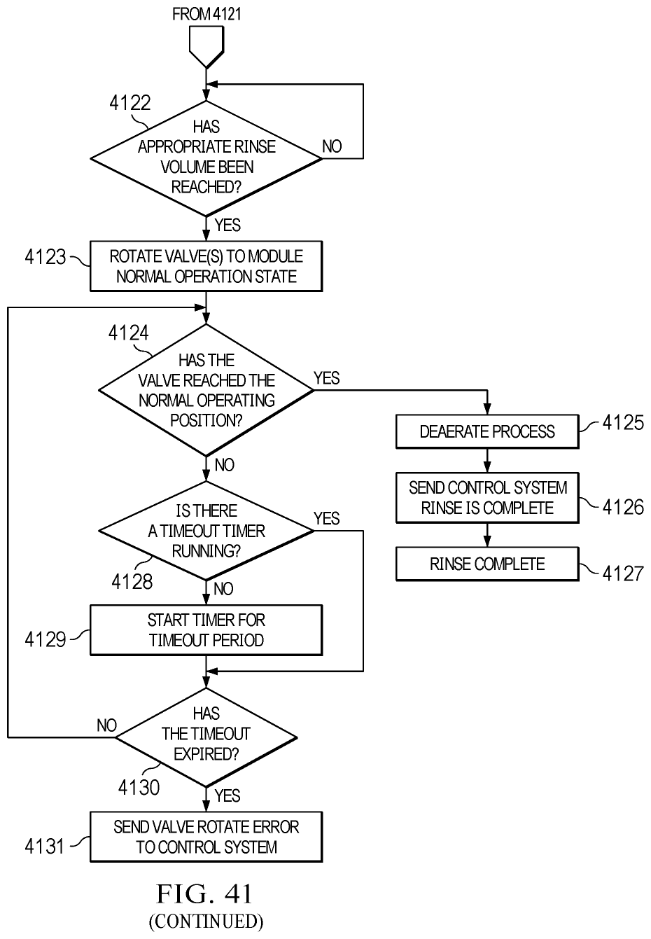

Turning now to FIG. 41, a method 4100 for performing a rinse process for a hybrid filter assembly is illustrated. The method 4100 can be utilized in a pool automation system or an aquatic environment (e.g., aquatic application 100 of FIG. 1) that includes any of the hybrid filter assemblies described herein, including the hybrid filter assembly 200 of FIG. 2 and/or the hybrid filter assembly 5500 of FIG. 33A. In some instances, the method 4100 can be performed as part of the main control flow described with reference to FIG. 38, for example, following completion of the chemical soak process described with reference to FIG. 40. In some instances, the method 4100 can be implemented as computer-readable instructions on a non-transitory medium (e.g., a random access memory, a hard drive, etc.) and executed by a processor (e.g., a CPU, a GPU, etc.). In some aspects, the method 4100 can include more or fewer steps depending on the instance. At a step 4101, the rinse process is initiated. At a step 4102, the central controller 150 can determine whether the one or more valves (e.g., the valve 400 and/or the valve 5520) are already in the rinse position. If the one or more valves are already in the rinse position (i.e., “YES” at the step 4102), the central controller 150 can proceed directly to the step 4115 as described below, thereby bypassing the pump stop and valve rotation sequence. If the one or more valves are not already in the rinse position (i.e., “NO” at the step 4102), the central controller 150 can proceed to a step 4103, at which the central controller 150 can request the control system (e.g., IntelliCenter) to stop the pump (e.g., the variable speed pump 122 and/or the booster pump 123). At a step 4104, the central controller 150 can determine whether the pump has stopped. In some instances, the central controller 150 can receive a signal or data packet from the control system indicating that the pump has stopped. If the pump has not stopped (i.e., “NO” at the step 4104), the central controller 150 can determine, at a step 4105, whether a timeout timer is running. If a timeout timer is not running (i.e., “NO” at the step 4105), the central controller 150 can start a timer for a timeout period at a step 4106. If a timeout timer is already running (i.e., “YES” at the step 4105), or upon starting the timer at the step 4106, the central controller 150 can determine, at a step 4107, whether the timeout has expired. If the timeout has not expired (i.e., “NO” at the step 4107), the central controller 150 can loop back to the step 4104 to continue checking whether the pump has stopped. If the timeout has expired (i.e., “YES” at the step 4107), the central controller 150 can proceed to a step 4108, at which the central controller 150 can send a pump stop error to the control system. In some instances, the duration of the timeout period can be an adjustable value configurable via the backend.

Upon confirming that the pump has stopped (i.e., “YES” at the step 4104), the central controller 150 can proceed to a step 4109, at which the central controller 150 can rotate the one or more valves to a module rinse state. At a step 4110, the central controller 150 can determine whether the one or more valves have reached the rinse position. In some instances, the central controller 150 can receive a signal or data packet from an actuator associated with the one or more valves indicating that the one or more valves have arrived at the rinse position. In some instances, the central controller 150 can be designed to receive either a signal or a data packet from the actuator to confirm that the valve has arrived at the specified location. If the one or more valves have not yet reached the rinse position (i.e., “NO” at the step 4110), the central controller 150 can determine, at a step 4111, whether a timeout timer is running. If a timeout timer is not running (i.e., “NO” at the step 4111), the central controller 150 can start a timer for a timeout period at a step 4112. If a timeout timer is already running (i.e., “YES” at the step 4111), or upon starting the timer at the step 4112, the central controller 150 can determine, at a step 4113, whether the timeout has expired. If the timeout has not expired (i.e., “NO” at the step 4113), the central controller 150 can loop back to the step 4110 to continue checking whether the one or more valves have reached the rinse position. If the timeout has expired (i.e., “YES” at the step 4113), the central controller 150 can proceed to a step 4114, at which the central controller 150 can send a valve rotate error to the control system. In some instances, the duration of the timeout period can be an adjustable value configurable via the backend.

Upon confirming that the one or more valves have reached the rinse position (i.e., “YES” at the step 4110), the central controller 150 can proceed to a step 4115, at which the central controller 150 can inform the control system that valve rotation is complete. At a step 4116, the central controller 150 can request the control system to turn on the pump at a requested rinse flow rate. In some instances, the requested rinse flow rate can be an adjustable value configurable via the backend. At a step 4117, the central controller 150 can determine whether the pump flow ramp duration has expired. In some instances, the pump flow ramp duration is the period of time allotted for the pump to ramp up to the requested flow rate before the flow rate is read, thereby allowing the pump sufficient time to ramp before reading the flow rate. If the pump flow ramp duration has not expired (i.e., “NO” at the step 4117), the central controller 150 can loop back to the step 4117 to continue waiting. If the pump flow ramp duration has expired (i.e., “YES” at the step 4117), the central controller 150 can proceed to a step 4118, at which the central controller 150 can read the flow rate.

At a step 4119, the central controller 150 can determine whether the flow rate is greater than or equal to the requested rinse flow rate. If the flow rate is not meeting the requested rinse flow rate (i.e., “NO” at the step 4119), the central controller 150 can proceed to a step 4120, at which the central controller 150 can send a rinse flow rate error to the control system. Upon sending the rinse flow rate error at the step 4120, or if the flow rate is meeting or exceeding the requested rinse flow rate (i.e., “YES” at the step 4119), the central controller 150 can proceed to a step 4121, at which the central controller 150 can run the rinse for the specified rinse volume. In some instances, the rinse volume can be an adjustable value configurable via the backend. At a step 4122, the central controller 150 can determine whether the appropriate rinse volume has been reached. If the rinse volume has not been reached (i.e., “NO” at the step 4122), the central controller 150 can loop back to the step 4121 to continue running the rinse. If the rinse volume has been reached (i.e., “YES” at the step 4122), the central controller 150 can proceed to a step 4123, at which the central controller 150 can rotate the one or more valves to the module normal operation state.

At a step 4124, the central controller 150 can determine whether the one or more valves have reached the normal operating position. If the one or more valves have not reached the normal operating position (i.e., “NO” at the step 4124), the central controller 150 can determine, at a step 4128, whether a timeout timer is running. If a timeout timer is not running (i.e., “NO” at the step 4128), the central controller 150 can start a timer for a timeout period at a step 4129. If a timeout timer is already running (i.e., “YES” at the step 4128), or upon starting the timer at the step 4129, the central controller 150 can determine, at a step 4130, whether the timeout has expired. If the timeout has not expired (i.e., “NO” at the step 4130), the central controller 150 can loop back to the step 4124 to continue checking whether the one or more valves have reached the normal operating position. If the timeout has expired (i.e., “YES” at the step 4130), the central controller 150 can proceed to a step 4131, at which the central controller 150 can send a valve rotate error to the control system. In some instances, the duration of the timeout period can be an adjustable value configurable via the backend.

Upon confirming that the one or more valves have reached the normal operating position (i.e., “YES” at the step 4124), the central controller 150 can proceed to a step 4125, at which the central controller 150 can initiate the deaeration process as described with reference to FIG. 42. Upon completion of the deaeration process, the central controller 150 can proceed directly to a step 4126, at which the central controller 150 can send a “Rinse Complete” or similar message to the control system. At a step 4127, the rinse process is complete.

In some instances, any of the steps of the method 4100 may be performed more than once. Furthermore, in some instances, any of the steps of the method 4100 may be omitted depending on the instance.

Turning T now to FIG. 42, a method 4200 for performing a deaeration process for a hybrid filter assembly is illustrated. The method 4200 can be utilized in a pool automation system or an aquatic environment (e.g., aquatic application 100 of FIG. 1) that includes any of the hybrid filter assemblies described herein, including the hybrid filter assembly 200 of FIG. 2 and/or the hybrid filter assembly 5500 of FIG. 33A. In some instances, the method 4200 can be performed as part of the backwash process described with reference to FIG. 39, the chemical soak process described with reference to FIG. 40, and/or the rinse process described with reference to FIG. 41. In addition, in some cases, the method 4200 may be performed as part of the main flow process described with reference to FIG. 38. In some instances, the method 4200 can be implemented as computer-readable instructions on a non-transitory medium (e.g., a random access memory, a hard drive, etc.) and executed by a processor (e.g., a CPU, a GPU, etc.). In some aspects, the method 4200 can include more or fewer steps depending on the instance.

At a step 4201, the deaeration process is initiated. At a step 4202, the central controller 150 can determine whether there is system flow. If there is system flow (i.e., “YES” at the step 4202), the central controller 150 can proceed directly to a step 4208 as described below, thereby bypassing the pump startup sequence. If there is no system flow (i.e., “NO” at the step 4202), the central controller 150 can proceed to a step 4203, at which the central controller 150 can request the control system (e.g., IntelliCenter) to turn on the pump (e.g., the variable speed pump 122 and/or the booster pump 123) at a requested speed. At a step 4204, the central controller 150 can determine whether the pump flow ramp duration has expired. In some instances, the pump flow ramp duration is a period of time allotted for the pump to ramp up to the requested flow rate before the flow rate is read, thereby allowing the pump sufficient time to ramp before reading the flow rate. If the pump flow ramp duration has not expired (i.e., “NO” at the step 4204), the central controller 150 can loop back to the step 4204 to continue waiting. If the pump flow ramp duration has expired (i.e., “YES” at the step 4204), the central controller 150 can proceed to a step 4205, at which the central controller 150 can read the flow rate. At a step 4206, the central controller 150 can determine whether the flow rate is greater than or equal to the requested flow rate. If the flow rate is not meeting the requested flow rate (i.e., “NO” at the step 4206), the central controller 150 can proceed to a step 4207, at which the central controller 150 can send a deaeration flow rate error to the control system. Upon sending the deaeration flow rate error at the step 4207, or if the flow rate is meeting or exceeding the requested flow rate (i.e., “YES” at the step 4206), the central controller 150 can proceed to a step 4208.

At the step 4208, the central controller 150 can open the air relief valve. At a step 4209, the central controller 150 can read the air relief water sensor. At a step 4210, the central controller 150 can determine whether water has been detected at the air relief water sensor. If water has not been detected (i.e., “NO” at the step 4210), the central controller 150 can determine, at a step 4211, whether a timeout timer is running. If a timeout timer is not running (i.e., “NO” at the step 4211), the central controller 150 can start a water detection timer at a step 4212. If a timeout timer is already running (i.e., “YES” at the step 4211), or upon starting the timer at the step 4212, the central controller 150 can determine, at a step 4213, whether the timeout has expired. If the timeout has not expired (i.e., “NO” at the step 4213), the central controller 150 can loop back to the step 4209 to continue reading the air relief water sensor. If the timeout has expired (i.e., “YES” at the step 4213), the central controller 150 can proceed to a step 4214, at which the central controller 150 can close the air relief valve. At a step 4215, the central controller 150 can increment the retry counter. At a step 4216, the central controller 150 can determine whether the retry count is greater than the maximum retry count. If the retry count is not greater than the maximum retry count (i.e., “NO” at the step 4216), the central controller 150 can loop back to the step 4202 to recheck for system flow and restart the deaeration attempt. If the retry count is greater than the maximum retry count (i.e., “YES” at the step 4216), the central controller 150 can proceed to a step 4217, at which the central controller 150 can send a deaeration water not detected error to the control system. At a step 4218, the central controller 150 can close the air relief valve, thereby ending the deaeration process on an error path.

If water has been detected at the step 4210 (i.e., “YES” at the step 4210), the central controller 150 can proceed to a step 4219, at which the central controller 150 can determine whether a water detection timer is running. If a water detection timer is not running (i.e., “NO” at the step 4219), the central controller 150 can start a water detection timer at a step 4220. If a water detection timer is already running (i.e., “YES” at the step 4219), or upon starting the timer at the step 4220, the central controller 150 can determine, at a step 4221, whether the timer has expired. If the timer has not expired (i.e., “NO” at the step 4221), the central controller 150 can loop back to the step 4209 to continue reading the air relief water sensor. If the timer has expired (i.e., “YES” at the step 4221), the central controller 150 can proceed to a step 4222.

At the step 4222, the central controller 150 can close the air relief valve. At a step 4223, the central controller 150 can read the air relief water sensor. At a step 4224, the central controller 150 can determine whether water has been detected. If water has not been detected (i.e., “NO” at the step 4224), the central controller 150 can proceed to a step 4225, at which the central controller 150 can send a Deaeration Complete message to the control system. At a step 4226, the deaeration process is complete. If water has been detected (i.e., “YES” at the step 4224), the central controller 150 can proceed to a step 4227, at which the central controller 150 can open the air relief valve. At a step 4228, the central controller 150 can close the air relief valve. At a step 4229, the central controller 150 can read the air relief water sensor. At a step 4230, the central controller 150 can determine whether water has been detected. If water has not been detected (i.e., “NO” at the step 4230), the central controller 150 can loop back to the step 4225 to send the Deaeration Complete message to the control system. If water has been detected (i.e., “YES” at the step 4230), the central controller 150 can proceed to a step 4231, at which the central controller 150 can increment the retry counter. At a step 4232, the central controller 150 can determine whether the retry number is greater than or equal to the maximum retry count. If the retry number is not greater than or equal to the maximum retry count (i.e., “NO” at the step 4232), the central controller 150 can loop back to the step 4227 to open the air relief valve and continue the deaeration attempt. If the retry number is greater than or equal to the maximum retry count (i.e., “YES” at the step 4232), the central controller 150 can proceed to a step 4233, at which the central controller 150 can send a deaeration valve stuck or leaking alert to the control system, and then proceed to a step 4234.

At the step 4234, the central controller 150 can determine whether there is system flow. If there is system flow (i.e., “YES” at the step 4234), the central controller 150 can proceed to a step 4235, at which the central controller 150 can request the control system to stop the pump. At a step 4236, the central controller 150 can determine whether the pump has stopped. If the pump has not stopped (i.e., “NO” at the step 4236), the central controller 150 can determine, at a step 4237, whether a timeout timer is running. If a timeout timer is not running (i.e., “NO” at the step 4237), the central controller 150 can start a timer for a timeout period at a step 4238. If a timeout timer is already running (i.e., “YES” at the step 4237), or upon starting the timer at the step 4238, the central controller 150 can determine, at a step 4239, whether the timeout has expired. If the timeout has not expired (i.e., “NO” at the step 4239), the central controller 150 can loop back to the step 4236 to continue checking whether the pump has stopped. If the timeout has expired (i.e., “YES” at the step 4239), the central controller 150 can proceed to a step 4240, at which the central controller 150 can send a pump stop error to the control system. In some instances, the duration of the timeout period can be an adjustable value configurable via the backend. Upon confirming that the pump has stopped (i.e., “YES” at the step 4236), or if there is no system flow (i.e., “NO” at the step 4234), the central controller 150 can proceed to a step 4241, at which the central controller 150 can rotate the one or more valves to a bypass state.

At a step 4242, the central controller 150 can determine whether the one or more valves have reached the bypass position. If the one or more valves have not reached the bypass position (i.e., “NO” at the step 4242), the central controller 150 can determine, at a step 4243, whether a timeout timer is running. If a timeout timer is not running (i.e., “NO” at the step 4243), the central controller 150 can start a timer for a timeout period at a step 4244. If a timeout timer is already running (i.e., “YES” at the step 4243), or upon starting the timer at the step 4244, the central controller 150 can determine, at a step 4245, whether the timeout has expired. If the timeout has not expired (i.e., “NO” at the step 4245), the central controller 150 can loop back to the step 4242 to continue checking whether the one or more valves have reached the bypass position. If the timeout has expired (i.e., “YES” at the step 4245), the central controller 150 can proceed to a step 4246, at which the central controller 150 can send a valve rotate error to the control system. In some instances, the duration of the timeout period can be an adjustable value configurable via the backend. Upon confirming that the one or more valves have reached the bypass position (i.e., “YES” at the step 4242), the central controller 150 can proceed to a step 4247, at which the central controller 150 can inform the control system that valve rotation is complete. At a step 4248, the deaeration process is complete.

In some instances, any of the steps of the method 4200 may be performed more than once. Furthermore, in some instances, any of the steps of the method 4200 may be omitted depending on the instance.

It is to be understood that the above methods described with reference to FIGS. 20-32 can be implemented in the aquatic application 100 in FIG. 1 and the hybrid filter assembly 200 in FIG. 2. Additionally, the methods described with reference to FIGS. 20-32 and FIGS. 34-37 can be implemented in the aquatic application 100 in FIG. 1 and the hybrid filter assembly 5500 in FIG. 33A. Additionally, the methods described with reference to FIGS. 38-42 (e.g., method 3800 of FIG. 38, method 3900 of FIG. 39, method 4000 of FIG. 40, method 4100 of FIG. 41, and method 4200 of FIG. 42) can be implemented in the aquatic application 100 in FIG. 1 and in any of the hybrid filter assemblies described herein, including the hybrid filter assembly 200 in FIG. 2 and the hybrid filter assembly 5500 in FIG. 33A. In some aspects, the methods 4200-5400 and 5600-5900 can include more or fewer steps depending on the instance, and any of the steps of the methods 4200-5400 and 5600-5900 may be performed more than once. Furthermore, any of the steps of the methods 4200-5400 and 5600-5900 may be omitted.

Further, as discussed above, the central controller 150 can be configured to perform the above methods. Referring back to FIG. 1, the central controller 150 can receive data from one or more of the components of the aquatic application 100, analyze the data as discussed herein, and execute one or more of the methods described above. Thus, the central controller 150 can create a communication link that operatively connects the plurality of system components. Accordingly, the central controller 150 can include one or more of a receiver, a memory, a processor, and a transmitter. In some instances, the central controller and the controller 5528 in the hybrid filter assembly 5500 perform at least a portion of one or more of the methods above.

The receiver can be configured to receive transmitted data from the aquatic application 100. For example, as discussed above, the aquatic application 100 can include one or more of a flow meter, a pressure transducer, a temperature sensor, and the like to monitor various system operational parameters. Thus, the receiver can receive the transmitted data from the one or more sensors. In some instances, the receiver can receive data inputs from a user. For example, a user can input a schedule for a cleaning operation.

The memory can be configured to store system information received from the one or more system components and/or user inputs. In some instances, the memory can be integrated with one or more of the system components discussed herein. In other instances, the memory can be implemented as a standalone memory unit.

The processor can be a programmable processor communicatively coupled to the memory. In some instances, the programmable processor can include program instructions that are stored on a cloud server or a non-transitory computer-readable medium and that are executable by the programmable processor to perform one or more of the methods described herein.

The transmitter can be configured to send the instructions from the processor to the one or more system components. Thus, the above methods can be automated.

Further, in some instances, one or more of the above methods can use machine learning (ML), artificial intelligence (AI), or similar, to iteratively train the central controller and improve the performance of the system based on one or more feedback parameters, characteristics, or similar. For example, in some instances, ML/AI can be used to predict an optimal cleaning schedule based on system data such as filter loading data, bather load data, geographic location of the system, weather data, user preferences, and the like. In some instances, ML/AI can be used to provide accurate chemical dosing and/or predict chemical usage trends. Thus, the system can be optimized to reduce fluctuations in the chemical dosage. This can be beneficial because it can reduce the likelihood of high chemical concentrations in the pool water which can irritate bathers. Additionally, it can help a user determine an amount of chemicals that are needed for the system and/or when to reorder chemicals.

It is to be understood that the methods described herein with reference to FIGS. 20-42 are not limited to implementation with any particular apparatus or hybrid filter assembly configuration. Rather, the disclosed methods can be implemented in any suitable hybrid filtration system that includes a controller, one or more membrane filters, a prefilter, and associated components capable of performing the recited method steps. The specific apparatus components described in conjunction with the methods are provided as non-limiting examples to illustrate possible implementations, and the methods are not limited to use with those specific structural embodiments.

It will be appreciated by those skilled in the art that while the above disclosure has been described above in connection with particular instances and examples, the above disclosure is not necessarily so limited, and that numerous other instances, examples, uses, modifications, and departures from the instances, examples, and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

We claim:

1. A filtration system comprising:
a pump in fluid communication with a pool or a spa;
a hybrid filter assembly comprising:
one or more membrane filters;
a prefilter in fluid communication with the one or more membrane filters; and
a valve comprising:
a first port in fluid communication with the one or more membrane filters;
a second port in fluid communication with the prefilter;
a third port in fluid communication with the pump and designed to receive pressurized water provided from the pump;
a fourth port in fluid communication with the pool or the spa; and
a fifth port in fluid communication with a waste system;
a chemical cleaning system including a container designed to retain a chemical cleaning agent, wherein the container is in fluid communication with the hybrid filter assembly; and
a controller in communication with the valve and the chemical cleaning system and designed to:
actuate the valve to a filtration configuration, wherein the valve couples the third port to the second port and the first port to the fourth port;
direct the chemical cleaning system to dose the one or more membrane filters with the chemical cleaning agent; and
actuate the valve to a backwash configuration, wherein the valve couples the third port to the first port and the second port to the fifth port.

2. The filtration system of claim 1, wherein the controller is further designed to determine an operational efficiency of the filtration system at predetermined time intervals.

3. The filtration system of claim 2, wherein the controller is further designed to determine if a first permeability value determined at a first time period associated with the predetermined time intervals is below a first threshold permeability value.

4. The filtration system of claim 1, wherein the controller is further designed to retain the chemical cleaning agent within an interior of the one or more membrane filters for at least about 1 hour before actuating the valve to the backwash configuration.

5. The filtration system of claim 1, wherein the controller is further designed to actuate the valve to a rinse configuration, in which the valve couples the third port to the second port and the first port to the fifth port.

6. The filtration system of claim 1, wherein the controller is further designed to:
determine a first permeability value of the one or more membrane filters at a first time period;
determine a second permeability value of the one or more membrane filters at a second time period;
actuate the valve to the backwash configuration if the first permeability value is less than a first permeability threshold value; and
direct the chemical cleaning system to dose the one or more membrane filters with the chemical cleaning agent if the second permeability value is less than a second permeability threshold value and the second time period is after the first time period.

7. The filtration system of claim 1, wherein the controller is further designed to determine if a permeability value of the one or more membrane filters is less than about 350.

8. The filtration system of claim 1, wherein the controller is further designed to actuate the valve to a bypass configuration, wherein the valve couples the third port to the fourth port.

9. A filtration system comprising:
a pump in fluid communication with a pool or a spa;
a hybrid filter assembly in fluid communication with the pump, comprising:
a first membrane filter;
a prefilter arranged upstream of the first membrane filter when the hybrid filter assembly operates in a filtration mode, the prefilter fluidly coupled to the first membrane filter; and
a valve comprising:
a first port in fluid communication with the first membrane filter;
a second port in fluid communication with the prefilter;
a third port in fluid communication with the pump and configured to receive pressurized water;
a fourth port in fluid communication with the pool or the spa; and
a fifth port in fluid communication with a waste system;
a chemical cleaning system in fluid communication with the hybrid filter assembly and including a chemical cleaning agent; and
a controller in communication with the valve and the chemical cleaning system and configured to:
actuate the valve in a filtration configuration;
monitor a permeability value of the first membrane filter within the filtration configuration;
actuate the valve in a bypass configuration in response to the permeability value falling below a minimum permeability threshold value;
direct the chemical cleaning system to dose the first membrane filter with the chemical cleaning agent; and
actuate the valve in a backwash configuration.

10. The filtration system of claim 9, wherein the controller is further configured to:
actuate the valve in a rinse configuration;
request the pump to operate at a requested flow rate; and
maintain the valve in the rinse configuration until a predetermined rinse volume has been processed.

11. The filtration system of claim 9, wherein the controller is further configured to maintain the chemical cleaning agent within an interior of the first membrane filter for at least about one hour before actuating the valve to the backwash configuration.

12. The filtration system of claim 9, wherein the chemical cleaning agent comprises a chlorine-containing compound.

13. The filtration system of claim 9, wherein the controller is further configured to:
receive a pool temperature value;
determine that the pool temperature value is below a temperature threshold value; and
decrease a permeability threshold value.

14. The filtration system of claim 9, wherein the controller is further configured to:
receive a pool temperature value;
determine that the pool temperature value is below a temperature threshold value; and
increase a dose value.

15. The filtration system of claim 9, wherein the controller is further configured to:
receive a pool temperature value;
determine that the pool temperature value is below a first temperature threshold value;
decrease a permeability threshold value;
determine that the pool temperature value is below a second temperature threshold value; and
increase a dose value.

16. A filtration system comprising:
a pump in fluid communication with a pool or a spa;
a hybrid filter assembly in fluid communication with the pump, comprising:
a membrane module;
a prefilter in fluid communication with the membrane module, the prefilter provided upstream of the membrane module when the hybrid filter assembly operates in a filtration mode; and
an electrically-actuatable valve comprising:
a first port in fluid communication with the membrane module;
a second port in fluid communication with the prefilter;
a third port in fluid communication with the pump and configured to receive pressurized water;
a fourth port in fluid communication with the pool or the spa; and
a fifth port in fluid communication with a waste system;
an air relief valve in fluid communication with the hybrid filter assembly;
an air relief water sensor positioned at an air relief valve outlet and configured to detect a water presence;
a chemical cleaning system in fluid communication with the hybrid filter assembly and including a chemical cleaning agent; and
a controller in communication with at least one of the electrically-actuatable valve, the air relief valve, the air relief water sensor, and the chemical cleaning system.

17. The filtration system of claim 16, wherein the controller is configured to:
actuate the electrically-actuatable valve in a filtration configuration, wherein the electrically-actuatable valve couples the third port to the second port and the first port to the fourth port;
determine that the hybrid filter assembly requires a backwash cycle;
actuate the electrically-actuatable valve in a bypass configuration, wherein the electrically-actuatable valve couples the third port to the fourth port;
direct the chemical cleaning system to dose the membrane module with the chemical cleaning agent; and
actuate the electrically-actuatable valve in a backwash configuration, wherein the electrically-actuatable valve couples the third port to the first port and the second port to the fifth port.

18. The filtration system of claim 17, wherein the controller is further configured to:
request the pump to operate at a requested flow rate;
open the air relief valve;
receive an indication from the air relief water sensor indicating water is present at the air relief outlet; and
close the air relief valve in response to receiving the indication.

19. The filtration system of claim 16, wherein to determine that the hybrid filter assembly requires a backwash cycle, the controller is further configured to determine that a permeability value is below a minimum permeability threshold value.

20. The filtration system of claim 19, wherein the controller is further configured to:
receive a pool temperature value;
determine that the pool temperature value is below a temperature threshold value; and
decrease the minimum permeability threshold value.
